(19) United States
(12) Patent Application Publication
(10) Pub. No.: US 2024/0122179 A1
(43) Pub. Date: Apr. 18, 2024

(54) AUXINIC HERBICIDES AND METHODS OF USE THEREOF

(71) Applicant: CORTEVA AGRISCIENCE LLC, INDIANAPOLIS, IN (US)

(72) Inventors: DAVID SIMPSON, ZIONSVILLE, IN (US); JEREMY KISTER, CARMEL, IN (US); MEI LI, WESTFIELD, IN (US); BIN WEI, CARMEL, IN (US); JAMES GIFFORD, LEBANON, IN (US)

(73) Assignee: CORTEVA AGRISCIENCE LLC, INDIANAPOLIS, IN (US)

(21) Appl. No.: 18/263,801

(22) PCT Filed: Feb. 4, 2022
(86) PCT No.: PCT/US2022/015283

§ 371 Date: Aug. 1, 2023

Related U.S. Application Data
(60) Provisional application No. 63/145,965, filed on Feb. 4, 2021.

(51) Int. Cl. A01N 37/40; A01N 25/32; A01N 37/22; A01N 41/10; A01N 43/08; A01N 43/10; A01N 43/12; A01N 43/16; A01N 43/36; A01N 43/38; A01N 43/40; A01N 43/42; A01N 43/50; A01N 43/52; A01N 43/54; A01N 43/56; A01N 43/653; A01N 43/72; A01N 43/76; A01N 43/78; A01N 43/80; A01N 43/82; A01N 43/84; A01P 13/00

(52) U.S. Cl. CPC A01N 37/40; A01N 25/32; A01N 37/22; A01N 41/10; A01N 43/08; A01N 43/10; A01N 43/12; A01N 43/16; A01N 43/36; A01N 43/38; A01N 43/40; A01N 43/42; A01N 43/50; A01N 43/52; A01N 43/54; A01N 43/56; A01N 43/653; A01N 43/72; A01N 43/76; A01N 43/78; A01N 43/80; A01N 43/82; A01N 43/84; A01P 13/00

(57) ABSTRACT

At least some aspects of this disclosure include one or more auxinic herbicides with relatively low volatility. Some of these compounds may be especially useful when used in the process of growing commercially important plants. Methods for using these actives to control the growth and spread of unwanted plants and/or to hasten the growth of desirable plants are also disclosed herein.

### FIELD

Aspects herein include herbicidal compositions and methods of controlling unwanted plants. The herbicides disclosed herein may be used alone, in various formulations, or together with other agriculturally actives including other herbicides to control weeds in various crops.

### BACKGROUND

Protecting crops from undesirable vegetation which adversely affect crop growth is a constantly recurring problem in agriculture. To help combat this problem, researchers in the field of synthetic chemistry have produced a variety of chemicals and chemical formulations effective in the control of such unwanted plant growth. Chemical herbicides of many types have been disclosed in the literature and a large number are in commercial use. However, there remains a need for compositions and methods that are effective in controlling undesirable vegetation, and which demonstrate other physiochemical characteristics that make them easy to formulate and to apply under varying field conditions.

### SUMMARY

In a first aspect provided herein includes herbicidal compositions comprising an herbicidally effective amount of (a) a compound of the Formula (I):

A second aspect may include any of the compounds of the first aspect formulated for use as a herbicide.

A third aspect provided herein includes any of the compounds and/or formulation of the first and second aspects further inducting at least one additional herbicidally active compound.

A fourth aspect includes a method of controlling weeds by applying any of the compounds and/or formulation of the first, second or third aspects to a plant, or to soil.

Included herein are compounds according to Formula I:

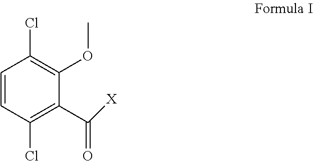

wherein X is:

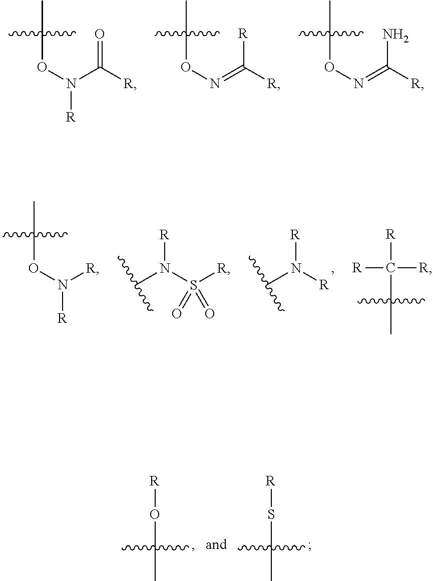

wherein R is independently selected from the group consisting of:
alkyl, aryl, or heteroaryl, wherein the compound exhibits herbicidal activity.
   Some of the compounds included herein are compounds wherein X is:

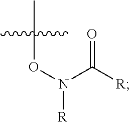

and
R is selected from the group consisting of; alkyl, aryl, or heteroaryl;
wherein, the compound exhibits herbicidal activity.
   Also included herein are compounds wherein X is:

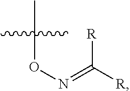

and
R is selected from the group consisting of: alkyl, aryl, or heteroaryl;
wherein the compound exhibits herbicidal activity.
   Also included herein are compounds wherein X is one or more tautomers of:

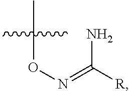

and
R is selected from the group consisting of: alkyl, aryl, or heteroaryl;
wherein the compound exhibits herbicidal activity.
   Also included herein are compounds wherein X is:

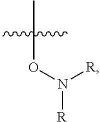

and
R is selected from the group consisting of: alkyl, aryl, or heteroaryl;
wherein the compound exhibits herbicidal activity.
   Also included herein are compounds comprising at least one compound with herbicidal activity selected from the group consisting of:

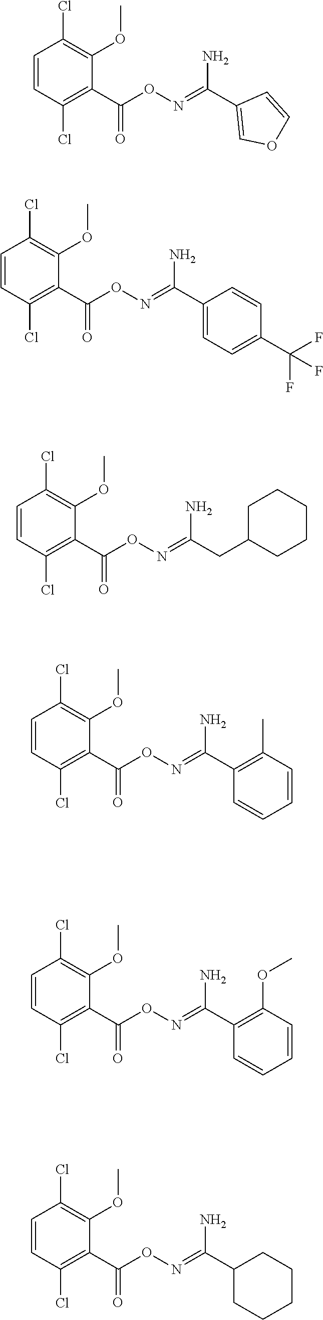 [SMILES: COc1c(Cl)ccc(Cl)c1C(=O)O/N=C(\N)c1ccoc1 ; COc1c(Cl)ccc(Cl)c1C(=O)O/N=C(\N)c1ccc(C(F)(F)F)cc1 ; COc1c(Cl)ccc(Cl)c1C(=O)O/N=C(\N)CC1CCCCC1 ; COc1c(Cl)ccc(Cl)c1C(=O)O/N=C(\N)c1ccccc1C ; COc1ccccc1/C(N)=N/OC(=O)c1c(Cl)ccc(Cl)c1OC ; COc1c(Cl)ccc(Cl)c1C(=O)O/N=C(\N)C1CCCCC1]

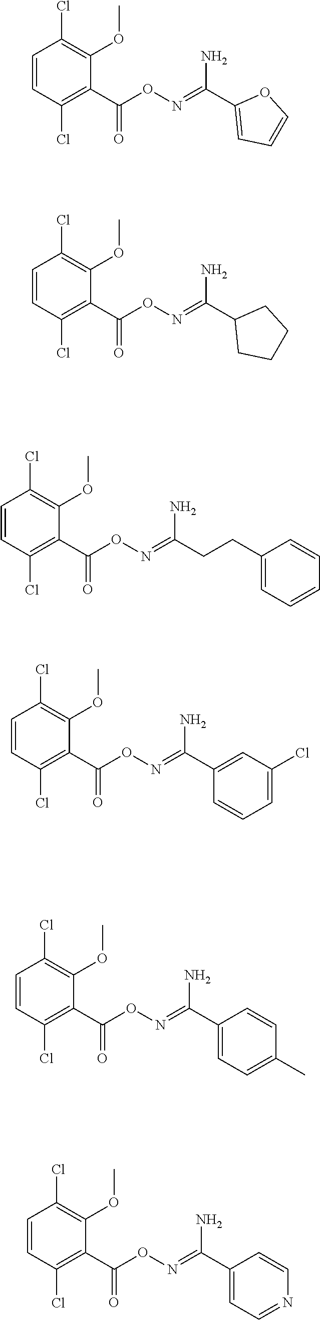 [SMILES: COc1c(Cl)ccc(Cl)c1C(=O)O/N=C(\N)c1ccco1 ; COc1c(Cl)ccc(Cl)c1C(=O)O/N=C(\N)C1CCCC1 ; COc1c(Cl)ccc(Cl)c1C(=O)O/N=C(\N)CCc1ccccc1 ; COc1c(Cl)ccc(Cl)c1C(=O)O/N=C(\N)c1cccc(Cl)c1 ; COc1c(Cl)ccc(Cl)c1C(=O)O/N=C(\N)c1ccc(C)cc1 ; COc1c(Cl)ccc(Cl)c1C(=O)O/N=C(\N)c1ccncc1]

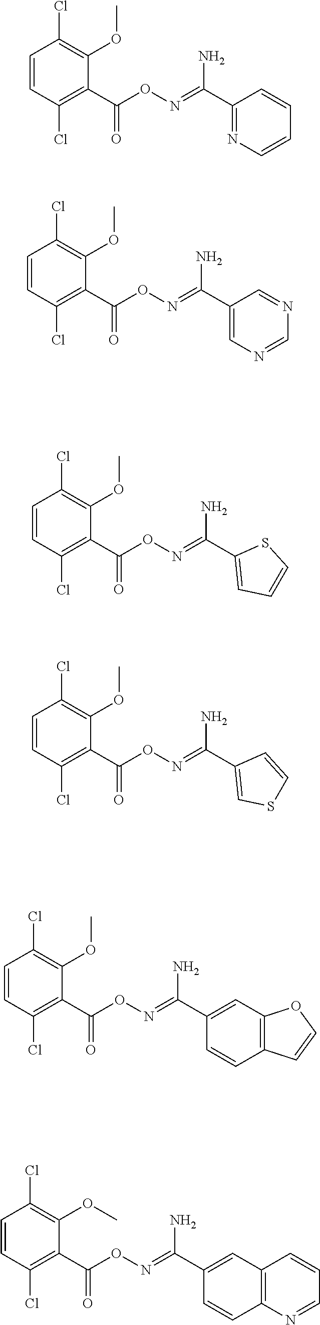 [SMILES: COc1c(Cl)ccc(Cl)c1C(=O)O/N=C(\N)c1ccccn1 ; COc1c(Cl)ccc(Cl)c1C(=O)O/N=C(\N)c1cncnc1 ; COc1c(Cl)ccc(Cl)c1C(=O)O/N=C(\N)c1cccs1 ; COc1c(Cl)ccc(Cl)c1C(=O)O/N=C(\N)c1ccsc1 ; COc1c(Cl)ccc(Cl)c1C(=O)O/N=C(\N)c1ccc2ccoc2c1 ; COc1c(Cl)ccc(Cl)c1C(=O)O/N=C(\N)c1ccc2ncccc2c1]

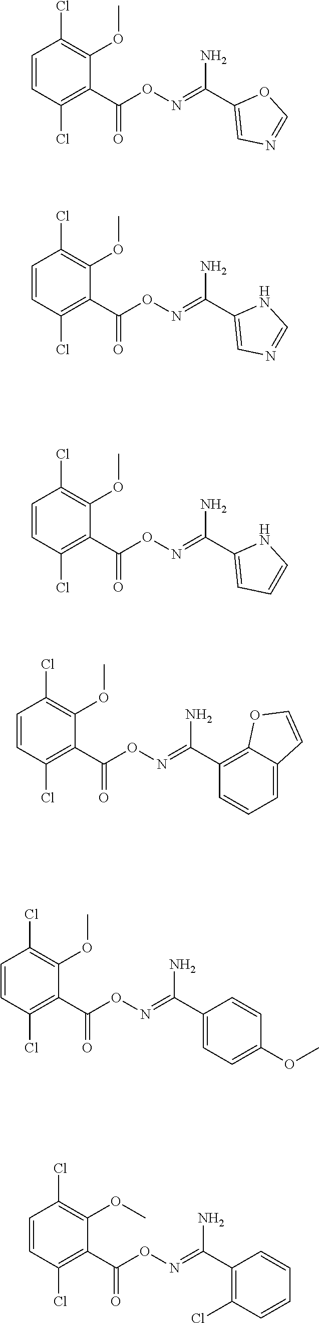 [SMILES: COc1c(Cl)ccc(Cl)c1C(=O)O/N=C(\N)c1cnco1 ; COc1c(Cl)ccc(Cl)c1C(=O)O/N=C(\N)c1cnc[nH]1 ; COc1c(Cl)ccc(Cl)c1C(=O)O/N=C(\N)c1ccc[nH]1 ; COc1c(Cl)ccc(Cl)c1C(=O)O/N=C(\N)c1cccc2ccoc12 ; COc1ccc(/C(N)=N/OC(=O)c2c(Cl)ccc(Cl)c2OC)cc1 ; COc1c(Cl)ccc(Cl)c1C(=O)O/N=C(\N)c1ccccc1Cl]

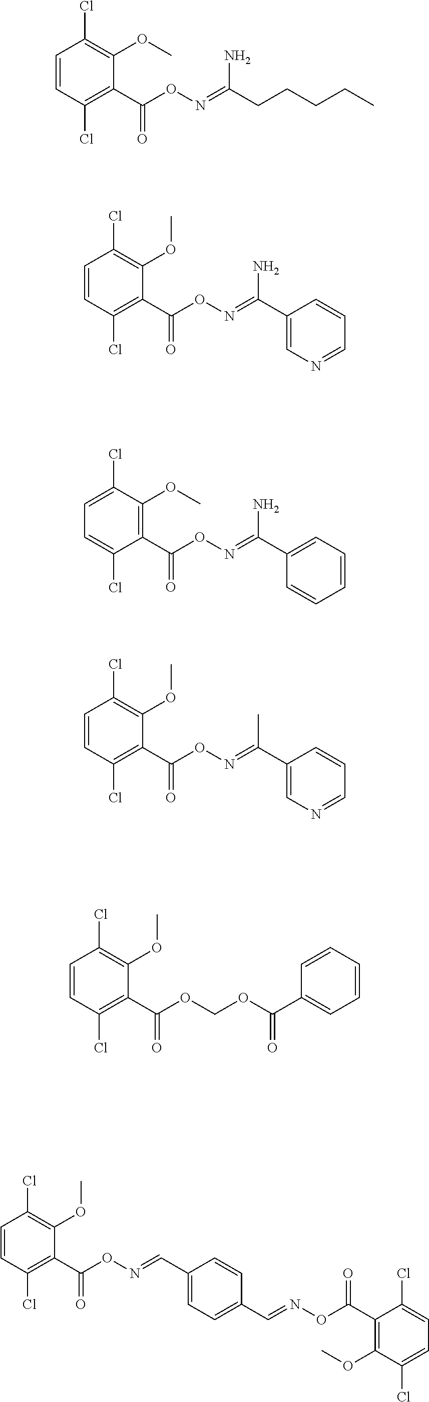 [SMILES: CCCCC/C(N)=N/OC(=O)c1c(Cl)ccc(Cl)c1OC ; COc1c(Cl)ccc(Cl)c1C(=O)O/N=C(\N)c1cccnc1 ; COc1c(Cl)ccc(Cl)c1C(=O)O/N=C(\N)c1ccccc1 ; COc1c(Cl)ccc(Cl)c1C(=O)O/N=C(\C)c1cccnc1 ; COc1c(Cl)ccc(Cl)c1C(=O)OCOC(=O)c1ccccc1 ; COc1c(Cl)ccc(Cl)c1C(=O)O/N=C/c1ccc(/C=N/OC(=O)c2c(Cl)ccc(Cl)c2OC)cc1]

Also included herein are any compounds of the compounds above, wherein the at least one compound exhibits lower volatility, than 3,6-dichloro-2-methoxybenzoic acid.
Also included herein are compounds comprising: one or more compounds selected from the group of compounds recited in Table 2, wherein the one or more compounds exhibit herbicidal activity. For example, some compounds include one or more compounds selected from the group of compounds recited in Table 2, wherein the one or more compounds are less volatile than 3,6-dichloro-2-methoxybenzoic acid.
Also included herein are various methods of treating a field, comprising the steps of obtaining at least one compound according to claim 1-9, and applying an agriculturally effective amount of the at least one compound to a field.
Also included herein are various methods of treating a plant, comprising the steps of obtaining at least one compound according to claim 1-9, and applying an agriculturally effective amount of the at least one compound to a plant.

Some embodiments of to the invention are the embodiments listed as 1 through 1-43 of the following portions of the summary section:

1. A compound, comprising at a compound according to Formula I:

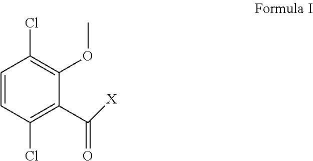

wherein X is:

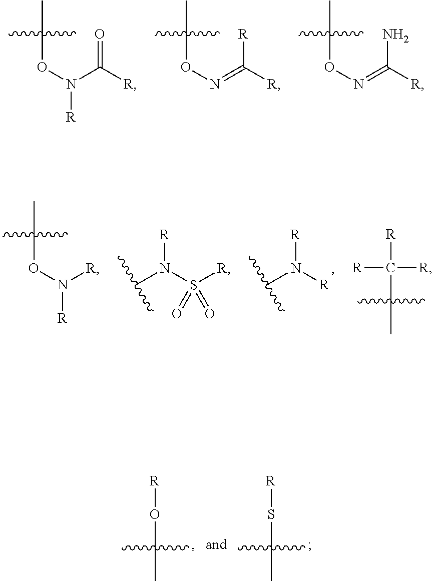

wherein R is independently selected from the group consisting of: alkyl, aryl, or heteroaryl,
wherein the compound exhibits herbicidal activity.

2. A compound according to claim 1, wherein X is:

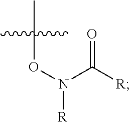

and R is selected from the group consisting of; alkyl, aryl, or heteroaryl; wherein; the compound exhibits herbicidal activity.

3. The compound according to claim 1, wherein, X is:

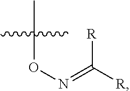

and R is selected from the group consisting of; alkyl, aryl, or heteroaryl; wherein the compound exhibits herbicidal activity.

4. The compound according to claim 1, wherein, Xa is one or more tautomers of:

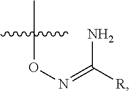

and R is selected from the group consisting of; alkyl, aryl, or heteroaryl; wherein the compound exhibits herbicidal activity.

5. The compound according to claim 1, wherein, X is:

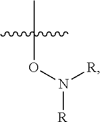

and R is selected from the group consisting of; alkyl, aryl, or heteroaryl;
   wherein the compound exhibits herbicidal activity.

6. A compound according to claim 1, comprising at least one compound with herbicidal activity selected from the group consisting of:

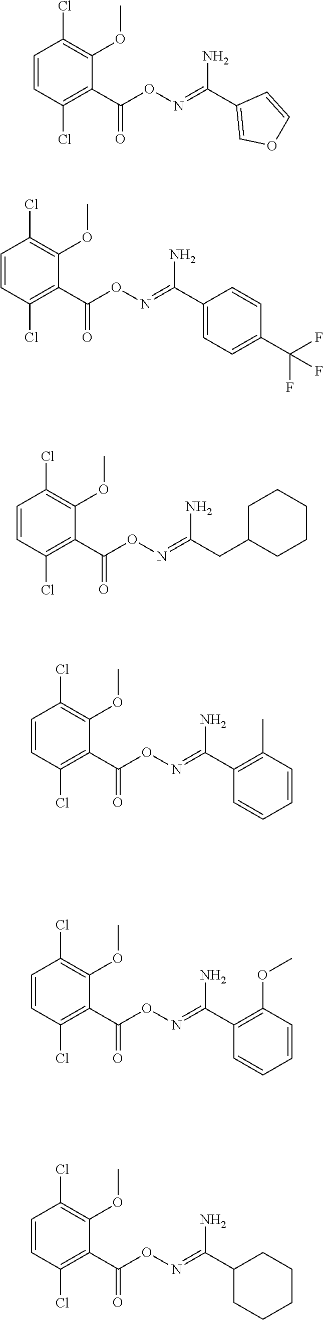 [SMILES: COc1c(Cl)ccc(Cl)c1C(=O)O/N=C(\N)c1ccoc1 ; COc1c(Cl)ccc(Cl)c1C(=O)O/N=C(\N)c1ccc(C(F)(F)F)cc1 ; COc1c(Cl)ccc(Cl)c1C(=O)O/N=C(\N)CC1CCCCC1 ; COc1c(Cl)ccc(Cl)c1C(=O)O/N=C(\N)c1ccccc1C ; COc1ccccc1/C(N)=N/OC(=O)c1c(Cl)ccc(Cl)c1OC ; COc1c(Cl)ccc(Cl)c1C(=O)O/N=C(\N)C1CCCCC1]

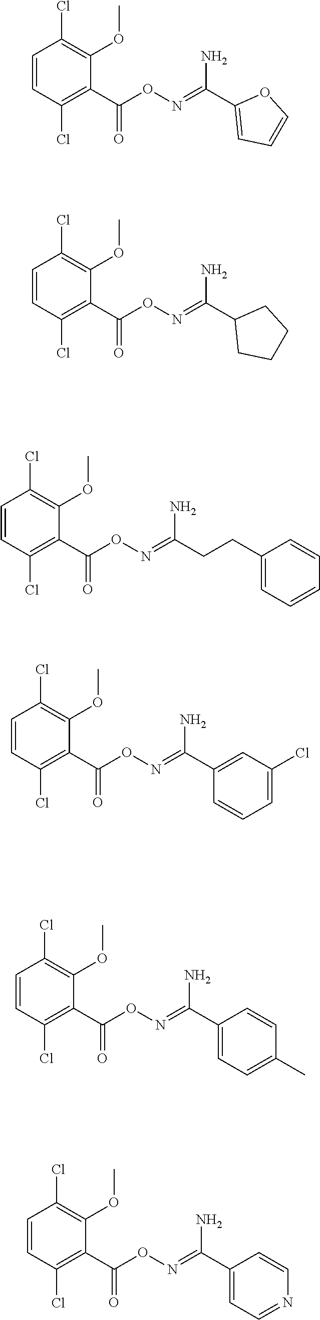 [SMILES: COc1c(Cl)ccc(Cl)c1C(=O)O/N=C(\N)c1ccco1 ; COc1c(Cl)ccc(Cl)c1C(=O)O/N=C(\N)C1CCCC1 ; COc1c(Cl)ccc(Cl)c1C(=O)O/N=C(\N)CCc1ccccc1 ; COc1c(Cl)ccc(Cl)c1C(=O)O/N=C(\N)c1cccc(Cl)c1 ; COc1c(Cl)ccc(Cl)c1C(=O)O/N=C(\N)c1ccc(C)cc1 ; COc1c(Cl)ccc(Cl)c1C(=O)O/N=C(\N)c1ccncc1]

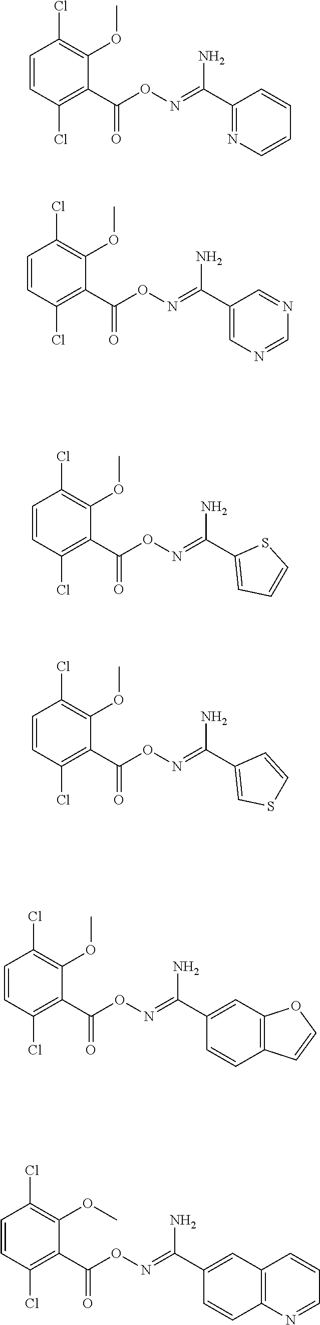 [SMILES: COc1c(Cl)ccc(Cl)c1C(=O)O/N=C(\N)c1ccccn1 ; COc1c(Cl)ccc(Cl)c1C(=O)O/N=C(\N)c1cncnc1 ; COc1c(Cl)ccc(Cl)c1C(=O)O/N=C(\N)c1cccs1 ; COc1c(Cl)ccc(Cl)c1C(=O)O/N=C(\N)c1ccsc1 ; COc1c(Cl)ccc(Cl)c1C(=O)O/N=C(\N)c1ccc2ccoc2c1 ; COc1c(Cl)ccc(Cl)c1C(=O)O/N=C(\N)c1ccc2ncccc2c1]

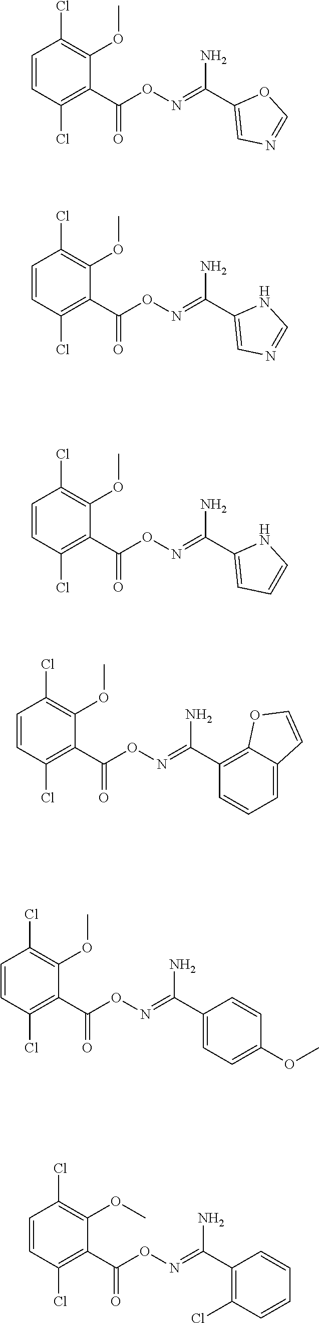 [SMILES: COc1c(Cl)ccc(Cl)c1C(=O)O/N=C(\N)c1cnco1 ; COc1c(Cl)ccc(Cl)c1C(=O)O/N=C(\N)c1cnc[nH]1 ; COc1c(Cl)ccc(Cl)c1C(=O)O/N=C(\N)c1ccc[nH]1 ; COc1c(Cl)ccc(Cl)c1C(=O)O/N=C(\N)c1cccc2ccoc12 ; COc1ccc(/C(N)=N/OC(=O)c2c(Cl)ccc(Cl)c2OC)cc1 ; COc1c(Cl)ccc(Cl)c1C(=O)O/N=C(\N)c1ccccc1Cl]

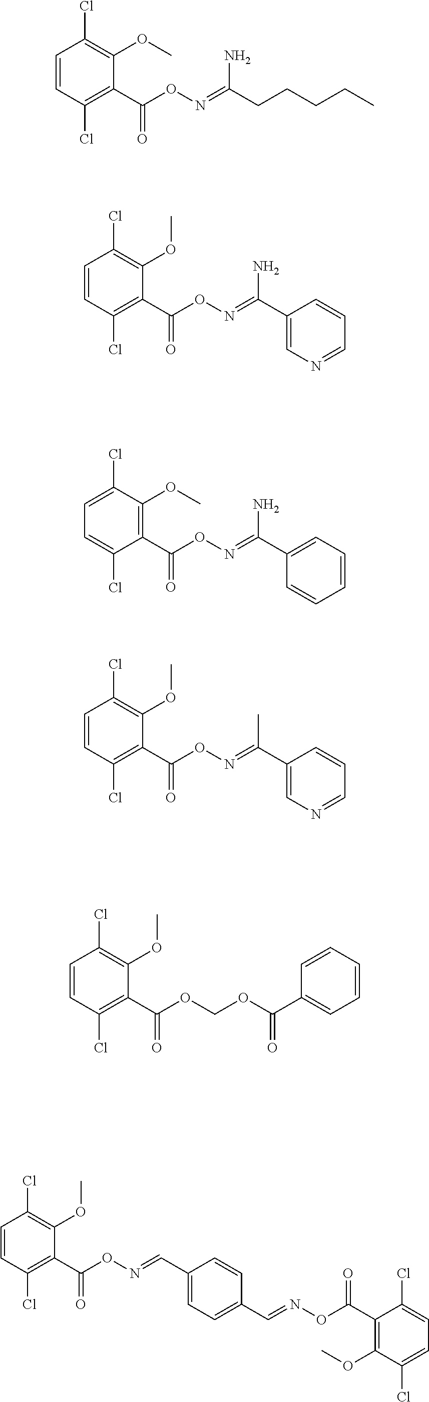 [SMILES: CCCCC/C(N)=N/OC(=O)c1c(Cl)ccc(Cl)c1OC ; COc1c(Cl)ccc(Cl)c1C(=O)O/N=C(\N)c1cccnc1 ; COc1c(Cl)ccc(Cl)c1C(=O)O/N=C(\N)c1ccccc1 ; COc1c(Cl)ccc(Cl)c1C(=O)O/N=C(\C)c1cccnc1 ; COc1c(Cl)ccc(Cl)c1C(=O)OCOC(=O)c1ccccc1 ; COc1c(Cl)ccc(Cl)c1C(=O)O/N=C/c1ccc(/C=N/OC(=O)c2c(Cl)ccc(Cl)c2OC)cc1]

7. The compounds according to claims 1-7, wherein the said least one compound exhibits lower volatility, than 3,6-dichloro-2-methoxybenzoic acid.

8. A compound, comprising: one or more compounds selected from the group of compounds recited in Table 2, wherein the one or more compounds exhibit herbicidal activity.

9. A compound, comprising: one or more compounds selected from the group of compounds recited in Table 2, wherein the one or more compounds are less volatile than 3,6-dichloro-2-methoxybenzoic acid.

10. A formulation, comprising: any of the compounds of claims 8-9, and at least one addition herbicide.

11. A formation, comprising: any of the compounds of claims 8-9, and at least one safener.

12. A method of treating a field, comprising the steps of: obtaining at least one compound according to claims 8-9, or at least one formulation according to claims, 10-11; and applying an agriculturally effective amount of the at least one of the compounds or at least one of the formulations to a field.

13. A method of treating a plant, comprising the steps of: obtaining at least one compound according to claim 8-9, or at least one formulation according to claims 10-11; and applying an agriculturally effective amount of the at least one of the compounds, or at least one of the formulations to a plant.

14. A compound, comprising, at least one compound selected from the compounds listed in Table 2.

15. The compound according to claim 14, wherein the compound exhibits herbicidal activity.

16. A formulation, comprising: at least one compound selected from the compounds according to claims 14-15: and at least one additional agriculturally active compound.

17. The formulation, according to claim 16, wherein the at least one additional agriculturally active compound is selected from the group consisting of: herbicides, insecticides, fungicides, and miticides.

18. The formulation, according to claim 17, wherein the at least one additional agriculturally active compound is an herbicide.

19. The formulation according to claim 18, wherein the at least one additional agriculturally active compound is an herbicide selected from the group consisting of acetolactate synthase (ALS) inhibitor herbicides, synthetic auxin herbicides, phytoene desaturase (PDS) inhibitor herbicides, glyphosate, glufosinate, photosystem II inhibitor herbicides, ACCase inhibitor herbicides, HPPD inhibitor herbicides, PROTOX inhibitor herbicides, plant growth regulator herbicides, cellulose biosynthesis inhibitor herbicides, very long chain fatty acid herbicides, microtubule assembly inhibitor herbicides, fatty acid and lipid synthesis inhibitor herbicides, and combinations thereof.

20. The formulation according to claim 18, wherein the herbicide is an acetolactate synthase inhibitor herbicide selected from the group consisting of: sulfonylureas, imidazolinones, triazolopyrimidine sulfonamides, pyrimidinyl oxybenzoates, sulfonylaminocarbonyl triazolinones, agriculturally acceptable salts and esters thereof, and combinations thereof.

21. The formulation according to claim 18, wherein the herbicide is an acetolactate synthase inhibitor herbicide selected from the group consisting of: clodinafop, cyhalofop, diclofop, fenoxaprop, fenthiaprop, fluazifop, haloxyfop, metamifop, propaquizafop, quizalofop, alloxydim, butroxydim, clethodim, cloproxydim, cycloxydim, pinoxaden, profoxydim, sethoxydim, tepraloxydim, tralkoxydim, agriculturally acceptable salts or esters thereof, or combinations thereof

22. The formulation according to claim 18, wherein the herbicide is a synthetic auxin herbicide selected from the group consisting of: phenoxy herbicides, benzoic acid herbicides, aryl picolinate herbicides, pyridine carboxylate herbicides, quinoline carboxylic acid herbicides, pyrimidine carboxylic acid herbicides, benzothiazole herbicides, agriculturally acceptable salts and esters thereof, and combinations thereof.

23. The formulation according to claim 18, wherein the herbicide is a synthetic auxin herbicide selected from the group consisting of: 2,4-D; 2,4-DB; 2,3,6-TBA, aminocyclopyrachlor, aminopyralid, benazolin-ethyl, chloramben, clomeprop, clopyralid, dichlorprop, dichlorprop-P, florpyrauxifen (such as florpyrauxifen-benzyl), fluroxypyr, fluroxypyr-MHE, halauxifen, halauxifen-methyl, mecoprop, mecoprop-P, MCPA, MCPA-thioethyl, MCPB, picloram, quinclorac, quinmerac, triclopyr, agriculturally acceptable salts and esters thereof, and combinations thereof.

24. The formulation according to claim 18, wherein the herbicide is a phytoene desaturase (PDS) inhibitor herbicides herbicide selected from the group consisting of: beflubutamid, diflufenican, fluridone, flurochloridone, flurtamone, norflurazon, picolinafen, agriculturally acceptable salts and esters thereof, and combinations thereof.

25. The formulation according to claim 18, wherein the herbicide is selected from the group consisting of: glyphosate, glufosinate, agriculturally acceptable salts and esters thereof, and combinations thereof.

26. The formulation according to claim 18, wherein the herbicide is a photosystem II (PS II) inhibitor herbicide selected from the group consisting of: phenylcarbamate herbicides, pyridazinone herbicides, triazolinone herbicides, triazine herbicides, urea herbicides, uracil herbicides, amide herbicides, nitrile herbicides, phenylpyridazine herbicides, agriculturally acceptable salts and esters thereof, and combinations thereof.

27. The formulation according to claim 18, wherein the herbicide is an acetyl CoA carboxylase (ACCase) inhibitor herbicide selected from the group consisting of: cyclohexanediones, aryloxyphenoxypropionates, phenylpyrazolines, agriculturally acceptable salts and esters thereof, and combinations thereof.

28. The formulation according to claim 18, wherein the herbicide is an acetyl CoA carboxylase (ACCase) inhibitor herbicide selected from the group consisting of: clodinafop, cyhalofop, diclofop, fenoxaprop, fenthiaprop, fluazifop, haloxyfop, metamifop, propaquizafop, quizalofop, alloxydim, butroxydim, clethodim, cloproxydim, cycloxydim, profoxydim, sethoxydim, tepraloxydim, tralkoxydim, agriculturally acceptable salts or esters thereof, and combinations thereof.

29. The formulation according to claim 18, wherein the herbicide is a 4-hydroxyphenylpyruvate dioxygenase (HPPD) inhibitor herbicide selected from the group consisting of: benzobicyclon, benzofenap, bicyclopyrone, fenquinotrione, isoxachlortole, isoxaflutole, lancotrione, mesotrione, pyrasulfotole, pyrazolynate, pyrazoxyfen, sulcotrione, tefuryltrione, tembotrione, tolpyralate, topramezone, agriculturally acceptable salts or esters thereof, and combinations thereof.

30. The formulation according to claim 18, wherein the herbicide is a protoporphyrinogen oxidase (PROTOX) inhibitor herbicide selected from the group consisting of: acifluorfen, azafenidin, benzfendizone, bifenox, butafenacil, carfentrazone, chlomethoxyfen, cinidon, fluazolate, flufenpyr, flumiclorac, flumioxazin, fluoroglycofen, fluthiacet, fomesafen, halosafen, lactofen, oxadiargyl, oxadiazon, oxyfluorfen, pentoxazone, profluazol, pyraclonil, pyraflufen, saflufenacil, sulfentrazone, thidiazimin, tiafenacil, agriculturally acceptable salts or esters thereof, and combinations thereof.

31. The formulation according to claim 18, wherein the herbicide is a plant growth regulator herbicide selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and combinations thereof.

32. The formulation according to claim 18, wherein the herbicide is a cellulose biosynthesis (CBI) herbicide selected from the group consisting of chlorthiamid, dichlobenil, flupoxam, indaziflam, isoxaben, triaziflam, agriculturally acceptable salts or esters thereof, and combinations thereof.

33. The formulation according to claim 18, wherein the herbicide is a very long chain fatty acid (VLCFA) herbicide selected from the group consisting of acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, thenylchlor, agriculturally acceptable salts or esters thereof, and combinations thereof.

34. The formulation according to claim 18, wherein the herbicide is a fatty acid and lipid synthesis inhibitor (FA/LSI) herbicide selected from the group consisting of benfuresate, bensulide, butylate, cycloate, dalapon, EPTC, esprocarb, ethofumesate, flupropanate, molinate, orbencarb, prosulfocarb, thiobencarb, tiocarbazil, tri-allate, vemolate, agriculturally acceptable salts or esters thereof, and combinations thereof.

35. The formulation according to claim 16, further comprising a safener.

36. The formulation according to claim 35, wherein the safener is an herbide safener.

37. The formulation according to claim 36, wherein the herbide safener is selected from the group consisting of quinolinoxyacetate safeners, azole safeners, or mixtures thereof.

38. The formulation according to claim 35, wherein the herbide safener is selected from the group consisting of isoxadifen (e.g., isoxadifen-ethyl), cloquintocet (e.g., cloquintocet-mexyl), cyprosulfamide, mefenpyr (e.g., mefenpyr-diethyl), naphthalic anhydride, oxabetrinil, benzenesulfonamide, N-(aminocarbonyl)-2-chlorobenzenesulfonamide (2-CBSU), daimuron, dichloroacetamide, dicyclonon, fenchlorazole (e.g., fenchlorazole-ethyl), fenclorim, fluxofenim, dichloroacetamide safeners (e.g., AD-67, benoxacor, dichlormid, and furilazole), metcamifen, naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetyl hexahydro-3,3,8a-trimethylpyrrolo[1,2-a]pyrimidin-6-(2H-one) (BAS-145138), dichloromethyl-1,3-dioxolane (MG-191), and agriculturally acceptable salts, esters, or mixtures thereof.

39. The formulation according to claim 18, wherein the formulation exhibits synergistic herbicidal activity.

40. A method of treating a field, comprising the steps of: obtaining at least one compound according to claims 9-9, or at least one formulation according to claims, 10-12; and applying an agriculturally effective amount of the at least one of the compounds or at least one of the formulations to a field.

41. A method of treating a plant, comprising the steps of: obtaining at least one compound according to claims 8-9, or at least one formulation according to claims 10-11; and applying an agriculturally effective amount of the at least one of the compounds, or at least one of the formulations to a plant

42. A method of treating a plant, comprising the steps of: providing at least one formulation according to claims 16-39; and applying the at least one formulation to the surface of a plant.

43. A method of treating a crop, comprising the steps of: providing at least one formulation according to claims 16-39; and applying the at least one formulation to the crop.

### BRIEF DESCRIPTION OF THE FIGURES

FIG. 1 is a bar graph illustrating the relative volatily of various compounds. Weight loss rate (μg/min) is measured for various compounds. Reading from left to right the compounds tested identified by Compound Nos. are, respectively: A-46, A-47, A-55, A-48, A-44, A-53, A-50, A-57, A-49, A-51, A-54, Dicamba.

FIG. 2 is a representative plot of weight (μg) as function of time (min) used to estimate the volatility of compounds. The darker upper line is data collected with a sample that was 98.3 percent dicamba; the fainter lower line is data collected with a chlorine salt of dicamba, all data was collected at 90° C.

### DETAILED DESCRIPTION

While various concepts of the present disclosure are illustrated and described in detail in the figures and the description herein, results in the figures and their description are to be considered as exemplary and not restrictive in character; it being understood that only the illustrative aspects are shown and described and that all changes and modifications that come within the spirit of the disclosure are desired to be protected.

### Definitions

Unless defined otherwise, the scientific and technology nomenclatures have the same meaning as commonly understood by a person of ordinary skill in the art pertaining to this disclosure.

As used herein, unless explicitly stated otherwise or clearly implied otherwise, the term “about” refers to a range of values plus or minus 10 percent, e.g., about 1.0 encompasses values from 0.9 to 1.1.

As used herein, unless explicitly stated otherwise or clearly implied otherwise, the term “agriculturally active” compound includes any compound that may be of benefit to agriculture, including compounds that either alone or in combination with other compounds inhibit the growth of plants deemed undesirable in a given agricultural setting.

The examples given in the definitions are generally non-exhaustive and must not be construed as limiting the invention disclosed in this document. It is understood that a substituent should comply with chemical bonding rules and steric compatibility constraints in relation to the molecule to which it is attached.

As used herein, the term “alkanes” may be understood to include straight changed, branched, or cyclic, substituted, or unsubstituted hydrocarbons, which comprise one or more carbon-carbon bonds. Elements and groups that can be used to substitute alkanes include, but are not limited to, groups which include oxygen, nitrogen, sulfur, halogen, or metals, the linkage between the hydrocarbon and the substituent may be via a carbon-carbon bond or through an element other than carbon including, but not limited to, oxygen, nitrogen, and sulfur.

As used herein, the term “alkenes” may be understood to refer to straight changed, branched, or cyclic substituted or unsubstituted hydrocarbons, which include at least one carbon-carbon double bond. Elements and groups that can be used to substitute alkenes include, but are not limited to, groups which include oxygen, nitrogen, sulfur, halogen, or metals, the linkage between the hydrocarbon and the substituent may be via a carbon-carbon bond or through an element other than carbon including, but not limited to, oxygen, nitrogen, and sulfur.

As used herein, the term “alkynes” may be understood to include reference to straight changed or branched or cyclic, substituted, or unsubstituted hydrocarbon, which include at least one carbon-carbon triple bond. Elements and groups that can be used to substitute alkynes include, but are not limited to, groups which include oxygen, nitrogen, sulfur, halogen, or metals, the linkage between the hydrocarbon and the substituent may be via a carbon-carbon bond or through an element other than carbon including, but not limited to, oxygen, nitrogen, and sulfur.

As used herein, the term “halo” may be understood to refer to one or more of the following elements: fluoro, chloro, bromo, and iodo.

As used herein, the term “aryl” may be understood to refer to any group comprising at least one aromatic ring. The aromatic ring itself may be substituted or unsubstituted. Elements and groups that can be used to substitute aryls include, but are not limited to, groups which include oxygen, nitrogen, sulfur, halogen, or metals, the linkage between the hydrocarbon and the substituent may be via a carbon-carbon bond or through an element other than carbon including, but not limited to, oxygen, nitrogen, and sulfur.

As used herein, the term “heteroaryl” may be understood to include two aromatic rings which include in the cyclic structure elements other than carbon, such other elements include, but are not limited to, oxygen, nitrogen, sulfur, and the like. Heteroaryl may include more than one ring structure. Heteroaryls may be substituted or unsubstituted, substituents include, but are not limited to, elements and/or groups which include oxygen, nitrogen, sulfur, halogen, or metals, the linkage between the hydrocarbon and the substituent may be via a carbon-carbon bond or through an element other than carbon including, but not limited to, oxygen, nitrogen, and sulfur.

Exemplary heteroaryls include, but are not limited to, benzofuranyl, benzoisothiazolyl, benzoisoxazolyl, benzoxazolyl, benzothienyl, benzothiazolyl, cinnolinyl, furanyl, imidazolyl, indazolyl, indolyl, isoindolyl, isoquinolinyl, isothiaz olyl, isoxazolyl, oxadiazolyl, oxazolinyl, oxazolyl, phthalazinyl, pyrazinyl, pyrazolinyl, pyrazolylpyridazinyl, pyridyl, pyrimidinyl, pyrrolyl, quinazolinyl, quinolinyl, quinoxalinyl, tetrazolyl, thiazolinyl, thiazolyl, thienyl, triazinyl, and triazolyl.

Saturated heterocycles are ring structures which include one or more elements other than carbon, these elements include, but are not limited to, oxygen, nitrogen, sulfur, and the like. Exemplary saturated heterocycles include, but are not limited to, piperazinyl, piperidinyl, morpholinyl, pyrrolidinyl, oxetanyl, tetrahydrofuranyl, tetrahydrothienyl and tetrahydropyranyl.

Examples of partially unsaturated hetero cycles include, but are not limited to, 1,2,3,4-tetrahydro quinolinyl, 4.5-dihydro-oxazolyl. 4,5-dihydro-1H-pyrazolyl, 4,5-dihydro-isoxazolyl, and 2,3-dihydro-1,3,4-oxadiazolyl.

As used herein, unless explicitly stated otherwise or clearly implied otherwise, the term “alkyl” refers to any of the following: alkanes, alkenes, or alkynes, which are straight chained, branched, or cyclic, substituted, or unsubstituted; substituents may include, but are not limited to, halogens, aminos, iminos, sulfones, sulfoxides, aryls, heteroaryl, esters, ketones, aldehydes, alcohols, acids, and/or esters. Unless explicitly stated otherwise, any compound capable of existing as an isomer, a stereoisomer, or a tautomer may be used in any of its herbicidally active isoforms, configurations, or tautomers.

As used herein, unless explicitly stated otherwise or clearly implied otherwise, the term “AMATA” refers to Amaranthus tuberculatus (common waterhemp).

As used herein, unless explicitly stated otherwise or clearly implied otherwise, the term “AMBEL” refers to Ambrosia artemisiifolia (common ragweed).

As used herein, unless explicitly stated otherwise or clearly implied otherwise, the term “KCHSC” refers to Bassia scoparia (kochia).

As used herein, unless explicitly stated otherwise or clearly implied otherwise, the term “R-AMAPA” refers to glyphosate resistant Amaranthus palmeri (palmer pigweed).

As used herein, unless explicitly stated otherwise or clearly implied otherwise, the term “ERICA” refers to glyphosate resistant Conyza canadensis (L.) (horseweed).

As used herein, unless explicitly stated otherwise or clearly implied otherwise, the term “GLXMA” refers to Glycine mas (L.) Merr., (soybean).

As used herein, unless explicitly stated otherwise or clearly implied otherwise, the term “DCM” refers to dichloromethane.

As used herein, unless explicitly stated otherwise or clearly implied otherwise, the term “EtOAC” refers to ethyl acetate.

As used herein, unless explicitly stated otherwise or clearly implied otherwise, the term “DMF” refers to dimethyl formamide.

As used herein, unless explicitly stated otherwise or clearly implied otherwise, the term “K₂CO₃” refers to potassium carbonate.

As used herein, unless explicitly stated otherwise or clearly implied otherwise, the term “EDC” refers to a-ethyl-3-(3-dimethylaminopropyl) carbodiimide.

As used herein, unless explicitly stated otherwise or clearly implied otherwise, the term “DMAP” refers to 4-dimethylaminopyridine.

As used herein, unless explicitly stated otherwise or clearly implied otherwise, the term “DIPEA” refers to N,N-diisopropylethylamine.

As used herein, unless explicitly stated otherwise or clearly implied otherwise, the term “Et₃N” refers to triethylamine.

As used herein, unless explicitly stated otherwise or clearly implied otherwise, the term “HPLC” refers to high-performance chromatography.

As used herein, unless explicitly stated otherwise or clearly implied otherwise, the term “LC-MS” refers to liquid chromatography coupled with mass spectrometry.

Some auxin-like compounds, specifically those that interfere with plant growth and development, have proven to be a very effective herbicide class. One widely used auxinic herbicide is 3,6-dichloro-2-methoxybenzoic acid, also known as 3,6-dichloro-o-anisic acid, and commonly referred to as dicamba. Dicamba and various salts of this compound are broad-spectrum herbicides, especially effective in the control of broadleaf weeds. Dicamba, and some formulations that include dicamba, exhibit a tendency to spread beyond the specific areas it is intended to treat. The excellent herbicidal activity of dicamba and its tendency to drift during and in some instances after its application has resulted in it being implicated in damage done to plants in areas in proximity to the area of its intended use. Current approaches to reducing dicamba-related collateral damage to adjacent plants includes producing various salts of dicamba. While these salts may exhibit reduced volatility as compared to the free acid form of dicamba, many salts of dicamba revert to the free acid of dicamba via protonation equilibrium in solution, which is volatile and prone to causing damage to plants adjacent to the targeted application areas. Some aspects of the instant disclosure are intended to provide compounds that exhibit herbicidal activity and are less volatile and therefore perhaps less prone to spray drift than are compounds such as dicamba. Some aspects include combining the compounds disclosed herein with other agriculturally active compounds to produce admixes with wider utility and/or more desirable properties than the compounds alone.

As used herein, the compound of Formula (I) has the following structure:

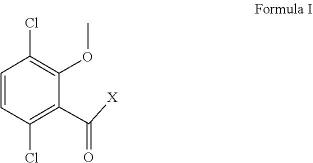

wherein X is:

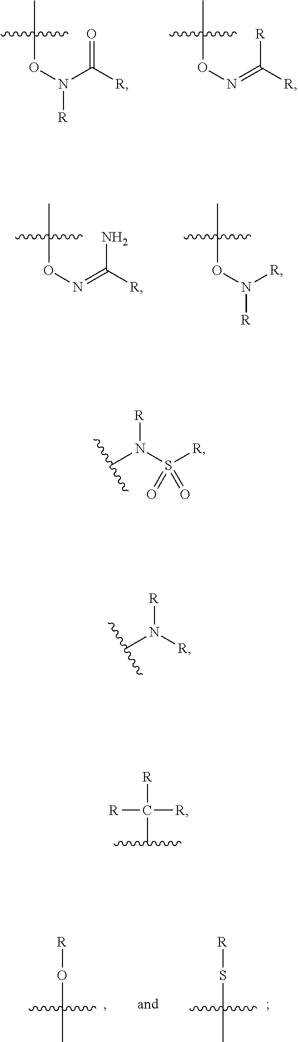

wherein R is independently selected from the group consisting of: alkyl, aryl, or heteroaryl, wherein the compound exhibits herbicidal activity.

As used herein, herbicide means a compound, e.g., an active ingredient, that kills, controls, or otherwise adversely affects the survival, growth and/or reproduction of plants.

As used herein, a herbicidally effective or vegetation controlling amount is an amount of active ingredient which causes an adversely modifying effect to the vegetation e.g., causing deviations from natural development, killing, effecting regulation, causing desiccation, causing retardation, and the like.

As used herein, controlling undesirable vegetation means preventing, reducing, killing, or otherwise adversely modifying the development of plants and vegetation. Described herein are methods of controlling undesirable vegetation through the application of certain herbicide combinations or compositions. Methods of application include, but are not limited to, applications to the vegetation or locus thereof, e.g., application to the area adjacent to the vegetation, as well as preemergence, postemergence, foliar (broadcast, directed, banded, spot, mechanical, over-the-top, or rescue), and in-water applications (emerged and submerged vegetation, broadcast, spot, mechanical, water-injected, granular broadcast, granular spot, shaker bottle, or stream spray) via hand, backpack, machine, tractor, or aerial (airplane and helicopter) application methods.

As used herein, plants and vegetation include, but are not limited to, germinant seeds, emerging seedlings, plants emerging from vegetative propagules, immature vegetation, and established vegetation.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Exemplary salts include those derived from alkali or alkaline earth metals and those derived from ammonia and amines. Exemplary cations include sodium, potassium, magnesium, and ammonium cations of the formula:

Herbicidal activity is exhibited by the compounds when they are applied directly to the plant or to the locus of the plant at any stage of growth. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some aspects, the compositions described herein are applied as a post-emergence application, preemergence application, or in-water application to flooded paddy rice or water bodies (e.g., ponds, lakes, and streams), to relatively immature undesirable vegetation to achieve the maximum control of weeds.

The compounds disclosed herein may be combined with one or more agents to create formulations that augment their utility. Such mixing partners include one or more of the agriculturally actives such as other herbicides, insecticides, fungicides, and miticides. At least some of these agriculturally active compounds may act in synergy with one or more of the compounds disclosed herein. For example, a second herbicide combined in the same formulation as one or more compounds disclosed herein or applied simultaneously with one or more of the compounds disclosed herein increase the activity of the compounds. The herbicidal activity of the mixture may be 10 percent or more active than the expected activity of the two or more herbicides applied separately.

Still other mixing partners may include safening agents, compounds that reduce the damage to useful plants that may be caused by applying one or more of the compounds disclosed herein. For example, the amount of damage done to crop plants may be reduced by 10 percent or more when the one or more compounds disclosed herein are mixed with at least one safening agent or applied simultaneously to crop plants with one or more safening agents.

### Safeners

In addition to the compounds of Formula I, the compositions and methods of the present disclosure can include a quinolinoxyacetate safener or an agriculturally acceptable salt or ester thereof. Herbicide safeners are molecules used in combination with herbicides to make them “safer”—that is, to reduce the herbicidal effect of the herbicide on crop plants and to improve selectivity between crops and the undesirable vegetation being targeted by the herbicide. Herbicide safeners can be used to pre-treat crop seeds prior to planting. Safeners may also be sprayed on plants as a mixture with the herbicide, or separately and sequentially with the herbicide.

Quinolinoxyacetate safeners are known in the art and described, for example, in U.S. Pat. No. 4,902,340 and U.S. Patent Application Publication No. 2014/0031224, the disclosures of which are both incorporated by reference herein. Quinolinoxyacetate safeners include, for example, cloquintocet and the derivatives thereof. Cloquintocet is a quinoline compound having the following chemical structure:

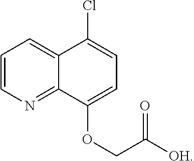 [SMILES: O=C(O)COc1ccc(Cl)c2cccnc12]

This form of cloquintocet may also be referred to as “cloquintocet-acid.”

In some aspects, the safener can comprise an agriculturally acceptable salt of cloquintocet. Agriculturally acceptable salts of cloquintocet include, for example sodium, potassium, ammonium, monoethanolammonium, diethanolammonium, triethanolammonium, monoisopropanolammonium, diisopropanolammonium, triisopropanolammonium, choline, N,N-dimethylethanolammonium, diethylammonium, dimethylammonium, trimethylammonium, triethylammonium, and isopropylammonium salts of cloquintocet.

In some aspects, the safener can comprise an agriculturally acceptable ester of cloquintocet. Agriculturally acceptable esters of cloquintocet include, for example, the methyl, ethyl, propyl, butyl, or methyl hexyl (also known as mexyl) ester of cloquintocet. In some aspects, the safener comprises cloquintocet-mexyl, the structure of which is shown below.

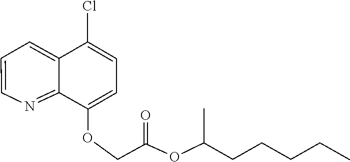 [SMILES: CCCCCC(C)OC(=O)COc1ccc(Cl)c2cccnc12]

In some aspects, the safener can comprise cloquintocet-acid, an agriculturally acceptable salt of cloquintocet, an agriculturally acceptable ester of cloquintocet, or mixtures thereof. Cloquintocet can be a safener when applied in combination with herbicides and can be used to reduce phytotoxicity to crops such as wheat, barley, triticale, rye, teff, oats, maize, Sorghum, rice, millet, canola/oilseed rape, sunflower, sugar beet, cotton, sugarcane, and pasture grasses. In some aspects, the undesirable vegetation is in broadleaf crops. In some aspects, the undesirable vegetation is in canola, flax, sunflower, soy, or cotton.

Cloquintocet or an agriculturally acceptable salt or ester thereof can be used in an amount sufficient to induce a safening effect. In some aspects, cloquintocet or an agriculturally acceptable salt or ester thereof is applied to vegetation or an area adjacent the vegetation or applied to soil or water in an amount of 1 g active ingredient per hectare (ai/ha) or greater, such as 2 g ai/ha or greater, 3 g ai/ha or greater, 4 g ai/ha or greater, 5 g ai/ha or greater, 6 g ai/ha or greater, 7 g ai/ha or greater, 8 g ai/ha or greater, 9 g ai/ha or greater, 10 g ai/ha or greater, 11 g ai/ha or greater, 12 g ai/ha or greater, 13 g ai/ha or greater, 14 g ai/ha or greater, 15 g ai/ha or greater, 16 g ai/ha or greater, 17 g ai/ha or greater, 18 g ai/ha or greater, 19 g ai/ha or greater, 20 g ai/ha or greater, 22 g ai/ha or greater, 24 g ai/ha or greater, 25 g ai/ha or greater, 26 g ai/ha or greater, 28 g ai/ha or greater, 30 g ai/ha or greater, 32 g ai/ha or greater, 34 g ai/ha or greater, 35 g ai/ha or greater, 36 g ai/ha or greater, 38 g ai/ha or greater, 40 g ai/ha or greater, 42.5 g ai/ha or greater, 45 g ai/ha or greater, 47.5 g ai/ha or greater, 50 g ai/ha or greater, 52.5 g ai/ha or greater, 55 g ai/ha or greater, 57.5 g ai/ha or greater, 60 g ai/ha or greater, 65 g ai/ha or greater, 70 g ai/ha or greater, 75 g ai/ha or greater, 80 g ai/ha or greater, 85 g ai/ha or greater, 90 g ai/ha or greater, 95 g ai/ha or greater, 100 g ai/ha or greater, 110 g ai/ha or greater, 120 g ai/ha or greater, 130 g ai/ha or greater, 140 g ai/ha or greater, 150 g ai/ha or greater, 160 g ai/ha or greater, 170 g ai/ha or greater, 180 g ai/ha or greater, 190 g ai/ha or greater, 200 g ai/ha or greater, 210 g ai/ha or greater, 220 g ai/ha or greater, 230 g ai/ha or greater, 240 g ai/ha or greater, 250 g ai/ha or greater, 260 g ai/ha or greater, 270 g ai/ha or greater, 280 g ai/ha or greater, or 290 g ai/ha or greater; in an amount of 300 g ai/ha or less such as 290 g ai/ha or less, 280 g ai/ha or less, 270 g ai/ha or less, 260 g a/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 57.5 g ai/ha or less, 55 g ai/ha or less, 52.5 g ai/ha or less, 50 g ai/ha or less, 47.5 g ai/ha or less, 45 g ai/ha or less, 42.5 g ai/ha or less, 40 g ai/ha or less, 38 g ai/ha or less, 36 g ai/ha or less, 35 g ai/ha or less, 34 g ai/ha or less, 32 g ai/ha or less, 30 g ai/ha or less, 28 g ai/ha or less, 26 g ai/ha or less, 25 g ai/ha or less, 24 g ai/ha or less, 22 g ai/ha or less, 20 g ai/ha or less, 19 g ai/ha or less, 18 g ai/ha or less, 17 g ai/ha or less, 16 g ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3 g ai/ha or less, or 2 g ai/ha or less; or in an amount within any range defined between any pair of the preceding values, such as from 1 g ai/ha to 300 g ai/ha, from 5 g ai/ha to 150 g ai/ha, from 10 g ai/ha to 200 g ai/ha, from 20 g ai/ha to 75 g ai/ha, or from 40 g ai/ha to 100 g ai/ha.

Azoles are a class of five-membered nitrogen heterocyclic ring compounds containing at least one additional heteroatom (e.g., nitrogen, sulfur, or oxygen) within the heterocyclic ring. Examples of azoles include, for example, pyrazoles, imidazoles, thiazoles, oxazoles, isoxazoles and triazoles.

Azole carboxylate safeners are a class of safeners based on carboxylate-substituted azole moieties. Examples of azole carboxylate safeners include pyrazole carboxylate safeners, imidazole carboxylate safeners, thiazole carboxylate safeners, oxazole carboxylate safeners, isoxazole carboxylate safeners, and triazole carboxylate safeners. In some aspects, the composition can include an azole carboxylate safener selected from the group consisting of fenchlorazole, flurazole, furilazole, isoxadifen, mefenpyr, agriculturally acceptable salts or esters thereof, or combinations thereof. In some aspects, the azole carboxylate safener can include fenchlorazole-ethyl, isoxadifen-ethyl, mefenpyr-diethyl, or combinations thereof.

In some aspects, the azole carboxylate safener can comprise fenchlorazole, shown below, or an agriculturally acceptable salt or ester thereof. Fenchlorazole's safening activity is described in The Pesticide Manual, Eighteenth Edition, 2016.

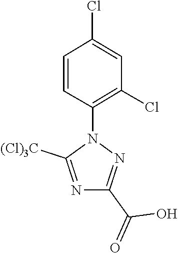

In some aspects, the fenchlorazole is provided as an agriculturally acceptable salt or ester. An exemplary agriculturally acceptable ester of fenchlorazole is fenchlorazole-ethyl, shown below.

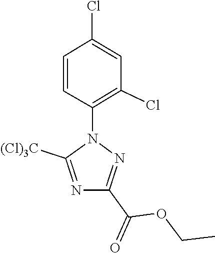

In some aspects, the azole carboxylate safener can comprise flurazole, shown below, or an agriculturally acceptable salt or ester thereof. Flurazole's safening activity is described in The Pesticide Manual, Eighteenth Edition, 2016.

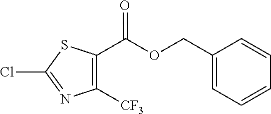 [SMILES: O=C(OCc1ccccc1)c1sc(Cl)nc1C(F)(F)F]

In some aspects, the azole carboxylate safener can comprise furilazole, shown below, or an agriculturally acceptable salt or ester thereof. Furilazole's safening activity is described in The Pesticide Manual, Eighteenth Edition, 2016.

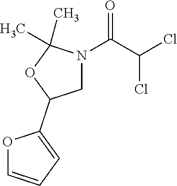 [SMILES: CC1(C)OC(c2ccco2)CN1C(=O)C(Cl)Cl]

In some aspects, the azole carboxylate safener can comprise isoxadifen, shown below, or an agriculturally acceptable salt or ester thereof. Isoxadifen's safening activity is described in The Pesticide Manual, Eighteenth Edition, 2016.

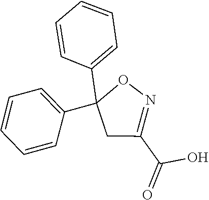 [SMILES: O=C(O)C1=NOC(c2ccccc2)(c2ccccc2)C1]

In some aspects, the isoxadifen is provided as an agriculturally acceptable salt or ester. An exemplary agriculturally acceptable ester of isoxadifen is isoxadifen-ethyl, shown below.

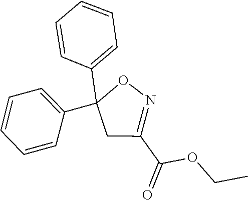 [SMILES: CCOC(=O)C1=NOC(c2ccccc2)(c2ccccc2)C1]

In some aspects, the azole carboxylate safener can comprise mefenpyr, shown below, or an agriculturally acceptable salt or ester thereof. Mefenpyr's safening activity is described in The Pesticide Manual, Eighteenth Edition, 2016.

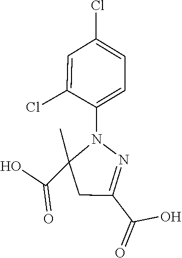 [SMILES: CC1(C(=O)O)CC(C(=O)O)=NN1c1ccc(Cl)cc1Cl]

In some aspects, the mefenpyr is provided as an agriculturally acceptable salt or ester. An exemplary agriculturally acceptable ester of mefenpyr is mefenpyr-diethyl, shown below.

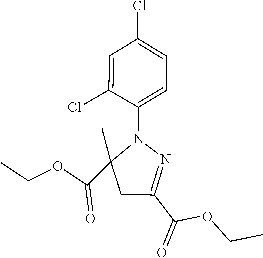 [SMILES: CCOC(=O)C1=NN(c2ccc(Cl)cc2Cl)C(C)(C(=O)OCC)C1]

In some aspects, the azole carboxylate safener can be provided as an agriculturally acceptable ester. Suitable esters include, but are not limited to, methyl, ethyl, isopropyl, butyl, hexyl, heptyl, isoheptyl, mexyl, isooctyl, 2-ethyl hexyl and butoxyethyl esters, and aryl esters such as benzyl. Exemplary agriculturally acceptable esters of the azole carboxylate safeners described herein include methyl, ethyl, and diethyl esters.

In some aspects, the azole carboxylate safener can comprise an agriculturally acceptable salt of the azole carboxylate safener. Agriculturally acceptable salts of the azole carboxylate safener include, for example sodium, potassium, ammonium, monoethanolammonium, diethanolammonium, triethanolammonium, monoisopropanolammonium, diisopropanolammonium, triisopropanolammonium, choline, N,N-dimethylethanolammonium, diethylammonium, dimethylammonium, trimethylammonium, triethylammonium, and isopropylammonium salts of the azole carboxylate safener.

An azole carboxylate safener, when applied in combination with herbicides, can be used to reduce phytotoxicity to crops such as wheat, barley, triticale, rye, teff, oats, maize, Sorghum, millet, rice, millet, canola/oilseed rape, flax, soy, sunflower, sugar beet, cotton, sugarcane, and pasture grasses.

Safeners include, isoxadifen (e.g., isoxadifen-ethyl), cloquintocet (e.g., cloquintocet-mexyl), cyprosulfamide, mefenpyr (e.g., mefenpyr-diethyl), naphthalic anhydride, oxabetrinil, benzenesulfonamide, N-(aminocarbonyl)-2-chlorobenzenesulfonamide (2-CBSU), daimuron, dichloroacetamide, dicyclonon, fenchlorazole (e.g., fenchlorazole-ethyl), fenclorim, fluxofenim, dichloroacetamide safeners (e.g., AD-67, benoxacor, dichlormid, and furilazole), metcamifen, naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetyl hexahydro-3,3,8a-trimethylpyrrolo[1,2-a]pyrimidin-6-(2H-one) (BAS-145138), dichloromethyl-1,3-dioxolane (MG-191 The azole carboxylate safener or an agriculturally acceptable salt or ester thereof can be used in an amount sufficient to induce a safening effect. In some aspects, the azole carboxylate safener is selected from the group consisting of fenchlorazole, fenclorim, flurazole, furilazole, isoxadifen, mefenpyr, an agriculturally acceptable salt or ester thereof, or combinations thereof, and is applied to vegetation or an area adjacent the vegetation or applied to soil or water in an amount of 1 g active ingredient per hectare (ai/ha) or greater, such as 2 g ai/ha or greater, 3 g ai/ha or greater, 4 g ai/ha or greater, 5 g ai/ha or greater, 6 g ai/ha or greater, 7 g ai/ha or greater, 8 g ai/ha or greater, 9 g ai/ha or greater, 10 g ai/ha or greater, 11 g ai/ha or greater, 12 g ai/ha or greater, 13 g ai/ha or greater, 14 g ai/ha or greater, 15 g ai/ha or greater, 16 g ai/ha or greater, 17 g ai/ha or greater, 18 g ai/ha or greater, 19 g ai/ha or greater, 20 g ai/ha or greater, 22 g ai/ha or greater, 24 g ai/ha or greater, 25 g ai/ha or greater, 26 g ai/ha or greater, 28 g ai/ha or greater, 30 g ai/ha or greater, 32 g ai/ha or greater, 34 g ai/ha or greater, 35 g ai/ha or greater, 36 g ai/ha or greater, 38 g ai/ha or greater, 40 g ai/ha or greater, 42.5 g ai/ha or greater, 45 g ai/ha or greater, 47.5 g ai/ha or greater, 50 g ai/ha or greater, 52.5 g ai/ha or greater, 55 g ai/ha or greater, 57.5 g ai/ha or greater, 60 g ai/ha or greater, 65 g ai/ha or greater, 70 g ai/ha or greater, 75 g ai/ha or greater, 80 g ai/ha or greater, 85 g ai/ha or greater, 90 g ai/ha or greater, 95 g ai/ha or greater, 100 g ai/ha or greater, 110 g ai/ha or greater, 120 g ai/ha or greater, 130 g ai/ha or greater, 140 g ai/ha or greater, 150 g ai/ha or greater, 160 g ai/ha or greater, 170 g ai/ha or greater, 180 g ai/ha or greater, 190 g ai/ha or greater, 200 g ai/ha or greater, 210 g ai/ha or greater, 220 g ai/ha or greater, 230 g ai/ha or greater, 240 g ai/ha or greater, 250 g ai/ha or greater, 260 g ai/ha or greater, 270 g ai/ha or greater, 280 g ai/ha or greater, or 290 g ai/ha or greater; in an amount of 300 g ai/ha or less, such as 290 g ai/ha or less, 280 g ai/ha or less, 270 g ai/ha or less, 260 g a/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 57.5 g ai/ha or less, 55 g ai/ha or less, 52.5 g ai/ha or less, 50 g ai/ha or less, 47.5 g ai/ha or less, 45 g ai/ha or less, 42.5 g ai/ha or less, 40 g ai/ha or less, 38 g ai/ha or less, 36 g ai/ha or less, 35 g ai/ha or less, 34 g ai/ha or less, 32 g ai/ha or less, 30 g ai/ha or less, 28 g ai/ha or less, 26 g ai/ha or less, 25 g ai/ha or less, 24 g ai/ha or less, 22 g ai/ha or less, 20 g ai/ha or less, 19 g ai/ha or less, 18 g ai/ha or less, 17 g ai/ha or less, 16 g ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3 g ai/ha or less, or 2 g ai/ha or less; or in an amount within any range defined between any pair of the preceding values, such as from 1 g ai/ha to 300 g ai/ha, from 5 g ai/ha to 150 g ai/ha, from 10 g ai/ha to 200 g ai/ha, from 20 g ai/ha to 75 g ai/ha, or from 40 g ai/ha to 100 g ai/ha.

### Herbicides

### ALS Inhibitors

In addition to the compounds of Formula I or agriculturally acceptable salts, or esters thereof, the compositions can include an acetolactate synthase (ALS) inhibitor. ALS inhibitors disrupt the production of amino acids in the plant, which eventually leads to inhibition of DNA synthesis. Examples of ALS inhibitors include sulfonylureas, imidazolinones, triazolopyrimidine sulfonamides, pyrimidinyl oxybenzoates and sulfonylaminocarbonyl triazolinones. In some aspects, the ALS inhibitor can contain a triazolopyrimidine sulfonamide herbicide. In some aspects, the ALS inhibitor can contain an imidazolinone herbicide. In some aspects, the ALS inhibitor can contain a pyrimidinyl oxybenzoate herbicide. In some aspects, the ALS inhibitor can contain a sulfonylaminocarbonyl triazolinone herbicide. In some aspects, the ALS inhibitor can contain a sulfonylurea herbicide.

In some aspects, the composition can include an ALS inhibitor selected from the group of imidazolinones, triazolopyrimidine sulfonamides, pyrimidinyl oxybenzoates, sulfonylaminocarbonyl triazolinones, sulfonylureas, and combinations thereof. In some cases, the composition can include amidosulfuron, azimsulfuron, bispyribac, bensulfuron, chlorimuron, chlorsulfuron, cinosulfuron, cloransulam, cyclosulfamuron, diclosulam, ethametsulfuron, ethoxysulfuron, flazasulfuron, florasulam, flucarbazone, flucetosulfuron, flumetsulam, flupyrsulfuron, foramsulfuron, halosulfuron, imazamethabenz, imazamox, imazapic, imazapyr, imazaquin, imazethapyr, imazosulfuron, iodosulfuron, iofensulfuron, mesosulfuron, metazosulfuron, metosulam, metsulfuron, nicosulfuron, orthosulfamuron, oxasulfuron, penoxsulam, primisulfuron, propoxycarbazone, propyrisulfuron, prosulfuron, pyrazosulfuron, pyribenzoxim, pyriftalid, pyriminobac, pyrimisulfan, pyrithiobac, pyroxsulam, rimsulfuron, sulfometuron, sulfosulfuron, thiencarbazone, thifensulfuron, triasulfuron, tribenuron, trifloxysulfuron, triflusulfuron, tritosulfuron, agriculturally acceptable salts and esters thereof, and combinations thereof.

The ALS inhibitor or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the ALS inhibitor or agriculturally acceptable salt or ester thereof is applied to vegetation or an area adjacent the vegetation or applied to soil or water to prevent the emergence or growth of vegetation in an amount of 0.25 grams active ingredient per hectare (g ai/ha) or more, such as 0.3 g ai/ha or more, 0.4 g ai/ha or more, 0.5 g ai/ha or more, 0.6 g ai/ha or more, 0.7 g ai/ha or more, 0.8 g ai/ha or more, 0.9 g ai/ha or more, 1 g ai/ha or more, 1.5 g ai/ha or more, 2 g ai/ha or more, 2.5 g ai/ha or more, 3 g ai/ha or more, 3.5 g ai/ha or more, 4 g ai/ha or more, 4.5 g ai/ha or more, 5 g ai/ha or more, 6 g ai/ha or more, 7 g ai/ha or more, 8 g ai/ha or more, 9 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 625 g ai/ha or more, 650 g ai/ha or more, 675 g ai/ha or more, 700 g ai/ha or more, 725 g ai/ha or more, 750 g ai/ha or more, 775 g ai/ha or more, 800 g ai/ha or more, 825 g ai/ha or more, 850 g ai/ha or more, 875 g ai/ha or more, 900 g ai/ha or more, 925 g ai/ha or more, 950 g ai/ha or more, 975 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1550 g ai/ha or more, 1600 g ai/ha or more, 1650 g ai/ha or more, 1675 g ai/ha or more, 1680 g ai/ha or more, or 1690 g ai/ha or more; in an amount of 1700 g ai/ha or less, such as 1690 g ai/ha or less, 1680 g ai/ha or less, 1675 g ai/ha or less, 1650 g ai/ha or less, 1600 g ai/ha or less, 1550 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 975 g ai/ha or less, 950 g ai/ha or less, 925 g ai/ha or less, 900 g ai/ha or less, 875 g ai/ha or less, 850 g ai/ha or less, 825 g ai/ha or less, 800 g ai/ha or less, 775 g ai/ha or less, 750 g ai/ha or less, 725 g ai/ha or less, 700 g ai/ha or less, 675 g ai/ha or less, 650 g ai/ha or less, 625 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, 1.5 g ai/ha or less, 1 g ai/ha or less, 0.9 g ai/ha or less, 0.8 g ai/ha or less, 0.7 g ai/ha or less, 0.6 g ai/ha or less, 0.5 g ai/ha or less, 0.4 g ai/ha or less, or 0.3 g ai/ha or less; or in an amount ranging from any of the minimum values described above to any of the maximum values described above, such as 0.25-1700 g ai/ha, 0.25-1250 g ai/ha, 0.5-150 g ai/ha, 2-90 g ai/ha, 2.5-200 g ai/ha, 3-900 g ai/ha, 5-260 g ai/ha, 5-750 g ai/ha, 5-1000 g ai/ha, 6-280 g ai/ha, 7-100 g ai/ha, 10-560 g ai/ha, 10-1600 g ai/ha, 20-500 g ai/ha, 25-140 g ai/ha, 30-480 g ai/ha, 40-400 g ai/ha, 50-320 g ai/ha, 60-300 g ai/ha, 70-1250 g ai/ha, 100-140 g ai/ha, 140-520 g ai/ha, or 250-1700 g ai/ha.

### Synthetic Auxin Herbicides

In addition to the compounds of Formula I or agriculturally acceptable, salts or esters thereof, the compositions can include a synthetic auxin herbicide. Synthetic auxin herbicides mimic natural plant hormones and can inhibit cell division and growth. Synthetic auxin herbicides include phenoxy herbicides, benzoic acid herbicides, aryl picolinate herbicides, pyridine carboxylate herbicides, such as those described in U.S. Patent Application Publication No. 2020/0068888, which is the national stage entrance of PCT Application No. PCT/US18/31004, the disclosure of which is incorporated by reference in its entirety herein, quinoline carboxylic acid herbicides, pyrimidine carboxylic acid herbicides, and benzothiazole herbicides, as well as agriculturally acceptable salts and esters thereof.

In some aspects, the composition can include a synthetic auxin herbicide selected from the group consisting of 2,4-D; 2,4-DB; 2,3,6-TBA, aminocyclopyrachlor, aminopyralid, benazolin-ethyl, chloramben, clomeprop, clopyralid, dichlorprop, dichlorprop-P, other salts and esters of dicamba, florpyrauxifen (such as florpyrauxifen-benzyl), fluroxypyr, fluroxypyr-MHE, halauxifen, halauxifen-methyl, mecoprop, mecoprop-P, MCPA, MCPA-thioethyl, MCPB, picloram, quinclorac, quinmerac, triclopyr, agriculturally acceptable salts and esters thereof, and combinations thereof. In some aspects, the synthetic auxin herbicide can comprise 2,4-D, MCPA, aminopyralid, clopyralid, other salts and esters of dicamba, florpyrauxifen, fluroxypyr, halauxifen, quinclorac, agriculturally acceptable salts and esters thereof, and combinations thereof.

The synthetic auxin herbicide or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the synthetic auxin herbicide or agriculturally acceptable salt or ester thereof is applied to vegetation or an area adjacent the vegetation or applied to soil or water to prevent the emergence or growth of vegetation in an amount of 1 gram acid equivalent per hectare (g ai) or more, such as 1.5 g ai or more, 2 g ai or more, 2.5 g ai or more, 3 g ai or more, 3.5 g ai or more, 4 g ai or more, 4.5 g ai or more, 5 g ai or more, 6 g ai or more, 7 g ai or more, 8 g ai or more, 9 g ai or more, 10 g ai or more, 15 g ai or more, 20 g ai or more, 25 g ai or more, 30 g ai or more, 35 g ai or more, 40 g ai or more, 45 g ai or more, 50 g ai or more, 55 g ai or more, 60 g ai or more, 65 g ai or more, 70 g ai or more, 75 g ai or more, 80 g ai or more, 85 g ai or more, 90 g ai or more, 95 g ai or more, 100 g ai or more, 110 g ai or more, 120 g ai or more, 130 g ai or more, 140 g ai or more, 150 g ai or more, 160 g ai or more, 170 g ai or more, 180 g ai or more, 190 g ai or more, 200 g ai or more, 220 g ai or more, 240 g ai or more, 250 g ai or more, 260 g ai or more, 280 g ai or more, 300 g ai or more, 320 g ai or more, 340 g ai or more, 350 g ai or more, 360 g ai or more, 380 g ai or more, 400 g ai or more, 450 g ai or more, 500 g ai or more, 550 g ai or more, 600 g ai or more, 650 g ai or more, 700 g ai or more, 750 g ai or more, 800 g ai or more, 850 g ai or more, 900 g ai or more, 950 g ai or more, 1000 g ai or more, 1050 g ai or more, 1100 g ai or more, 1150 g ai or more, 1200 g ai or more, 1250 g ai or more, 1300 g ai or more, 1350 g ai or more, 1400 g ai or more, 1450 g ai or more, 1500 g ai or more, 1600 g ai or more, 1700 g ai or more, 1800 g ai or more, 1900 g ai or more, 2000 g ai or more, 2050 g ai or more, 2100 g ai or more, 2150 g ai or more, 2200 g ai or more, 2240 g ai or more, 2250 g ai or more, 2300 g ai or more, 2350 g ai or more, 2400 g ai or more, 2450 g ai or more, 2500 g ai or more, 2600 g ai or more, 2700 g ai or more, 2750 g ai or more, 2800 g ai or more, 2900 g ai or more, 3000 g ai or more, 3050 g ai or more, 3100 g ai or more, 3150 g ai or more, 3200 g ai or more, 3250 g ai or more, 3300 g ai or more, 3350 g ai or more, 3400 g ai or more, 3450 g ai or more, 3500 g ai or more, 3600 g ai or more, 3700 g ai or more, 3750 g ai or more, 3800 g ai or more, 3900 g ai or more, or 3950 g ai or more; in an amount of 4000 g ai or less, such as 3950 g ai or less, 3900 g ai or less, 3800 g ai or less, 3750 g ai or less, 3700 g ai or less, 3600 g ai or less, 3500 g ai or less, 3450 g ai or less, 3400 g ai or less, 3350 g ai or less, 3300 g ai or less, 3250 g ai or less, 3200 g ai or less, 3150 g ai or less, 3100 g ai or less, 3050 g ai or less, 3000 g ai or less, 2900 g ai or less, 2800 g ai or less, 2750 g ai or less, 2700 g ai or less, 2600 g ai or less, 2500 g ai or less, 2450 g ai or less, 2400 g ai or less, 2350 g ai or less, 2300 g ai or less, 2250 g ai or less, 2240 g ai or less, 2200 g ai or less, 2150 g ai or less, 2100 g ai or less, 2050 g ai or less, 2000 g ai or less, 1900 g ai or less, 1800 g ai or less, 1750 g ai or less, 1700 g ai or less, 1600 g ai or less, 1500 g ai or less, 1450 g ai or less, 1400 g ai or less, 1350 g ai or less, 1300 g ai or less, 1250 g ai or less, 1240 g ai or less, 1200 g ai or less, 1150 g ai or less, 1100 g ai or less, 1050 g ai or less, 1000 g ai or less, 950 g ai or less, 900 g ai or less, 850 g ai or less, 800 g ai or less, 750 g ai or less, 700 g ai or less, 650 g ai or less, 600 g ai or less, 550 g ai or less, 500 g ai or less, 450 g ai or less, 400 g ai or less, 380 g ai or less, 360 g ai or less, 350 g ai or less, 340 g ai or less, 320 g ai or less, 300 g ai or less, 280 g ai or less, 260 g ai or less, 250 g ai or less, 240 g ai or less, 220 g ai or less, 200 g ai or less, 190 g ai or less, 180 g ai or less, 170 g ai or less, 160 g ai or less, 150 g ai or less, 140 g ai or less, 130 g ai or less, 120 g ai or less, 110 g ai or less, 100 g ai or less, 95 g ai or less, 90 g ai or less, 85 g ai or less, 80 g ai or less, 75 g ai or less, 70 g ai or less, 65 g ai or less, 60 g ai or less, 55 g ai or less, 50 g ai or less, 45 g ai or less, 40 g ai or less, 35 g ai or less, 30 g ai or less, 25 g ai or less, 20 g ai or less, 15 g ai or less, 10 g ai or less, 9 g ai or less, 8 g ai or less, 7 g ai or less, 6 g ai or less, 5 g ai or less, 4.5 g ai or less, 4 g ai or less, 3.5 g ai or less, 3 g ai or less, 2.5 g ai or less, 2 g ai or less, 1.5 g ai or less, or 1 g ai or less; or in an amount ranging from any of the minimum values described above to any of the maximum values described above, such as 1-4000 g ai, 1-2240 g ai, 1-150 g ai, 1.5-3150 g ai, 2-900 g ai, 2.5-3200 g ai, 3-1250 g ai, 5-260 g ai, 6-750 g ai, 7-2100 g ai, 10-2240 g ai, 20-3600 g ai, 40-3950 g ai, 50-400 g ai, 70-1250 g ai, 100-1400 g ai, or 250-1700 g ai.

### PDS Inhibitor Herbicides

In addition to the compounds of Formula I or agriculturally acceptable e, salst or esters thereof, the compositions can include a phytoene desaturase (PDS) inhibitor herbicide or agriculturally acceptable salt or ester thereof. PDS inhibitors block carotenoid biosynthesis by inhibition of phytoene desaturase, a key enzyme in the carotenoid biosynthesis pathway. An absence of carotenoids leads to destruction of membrane fatty acid and chlorophyll by excessive energy. Examples of PDS inhibitors include, but are not limited to, beflubutamid, diflufenican, fluridone, flurochloridone, flurtamone, norflurazon, and picolinafen.

In some aspects, the composition can include a PDS inhibitor herbicide selected from the group consisting of beflubutamid, diflufenican, fluridone, flurochloridone, flurtamone, norflurazon, picolinafen, agriculturally acceptable salts and esters thereof, and combinations thereof.

The PDS inhibitor herbicide or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the PDS inhibitor herbicide or agriculturally acceptable salt or ester thereof is applied to vegetation or an area adjacent the vegetation or applied to soil or water to prevent the emergence or growth of vegetation in an amount of 12.5 grams active ingredient per hectare (g ai/ha) or more, such as 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2050 g ai/ha or more, 2100 g ai/ha or more, 2150 g ai/ha or more, 2200 g ai/ha or more, 2240 g ai/ha or more, 2250 g ai/ha or more, 2300 g ai/ha or more, 2350 g ai/ha or more, 2400 g ai/ha or more, 2450 g ai/ha or more, 2500 g ai/ha or more, 2600 g ai/ha or more, 2700 g ai/ha or more, 2750 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3600 g ai/ha or more, 3700 g ai/ha or more, 3750 g ai/ha or more, 3800 g ai/ha or more, 3900 g ai/ha or more, 3950 g ai/ha or more, 4000 g ai/ha or more, 4100 g ai/ha or more, 4200 g ai/ha or more, 4250 g ai/ha or more, 4300 g ai/ha or more, 4400 g ai/ha or more, or 4450 g ai/ha or more; in an amount of 4500 g ai/ha or less, such as 4450 g ai/ha or less, 4400 g ai/ha or less, 4300 g ai/ha or less, 4250 g ai/ha or less, 4100 g ai/ha or less, 4000 g ai/ha or less, 3950 g ai/ha or less, 3900 g ai/ha or less, 3800 g ai/ha or less, 3750 g ai/ha or less, 3700 g ai/ha or less, 3600 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2750 g ai/ha or less, 2700 g ai/ha or less, 2600 g ai/ha or less, 2500 g ai/ha or less, 2450 g ai/ha or less, 2400 g ai/ha or less, 2350 g ai/ha or less, 2300 g ai/ha or less, 2250 g ai/ha or less, 2240 g ai/ha or less, 2200 g ai/ha or less, 2150 g ai/ha or less, 2100 g ai/ha or less, 2050 g ai/ha or less, 2000 g ai/ha or less, 1900 g ai/ha or less, 1800 g ai/ha or less, 1750 g ai/ha or less, 1700 g ai/ha or less, 1600 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1240 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 450 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, or 15 g ai/ha or less; or in an amount ranging from any of the minimum values described above to any of the maximum values described above, such as 12.5-4500 g ai/ha, 15-2250 g ai/ha, 20-2500 g ai/ha, 25-3150 g ai/ha, 30-900 g ai/ha, 45-4200 g ai/ha, 50-1200 g ai/ha, 50-4100 g ai/ha, 60-750 g ai/ha, 75-2100 g ai/ha, 100-4000 g ai/ha, 200-3600 g ai/ha, 250-3000 g ai/ha, 250-1000 g ai/ha, 700-4250 g ai/ha, 800-1400 g ai/ha, or 1000-3700 g ai/ha.

In some aspects, the composition contains (a) compounds of Formula I, and (b) diflufenican, flurtamone, picolinafen, or mixtures thereof.

### Glyphosate and Glufosinate

In addition to the compounds of Formula I or agriculturally acceptable, salts or esters thereof, the compositions can include glyphosate, glufosinate, an agriculturally acceptable salt thereof, or mixtures thereof.

### Glyphosate

In some aspects, compositions and methods of the present disclosure can include glyphosate or an agriculturally acceptable salt thereof. Glyphosate, as well as methods of preparing glyphosate, are known in the art. Glyphosate, shown below, is N-(phosphonomethyl)glycine. Its herbicidal activity is exemplified in The Pesticide Manual, Seventeenth Edition, 2016. Exemplary uses of glyphosate include its use for control of annual and perennial grasses and broadleaf weeds, particularly in crops that have been genetically modified to be tolerant of glyphosate.

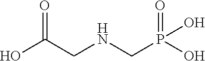

Exemplary chemical forms of glyphosate include, but are not limited to, for example, glyphosate potassium salt, glyphosate sodium salt, glyphosate monoammonium salt, glyphosate diammonium salt, glyphosate isopropylamine (IPA) salt, glyphosate monoethanolamine (MEA) salt, glyphosate monomethylamine (MMA) salt, and glyphosate dimethylamine (DMA) salt. As used herein, glyphosate salt or salt of glyphosate generally refers to the reaction product of glyphosate with a moiety that can act as a base. Typically, the reaction is an acid-base reaction.

Glyphosate can be applied to vegetation or an area adjacent the vegetation or applied to soil or water to prevent the emergence or growth of vegetation in an amount sufficient to induce a herbicidal effect. In some aspects, glyphosate is applied to vegetation or an area adjacent the vegetation or applied to soil or water to prevent the emergence or growth of vegetation in an amount of 25 g ai/ha or more, such as 30 g ai/ha or more, 50 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 500 g ai/ha or more, 600 g ai/ha or more, 700 g ai/ha or more, 750 g ai/ha or more, 800 g ai/ha or more, 900 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3300 g ai/ha or more, 3400 g ai/ha or more, 3500 g ai/ha or more, 3600 g ai/ha or more, 3700 g ai/ha or more, 3800 g ai/ha or more, 3900 g ai/ha or more, 4000 g ai/ha or more, 4100 g ai/ha or more, 4200 g ai/ha or more, or 4250 g ai/ha or more, in an amount of 4300 g ai/ha or less, such as 4250 g ai/ha or less, 4200 g ai/ha or less, 4100 g ai/ha or less, 4000 g ai/ha or less, 3900 g ai/ha or less, 3800 g ai/ha or less, 3700 g ai/ha or less, 3600 g ai/ha or less, 3500 g ai/ha or less, 3400 g ai/ha or less, 3300 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 900 g ai/ha or less, 800 g ai/ha or less, 750 g ai/ha or less, 700 g ai/ha or less, 600 g ai/ha or less, 500 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 50 g ai/ha or less, or 30 g ai/ha or less, in an amount within any range defined between any pair of the preceding values, such as 25-4300 g ai/ha, 50-1800 g ai/ha, 60-375 g ai/ha, 125-2500 g ai/ha, 170-1700 g ai/ha, 95-350 g ai/ha, 800-3800 g ai/ha, 185-4000 g ai/ha, 390-3700 g ai/ha, 100-420 g ai/ha, 1200-3300 g ai/ha, or 750-4250 g ai/ha.

### Glufosinate

In some aspects, compositions and methods of the present disclosure can include glufosinate or an agriculturally acceptable salt thereof. Glufosinate, shown below, is 2-amino-4-(hydroxy(methyl)phosphinyl) butanoic acid. Its herbicidal activity is exemplified in The Pesticide Manual, Seventeenth Edition, 2016. Exemplary uses of glufosinate include its use for control of annual and perennial grasses and broadleaf weeds, particularly in crops that have been genetically modified to be tolerant of glufosinate.

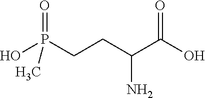

An exemplary salt of glufosinate is glufosinate-ammonium, which is also known as 2-amino-4-(hydroxy(methyl)phosphinyl) butanoic acid ammonium salt, and which has the following structure:

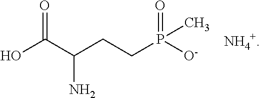

Glufosinate-ammonium is registered for controlling a wide variety of broad-leaved weeds and grasses particularly in glufosinate-tolerant crops like canola, maize, soybean, rice, cotton, and sugar beet. As used herein, glufosinate salt or salt of glufosinate generally refers to the reaction product of glufosinate with a moiety that can act as a base. Typically, the reaction is an acid-base reaction.

Other chemical forms of glufosinate include bilanafos, also known as bialaphos, which has the following structure:

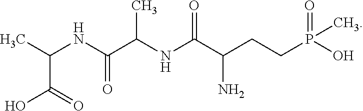 [SMILES: CC(NC(=O)C(C)NC(=O)C(N)CCP(C)(=O)O)C(=O)O]

Bilanafos also can be used in the salt form such as bilanafos sodium. Exemplary uses are described in The Pesticide Manual, Seventeenth Edition, 2016. Exemplary uses include its use to control annual and perennial broadleaf weeds and grasses.

Glufosinate can be applied to vegetation or an area adjacent the vegetation or applied to soil or water to prevent the emergence or growth of vegetation in an amount sufficient to induce a herbicidal effect. In some aspects, glufosinate is applied to vegetation or an area adjacent the vegetation or applied to soil or water to prevent the emergence or growth of vegetation in an amount of 25 g ai/ha or more, such as 50 g ai/ha or more, 70 g ai/ha or more, 75 g ai/ha or more, 90 g ai/ha or more, 100 g ai/ha or more, 112.5 g ai/ha or more, 125 g ai/ha or more, 150 g ai/ha or more, 175 g ai/ha or more, 200 g ai/ha or more, 225 g ai/ha or more, 250 g ai/ha or more, 275 g ai/ha or more, 300 g ai/ha or more, 325 g ai/ha or more, 350 g ai/ha or more, 375 g ai/ha or more, 400 g ai/ha or more, 425 g ai/ha or more, 450 g ai/ha or more, 475 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2050 g ai/ha or more, 2100 g ai/ha or more, 2150 g ai/ha or more, or 2200 g ai/ha or more, in an amount of 2250 g ai/ha or less (e.g., 2200 g ai/ha or less, 2150 g ai/ha or less, 2100 g ai/ha or less, 2050 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 475 g ai/ha or less, 450 g ai/ha or less, 425 g ai/ha or less, 400 g ai/ha or less, 375 g ai/ha or less, 350 g ai/ha or less, 325 g ai/ha or less, 300 g ai/ha or less, 275 g ai/ha or less, 250 g ai/ha or less, 225 g ai/ha or less, 200 g ai/ha or less, 175 g ai/ha or less, 150 g ai/ha or less, 125 g ai/ha or less, 112.5 g ai/ha or less, 100 g ai/ha or less, 90 g ai/ha or less, 75 g ai/ha or less, 70 g ai/ha or less, or 50 g ai/ha or less, or in an amount ranging from any of the minimum values described above to any of the maximum values described above, such as in an amount of 25-2250 g ai/ha, 50-900 g ai/ha, 70-1800 g ai/ha, 125-475 g ai/ha, 112.5-1600 g ai/ha, 200-1300 g ai/ha, 350-2150 g ai/ha, 275-1900 g ai/ha, 400-1400 g ai/ha, 450-750 g ai/ha, 475-1100 g ai/ha, 500-2200 g ai/ha, or 650-1700 g ai/ha).

### Photosystem II Inhibitor Herbicides

In addition to the compounds of Formula I or agriculturally acceptable salts or esters thereof, the compositions can include a photosystem II (PS II) inhibitor herbicide or agriculturally acceptable salt or ester thereof. Photosystem II inhibitors inhibit photosynthesis by binding to the photosystem II complex in the chloroplast. Examples of photosystem II inhibitors include phenylcarbamate herbicides, pyridazinone herbicides, triazolinone herbicides, triazine herbicides, urea herbicides, uracil herbicides, amide herbicides, nitrile herbicides, and phenylpyridazine herbicides.

In some aspects, the composition can include a PS II inhibitor herbicide selected from the group consisting of ametryne, amicarbazone, atrazine, bentazone, bromacil, bromofenoxim, bromoxynil, chlorbromuron, chloridazon, chlorotoluron, chloroxuron, cyanazine, desmedipham, desmetryn, dimefuron, dimethametryn, diuron, ethidimuron, ethiozin, fenuron, fluometuron, hexazinone, iodobonil, ioxynil, isocil, isomethiozin, isoproturon, isouron, karbutilate, lenacil, linuron, metamitron, methabenzthiazuron, metobromuron, metoxuron, metribuzin, monolinuron, neburon, pentanochlor, phenmedipham, prometon, prometryn, propanil, propazine, pyridafol, pyridate, siduron, simazine, simetryne, tebuthiuron, terbacil, terbumeton, terbuthylazine, terbutryn, trietazine, and combinations thereof.

The PS II inhibitor herbicide or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the PS II inhibitor herbicide or agriculturally acceptable salt or ester thereof is applied to vegetation or an area adjacent the vegetation or applied to soil or water to prevent the emergence or growth of vegetation in an amount of 5 grams active ingredient per hectare (g ai/ha) or more, such as 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, 300 g ai/ha or more, 310 g ai/ha or more, 320 g ai/ha or more, 330 g ai/ha or more, 340 g ai/ha or more, 350 g ai/ha or more, 360 g ai/ha or more, 370 g ai/ha or more, 380 g ai/ha or more, 390 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 625 g ai/ha or more, 650 g ai/ha or more, 675 g ai/ha or more, 700 g ai/ha or more, 725 g ai/ha or more, 750 g ai/ha or more, 775 g ai/ha or more, 800 g ai/ha or more, 825 g ai/ha or more, 850 g ai/ha or more, 875 g ai/ha or more, 900 g ai/ha or more, 925 g ai/ha or more, 950 g ai/ha or more, 975 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3300 g ai/ha or more, 3400 g ai/ha or more, 3500 g ai/ha or more, 3600 g ai/ha or more, 3700 g ai/ha or more, 3800 g ai/ha or more, 3900 g ai/ha or more, 4000 g ai/ha or more, 5000 g ail/ha or more, 6000 g ai/ha or more, 7000 g ail/ha or more, 8000 g ai/ha or more, 9000 g ail/ha or more, 10,000 g ai/ha or more, 12,000 g ail/ha or more, 14,000 g ai/ha or more, 15,000 g ail/ha or more, 16000 g ai/ha or more, or 17,000 g ail/ha or more; in an amount of 18,000 g ai/ha or less, such as 17,000 g ai/ha or less, 16,000 g ai/ha or less, 15,000 g ai/ha or less, 14,000 g ai/ha or less, 12,000 g ai/ha or less, 10,000 g ai/ha or less, 9000 g ai/ha or less, 8000 g ai/ha or less, 7000 g ai/ha or less, 6000 g ai/ha or less, 5000 g ai/ha or less, 4000 g ai/ha or less, 3900 g ai/ha or less, 3800 g ai/ha or less, 3700 g ai/ha or less, 3600 g ai/ha or less, 3500 g ai/ha or less, 3400 g ai/ha or less, 3300 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 975 g ai/ha or less, 950 g ai/ha or less, 925 g ai/ha or less, 900 g ai/ha or less, 875 g ai/ha or less, 850 g ai/ha or less, 825 g ai/ha or less, 800 g ai/ha or less, 775 g ai/ha or less, 750 g ai/ha or less, 725 g ai/ha or less, 700 g ai/ha or less, 675 g ai/ha or less, 650 g ai/ha or less, 625 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 390 g ai/ha or less, 380 g ai/ha or less, 370 g ai/ha or less, 360 g ai/ha or less, 350 g ai/ha or less, 340 g ai/ha or less, 330 g ai/ha or less, 320 g ai/ha or less, 310 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, or 10 g ai/ha or less; or in an amount ranging from any of the minimum values described above to any of the maximum values described above, such as 5-4000 g ai/ha, 5-3000 g ai/ha, 3000-4000 g ai/ha, 5-2900 g ai/ha, 5-2800 g ai/ha, 5-2700 g ai/ha, 5-2600 g ai/ha, 5-2500 g ai/ha, 5-2400 g ai/ha, 5-2300 g ai/ha, 5-2200 g ai/ha, 5-2100 g ai/ha, 5-2000 g ai/ha, 5-1800 g ai/ha, 5-1600 g ai/ha, 5-1400 g ai/ha, 5-1200 g ai/ha, 5-1000 g ai/ha, 5-900 g ai/ha, 5-800 g ai/ha, 5-700 g ai/ha, 5-600 g ai/ha, 5-500 g ai/ha, 10-4000 g ai/ha, 10-3000 g ai/ha, 10-2000 g ai/ha, 20-4000 g ai/ha, 20-3000 g ai/ha, 20-2000 g ai/ha, 20-1500 g ai/ha, 30-4000 g ai/ha, 30-3000 g ai/ha, 30-2000 g ai/ha, 50-4000 g ai/ha, 50-3000 g ai/ha, 50-2000 g ai/ha, 50-1500 g ai/ha, 70-4000 g ai/ha, 70-3000 g ai/ha, 70-2500 g ai/ha, 70-2000 g ai/ha, 70-1500 g ai/ha, 100-3000 g ai/ha, 100-2500 g ai/ha, or 100-2000 g ai/ha. In some aspects, the photosystem II inhibitor or agriculturally acceptable salt or ester thereof is applied to vegetation or an area adjacent the vegetation or applied to soil or water to prevent the emergence or growth of vegetation in an amount of from 30-1000 g ai/ha.

In some aspects, the composition contains (a) a compounds of Formula I, and (b) ametryne, amicarbazone, atrazine, bentazone, bromacil, bromofenoxim, bromoxynil, chlorbromuron, chloridazon, chlorotoluron, chloroxuron, cyanazine, desmedipham, desmetryn, dimefuron, dimethametryn, diuron, ethidimuron, ethiozin, fenuron, fluometuron, hexazinone, iodobonil, ioxynil, isocil, isomethiozin, isoproturon, isouron, karbutilate, lenacil, linuron, metamitron, methabenzthiazuron, methoprotryne, metobromuron, metoxuron, metribuzin, monolinuron, neburon, pentanochlor, phenmedipham, prometon, prometryn, propanil, propazine, pyridafol, pyridate, siduron, simazine, simetryne, tebuthiuron, terbacil, terbumeton, terbuthylazine, terbutryn, trietazine, or mixtures thereof.

### ACCase Inhibitor Herbicides

In addition to the compounds of Formula I or agriculturally acceptable, salts or esters thereof, the compositions include an acetyl CoA carboxylase (ACCase) inhibitor herbicide or an agriculturally acceptable salt or ester thereof. ACCase inhibitor herbicides inhibit lipid biosynthesis in the plant. Examples of ACCase inhibitor herbicides include aryloxyphenoxypropionates, cyclohexanediones, and phenylpyrazolines. In some aspects, the ACCase inhibitor herbicide can include an aryloxyphenoxypropionate herbicide. In some aspects, the ACCase inhibitor herbicide can include a cyclohexanedione herbicide. In some aspects, the ACCase inhibitor herbicide can include a phenylpyrazoline herbicide.

In some aspects, the composition can include an ACCase inhibitor selected from the group of cyclohexanediones, aryloxyphenoxypropionates, phenylpyrazolines, or combinations thereof. In some cases, the composition can include clodinafop, cyhalofop, diclofop, fenoxaprop, fenthiaprop, fluazifop, haloxyfop, metamifop, propaquizafop, quizalofop, agriculturally acceptable salts or esters thereof, or combinations thereof. In some cases, the composition can include alloxydim, butroxydim, clethodim, cloproxydim, cycloxydim, pinoxaden, profoxydim, sethoxydim, tepraloxydim, tralkoxydim, agriculturally acceptable salts or esters thereof, or combinations thereof.

The ACCase inhibitor herbicide or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the ACCase inhibitor herbicide or agriculturally acceptable salt or ester thereof is applied to vegetation or an area adjacent the vegetation or applied to soil or water to prevent the emergence or growth of vegetation in an amount of 2 g ai/ha or more, such as 2.5 g ai/ha or more, 3 g ai/ha or more, 3.5 g ai/ha or more, 4 g ai/ha or more, 4.5 g ai/ha or more, 5 g ai/ha or more, 6 g ai/ha or more, 7 g ai/ha or more, 8 g ai/ha or more, 9 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, or 1450 g ai/ha or more; in an amount of 1500 g ai/ha or less, such as 1450 g ai/ha or less, 1400 g ai/ha or less, 1350 g ai/ha or less, 1300 g ai/ha or less, 1250 g ai/ha or less, 1240 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 450 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, or 2.5 g ai/ha or less; or in an amount ranging from any of the minimum values described above to any of the maximum values described above, such as 2-1500 g ai/ha, 5-1300 g ai/ha, 6-250 g ai/ha, 75-1240 g ai/ha, 90-900 g ai/ha, 55-290 g ai/ha, 7-600 g ai/ha, 20-700 g ai/ha, 190-1450 g ai/ha, 65-1100 g ai/ha, 320-1000 g ai/ha, 250-750 g ai/ha, 700-1200 g ai/ha, 850-1400 g ai/ha, or 2.5-1450 g ai/ha.

In some aspects, the composition contains: (a) a compounds of Formula I and (b) alloxydim, butroxydim, clethodim, clodinafop, cloproxydim, cycloxydim, cyhalofop, diclofop, fenoxaprop, fenthiaprop, fluazifop, haloxyfop, metamifop, pinoxaden, profoxydim, propaquizafop, quizalofop, sethoxydim, tepraloxydim, tralkoxydim, agriculturally acceptable salts and esters thereof, and combinations thereof.

### HPPD Inhibitor Herbicides

In addition to the compounds of Formula I or agriculturally acceptable, salts, or esters thereof, the compositions can include an inhibitor of 4-hydroxyphenylpyruvate dioxygenase (HPPD), an oxygenase enzyme involved in the creation of energy in plants and higher order eukaryotes. Examples of HPPD inhibitors include benzobicyclon, benzofenap, bicyclopyrone, fenquinotrione, isoxachlortole, isoxaflutole, lancotrione, mesotrione, pyrasulfotole, pyrazolynate, pyrazoxyfen, sulcotrione, tefuryltrione, tembotrione, tolpyralate, topramezone, or agriculturally acceptable salts or esters thereof, and combinations thereof.

The HPPD inhibitor or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the HPPD inhibitor or agriculturally acceptable salt or ester thereof is applied to vegetation or an area adjacent the vegetation or applied to soil or water to prevent the emergence or growth of vegetation in an amount of 1 grams active ingredient per hectare (g ai/ha) or more, such as 1.1 g ai/ha or more, 1.25 g ai/ha or more, 1.5 g ai/ha or more, 1.75 g ai/ha or more, 2 g ai/ha or more, 2.5 g ai/ha or more, 3 g ai/ha or more, 3.5 g ai/ha or more, 4 g ai/ha or more, 5 g ai/ha or more, 6 g ai/ha or more, 7 g ai/ha or more, 8 g ai/ha or more, 9 g ai/ha or more, 10 g ai/ha or more, 11 g ai/ha or more, 12 g ai/ha or more, 13 g ai/ha or more, 14 g ai/ha or more, 15 g ai/ha or more, 16 g ai/ha or more, 17 g ai/ha or more, 18 g ai/ha or more, 19 g ai/ha or more, 20 g ai/ha or more, 21 g ai/ha or more, 22 g ai/ha or more, 23 g ai/ha or more, 24 g ai/ha or more, 25 g ai/ha or more, 26 g ai/ha or more, 27 g ai/ha or more, 28 g ai/ha or more, 29 g ai/ha or more, 30 g ai/ha or more, 31 g ai/ha or more, 32 g ai/ha or more, 33 g ai/ha or more, 34 g ai/ha or more, 35 g ai/ha or more, 36 g ai/ha or more, 37 g ai/ha or more, 38 g ai/ha or more, 39 g ai/ha or more, 40 g ai/ha or more, 41 g ai/ha or more, 42 g ai/ha or more, 43 g ai/ha or more, 44 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2050 g ai/ha or more, 2100 g ai/ha or more, 2150 g ai/ha or more, 2200 g ai/ha or more, 2240 g ai/ha or more, 2250 g ai/ha or more, 2300 g ai/ha or more, 2350 g ai/ha or more, 2400 g ai/ha or more, 2450 g ai/ha or more, 2500 g ai/ha or more, 2600 g ai/ha or more, 2700 g ai/ha or more, 2750 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3600 g ai/ha or more, 3700 g ai/ha or more, 3750 g ai/ha or more, 3800 g ai/ha or more, 3900 g ai/ha or more, 3950 g ai/ha or more, 4000 g ai/ha or more, 4100 g ai/ha or more, 4200 g ai/ha or more, 4250 g ai/ha or more, 4250 g ai/ha or more, 4300 g ai/ha or more, or 4350 g ai/ha or more, or 4400 g ai/ha or more; in an amount of 4500 g ai/ha or less, such as 4450 g ai/ha or less, 4400 g ai/ha or less, 4350 g ai/ha or less, 4300 g ai/ha or less, 4250 g ai/ha or less, 4100 g ai/ha or less, 4000 g ai/ha or less, 3950 g ai/ha or less, 3900 g ai/ha or less, 3800 g ai/ha or less, 3750 g ai/ha or less, 3700 g ai/ha or less, 3600 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2750 g ai/ha or less, 2700 g ai/ha or less, 2600 g ai/ha or less, 2500 g ai/ha or less, 2450 g ai/ha or less, 2400 g ai/ha or less, 2350 g ai/ha or less, 2300 g ai/ha or less, 2250 g ai/ha or less, 2240 g ai/ha or less, 2200 g ai/ha or less, 2150 g ai/ha or less, 2100 g ai/ha or less, 2050 g ai/ha or less, 2000 g ai/ha or less, 1900 g ai/ha or less, 1800 g ai/ha or less, 1750 g ai/ha or less, 1700 g ai/ha or less, 1600 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1240 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 450 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 44 g ai/ha or less, 43 g ai/ha or less, 42 g ai/ha or less, 41 g ai/ha or less, 40 g ai/ha or less, 39 g ai/ha or less, 38 g ai/ha or less, 37 g ai/ha or less, 36 g ai/ha or less, 35 g ai/ha or less, 34 g ai/ha or less, 33 g ai/ha or less, 32 g ai/ha or less, 31 g ai/ha or less, 30 g ai/ha or less, 29 g ai/ha or less, 28 g ai/ha or less, 27 g ai/ha or less, 26 g ai/ha or less, 25 g ai/ha or less, 24 g ai/ha or less, 23 g ai/ha or less, 22 g ai/ha or less, 21 g ai/ha or less, 20 g ai/ha or less, 19 g ai/ha or less, 18 g ai/ha or less, 17 g ai/ha or less, 16 ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3.5 g ai/ha or less, 3 g ai/ha or less, 2.5 g ai/ha or less, 2 g ai/ha or less, 1.75 g ai/ha or less, 1.5 g ai/ha or less, 1.25 g ai/ha or less, or 1.1 g ai/ha or less; or in an amount ranging from any of the minimum values described above to any of the maximum values described above, such as 1-4500 g ai/ha, 4-3900 g ai/ha, 1.75-2500 g ai/ha, 75-3100 g ai/ha, 90-900 g ai/ha, 55-4200 g ai/ha, 50-2350 g ai/ha, 80-2900 g ai/ha, 120-4100 g ai/ha, 65-2700 g ai/ha, 300-4000 g ai/ha, 1200-3600 g ai/ha, 250-2000 g ai/ha, 1.75-250 g ai/ha, 700-4250 g ai/ha, 39-1100 g ai/ha, or 1.1-4450 g ai/ha.

In some aspects, the herbicidal composition contains a herbicidally effective amount of (a) a compound of Formula I, and (b) benzobicyclon, benzofenap, bicyclopyrone, fenquinotrione, isoxachlortole, isoxaflutole, lancotrione, mesotrione, pyrasulfotole, pyrazolynate, pyrazoxyfen, sulcotrione, tefuryltrione, tembotrione, tolpyralate, topramezone, agriculturally acceptable salts or esters, or combinations thereof.

### PROTOX Inhibitor Herbicides

In addition to the compounds of Formula I or agriculturally acceptable, salst, or esters thereof, the compositions can include an inhibitor of a protoporphyrinogen oxidase (PROTOX), which is an enzyme involved in the biosynthesis of both heme and chlorophyll. It is believed that PROTOX inhibitors generate large amounts of singlet oxygen, which leads to the peroxidation of the lipids in cell membranes. Examples of PROTOX inhibitors include acifluorfen, azafenidin, benzfendizone, bifenox, butafenacil, carfentrazone, chlomethoxyfen, cinidon, fluazolate, flufenpyr, flumiclorac, flumioxazin, fluoroglycofen, fluthiacet, fomesafen, halosafen, lactofen, oxadiargyl, oxadiazon, oxyfluorfen, pentoxazone, profluazol, pyraclonil, pyraflufen, saflufenacil, sulfentrazone, thidiazimin, tiafenacil, agriculturally acceptable salts thereof, agriculturally acceptable esters thereof, or combinations thereof.

In some aspects the PROTOX inhibitor may include at least one of acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1-H-pyrazole-1-carboxamide (CAS 915396-43-9), N-ethyl-3-(2-chloro-6-fluoro-4-trifluoromethylphenoxy)-5-methyl-1H-pyrazo-le-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7), 3-[7-fluoro-3-oxo-4-(prop-2-ynyl)-3,4-dihydro-2H-benzo[1,4]oxazin-6-yl]-1,5-dimethyl-6-thioxo[1,3,5]triazinan-2,4-dione, agriculturally acceptable salts thereof, agriculturally acceptable esters thereof, or combinations thereof.

The PROTOX inhibitor or agriculturally acceptable salt or ester thereof can be applied to vegetation or an area adjacent to the vegetation or applied to soil or water to prevent the emergence or growth of vegetation in an amount sufficient to induce a herbicidal effect. In some aspects, the PROTOX inhibitor or agriculturally acceptable salt or ester thereof is applied to vegetation or an area adjacent the vegetation or applied to soil or water to prevent the emergence or growth of vegetation in an amount of 0.5 grams active ingredient per hectare (g ai/ha) or more, such as 1 g ai/ha or more, 1.25 g ai/ha or more, 1.5 g ai/ha or more, 1.75 g ai/ha or more, 2 g ai/ha or more, 2.5 g ai/ha or more, 3 g ai/ha or more, 3.5 g ai/ha or more, 4 g ai/ha or more, 5 g ai/ha or more, 6 g ai/ha or more, 7 g ai/ha or more, 8 g ai/ha or more, 9 g ai/ha or more, 10 g ai/ha or more, 11 g ai/ha or more, 12 g ai/ha or more, 13 g ai/ha or more, 14 g ai/ha or more, 15 g ai/ha or more, 16 g ai/ha or more, 17 g ai/ha or more, 18 g ai/ha or more, 19 g ai/ha or more, 20 g ai/ha or more, 21 g ai/ha or more, 22 g ai/ha or more, 23 g ai/ha or more, 24 g ai/ha or more, 25 g ai/ha or more, 26 g ai/ha or more, 27 g ai/ha or more, 28 g ai/ha or more, 29 g ai/ha or more, 30 g ai/ha or more, 31 g ai/ha or more, 32 g ai/ha or more, 33 g ai/ha or more, 34 g ai/ha or more, 35 g ai/ha or more, 36 g ai/ha or more, 37 g ai/ha or more, 38 g ai/ha or more, 39 g ai/ha or more, 40 g ai/ha or more, 41 g ai/ha or more, 42 g ai/ha or more, 43 g ai/ha or more, 44 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, or 975 g ai/ha or more; in an amount of 1000 g ai/ha or less, such as 975 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 450 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 44 g ai/ha or less, 43 g ai/ha or less, 42 g ai/ha or less, 41 g ai/ha or less, 40 g ai/ha or less, 39 g ai/ha or less, 38 g ai/ha or less, 37 g ai/ha or less, 36 g ai/ha or less, 35 g ai/ha or less, 34 g ai/ha or less, 33 g ai/ha or less, 32 g ai/ha or less, 31 g ai/ha or less, 30 g ai/ha or less, 29 g ai/ha or less, 28 g ai/ha or less, 27 g ai/ha or less, 26 g ai/ha or less, 25 g ai/ha or less, 24 g ai/ha or less, 23 g ai/ha or less, 22 g ai/ha or less, 21 g ai/ha or less, 20 g ai/ha or less, 19 g ai/ha or less, 18 g ai/ha or less, 17 g ai/ha or less, 16 ai/ha or less, 15 g ai/ha or less, 14 g ai/ha or less, 13 g ai/ha or less, 12 g ai/ha or less, 11 g ai/ha or less, 10 g ai/ha or less, 9 g ai/ha or less, 8 g ai/ha or less, 7 g ai/ha or less, 6 g ai/ha or less, 5 g ai/ha or less, 4 g ai/ha or less, 3.5 g ai/ha or less, 3 g ai/ha or less, 2.5 g ai/ha or less, 2 g ai/ha or less, 1.75 g ai/ha or less, 1.5 g ai/ha or less, 1.25 g ai/ha or less, or 1 g ai/ha or less; or in an amount ranging from any of the minimum values described above to any of the maximum values described above, such as 0.5-1000 g ai/ha, 2-900 g ai/ha, 1.75-300 g ai/ha, 75-550 g ai/ha, 90-900 g ai/ha, 55-400 g ai/ha, 36-250 g ai/ha, 80-650 g ai/ha, 120-360 g ai/ha, 65-170 g ai/ha, 34-700 g ai/ha, 12-200 g ai/ha, 5-220 g ai/ha, 1.5-25 g ai/ha, 70-450 g ai/ha, 39-110 g ai/ha, or 1-975 g ai/ha.

In some aspects, the herbicidal composition contains a herbicidally effective amount of (a) a compound of Formula I, and (b) acifluorfen, azafenidin, benzfendizone, bifenox, butafenacil, carfentrazone, chlomethoxyfen, cinidon, fluazolate, flufenpyr, flumiclorac, flumioxazin, fluoroglycofen, fluthiacet, fomesafen, halosafen, lactofen, oxadiargyl, oxadiazon, oxyfluorfen, pentoxazone, profluazol, pyraclonil, pyraflufen, saflufenacil, sulfentrazone, thidiazimin, tiafenacil, agriculturally acceptable salts or esters thereof, or combinations thereof.

### Plant Growth Regulators

In addition to the compounds of Formula I or agriculturally acceptable salts or esters thereof, the compositions can include a plant growth regulator (PGR), an agriculturally acceptable salt or ester thereof, or mixtures thereof. PGRs, also called plant hormones, act as chemical messengers for intercellular communication. PGRs can be classified into a number of modes of action that may influence, for example, the growth, division, elongation, or differentiation of plant cells. Examples of PGRs include 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, and uniconazole.

In some aspects, the composition can include a PGR selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and mixtures thereof.

PGRs can be applied to vegetation or an area adjacent the vegetation or applied to soil or water to prevent the emergence or growth of vegetation in an amount sufficient to induce a herbicidal effect. In some aspects, the PGR is applied to vegetation or an area adjacent the vegetation or applied to soil or water to prevent the emergence or growth of vegetation in an amount of 20 g ai/ha or more, such as 0.020 g ai/ha or more, 0.025 g ai/ha or more, 0.03 g ai/ha or more, 0.04 g ai/ha or more, 0.05 g ai/ha or more, 0.06 g ai/ha or more, 0.07 g ai/ha or more, 0.08 g ai/ha or more, 0.09 g ai/ha or more, 0.1 g ai/ha or more, 0.11 g ai/ha or more, 0.125 g ai/ha or more, 0.15 g ai/ha or more, 0.175 g ai/ha or more, 0.20 g ai/ha or more, 0.25 g ai/ha or more, 0.3 g ai/ha or more, 0.4 g ai/ha or more, 0.5 g ai/ha or more, 0.6 g ai/ha or more, 0.7 g ai/ha or more, 0.8 g ai/ha or more, 0.9 g ai/ha or more, 1 g ai/ha or more, 1.1 g ai/ha or more, 1.25 g ai/ha or more, 1.5 g ai/ha or more, 1.75 g ai/ha or more, 2 g ai/ha or more, 2.25 g ai/ha or more, 2.5 g ai/ha or more, 2.75 g ai/ha or more, 3 g ai/ha or more, 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8250 g ai/ha or more, 8500 g ai/ha or more, 8750 g ai/ha or more, 9000 g ai/ha or more, 9250 g ai/ha or more, 9500 g ai/ha or more, 9750 g ai/ha or more, 10 kg ai/ha or more, 10.5 kg ai/ha or more, 11 kg ai/ha or more, 11.5 kg ai/ha or more, 12 k g ai/ha or more, 12.5 kg ai/ha or more, 13 kg ai/ha or more, 13.5 kg ai/ha or more, 14 kg ai/ha or more, 14.5 kg ai/ha or more, 15 kg ai/ha or more, 15.5 kg ai/ha or more, 16 kg ai/ha or more, 16.5 kg ai/ha or more, 16.75 kg ai/ha or more, 17 kg ai/ha or more, or 17.5 kg ai/ha or more; in an amount of 17.5 kg ai/ha or less, such as 17 kg ai/ha or less, 16.5 kg ai/ha or less, 16 kg ai/ha or less, 15.5 kg ai/ha or less, 15 kg ai/ha or less, 14.5 k g ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, 10.5 kg ai/ha, 10 kg ai/ha or less, 9750 g ai/ha or less, 9500 g ai/ha or less, 9250 g ai/ha or less, 9000 g ai/ha or less, 8750 g ai/ha or less, 8500 g ai/ha or less, 8250 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9.5 g ai/ha or less, 9 g ai/ha or less, 8.5 g ai/ha or less, 8 g ai/ha or less, 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, 3.25 g ai/ha or less, 3 g ai/ha or less, 2.75 g ai/ha or less, 2.5 g ai/ha or less, 2.25 g ai/ha or less, 2 g ai/ha or less, 1.75 g ai/ha or less, 1.5 g ai/ha or less, 1.25 g ai/ha or less, 1.1 g ai/ha or less, 1 g ai/ha or less, 0.9 g ai/ha or less, 0.8 g ai/ha or less, 0.7 g ai/ha or less, 0.6 g ai/ha or less, 0.5 g ai/ha or less, 0.4 g ai/ha or less, 0.3 g ai/ha or less, 0.2 g ai/ha or less, 0.175 g ai/ha or less, 0.15 g ai/ha or less, 0.125 g ai/ha or less, 0.11 g ai/ha or less, 0.1 g ai/ha or less, 0.09 g ai/ha or less, 0.08 g ai/ha or less, 0.07 g ai/ha or less, 0.06 g ai/ha or less, 0.05 g ai/ha or less, 0.04 g ai/ha or less, 0.03 g ai/ha or less, or 0.025 g ai/ha or less; or in an amount ranging from any of the minimum values described above to any of the maximum values described above, such as 0.020 g-17.5 kg ai/ha, 950-6500 g ai/ha, 0.7-8.5 g ai/ha, 460-3750 g ai/ha, 600-2500 g ai/ha, 50-5000 g ai/ha, 110-450 g ai/ha, 11.5-16 kg ai/ha, 1900-4000 g ai/ha, 1-4 g ai/ha, 750-2200 g ai/ha, 380-5250 g ai/ha, 0.2-17.25 g ai/ha, 500-1400 g ai/ha, 3.25-950 g ai/ha, 440-2900 g ai/ha, or 0.025 g-17 kg ai/ha.

### Cellulose Biosynthesis Inhibitor (CBI) Herbicides

In addition to the compounds of Formula I or agriculturally acceptable salts or esters thereof, the compositions can include a CBI herbicide, an agriculturally acceptable salt or ester thereof, or mixtures thereof. CBI herbicides appear to interfere with the biosynthesis of plant cell walls, thereby inhibiting cell division in germinating seedlings. Examples of CBI herbicides include chlorthiamid, dichlobenil, flupoxam, indaziflam, isoxaben, and triaziflam.

In some aspects, the composition can include a CBI herbicide selected from the group consisting of chlorthiamid, dichlobenil, flupoxam, indaziflam, isoxaben, triaziflam, agriculturally acceptable salts or esters thereof, and mixtures thereof.

CBI herbicides can be applied to vegetation or an area adjacent the vegetation or applied to soil or water to prevent the emergence or growth of vegetation in an amount sufficient to induce a herbicidal effect. In some aspects, the CBI herbicide is applied to vegetation or an area adjacent the vegetation or applied to soil or water to prevent the emergence or growth of vegetation in an amount of 25 g ai/ha or more, such as 35 g ai/ha or more, 50 g ai/ha or more, 75 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3250 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5400 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8100 g ai/ha or more, 8250 g ai/ha or more, 8500 g ai/ha or more, 8750 g ai/ha or more, or 9000 g ai/ha or more; in an amount of 9000 g ai/ha or less, such as 8750 g ai/ha or less, 8500 g ai/ha or less, 8250 g ai/ha or less, 8100 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 5750 g ai/ha or less, 5500 g ai/ha or less, 5400 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3250 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 75 g ai/ha or less, 50 g ai/ha or less, or 35 g ai/ha or less; or in an amount ranging from any of the minimum values described above to any of the maximum values described above, such as 25-9000 g ai/ha, 950-6500 g ai/ha, 460-3750 g ai/ha, 675-2500 g ai/ha, 50-7000 g ai/ha, 110-450 g ai/ha, 1500-8000 g ai/ha, 750-5400 g ai/ha, 380-3250 g ai/ha, 500-1200 g ai/ha, 440-2500 g ai/ha, or 35-1200 g ai/ha.

In some aspects, the composition contains: (a) a compound of Formula I and (b) chlorthiamid, dichlobenil, flupoxam, indaziflam, isoxaben, triaziflam, agriculturally acceptable salts or esters thereof, and mixtures thereof.

### VLCFA Synthesis Inhibitor Herbicides

In addition to the compounds of Formula I or agriculturally acceptable, salts or esters thereof, the compositions include a very long chain fatty acid (VLCFA) synthesis inhibitor herbicide. Very long chain fatty acids have multiple functions in the plant, primarily serving as precursors of cuticle wax biosynthesis, and as components of storage lipids, sphingolipids and phospholipids. Examples of VLCFA synthesis inhibitors include, but are not limited to, acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, and thenylchlor.

In some aspects, the composition can include a VLCFA synthesis inhibitor herbicide selected from the group consisting of acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, thenylchlor, agriculturally acceptable salts and esters thereof, and combinations thereof.

The VLCFA synthesis inhibitor herbicide or agriculturally acceptable salt or ester thereof can be applied to vegetation or an area adjacent the vegetation or applied to soil or water to prevent the emergence or growth of vegetation in an amount sufficient to induce a herbicidal effect. In some aspects, the VLCFA synthesis inhibitor herbicide or agriculturally acceptable salt or ester thereof is applied to vegetation or an area adjacent the vegetation or applied to soil or water to prevent the emergence or growth of vegetation in an amount of 40 grams active ingredient per hectare (g ai/ha) or more, such as 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 250 g ai/ha or more, 260 g ai/ha or more, 280 g ai/ha or more, 300 g ai/ha or more, 320 g ai/ha or more, 340 g ai/ha or more, 350 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 650 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2050 g ai/ha or more, 2100 g ai/ha or more, 2150 g ai/ha or more, 2200 g ai/ha or more, 2240 g ai/ha or more, 2250 g ai/ha or more, 2300 g ai/ha or more, 2350 g ai/ha or more, 2400 g ai/ha or more, 2450 g ai/ha or more, 2500 g ai/ha or more, 2600 g ai/ha or more, 2700 g ai/ha or more, 2750 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3600 g ai/ha or more, 3700 g ai/ha or more, 3750 g ai/ha or more, 3800 g ai/ha or more, 3900 g ai/ha or more, 3950 g ai/ha or more, 4000 g ai/ha or more, 4100 g ai/ha or more, 4200 g ai/ha or more, 4250 g ai/ha or more, 4300 g ai/ha or more, 4400 g ai/ha or more, 4450 g ai/ha or more, 4500 g ai/ha or more, 4640 g ai/ha or more, 4780 g ai/ha or more, 4920 g ai/ha or more, 5060 g ai/ha or more, 5200 g ai/ha or more, 5340 g ai/ha or more, 5480 g ai/ha or more, 5620 g ai/ha or more, 5760 g ai/ha or more, 5900 g ai/ha or more, 6040 g ai/ha or more, 6180 g ai/ha or more, 6320 g ai/ha or more, 6460 g ai/ha or more, or 6600 g ai/ha or more; in an amount of 6720 g ai/ha or less, such as 6645 g ai/ha or less, 6575 g ai/ha or less, 6500 g ai/ha or less, 6425 g ai/ha or less, 6350 g ai/ha or less, 6275 g ai/ha or less, 6200 g ai/ha or less, 6125 g ai/ha or less, 6050 g ai/ha or less, 5975 g ai/ha or less, 5900 g ai/ha or less, 5825 g ai/ha or less, 5750 g ai/ha or less, 5675 g ai/ha or less, 5600 g ai/ha or less, 5525 g ai/ha or less, 5450 g ai/ha or less, 5375 g ai/ha or less, 5300 g ai/ha or less, 5225 g ai/ha or less, 5150 g ai/ha or less, 5075 g ai/ha or less, 5000 g ai/ha or less, 4925 g ai/ha or less, 4850 g ai/ha or less, 4775 g ai/ha or less, 4700 g ai/ha or less, 4625 g ai/ha or less, 4550 g ai/ha or less, 4475 g ai/ha or less, 4450 g ai/ha or less, 4400 g ai/ha or less, 4300 g ai/ha or less, 4250 g ai/ha or less, 4100 g ai/ha or less, 4000 g ai/ha or less, 3950 g ai/ha or less, 3900 g ai/ha or less, 3800 g ai/ha or less, 3750 g ai/ha or less, 3700 g ai/ha or less, 3600 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2750 g ai/ha or less, 2700 g ai/ha or less, 2600 g ai/ha or less, 2500 g ai/ha or less, 2450 g ai/ha or less, 2400 g ai/ha or less, 2350 g ai/ha or less, 2300 g ai/ha or less, 2250 g ai/ha or less, 2240 g ai/ha or less, 2200 g ai/ha or less, 2150 g ai/ha or less, 2100 g ai/ha or less, 2050 g ai/ha or less, 2000 g ai/ha or less, 1900 g ai/ha or less, 1800 g ai/ha or less, 1750 g ai/ha or less, 1700 g ai/ha or less, 1600 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1240 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 650 g ai/ha or less, 600 g ai/ha or less, 550 g ai/ha or less, 500 g ai/ha or less, 450 g ai/ha or less, 400 g ai/ha or less, 380 g ai/ha or less, 360 g ai/ha or less, 350 g ai/ha or less, 340 g ai/ha or less, 320 g ai/ha or less, 300 g ai/ha or less, 280 g ai/ha or less, 260 g ai/ha or less, 250 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, or 45 g ai/ha or less; or in an amount ranging from any of the minimum values described above to any of the maximum values described above, such as 40-6720 g ai/ha, 45-5825 g ai/ha, 60-2500 g ai/ha, 75-3100 g ai/ha, 90-900 g ai/ha, 55-4200 g ai/ha, 50-6050 g ai/ha, 80-4700 g ai/ha, 120-4775 g ai/ha, 65-2100 g ai/ha, 300-4000 g ai/ha, 1200-3600 g ai/ha, 250-5000 g ai/ha, 250-1000 g ai/ha, 700-4250 g ai/ha, 800-1400 g ai/ha, or 1000-6720 g ai/ha.

In some aspects, the composition contains: (a) a compound of Formula I and (b) acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, thenylchlor, or combinations thereof.

### III. Microtubule Assembly Inhibitor (MAI) Herbicides

In addition to the compounds of Formula I or agriculturally acceptable N-oxide, salt or ester thereof, the compositions can include a microtubule assembly inhibitor (MAI) herbicide, an agriculturally acceptable salt or ester thereof, or mixtures thereof. MAI herbicides may inhibit plant cell division by binding to tubulin, the major protein needed to form the microtubules required in cell division.

Examples of MAI herbicides include benfluralin, butamifos, butralin, carbetamide, chlorpropham, chlorthal, dithiopyr, ethalfluralin, oryzalin, pendimethalin, prodiamine, propham, propyzamide, thiazopyr, trifluralin, and agriculturally acceptable salts or esters thereof.

MAI herbicides can be applied to vegetation or an area adjacent the vegetation or applied to soil or water to prevent the emergence or growth of vegetation in an amount sufficient to induce a herbicidal effect. In some aspects, the MAI herbicide is applied to vegetation or an area adjacent the vegetation or applied to soil or water to prevent the emergence or growth of vegetation in an amount of 100 g ai/ha or more, such as 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, 145 g ai/ha or more, 150 g ai/ha or more, 155 g ai/ha or more, 160 g ai/ha or more, 165 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 500 g ai/ha or more, 600 g ai/ha or more, 700 g ai/ha or more, 750 g ai/ha or more, 800 g ai/ha or more, 900 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8250 g ai/ha or more, 8500 g ai/ha or more, 8750 g ai/ha or more, 9000 g ai/ha or more, 9250 g ai/ha or more, 9500 g ai/ha or more, 9750 g ai/ha or more, 10 kg ai/ha or more, 10.5 kg ai/ha or more, 11 kg ai/ha or more, 11.5 kg ai/ha or more, 12 k g ai/ha or more, 12.5 kg ai/ha or more, 13 kg ai/ha or more, 13.5 kg ai/ha or more, 14 kg ai/ha or more, 14.5 kg ai/ha or more, 15 kg ai/ha or more, 15.5 kg ai/ha or more, 16 kg ai/ha or more, 16.5 kg ai/ha or more, or 16.75 kg ai/ha or more; in an amount of 17 kg ai/ha or less, such as 16.75 kg ai/ha or less, 16.5 kg ai/ha or less, 16 kg ai/ha or less, 15.5 kg ai/ha or less, 15 kg ai/ha or less, 14.5 k g ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, 10.5 kg ai/ha, 10 kg ai/ha or less, 9750 g ai/ha or less, 9500 g ai/ha or less, 9250 g ai/ha or less, 9000 g ai/ha or less, 8750 g ai/ha or less, 8500 g ai/ha or less, 8250 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3600 g ai/ha or less, 3500 g ai/ha or less, 3400 g ai/ha or less, 3300 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 900 g ai/ha or less, 800 g ai/ha or less, 750 g ai/ha or less, 700 g ai/ha or less, 600 g ai/ha or less, 500 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 165 g ai/ha or less, 160 g ai/ha or less, 155 g ai/ha or less, 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, or 105 g ai/ha or less; or in an amount ranging from any of the minimum values described above to any of the maximum values described above, e.g., 100 g-17 kg ai/ha, 350-1800 g ai/ha, 160-3750 g ai/ha, 225-2500 g ai/ha, 7.5-12.5 kg ai/ha, 115-350 g ai/ha, 3400-6750 g ai/ha, 185-8000 g ai/ha, 390-3100 g ai/ha, 2000-4250 g ai/ha, 1200-3300 g ai/ha, or 105 g-16.75 kg ai/ha.

### III. Fatty Acid and Lipid Synthesis Inhibitor (FA/LSI) Herbicides

In addition to the compounds of Formula I or agriculturally acceptable, salts or esters thereof, the compositions can include a fatty acid and lipid synthesis inhibitor (FA/LSI) herbicide, an agriculturally acceptable salt or ester thereof, or mixtures thereof. FA/LSI herbicides appear to interfere with the biosynthesis of fatty acids and lipids, thereby reducing the deposition of cuticle wax, and to cause abnormal cell development or to inhibit cell division in germinating seedlings. Examples of FA/LSI herbicides include benfuresate, bensulide, butylate, cycloate, dalapon, EPTC, esprocarb, ethofumesate, flupropanate, molinate, orbencarb, prosulfocarb, thiobencarb, tiocarbazil, tri-allate, vemolate.

In some aspects, the composition can include a FA/LSI herbicide selected from the group consisting of benfuresate, bensulide, butylate, cycloate, dalapon, EPTC, esprocarb, ethofumesate, flupropanate, molinate, orbencarb, prosulfocarb, thiobencarb, tiocarbazil, tri-allate, vemolate, agriculturally acceptable salts or esters thereof, and mixtures thereof.

FA/LSI herbicides can be applied to vegetation or an area adjacent the vegetation or applied to soil or water to prevent the emergence or growth of vegetation in an amount sufficient to induce a herbicidal effect. In some aspects, the FA/LSI herbicide is applied to vegetation or an area adjacent the vegetation or applied to soil or water to prevent the emergence or growth of vegetation in an amount of 300 g ai/ha or more, such as 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1100 g ai/ha or more, 1200 g ai/ha or more, 1300 g ai/ha or more, 1400 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3250 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8250 g ai/ha or more, 8500 g ai/ha or more, 8750 g ai/ha or more, 9000 g ai/ha or more, 9250 g ai/ha or more, 9500 g ai/ha or more, 9750 g ai/ha or more, 10 kg ai/ha or more, 10.5 kg ai/ha or more, 11 kg ai/ha or more, 11.5 kg ai/ha or more, 12 k g ai/ha or more, 12.5 kg ai/ha or more, 13 kg ai/ha or more, 13.5 kg ai/ha or more, 14 kg ai/ha or more, 14.5 kg ai/ha or more, 15 kg ai/ha or more, 15.5 kg ai/ha or more, 16 kg ai/ha or more, 16.5 kg ai/ha or more, 16.75 kg ai/ha or more, 17 kg ai/ha or more, 17.5 kg ai/ha or more, 18 kg ai/ha or more, 18.5 kg ai/ha or more, 19 kg ai/ha or more, 19.5 kg ai/ha or more, 20 kg ai/ha or more, or 20.5 kg ai/ha or more; in an amount of 21 kg ai/ha or less, such as 20.5 kg ai/ha or less, 20 kg ai/ha or less, 19.5 k g ai/ha or less, 19 kg ai/ha or less, 18.5 kg ai/ha or less, 18 kg ai/ha or less, 17.5 kg ai/ha or less, 17 kg ai/ha or less, 16.5 kg ai/ha or less, 16 kg ai/ha or less, 15.5 kg ai/ha or less, 15 kg ai/ha or less, 14.5 k g ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, 10.5 kg ai/ha, 10 kg ai/ha or less, 9750 g ai/ha or less, 9500 g ai/ha or less, 9250 g ai/ha or less, 9000 g ai/ha or less, 8750 g ai/ha or less, 8500 g ai/ha or less, 8250 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 6750 g ai/ha or less, 6500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3250 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, or 310 g ai/ha or less; or in an amount ranging from any of the minimum values described above to any of the maximum values described above, such as 300 g-21 kg ai/ha, 950-4500 g ai/ha, 460-3750 g ai/ha, 6-15 kg ai/ha, 900-1700 g ai/ha, 320-450 g ai/ha, 8500 g-14 kg ai/ha, 750-2200 g ai/ha, 390-5250 g ai/ha, 400-1200 g ai/ha, 1200-3500 g ai/ha, or 310 g-20.5 kg ai/ha.

In some aspects, the compositions and methods provided herein are utilized to control weeds in crops, including but not limited to direct-seeded, water-seeded and transplanted rice, cereals, wheat, barley, oats, rye, Sorghum, corn/maize, sugarcane, sunflower, oilseed rape, canola, sugar beet, soybean, cotton, pineapple, pastures, grasslands, rangelands, fallow-land, turf, tree and vine orchards, aquatics, plantation crops, vegetables, industrial vegetation management (IVM) and rights of way (ROW).

The compositions and methods described herein may be used to control undesirable vegetation in glyphosate-tolerant-, 5-enolpyruvylshikimate-3-phosphate (EPSP) synthase inhibitor-tolerant-, glufosinate-tolerant-, glutamine synthetase inhibitor-tolerant-, dicamba-tolerant-, phenoxy auxin-tolerant-, pyridyloxy auxin-tolerant-, auxin-tolerant-, auxin transport inhibitor-tolerant-, aryloxyphenoxypropionate-tolerant-, cyclohexanedione-tolerant-, phenylpyrazoline-tolerant-, acetyl CoA carboxylase (ACCase) inhibitor-tolerant-, imidazolinone-tolerant-, sulfonylurea-tolerant-, pyrimidinylthiobenzoate-tolerant-, triazolopyrimidine-tolerant-, sulfonylaminocarbonyltriazolinone-tolerant-, acetolactate synthase (ALS) or acetohydroxy acid synthase (AHAS) inhibitor-tolerant-, 4-hydroxyphenyl-pyruvate dioxygenase (HPPD) inhibitor-tolerant-, phytoene desaturase inhibitor-tolerant-, carotenoid biosynthesis inhibitor-tolerant-, protoporphyrinogen oxidase (PPO) inhibitor-tolerant-, cellulose biosynthesis inhibitor-tolerant-, mitosis inhibitor-tolerant-, microtubule inhibitor-tolerant-, very long chain fatty acid inhibitor-tolerant-, fatty acid and lipid biosynthesis inhibitor-tolerant-, photosystem I inhibitor-tolerant-, photosystem II inhibitor-tolerant-, triazine-tolerant- and bromoxynil-tolerant-crops (such as, but not limited to, soybean, cotton, canola/oilseed rape, rice, cereals, corn, Sorghum, sunflower, sugar beet, sugarcane, turf, etc.), for example, in conjunction with glyphosate, EPSP synthase inhibitors, glufosinate, glutamine synthase inhibitors, dicamba, phenoxy auxins, pyridyloxy auxins, synthetic auxins, auxin transport inhibitors, aryloxyphenoxypropionates, cyclohexanediones, phenylpyrazolines, ACCase inhibitors, imidazolinones, sulfonylureas, pyrimidinylthiobenzoates, triazolopyrimidines, sulfonylaminocarbonyltriazolinones, ALS or AHAS inhibitors, HPPD inhibitors, phytoene desaturase inhibitors, carotenoid biosynthesis inhibitors, PPO inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil. The compositions and methods may be used in controlling undesirable vegetation in crops possessing multiple or stacked traits conferring tolerance to multiple chemistries and/or inhibitors of multiple modes of action. In some aspects, the compound of formula (I) or formulation thereof and complementary herbicide formulation thereof are used in combination with herbicides that are selective for the crop being treated and which complement the spectrum of weeds controlled by these compounds at the application rate employed. In some aspects, the compositions described herein, and other complementary herbicides are applied at the same time, either as a combination formulation, as a tank mix or sequentially.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi, and pathogens) and crop improvement traits (including but not limited to yield; protein, carbohydrate, or oil content; protein, carbohydrate, or oil composition; plant stature and plant architecture).

The compositions and methods provided herein are utilized to control undesirable vegetation. Undesirable vegetation includes, but is not limited to, undesirable vegetation that occurs in rice, cereals, wheat, barley, oats, rye, pastures, grasslands, rangelands, fallow-land, row crops (e.g., corn/maize, sugarcane, sunflower, oilseed rape, canola, sugarbeet, soybean, cotton), turf, trees and vine orchards, plantation crops, vegetables, ornamental species, aquatic or non-crop settings (e.g., rights-of-way, industrial vegetation management).

In some aspects, the methods provided herein are utilized to control undesirable vegetation in rice. In certain aspects, the undesirable vegetation is Brachiaria platyphylla (Groseb.) Nash or Urochloa platyphylla (Nash) R. D. Webster (broadleaf signalgrass, BRAPP), Digitaria sanguinalis (L.) Scop. (large crabgrass, DIGSA), Echinochloa species (ECHSS), Echinochloa crus-galli (L.) P. Beauv. (barnyardgrass, ECHCG), Echinochloa crus-pavonis (Kunth) Schult. (gulf cockspur, ECHCV), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Echinochloa phyllopogon (Stapf) Koso-Pol. (rice barnyardgrass, ECHPH), Echinochloa polystachya (Kunth) Hitchc. (creeping river grass, ECHPO), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Oryza species (red and weedy rice, ORYSS), Panicum dichotomiflorum (L.) Michx. (fall Panicum, PANDI), Paspalum dilatatum Poir. (dallisgrass, PASDI), Rottboellia cochinchinensis (Lour.) W. D. Clayton (itchgrass, ROOEX), Cyperus species (CYPSS), Cyperus difformis L. (smallflower flatsedge, CYPDI), Cyperus dubius Rottb. (MAPDU), Cyperus esculentus L. (yellow nutsedge, CYPES), Cyperus iria L. (rice flatsedge, CYPIR), Cyperus rotundus L. (purple nutsedge, CYPRO), Cyperus serotinus Rottb./C. B. Clarke (tidalmarsh flatsedge, CYPSE), Eleocharis species (ELOSS), Fimbristylis miliacea (L.) Vahl (globe fringerush, FIMMI), Schoenoplectus species (SCPSS), Schoenoplectus juncoides Roxb. (Japanese bulrush, SCPJU), Bolboschoenus maritimus (L.) Palla or Schoenoplectus maritimus L. Lye (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Commelina benghalensis L. (Benghal dayflower, COMBE), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea species (morningglories, IPOSS), Ipomoea hederacea (L.) Jacq. (ivy leaf morningglory, IPOHE), Lindernia dubia (L.) Pennell (low false pimpernel, LIDDU), Ludwigia species (LUDSS), Ludwigia linifolia Poir. (southeastern primrose-willow, LUDLI), Ludwigia octovalvis (Jacq.) Raven (longfruited primrose-willow, LUDOC), Monochoria korsakowii Regel & Maack (Monochoria, MOOKA), Monochoria vaginalis (Burm. F.) C. Presl ex Kuhth, (Monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (POLHP, mild smartweed), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some aspects, the methods provided herein are utilized to control undesirable vegetation in cereals. In certain aspects, the undesirable vegetation is Alopecurus myosuroides Huds. (blackgrass, ALOMY), Apera spica-venti (L.) Beauv. (windgrass, APESV), Avena fatua L. (wild oat, AVEFA), Bromus tectorum L. (downy brome, BROTE), Lolium multiflorum Lam. (Italian ryegrass, LOLMU), Phalaris minor Retz. (littleseed canarygrass, PHAMI), Poa annua L. (annual bluegrass, POANN), Setaria pumila (Poir.) Roemer & J. A. Schultes (yellow foxtail, SETLU), Setaria viridis (L.) Beauv. (green foxtail, SETVI), Amaranthus retroflexus L. (redroot pigweed, AMARE), Brassica species (BRSSS), Chenopodium album L. (common lambsquarters, CHEAL), Cirsium arvense (L.) Scop. (Canada thistle, CIRAR), Galium aparine L. (catchweed bedstraw, GALAP), Kochia scoparia (L.) Schrad. (Kochia, KCHSC), Lamium purpureum L. (purple deadnettle, LAMPU), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Sinapis species (SINSS), Sinapis arvensis L. (wild mustard, SINAR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some aspects, the methods provided herein are utilized to control undesirable vegetation in range and pasture, fallowland, IVM, and ROW. In certain aspects, the undesirable vegetation is Ambrosia artemisiifolia L. (common ragweed, AMBEL), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Daucus carota L. (wild carrot, DAUCA), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly Sida, SIDSP), Sinapis arvensis L. (wild mustard, SINAR), Sonchus arvensis L. (perennial sowthistle, SONAR), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some aspects, the methods provided herein are utilized to control undesirable vegetation found in row crops, tree and vine crops, and perennial crops. In certain aspects, the undesirable vegetation is Alopecurus myosuroides Huds. (blackgrass, ALOMY), Avena fatua L. (wild oat, AVEFA), Brachiaria decumbens Stapf. or Urochloa decumbens (Stapf) R. D. Webster (Surinam grass, BRADC), Brachiaria brizantha (Hochst. ex A. Rich.) Stapf or Urochloa brizantha (Hochst. ex A. Rich.) R. D. (beard grass, BRABR), Brachiaria platyphylla (Groseb.) Nash or Urochloa platyphylla (Nash) R. D. Webster (broadleaf signalgrass, BRAPP), Brachiaria plantaginea (Link) Hitchc. or Urochloa plantaginea (Link) R. D. Webster (alexandergrass, BRAPL), Cenchrus echinatus L. (southern sandbur, CENEC), Digitaria horizontalis Willd. (Jamaican crabgrass, DIGHO), Digitaria insularis (L.) Mez ex Ekman (sourgrass, TRCIN), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Eleusine indica (L.) Gaertn. (goosegrass, ELEIN), Lolium multiflorum Lam. (Italian ryegrass, LOLMU), Panicum dichotomiflorum Michx. (fall Panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Anoda cristata (L.) Schlecht. (spurred Anoda, ANVCR), Asclepias syriaca L. (common milkweed, ASCSY), Bidens pilosa L. (hairy beggarticks, BIDPI), Borreria species (BOISS), Borreria alata (Aubl.) DC. or Spermacoce alata Aubl. (broadleaf buttonweed, BOILF), Spermacose latifolia (broadleaved button weed, BOILF), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Euphorbia hirta L. or Chamaesyce hirta (L.) Millsp. (garden spurge, EPHHI), Euphorbia dentata Michx. (toothed spurge, EPHDE), Erigeron bonariensis L. or Conyza bonariensis (L.) Cronq. (hairy fleabane, ERIBO), Erigeron canadensis L. (Canadian fleabane, ERICA), Conyza sumatrensis (Retz.) E. H. Walker (tall fleabane, ERIFL), Helianthus annuus L. (common sunflower, HELAN), Jacquemontia tamnfolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Richardia species (pusley, RCHSS), Sida species (Sida, SIDSS), Sida spinosa L. (prickly Sida, SIDSP), Sinapis arvensis L. (wild mustard, SINAR), Solanum ptychanthum Dunal (eastern black nightshade, SOLPT), Tridax procumbens L. (coat buttons, TRQPR) or Xanthium strumarium L. (common cocklebur, XANST).

In some aspects, the methods provided herein are utilized to control undesirable vegetation in turf. In certain aspects, the undesirable vegetation is Bellis perennis L. (English daisy, BELPE), Cyperus esculentus L. (yellow nutsedge, CYPES), Cyperus species (CYPSS), Digitaria sanguinalis (L.) Scop. (large crabgrass, DIGSA), Diodia virginiana L. (Virginia buttonweed, DIQVI), Euphorbia species (spurge, EPHSS), Glechoma hederacea L. (ground ivy, GLEHE), Hydrocotyle umbellata L. (dollarweed, HYDUM), Kyllinga species (Kyllinga, KYLSS), Lamium amplexicaule L. (henbit, LAMAM), Murdannia nudiflora (L.) Brenan (doveweed, MUDNU), Oxalis species (woodsorrel, OXASS), Plantago major L. (broadleaf plantain, PLAMA), Plantago lanceolata L. (buckhorn/narrowleaf plantain, PLALA), Phyllanthus urinaria L. (chamberbitter, PYLTE), Rumex obtusifolius L. (broadleaf dock, RUMOB), Stachys floridana Shuttlew. (Florida betony, STAFL), Stellaria media (L.) Vill. (common chickweed, STEME), Taraxacum officinale G. H. Weber ex Wiggers (dandelion, TAROF), Trifolium repens L. (white clover, TRFRE), or Viola species (wild violet, VIOSS).

In some aspects, the compositions and methods provided herein are utilized to control undesirable vegetation, including grass, broadleaf and sedge weeds. In certain aspects, the compositions and methods provided herein are utilized to control undesirable vegetation including but not limited to Alopecurus, Avena, Centaurea, Cyperus, Digitaria, Echinochloa, Ipomoea, Leptochloa and Sonchus.

In some aspects, the combination of a compound of Formula (I) or formulation hereof may be used to control Abutilon theophrasti Medik. (velvetleaf, ABUTH), Amaranthus rudis Sauer, (common waterhemp, AMATA), Chenopodium album L. (common lambsquarters, CHEAL), Polygonum convolvulus L. (wild buckwheat, POLCO) and Sinapis arvensis L. (wild mustard, SINAR).

The compounds of Formula (I) or agriculturally acceptable formulation of the same may be used to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors, (e.g., imidazolinones, sulfonylureas, pyrimidinylthiobenzoates, triazolopyrimidines, and sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors, (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes-of-action, and biotypes with multiple resistance or tolerance mechanisms (e.g., target site resistance or metabolic resistance).

With respect to the methods for treating crop fields to reduce or eliminate the growth of unwanted plants, these methods may comprise contacting the undesirable vegetation or locus thereof or applying to the soil or water to prevent the emergence or growth of vegetation or a composition described herein. In some aspects, the composition is applied at an application rate of from about 1 gram of acid equivalent per hectare (gae/ha) to about 400 grams active ingredient per hectare (gai/ha) based on the total amount of active ingredients in the composition. In certain aspects, the composition is applied at an application rate of from about 4 grams acid equivalent per hectare (gae/ha) to about 400 gae/ha based on the total amount of active ingredients in the composition.

With respect to the methods, in certain aspects, the methods comprise contacting the undesirable vegetation or locus thereof or applying to the soil or water to prevent the emergence or growth of vegetation or a composition described herein. In some aspects, the composition is applied at an application rate sufficient to control, inhibit, or promote the growth of at least one plant. In some aspects the compound is applied, based on the total amount of active ingredients in the composition, in at least one of the following ranges: of from: cabout 1 gram to about 1,000 grams of acid equivalent per hectare (gae/ha); in some aspects the composition is applied at an application rate of between about 1 gram to about 500 grams gae/ha; in some aspects composition is applied at an application rate of between about 1 gram to about 250 grams gae/ha; composition is applied at an application rate of between about 1 gram to about 140 grams gae/h; in some aspects the composition is applied at an application rate of between about 1 gram to about 70 grams gae/ha. In some aspects, the methods comprise contacting the undesirable vegetation or locus thereof or applying to the soil or water to prevent the emergence or growth of vegetation.

In some aspects, the concentration of the active ingredients in the compositions described herein is from about 0.0005 to 98 percent by weight. In some aspects, the concentration is from about 0.0006 to 90 percent by weight. In compositions designed to be employed as concentrates, the active ingredients, in certain aspects, are present in a concentration from about 0.1 to 98 weight percent, and in certain aspects about 0.5 to 90 weight percent. Such compositions are, in certain aspects, diluted with an inert carrier, such as water, before application. The diluted compositions usually applied to weeds or the locus of weeds contain, in certain aspects, about 0.0006 to 3.0 weight percent active ingredient and in certain aspects contain about 0.01 to 1.0 weight percent.

The present compositions can be applied to weeds or their locus by almost any conventional means of application, including but not limited to the use of aerial dusters, sprayers, and granule applicators. Under some circumstances these compounds and formulations thereof may be added to irrigation or paddy water, which is then used to treat plants, soil, and other surfaces.

The described aspects and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

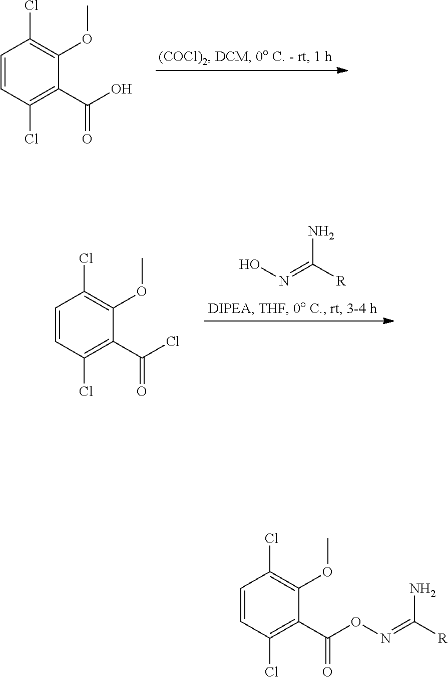

### Example 1

### Synthesis of 3,6-dichloro-2-methoxybenzoyl chloride

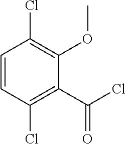

To a clean dry RB flask was charged with 3,6-dichloro-2-methoxy benzoic acid (0.6 g, 2.71 mmol) in DCM (6 mL), added oxalyl chloride (1.72 g, 13.57 mmol) at 0° C. followed by few drops of DMF and stirred at rt for 1 h. Upon completion of reaction by TLC (aliquot quenched with methanol), concentrated the reaction mixture to remove volatiles to afford the title compound (acid chloride 0.65 g, crude). Without further purification crude compound taken for next step reaction.

### Example-2

### Synthesis of (Z)—N′-((3,6-dichloro-2-methoxybenzoyl) oxy) acetimidamide

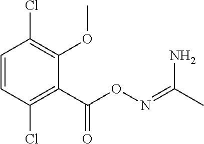 [SMILES: COc1c(Cl)ccc(Cl)c1C(=O)O/N=C(/C)N]

To a solution of (Z)—N′-hydroxyacetimidamide (61.8 mg, 0.835 mmol) in THE (3 mL), cooled to 0° C., added DIPEA (161 mg, 1.25 mmol) followed by 3,6-dichloro-2-methoxybenzoyl chloride (200 mg, 0.835 mmol) in DCM and stirred at rt for 1 h. Upon completion of reaction by TLC, quenched the reaction mixture with ice cold water and extracted with EtOAc (25 mL×3 times). To the combined organic layer were washed with brine, dried over anhydrous sodium sulfate and concentrated under reduced pressure. The crude compound was purified by using MPLC with 30% EtOAc:hexane as an eluent to give the title compound as off-white solid (144 mg, 62%). Mp 108-111° C. ¹H NMR (300 MHz, CDCl₃) δ 7.38 (d, J=8.6 Hz, 1H), 7.13 (d, J=8.7 Hz, 1H), 4.87 (s, 2H), 3.93 (s, 3H), 2.04 (m, 3H). ESIMS m/z 277 [(M+H)³⁰].

### Intermediate Preparation.

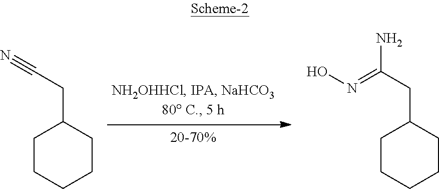 [SMILES: N#CCC1CCCCC1 ; N/C(CC1CCCCC1)=N\O]

### Example 3

### Synthesis of (Z)-2-cyclohexyl-N′-hydroxyacetimidamide

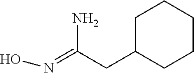 [SMILES: N/C(CC1CCCCC1)=N\O]

To a solution of hydroxylamine hydrochloride (0.846 g, 8.1 mmol) in 2 mL of isopropyl alcohol, sodium bicarbonate (1.499 g, 17.8 mmol) was added. The resulting mixture was stirred at rt for 10-15 min. 2-Cyclohexylacetonitrile (1.0 g, 8.1 mmol) was added and stirred at 85° C. for 4 h. After completion of the reaction, the reaction mixture was cooled to RT, filtered and washed with 2 mL of isopropyl alcohol. The filtrate was collected and distilled out completely to obtain a crude residue (0.6 g, 47%). ESIMS m/z 157 [(M+H)⁺]. Without further purification the crude compound was taken for next step. See Table 1 for additional compounds sysnthesised using methods outline in Example 3.

### Scheme-4:

### Synthesis of Starting Inputs:

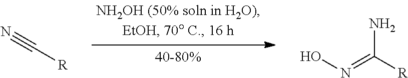

### Example 4

### Synthesis of N′-hydroxyquinoline-6-carboximidamide

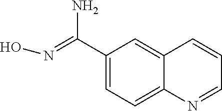 [SMILES: N/C(=N\O)c1ccc2ncccc2c1]

To a solution of quinoline-6-carbonitrile (0.3 g, 1.94 mmol) in ethanol (5 mL), was added hydroxylamine (50% solution in H₂O) (0.6 mL, 9.74 mmol). The resulting mixture was heated at 70° C. for 16 h. The reaction mixture was cooled and then concentrated under vacuum. The crude residue was co-distilled with 5 mL of toluene to yield the title compound as colorless liquid (0.25 g, 680%). ESIMS m/z 188 [(M+H)⁺]. Without further purification crude compound was taken for next step.

TABLE 1
Compounds synthesized using the methods of Examples 3 and 4.

| Compound | | |
|---|---|---|
| Id. | Compound structure | Analytical data |
| I-1 | 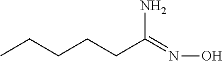 | Yield = 49%, ¹H NMR (300 MHz, Chloroform-d) δ 5.68 (s, 1H), 4.71 (s, 2H), 2.27-2.09 (m, 2H), 1.61-1.51 (m, 2H), 1.40-1.16 (m, 4H), 0.95-0.81 (m, 3H). LCMS (M + 1): 131.4. |
| I-2 | 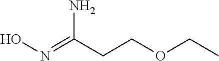 | Yield = 71%, ¹H NMR (300 MHz, Chloroform-d) δ 5.00 (s, 2H), 3.61 (t, J = 5.7, Hz, 2H), 3.50 (q, J = 7.5, 7.1, Hz, 2H), 2.38 (t, J = 5.6, 5.6 Hz, 2H), 1.20 (t, J = 7.1, Hz, 3H). |
| I-3 | 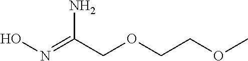 | Yield = 40%, ¹H NMR (300 MHz, Chloroform-d) δ 4.91 (s, 2H), 4.03 (s, 2H), 3.62-3.57 (m, 2H), 3.54 (dd, J = 6.2, 2.5 Hz, 2H), 3.38 (s, 3H). |
| I-4 | 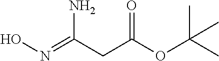 | Yield = 61%, ¹H NMR (300 MHz, DMSO-d6) δ 8.98 (d, J = 0.8 Hz, 1H), 5.41 (s, 2H), 2.90 (s, 2H), 1.40 (s, 9H). |
| I-5 | 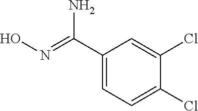 [SMILES: N/C(=N\O)c1ccc(Cl)c(Cl)c1] | Yield = 50%, ¹H NMR (300 MHz, DMSO-d6) δ 9.89 (s, 1H), 7.89 (s, 1H), 7.65 (d, J = 3.3 Hz, 2H), 5.97 (s, 2H). LCMS (M + 2): 207.0. |
| I-6 | 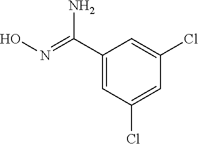 [SMILES: N/C(=N\O)c1cc(Cl)cc(Cl)c1] | Yield = 84%, ¹H NMR (300 MHz, DMSO-d6) δ 7.67 (s, 2H), 7.48 (d, J = 2.4 Hz, 1H), 5.76 (s, 2H). LCMS (M + 1): 205.0 |
| I-7 | 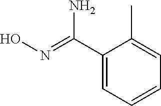 | Yield = 63%, ¹H NMR (300 MHz, Chloroform-d) δ 7.40-7.35 (m, 1H), 7.33-7.27 (m, 1H), 7.19 (d, J = 7.9 Hz, 1H), 4.78 (s, 2H), 2.45-2.43 (m, 3H). LCMS (M + 1): 151.3. |
| I-8 | 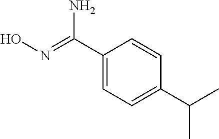 | Yield = 82%, ¹H NMR (300 MHz, DMSO-d6) δ 9.53 (s, 1H), 7.81-7.72 (m, 1H), 7.57 (d, J = 8.2 Hz, 1H), 7.46 (d, J = 8.3 Hz, 1H), 7.23 (d, J = 8.3 Hz, 1H), 5.74 (s, 2H), 3.1-2.9 (m, 1H), 1.20 (dd, J = 7.1, 2.7 Hz, 6H). LCMS (M + 1): 179.2. |
| I-9 | 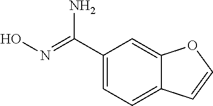 [SMILES: N/C(=N\O)c1ccc2ccoc2c1] | LCMS (M + 1) = 177.2. |
| I-10 | 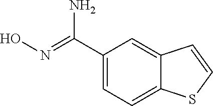 [SMILES: N/C(=N\O)c1ccc2sccc2c1] | LCMS (M + 1) = No ionization. |
| I-11 | 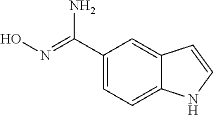 [SMILES: N/C(=N\O)c1ccc2[nH]ccc2c1] | ¹H NMR (300 MHz, DMSO-d6) § 11.16 (s, 1H), 9.38 (s, 1H), 7.84 (s, 1H), 7.43 (td, J = 8.0, 7.5, 2.1 Hz, 1H), 7.38-7.29 (m, 2H), 6.44 (t, J = 2.5, 2.5 Hz, 1H), 5.72 (s, 2H). LCMS (M + 1) = No ionization. |
| I-12 | 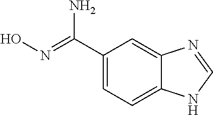 [SMILES: N/C(=N\O)c1ccc2[nH]cnc2c1] | ¹H NMR (300 MHz, DMSO-d6) δ 12.48 (s, 1H), 9.52 (s, 1H), 8.23 (s, 1H), 7.88 (s, 1H), 7.55 (s, 2H), 5.81 (s, 2H). LCMS (M + 1) = 177.1. |
| I-13 | 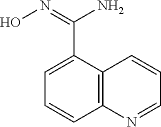 [SMILES: N/C(=N/O)c1cccc2ncccc12] | ¹H NMR (300 MHz, DMSO-d6) δ 8.94 (d, J = 3.7 Hz, 1H), 8.78-8.70 (m, 1H), 8.12-7.98 (m, 2H), 7.83-7.73 (m, 2H), 7.69 (q, J = 7.0, 5.8 Hz, 1H), 7.57 (td, J = 8.7, 8.4, 4.3 Hz, 1H). LCMS (M + 1) = 188.1 |
| I-14 | 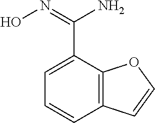 [SMILES: N/C(=N/O)c1cccc2ccoc12] | LCMS (M + 1) = 177.3. |
| I-15 | 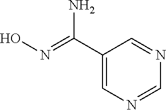 | ¹H NMR (400 MHz, DMSO-d6) δ 10.07 (s, 1H), 9.18 (s, 1H), 9.02 (s, 2H), 6.17 (s, 2H). LCMS (M + 1) = 139.1. |
| I-16 | 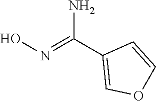 | ¹H NMR (400 MHz, DMSO-d6) δ 9.39 (s, 1H), 7.99 (s, 1H), 7.63 (d, J = 1.9 Hz, 1H), 6.61 (d, J = 1.7 Hz, 1H), 5.68 (s, 2H). LCMS (M + 1) = 127.3. |
| I-17 | 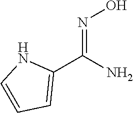 | ¹H NMR (400 MHz, DMSO-d6) § 10.83 (s, 1H), 9.13 (s, 1H), 6.68 (d, J = 1.6 Hz, 1H), 6.42 (d, J = 3.2 Hz, 1H), 6.00 (q, J = 2.8, 2.8 Hz, 1H), 5.54 (s, 2H). LCMS (M + 1) = 126.1. |
| I-18 | 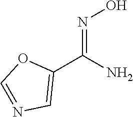 | ¹H NMR (400 MHz, DMSO-d6) δ 9.87 (s, 1H), 8.39 (s, 1H), 7.47 (s, 1H), 5.91 (s, 2H). LCMS (M + 1) = 128.0. |

### Example 5a

### Synthesis of compound 2-ethyl hexyl 3,6-dichloro-2-methoxybenzoate

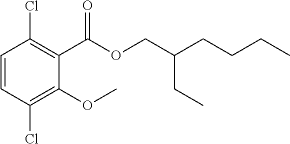 [SMILES: CCCCC(CC)COC(=O)c1c(Cl)ccc(Cl)c1OC]

To a solution of 6-dichloro-2-methoxy benzoic acid (0.5 g, 2.26 mmol) in N,N-dimethyl form amide (5 mL) was added potassium carbonate (0.62 g, 4.52 mmol) and stirred for 5 min. at RT. 3-(Bromomethyl) heptane (0.087 g, 4.52 mmol) was added to the above reaction mixture through syringe and stirred for 16 h at RT. Reaction mixture was poured into ice water, extracted with ethyl acetate. Combined organic layers were washed with water, brine solution, dried over sodium sulfate and concentrated. Obtained crude compound was purified by using MPLC with 5% ethyl acetate:hexane to afford the title compound as colorless liquid (0.24 g, 32%). ¹H NMR (400 MHz, CDCl₃) δ 7.34 (d, J=8.7 Hz, 1H), 7.11 (d, J=8.8 Hz, 1H), 4.36-4.21 (m, 2H), 3.90 (s, 3H), 1.72-1.66 (m, 1H), 1.47-1.36 (m, 4H), 1.34-1.31 (m, 4H), 0.96-0.85 (m, 6H). 13C NMR (75 MHz, CDCl₃) δ 164.84, 131.56, 130.82, 129.50, 126.64, 125.76, 109.97, 68.35, 62.18, 38.72, 30.15, 28.81, 23.53, 22.95, 14.04, 10.87. ESIMS m/z 332 [(M+H)⁺].

Using the strategy outline in Scheme 1 and 3,6-dichloro-2-methoxybenzoyl chloride (2): which may be synthesized in accordance with the method of example 1 and following R groups additional compounds are synthesized. SEE TABLE 1.

### Example 5b

### Synthesis of (Z)—N′-((3,6-dichloro-2-methoxybenzoyl) oxy)-2-naphthimidamide

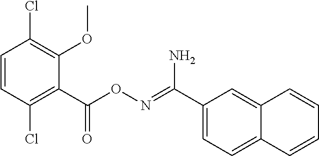 [SMILES: COc1c(Cl)ccc(Cl)c1C(=O)O/N=C(\N)c1ccc2ccccc2c1]

To a solution of N′-hydroxy-2-naphthimidamide (0.156 g, 0.84 mmol) in THE (3 mL) was cooled to 0° C., added DIPEA (0.28 mL, 1.68 mmol) followed by a solution of 3,6-dichloro-2-methoxybenzoyl chloride (0.2 g, 0.84 mmol) in DCM and stirred at rt for 1 h. Upon completion of reaction by TLC, quenched the reaction mixture with ice cold water and extracted with EtOAc (25 mL×3 times). The combined organic layers were washed with brine, dried over anhydrous sodium sulfate and concentrated under reduced pressure. The crude compound was purified by using MPLC with 30% EtOAc:hexane as an eluent to afford the title compound as an off-white solid (0.158 g, 48%). Mp 170-172° C. ¹H NMR (400 MHz, DMSO-d6) δ 8.35 (s, 1H), 7.99 (q, J=5.9, 5.9, 4.1 Hz, 3H), 7.80 (d, J=8.7 Hz, 1H), 7.68 (d, J=8.7 Hz, 1H), 7.61 (q, J=5.4, 5.4, 3.9 Hz, 2H), 7.43 (d, J=8.7 Hz, 1H), 7.09 (s, 2H), 3.90 (s, 3H). ESIMS m/z 389 [(M+H)⁺].

### Scheme-4:

### Synthesis of Starting Inputs:

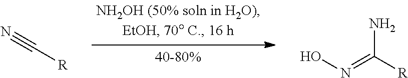

### Example 6

### Synthesis of N′-hydroxyquinoline-6-carboximidamide

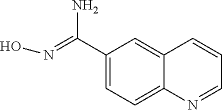 [SMILES: N/C(=N\O)c1ccc2ncccc2c1]

To a solution of quinoline-6-carbonitrile (0.3 g, 1.94 mmol) in ethanol (5 mL), was added hydroxylamine (50% solution in H₂O) (0.6 mL, 9.74 mmol). The resulting mixture was heated at 70° C. for 16 h. The reaction mixture was cooled and then concentrated under vacuum. The crude residue was co-distilled with 5 mL of toluene to yield the title compound as colorless liquid (0.25 g, 68%). ESIMS m/z 188 [(M+H)⁺]. Without further purification crude compound was taken for next step.

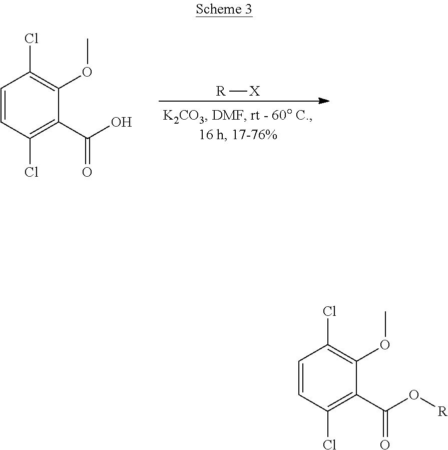

where R—X is one of the following compounds:

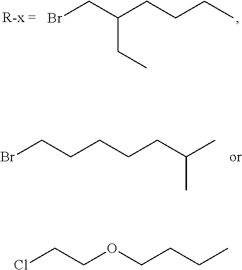

### Example 7

### Synthesis of N′-hydroxy-1H-benzo[d]imidazole-4-carboximidamide

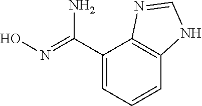 [SMILES: N/C(=N\O)c1cccc2[nH]cnc12]

To a solution of hydroxylamine hydrochloride (0.16 g, 2.28 mmol) in THF:H₂O (5 mL; 0.5 mL) was added TEA (0.6 mL, 2.31 mmol). The resulting mixture was stirred at RT for 10 min. 1H-benzo[d]imidazole-4-carbonitrile (0.3 g, 2.09 mmol) was added to the reaction mixture and heated at 70° C. for 16 h. The reaction mixture was diluted with ethyl acetate, washed with water and brine solution, dried over anhydrous sodium sulfate and concentrated under reduced pressure. Obtained crude compound was triturated with diethyl ether to afford the title compound as an off-white solid (0.17 g, 46%). ¹H NMR (300 MHz, DMSO-d6) δ 12.74 (s, 1H), 9.63 (s, 1H), 8.25 (s, 1H), 7.64 (d, J=9.2 Hz, 2H), 7.20 (t, J=7.8 Hz, 1H), 6.89 (s, 1H), 6.18 (s, 1H). ESIMS m/z 177 [(M+H)⁺].

### Example 8

### Synthesis of N′-hydroxy-1H-pyrazole-5-carboximidamide)

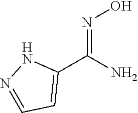

To a solution of hydroxylamine hydrochloride (0.22 g, 3.22 mmol) in MeOH (5 mL), were added TEA (0.45 mL, 3.22 mmol). The resulting mixture was stirred at RT for 10 min. 1H-pyrazole-5-carbonitrile (0.3 g, 3.22 mmol) was added to the reaction mixture and heated at 70° C. for 16 h. The reaction mixture was diluted with ethyl acetate, washed with water and brine solution, dried over anhydrous sodium sulfate and concentrated under reduced pressure. Obtained crude was triturated with diethyl ether to afford the title compound as gummy solid (0.3 g, 73%). ¹H NMR (400 MHz, DMSO-d6) δ 12.93 (s, 1H), 10.03 (s, 1H), 7.71 (s, 1H), 6.38 (s, 1H), 5.49 (s, 2H). ESIMS m/z 127 [(M+H)⁺].

### Example 9

### Synthesis of N′-hydroxy-1H-imidazole-5-carboximidamide

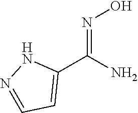

To a solution of hydroxylamine hydrochloride (0.42 g, 6.45 mmol) in H₂O (3 mL), were added Na₂CO₃ (0.34 mL, 3.22 mmol). The resulting mixture was stirred at RT for 10 min. 1H-imidazole-5-carbonitrile (0.3 g, 3.22 mmol) was added to the reaction mixture and heated at 70° C. for 16 h. The reaction mixture was cooled, obtained solid was filtered and dried under vacuum to afford the title compound as an off-white solid (0.24 g, 60%). ¹H NMR (400 MHz, DMSO-d6) δ 12.20 (s, 1H), 9.15 (s, 1H), 7.62 (s, 1H), 7.28 (s, 1H), 5.50 (s, 2H). ESIMS m/z 127 [(M+H)⁺].

### Example 10

### Synthesis of benzyl 3,6-dichloro-2-methodzxybenzoate)

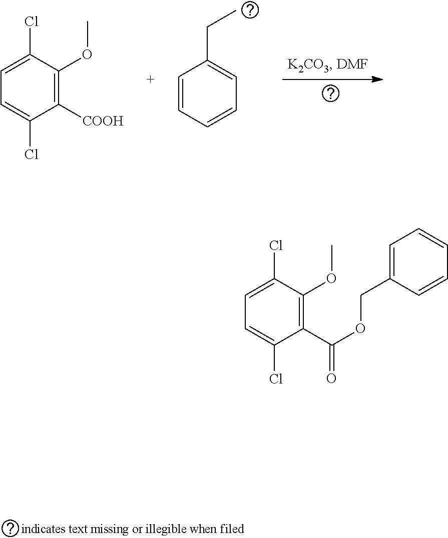

A 50 mL flask equipped with a magnetic stir-bar and a nitrogen balloon was charged with 3,6-dichloro-2-methoxybenzoic acid (500 mg, 2.26 mmol), K₂CO₃ (468 mg, 3.39 mmol) and DMF (10 mL). The mixture was stirred for 5 minutes and then (bromomethyl)benzene (0.32 mL, 2.71 mmol) was added slowly. After the addition was complete, the reaction was stirred for 18 hours. HPLC and LC-MS analysis on a sample of the reaction mixture showed complete conversion. Water (20 mL) was slowly added.

After stirring for 5 minutes, EtOAc (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column chromatography using Ethyl Acetate:Hexane to afford the title compound as a colorless liquid. (182 mg, 26%). ¹H NMR (CDCl₃) δ: 7.46 (d, J=6.5 Hz, 2H), 7.43-7.31 (m, 4H), 7.11 (d, J=8.7 Hz, 1H), 5.41 (s, 2H), 3.82 (s, 3H). ESIMS m/z 312 [(M+H)⁺].

### Example 11

### Synthesis of pyridin-3-ylmethyl 3,6-dichloro-2-methoxybenzoate

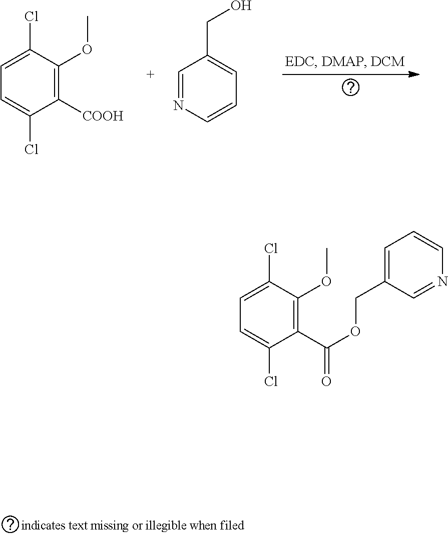 [SMILES: COc1c(Cl)ccc(Cl)c1C(=O)O ; OCc1cccnc1 ; COc1c(Cl)ccc(Cl)c1C(=O)OCc1cccnc1]

A 50-mL flask equipped with a magnetic stir-bar and a nitrogen balloon was charged with 3,6-dichloro-2-methoxybenzoic acid (500 mg, 2.26 mmol), pyridin-3-ylmethanol (0.24 mL, 2.49 mmol), EDC (651 mg, 3.39 mmol), DMAP (55 mg, 0.45 mmol), and DCM (10 mL). The reaction was stirred at ambient temperature for 18 hours. HPLC and LC-MS analysis on a sample of the reaction mixture showed complete conversion. Water (20 mL) was slowly added. After stirring for 5 minutes, DCM (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane solvent system to afford the title compound as a brown liquid. (148 mg, 21%). ¹H NMR (CDCl₃) δ: 8.72 (s, 1H), 8.61 (d, J=3.3 Hz, 1H), 7.81 (d, J=7.6 Hz, 1H), 7.37-7.30 (m, 2H), 7.11 (d, J=8.7 Hz, 1H), 5.43 (s, 2H), 3.82 (s, 3H). ESIMS m/z 312 [(M+H)⁺].

### Example 12

### Synthesis of (E)-acetophenone O-(3,6-dichloro-2-methoxybenzoyl) oxime

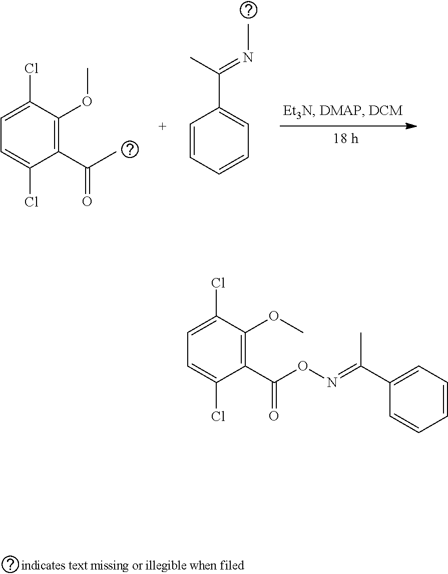

A 50-mL flask equipped with a magnetic stir-bar and a nitrogen balloon was charged with 3,6-dichloro-2-methoxybenzoyl chloride (500 mg, 2.09 mmol), (E)-acetophenone oxime (339 mg, 2.51 mmol), Et₃N (0.44 mL, 3.13 mmol), DMAP (12 mg, 0.1 mmol), and DCM (5 mL). The reaction was stirred at ambient temperature for 18 hours. HPLC and LC-MS analysis on a sample of the reaction mixture showed complete conversion. Water (20 mL) was slowly added. After stirring for 5 minutes, DCM (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane solvent system to afford the title compound as a white solid. (482 mg, 68%). ¹H NMR (CDCl₃) δ: 7.80-7.73 (m, 2H), 7.50-7.38 (m, 4H), 7.17 (d, J=8.7 Hz, 1H), 3.97 (s, 3H), 2.43 (s, 3H). ¹³C NMR (CDCl₃):14.8, 62.5, 125.8, 126.8, 127.2, 128.6, 129.3, 130.1, 130.9, 132.2, 134.4, 154.3, 162.4, 164.5. ESIMS m/z 362 [(M+Na)⁺].

### Example 13

### Synthesis of (E)-1-(pyridin-3-yl)ethanone O-(3,6-dichloro-2-methoxybenzoyl) oxime

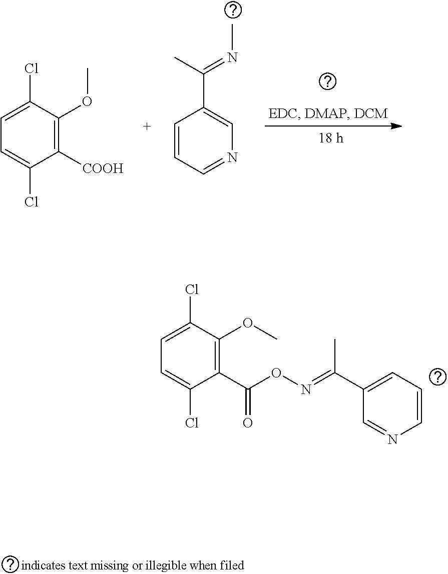

A 50-mL flask equipped with a magnetic stir-bar and a nitrogen balloon was charged with 3,6-dichloro-2-methoxybenzoic acid (500 mg, 2.26 mmol), pyridin-3-ylmethanol (370 mg, 2.72 mmol), EDC (651 mg, 3.39 mmol), DMAP (55 mg, 0.45 mmol), and DCM (10 mL). The reaction was stirred at ambient temperature for 18 hours. HPLC and LC-MS analysis on a sample of the reaction mixture showed complete conversion. Water (20 mL) was slowly added. After stirring for 5 minutes, DCM (50 mL) was added and the layers were separated.

The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as an off-white solid. (215 mg, 28%). ¹H NMR (CDCl₃) δ: 8.94 (d, J=1.7 Hz, 1H), 8.69 (dd, J=4.8, 1.6 Hz, 1H), 8.12 (dt, J=8.0, 1.9 Hz, 1H), 7.42 (d, J=8.7 Hz, 1H), 7.36 (dd, J=8.0, 4.8 Hz, 1H), 7.17 (d, J=8.7 Hz, 1H), 3.96 (s, 3H), 2.45 (s, 3H). ¹³C NMR (CDCl₃): 14.5, 62.5, 123.4, 125.9, 126.8, 129.0, 130.0, 130.4, 132.4, 134.5, 148.3, 151.8, 154.3, 162.2. ESIMS m/z 340 [(M+H)+].

### Example 14

### Synthesis of 3,6-dichloro-2-methoxybenzoyl chloride

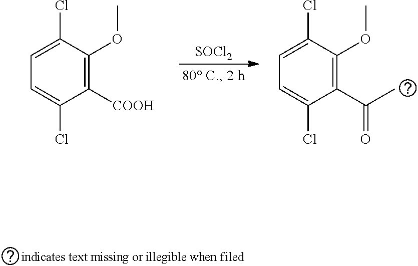

A 50-mL flask equipped with a magnetic stir-bar, reflux condenser and a nitrogen balloon was charged with 3,6-dichloro-2-methoxybenzoic acid (11.3 g, 51.13 mmol) and SOCl₂ (15 mL) was then added slowly. The reaction was heated at 80-82° C. for 2 hours. HPLC analysis on a sample of the reaction mixture showed complete conversion. The reaction mixture was concentrated to afford the crude product as a brown oil. The crude product was purified by vacuum distillation to afford the title compound as a colorless liquid. (10.1 g, 82%). ¹H NMR (CDCl₃) δ: 7.42 (d, J=8.7 Hz, 1H), 7.16 (d, J=8.7 Hz, 1H), 3.98 (s, 3H).

### Example 15

### Synthesis of (E)-acetophenone O-(3,6-dichloro-2-methoxybenzoyl) oxime

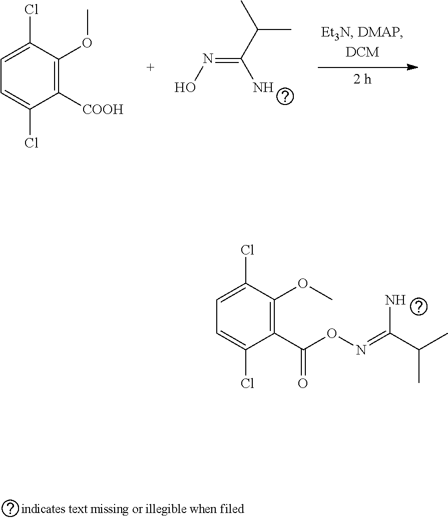

A 50-mL flask equipped with a magnetic stir-bar and a nitrogen balloon was charged with 3,6-dichloro-2-methoxybenzoyl chloride (400 mg, 1.67 mmol), (Z)—N′-hydroxyisobutyrimidamide (341 mg, 3.35 mmol), Et₃N (0.7 mL, 5.0 mmol), DMAP (10 mg, 0.08 mmol), and DCM (5 mL). The reaction was stirred at ambient temperature for 2 hours. HPLC and LC-MS analysis on a sample of the reaction mixture showed complete conversion. Water (20 mL) was slowly added. After stirring for 5 minutes, DCM (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as a white solid. (368 mg, 72%). ¹H NMR (CDCl₃) δ: 7.35 (d, J=8.7 Hz, 1H), 7.11 (d, J=8.7 Hz, 1H), 4.82 (s, 2H), 3.92 (s, 3H), 2.66 (p, J=7.0 Hz, 1H), 1.23 (d, J=7.0 Hz, 6H). ¹³C NMR (CDCl₃): 20.2, 30.8, 62.5, 125.8, 126.7, 129.6, 130.0, 131.9, 154.2, 162.2, 164.0. ESIMS m/z 329 [(M+Na)⁺].

### Example 16

### Synthesis of (E)-N′-((3,6-dichloro-2-methoxybenzoyl)oxy)benzimidamide

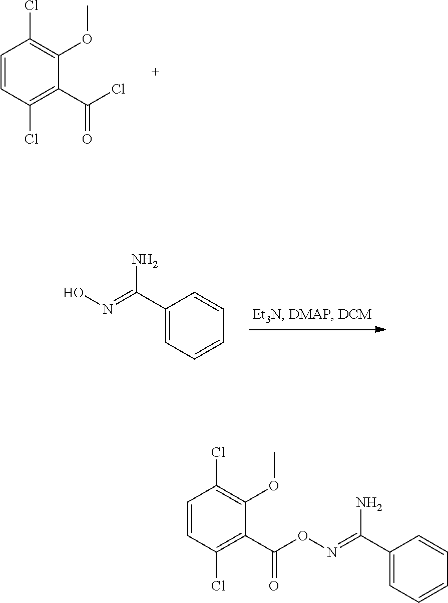 [SMILES: COc1c(Cl)ccc(Cl)c1C(=O)Cl ; N/C(=N\O)c1ccccc1 ; COc1c(Cl)ccc(Cl)c1C(=O)O/N=C(\N)c1ccccc1]

A 50-mL flask equipped with a magnetic stir-bar and a nitrogen balloon was charged with 3,6-dichloro-2-methoxybenzoyl chloride (500 mg, 2.09 mmol), (Z)—N-hydroxybenzimidamide (569 mg, 4.18 mmol), Et₃N (0.87 mL, 6.27 mmol), DMAP (12 mg, 0.1 mmol), and DCM (5 mL). The reaction was stirred at ambient temperature for 2 hours. HPLC and LC-MS analysis on a sample of the reaction mixture showed complete conversion. Water (20 mL) was slowly added. After stirring for 5 minutes, DCM (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as a white solid. (428 mg, 60%). ¹H NMR (CDCl₃) δ: 7.73 (d, J=7.3 Hz, 2H), 7.51-7.36 (m, 4H), 7.15 (d, J=8.7 Hz, 1H), 5.23 (s, 2H), 3.96 (s, 3H). ¹³C NMR (CDCl₃): 62.5, 125.9, 126.8, 126.9, 128.8, 129.4, 130.1, 130.7, 131.3, 132.1, 154.3, 157.9, 162.1. ESIMS m/z 339 [(M+H)⁺].

### Example 17

### Synthesis of (E)-N′-((3,6-dichloromethoxybenzoyl)oxy)isonicotinimidamide

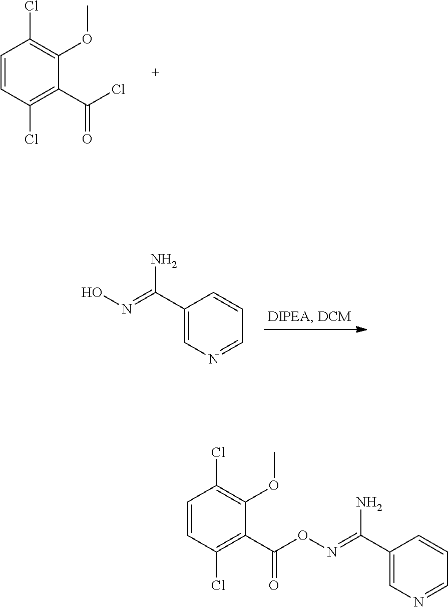 [SMILES: COc1c(Cl)ccc(Cl)c1C(=O)Cl ; N/C(=N\O)c1cccnc1 ; COc1c(Cl)ccc(Cl)c1C(=O)O/N=C(\N)c1cccnc1]

A 50-mL flask equipped with a magnetic stir-bar and a nitrogen balloon was charged with 3,6-dichloro-2-methoxybenzoyl chloride (500 mg, 2.09 mmol), (Z)—N-hydroxyisonicotinimidamide (430 mg, 3.14 mmol), Et₃N (0.3 mL, 2.09 mmol), DIPEA (0.9 mL, 5.22 mmol), and DCM (5 mL). The reaction was stirred at ambient temperature for 2 hours. HPLC and LC-MS analysis on a sample of the reaction mixture showed complete conversion. Water (20 mL) was slowly added. After stirring for 5 minutes, DCM (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as a white solid. (202 mg, 28%). ¹H NMR (CDCl₃) δ: 8.94 (d, J=2.1 Hz, 1H), 8.71 (dd, J=4.8, 1.6 Hz, 1H), 8.08 (dt, J=8.0, 1.9 Hz, 1H), 7.41 (d, J=8.7 Hz, 1H), 7.36 (dd, J=8.0, 4.9 Hz, 1H), 7.16 (d, J=8.7 Hz, 1H), 5.36 (s, 2H), 3.96 (s, 3H). ¹³C NMR (CDCl₃): 62.6, 123.5, 125.9, 126.8, 127.0, 129.1, 130.1, 132.3, 134.8, 147.7, 152.2, 154.3, 155.7. ESIMS m/z 340 [(M+H)⁺].

### Example 18

### Synthesis of (benzoyloxy)methyl 3,6-dichloro-2-methoxybenzoate

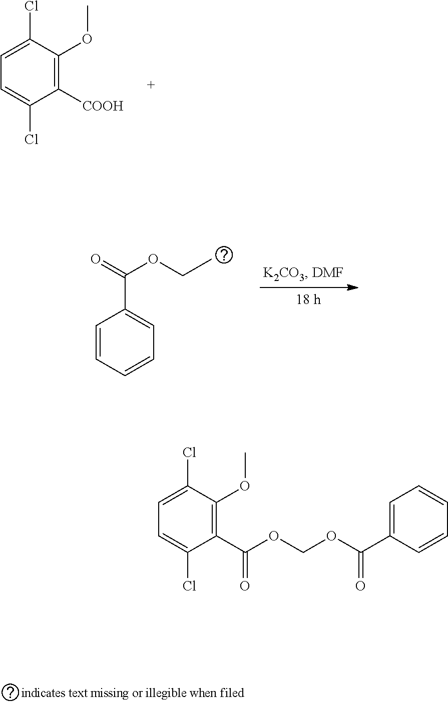 [SMILES: COc1c(Cl)ccc(Cl)c1C(=O)O ; CCOC(=O)c1ccccc1 ; COc1c(Cl)ccc(Cl)c1C(=O)OCOC(=O)c1ccccc1]

A 50-mL flask equipped with a magnetic stir-bar and a nitrogen balloon was charged with 3,6-dichloro-2-methoxybenzoic acid (250 mg, 1.13 mmol), K₂CO₃ (250 mg, 1.81 mmol) and DMF (8 mL). The mixture was stirred for 10 minutes and then chloromethyl benzoate (211 mg, 1.24 mmol) was added slowly. After the addition was complete, the reaction was stirred for 18 hours. HPLC and LC-MS analysis on a sample of the reaction mixture showed complete conversion. Water (20 mL) was slowly added. After stirring for 5 minutes, EtOAc (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as a colorless liquid. (189 mg, 47%). ¹H NMR (CDCl₃) δ: 8.14-8.07 (m, 2H), 7.62 (t, J=7.5 Hz, 1H), 7.48 (t, J=7.8 Hz, 2H), 7.36 (d, J=8.7 Hz, 1H), 7.11 (d, J=8.7 Hz, 1H), 6.25 (s, 2H), 3.86 (s, 3H). ESIMS m/z 355 [(M+H)⁺].

### Example 19

### Synthesis of ((diisopropylcarbamoyl)oxy)methyl3,6-dichloro-2-methoxybenzoate

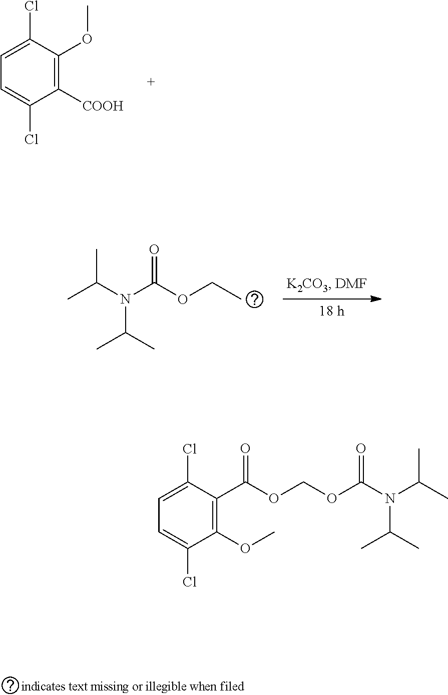 [SMILES: COc1c(Cl)ccc(Cl)c1C(=O)O ; CCOC(=O)N(C(C)C)C(C)C ; COc1c(Cl)ccc(Cl)c1C(=O)OCOC(=O)N(C(C)C)C(C)C]

A 50-mL flask equipped with a magnetic stir-bar and a nitrogen balloon was charged with 3,6-dichloro-2-methoxybenzoic acid (300 mg, 1.36 mmol), K₂CO₃ (218 mg, 1.58 mmol) and DMF (5 mL). The mixture was stirred for 10 minutes and then chloromethyl diisopropylcarbamate (316 mg, 1.62 mmol) was added slowly. After the addition was complete, the reaction was stirred for 18 hours. HPLC and LC-MS analysis on a sample of the reaction mixture showed complete conversion. Water (20 mL) was slowly added. After stirring for 5 minutes, EtOAc (50 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:Hexane system to afford the title compound as a colorless liquid. (178 mg, 35%). ¹H NMR (CDCl₃) δ: 7.35 (d, J=8.4 Hz, 1H), 7.10 (d, J=8.8 Hz, 1H), 6.02 (s, 2H), 4.12-3.96 (m, 1H), 3.89 (s, 3H), 3.88-3.82 (m, 1H), 1.23 (d, J=6.8 Hz, 12H). ¹³C NMR (CDCl₃): 20.4, 21.3, 46.0, 46.8, 62.2, 80.3, 125.8, 126.8, 129.6, 129.8, 132.1, 153.3, 154.1, 163.6. ESIMS m/z 401 [(M+Na)⁺].

### Example 20

### Synthesis of methylene bis(3,6-dichloro-2-methoxybenzoate)

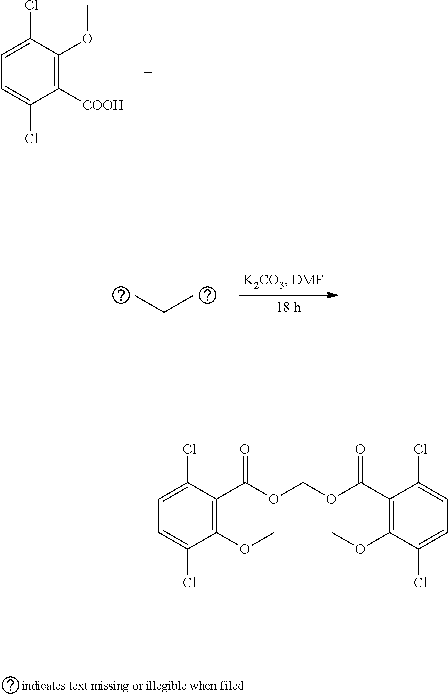

A 50-mL flask equipped with a magnetic stir-bar and a nitrogen balloon was charged with 3,6-dichloro-2-methoxybenzoic acid (200 mg, 0.9 mmol), K₂CO₃ (186 mg, 1.35 mmol) and DMF (5 mL). The mixture was stirred for 5 minutes and then dibromomethane (62 mg, 0.36 mmol) was added slowly. After the addition was complete, the reaction was stirred for 18 hours. HPLC analysis on a sample of the reaction mixture showed complete conversion. Water (15 mL) was slowly added. After stirring for 5 minutes, EtOAc (40 mL) was added and the layers were separated. The organic layer was washed with water (10 mL), brine (10 mL), dried over anhydrous sodium sulfate, filtered and then concentrated to dryness to afford the crude product as an oil. The crude material was purified by flash column using Ethyl Acetate:Hexane system to afford as a white solid. (64 mg, 40%). ¹H NMR (CDCl₃) δ: 7.39 (d, J=8.7 Hz, 2H), 7.14 (d, J=8.7 Hz, 2H), 6.22 (s, 2H), 3.93 (s, 6H). ¹³C NMR (CDCl₃): 62.4, 80.8, 125.9, 126.9, 129.0, 130.0, 132.6, 154.3, 163.1. ESIMS m/z 477 [(M+Na)⁺].

### Example 21

### Synthesis of ethane-1,2-diyl bis(3,6-dichloro-2-methoxybenzoate)

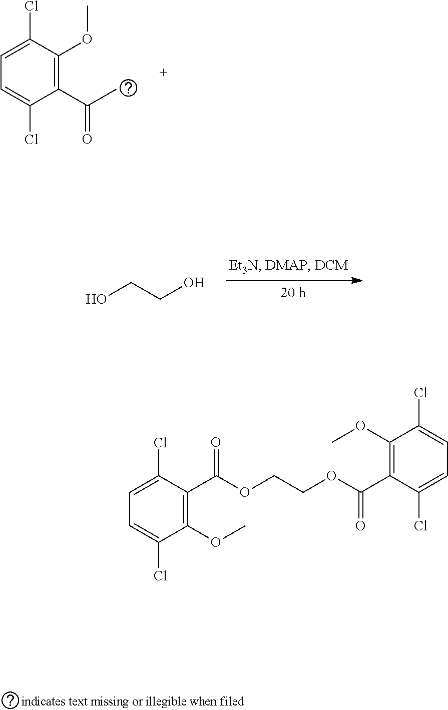

### Example 22

### Synthesis of oxybis(ethane-2,1-diyl) bis(3,6-dichloro-2-methoxybenzoate)

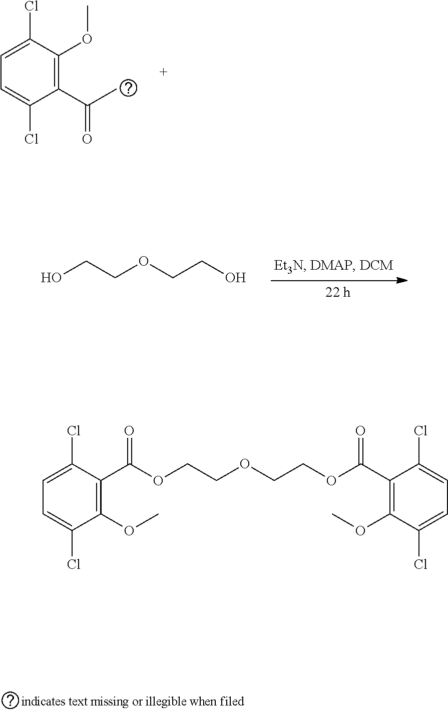 [SMILES: COc1c(Cl)ccc(Cl)c1C(C)=O ; OCCOCCO ; COc1c(Cl)ccc(Cl)c1C(=O)OCCOCCOC(=O)c1c(Cl)ccc(Cl)c1OC]

A 50-mL flask equipped with a magnetic stir-bar and a nitrogen balloon was charged with 3,6-dichloro-2-methoxybenzoyl chloride (1.0 g, 4.18 mmol), 2,2′-oxydiethanol (0.2 mL, 2.26 mmol), Et₃N (0.9 mL, 6.47 mmol), DMAP (25 mg, 0.21 mmol), and DCM (8 mL). The reaction was stirred at ambient temperature for 22 hours. HPLC and LC-MS analysis on a sample of the reaction mixture showed complete conversion. Water (20 mL) was slowly added. After stirring for 5 minutes, DCM (60 mL) was added and the layers were separated. The organic layer was washed with water (20 mL), brine (10 mL), dried over anhydrous sodium sulfate, filtered and then concentrated to dryness to afford the crude product as an oil. The crude product was purified by flash column using Ethyl Acetate:hexane system to afford the title compound as a white solid. (228 mg, 20%). ¹H NMR(CDCl₃) δ: 7.34 (d, J=8.7 Hz, 2H), 7.09 (d, J=8.7 Hz, 2H), 4.56-4.47 (m, 4H), 3.88 (s, 6H), 3.86-3.80 (m, 4H). ¹³C NMR (CDCl₃): 62.2, 65.0, 68.8, 125.8, 126.7, 129.7, 130.2, 131.9, 153.9, 164.4. ESIMS m/z 513 [(M+H)⁺].

### Example 23

### Synthesis of 1,4-phenylenebis(methylene) bis(3,6-dichloro-2-methoxybenzoate)

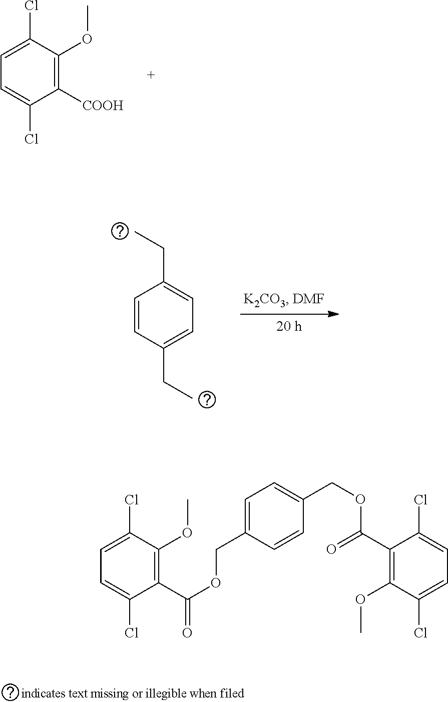

A 50-mL flask equipped with a magnetic stir-bar and a nitrogen balloon was charged with 3,6-dichloro-2-methoxybenzoic acid (353 mg, 1.6 mmol), K₂CO₃ (315 mg, 2.28 mmol) and DMF (10 mL). The mixture was stirred for 5 minutes and then 1,4-bis(bromomethyl)benzene (200 mg, 0.76 mmol) was added slowly. After the addition was complete, the reaction was stirred over 20 hours. HPLC analysis on a sample of the reaction mixture showed complete conversion. Water (15 mL) was slowly added. After stirring for 5 minutes, EtOAc (40 mL) was added and the layers were separated. The organic layer was washed with water (10 mL), brine (10 mL), dried over anhydrous sodium sulfate, filtered and then concentrated to dryness to afford the crude product as an oil. The crude product was purified by flash column using Ethyl Acetate:Hexane system to afford the title compound as a white solid. (146 mg, 35%). ¹H NMR (CDCl₃) δ: 7.48 (s, 4H), 7.35 (d, J=8.7 Hz, 2H), 7.11 (d, J=8.7 Hz, 2H), 5.41 (s, 4H), 3.82 (s, 6H). ¹³C NMR (CDCl₃): 62.2, 67.4, 125.8, 126.8, 128.8, 129.7, 130.3, 131.9, 135.5, 154.0, 164.4. ESIMS m/z 567 [(M+Na)⁺].

### Example 24

### Synthesis of (1E,1′E)-4-((E)-(((3,6-dichloro-2-methoxybenzoyl)oxy)imino)methyl) benzaldehyde O-(3,6-dichloro-2-methoxybenzoyl) oxime

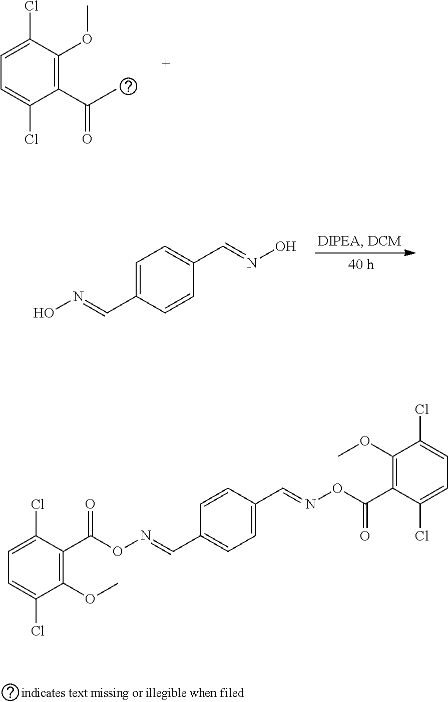 [SMILES: COc1c(Cl)ccc(Cl)c1C(C)=O ; O/N=C/c1ccc(/C=N/O)cc1 ; COc1c(Cl)ccc(Cl)c1C(=O)O/N=C/c1ccc(/C=N/OC(=O)c2c(Cl)ccc(Cl)c2OC)cc1]

A 50 mL flask equipped with a magnetic stir-bar and a nitrogen balloon was charged with 3,6-dichloro-2-methoxybenzoyl chloride (1 g, 4.18 mmol), (1Z,1′Z)-4-((Z)-(hydroxyimino)methyl)benzaldehyde oxime (816 mg, 6.27 mmol), DIPEA (1.1 mL, 6.21 mmol), and DCM (12 mL). The reaction was stirred at ambient temperature for 40 hours. HPLC and LC-MS analysis on a sample of the reaction mixture showed complete conversion. The reaction mixture was concentrated to dryness to afford the residue as an oil, which was directly purified by flash column using Ethyl Acetate:Hexane system to afford the title compound as a white solid. (168 mg, 23%). ¹H NMR (CDCl₃) δ: 8.48 (s, 2H), 7.85 (s, 4H), 7.43 (d, J=8.7 Hz, 2H), 7.17 (d, J=8.7 Hz, 2H), 3.97 (s, 6H). ¹³C NMR (CDCl₃): 62.5, 125.9, 126.9, 128.5, 129.1, 130.2, 132.6, 133.0, 154.4, 156.3, 162.0. ESIMS m/z 571 [(M+H)⁺].

### Example 25

### Synthesis of (2E,4E)-pentane-2,4-dione 0,0-di(3,6-dichloro-2-methoxybenzoyl) dioxime

### Step 1: Synthesis of Intermediate

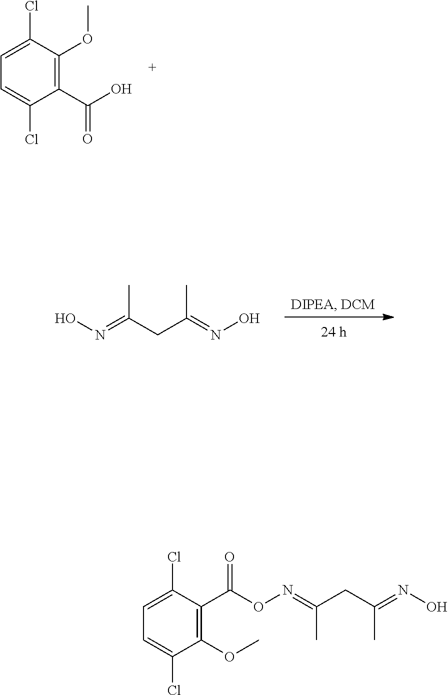

A 50-mL flask equipped with a magnetic stir-bar and a nitrogen balloon was charged with 3,6-dichloro-2-methoxybenzoyl chloride (1.0 g, 4.18 mmol), (2E,4E)-pentane-2,4-dione dioxime (1.09 g, 8.36 mmol), DIPEA (1.1 mL, 6.27 mmol), and DCM (15 mL). The reaction was stirred at ambient temperature over 24 hours. HPLC and LC-MS analysis on a sample of the reaction mixture showed incomplete conversion with the formation of side products. The reaction was concentrated to dryness to afford the residue as an oil, which was directly purified by flash column using Ethyl Acetate:Hexane system to afford the title compound as a white solid. (910 mg, 65%). ¹H NMR (CDCl₃): 7.40 (d, J=8.7 Hz, 1H), 7.23 (s, 1H), 7.15 (d, J=8.7 Hz, 1H), 3.95 (s, 3H), 3.26 (s, 2H), 2.02 (s, 3H), 1.90 (s, 3H).

### Step 2: Synthesis of (2E,4E)-pentane-2,4-dione 0,0-di(3,6-dichloro-2-methoxybenzoyl) dioxime

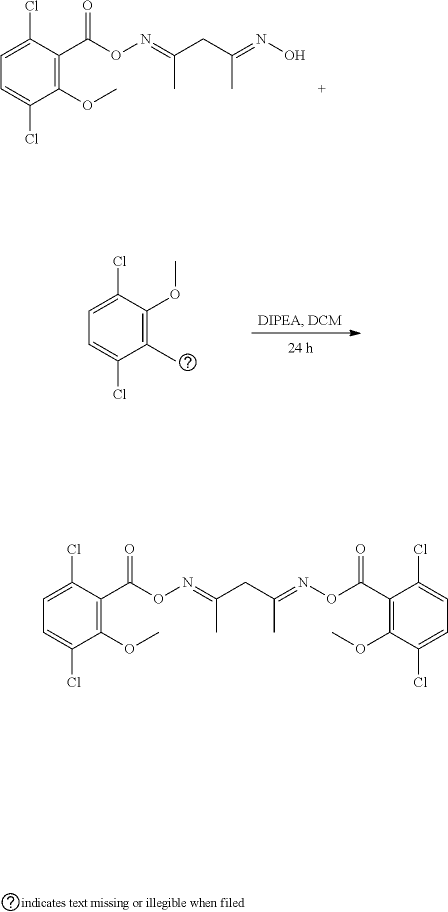 [SMILES: COc1c(Cl)ccc(Cl)c1C(=O)O/N=C(\C)C/C(C)=N/O ; COc1c(Cl)ccc(Cl)c1C ; COc1c(Cl)ccc(Cl)c1C(=O)O/N=C(\C)C/C(C)=N/OC(=O)c1c(Cl)ccc(Cl)c1OC]

A 50-mL flask equipped with a magnetic stir-bar and a nitrogen balloon was charged with 3,6-dichloro-2-methoxybenzoyl chloride (770 mg, 3.22 mmol), (2E,4E)-pentane-2,4-dione O⁴-(3,6-dichloro-2-methoxybenzoyl) dioxime (900 mg, 2.70 mmol), DIPEA (0.7 mL, 3.95 mmol), and DCM (12 mL). The reaction was stirred at ambient temperature over 24 hours. HPLC and LC-MS analysis on a sample of the reaction mixture showed incomplete conversion with formation of side products. The reaction was concentrated to dryness to afford the residue as an oil, which was directly purified by flash column using Ethyl Acetate:Hexane system to afford the title compound as a white solid. (166 mg, 11%). ¹H NMR (CDCl₃) δ: 7.40 (d, J=8.7 Hz, 2H), 7.15 (d, J=8.7 Hz, 2H), 3.94 (s, 6H), 3.48 (s, 2H), 2.06 (s, 6). ¹³C NMR (CDCl₃): 15.6, 42.1, 62.5, 77.3, 125.8, 126.8, 128.9, 129.9, 132.3, 154.3, 162.2, 163.8. ESIMS m/z 537 [(M+H)⁺].

### Example 26

### Synthesis of (E)-benzaldehyde O-(3,6-dichloro-2-methoxybenzoyl) oxime

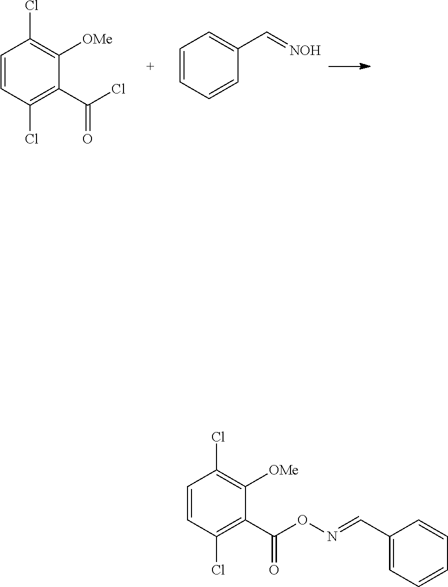

Benzaldehyde oxime (0.36 g, 3.0 mmol) was dissolved with CHCl₃ (10 mL). NMM (1 mL, 9.0 mmol) and 3,6-dichloro-2-methoxybenzoyl chloride (0.6 g, 5.0 mmol) were added and the reaction mixture was heated to 50° C. for 2 h. The reaction mixture was then cooled to RT and water (10 mL) and DCM (10 mL) were added. The organic layer was separated and washed with brine, dried over Na₂SO₄ and concentrated in vacuo to give the crude product, which was purified by flash column chromatography (silica gel; gradient elution 0-10% EtOAc:hexanes) to give the title compound as an colorless oil (0.31 g. 0.96 mmol, 32%). ¹H NMR (CDCl₃): δ 8.49-8.50 (d, J=4 Hz, 1H), 7.79-7.81 (d, J=8, 1H), 7.62-7.81 (dd, J=40 Hz, 1H), 7.43-7.54 (m, 3H), 7.17-7.22 (td, J=8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. ESIMS m/z 345.9 [(M+Na)+].

### Example 27

### Synthesis of nicotinaldehyde O-(3,6-dichloro-2-methoxybenzoyl) oxime

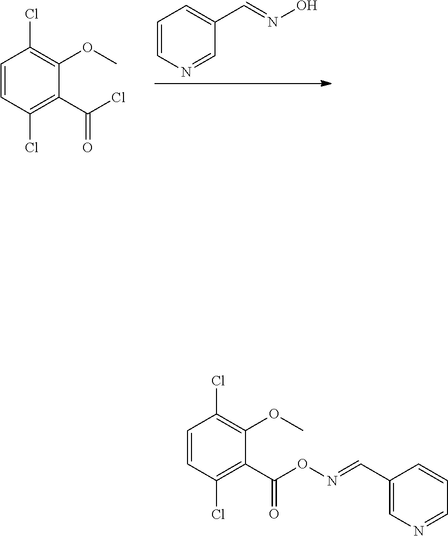

Nicotinaldehydeoxime (0.83 g, 8.3 mmol, 1.0 eq; CAS #1193-92-6) and THE (30 mL) were added to a flame-dried 50 mL RBF to yield a homogenous solution. DIPEA (1.31 g, 12.0 mmol, 1.5 eq) was added and the reaction mixture was cooled to 0° C. A solution of 3,6-dichloro-2-methoxybenzoyl chloride (2.0 g, 8.3 mmol, 1.0 eq) in THE (5 mL) was added and the resultant mixture was stirred for 16 h at RT. After this time, TLC indicated that the reaction was complete. The reaction mixture was poured into ice/water (50 mL) and extracted with EtOAc (100 mL). The organic extract was washed with a saturated NaHCO₃ solution (20 mL), followed by brine (20 mL), dried over Na₂SO₄ and concentrated in vacuo to yield the crude product. Purification by flash column chromatography (silica gel; gradient elution: 5-40% EtOAc in hexanes) yielded the title compound as a tan-coloured solid (0.3 g, 0.92 mmol, 11%). ¹H NMR (400 MHz, CDCl₃) δ 8.91-8.86 (m, 1H), 8.77 (d, J=5.5 Hz, 1H), 8.54 (s, 1H), 8.28-8.21 (m, 1H), 7.50-7.40 (m, 2H), 7.21 (d, J=8.7 Hz, 1H), 4.01 (s, 3H).

### Example 28

### Synthesis of 3,6-dichloro-2-methoxyphenyl)({(E)-[(furan-2-yl)methylidene]amino}oxy)methanone

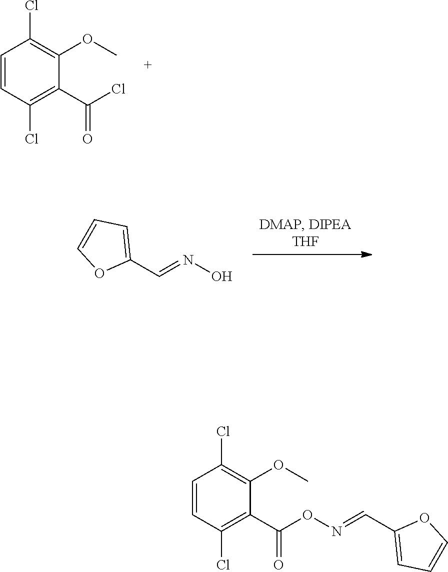 [SMILES: COc1c(Cl)ccc(Cl)c1C(=O)Cl ; O/N=C/c1ccco1 ; COc1c(Cl)ccc(Cl)c1C(=O)O/N=C/c1ccco1]

2-Furaldehyde oxime (0.40 g, 3.6 mmol) and 15 mL of anhydrous THF (15 mL) were added to a flame-dried 50 mL RBF. DMAP (0.044 g, 0.36 mmol) and DIPEA (0.46 g, 3.6 mmol) were then added and the mixture was stirred at 0° C. 3,6-Dichloro-2-methoxybenzoyl chloride (0.87 g, 3.6 mmol) was added dropwise to the mixture which was stirred at 0° C. for 30 min. and then allowed to warm to RT and stirred for a further 8 h. HCl (1 M, 30 mL) was added and the mixture was extracted with DCM (3×50 mL). The combined organic extracts were dried over Na₂SO₄ and concentrated in vacuo to give the crude product which was purified by flash column chromatography (silica gel; eluting with 10-15% EtOAc:hexane) to yield the title compound as a colorless solid (0.45 g, 1.4 mmol, 39%). ¹H NMR (400 MHz, CDCl₃) δ 9.12 (s, 1H), 7.61 (d, J=1.8 Hz, 1H), 7.42 (d, J=8.6 Hz, 1H), 7.33 (d, J=3.6 Hz, 1H), 7.18 (d, J=8.7 Hz, 1H), 6.63 (dd, J=3.7, 1.8 Hz, 1H), 3.94 (s, 3H).

### Example 29

### Synthesis of (E)-2-oxopropanal O-(3,6-dichloro-2-methoxybenzoyl) oxime

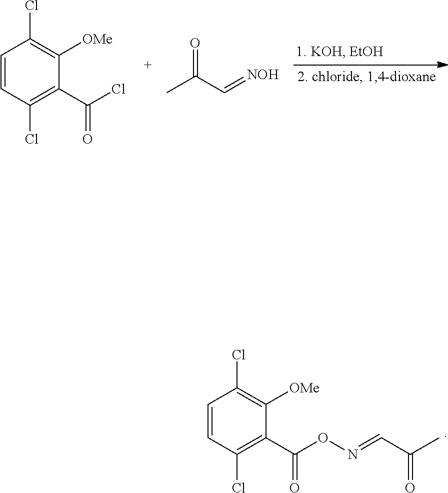

1-(Hydroxyimino)propan-2-one (1.72 g, 20.0 mmol) was dissolved in ethanol (10 mL) followed by the addition of KOH (1.34 g, 24.0 mmol). The mixture was stirred at RT for 1 h and then concentrated in vacuo to give a yellow solid (2.3 g), 0.6 g of which was dissolved in 1,4-dioxane (5 mL). 3,6-dichloro-2-methoxybenzoyl chloride (1.6 g, 6.7 mmol) was added and the resultant mixture was stirred at RT for 18 h. Water was added and the mixture was extracted with EtOAc (50 mL). The combined organic extracts were washed with brine, dried over Na₂SO₄, and concentrated to give the crude product which was purified by flash column chromatography (silica gel; gradient elution 0-15% EtOAc:hexanes) to give the title compound as a colorless solid (0.43 g, 1.48 mmol, 29%). ¹H-NMR (CDCl₃): δ 7.77 (s, 1H), 7.79-7.81 (d, J=8, 1H), 7.46-7.48 (dd, J=8 Hz, 1H), 7.19-7.22 (dd, J=6 Hz, 1H), 3.98 (s, 3H), 2.57 (s, 3H). ¹³C-NMR (CDCl₃): 26.2, 63.5, 126.0, 126.9, 127.7, 130.2, 133.0, 154.0, 154.5, 161.4, 195.1.

### Example 30

### Synthesis of butan-2-one O-(3,6-dichloro-2-methoxybenzoyl) oxime

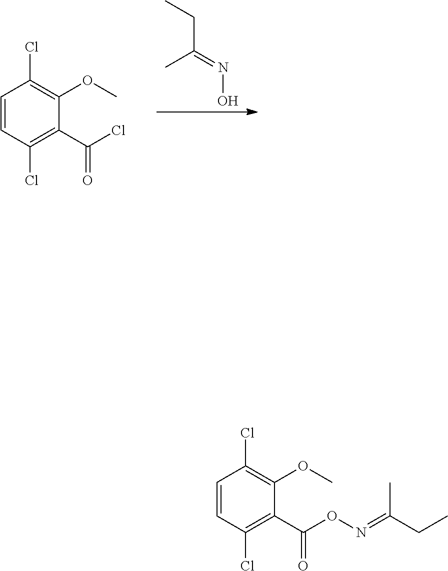

2-Butanoneoxime (0.3 g, 4.1 mmol, 1.0 eq; CAS #96-29-7) and THE (15 mL) were added to a flame-dried 50 mL RBF to form a homogenous solution. DIPEA (0.66 g, 6.2 mmol, 1.5 eq) was added and the mixture was cooled to 0° C. 3,6-Dichloro-2-methoxybenzoyl chloride (1.0 g, 4.1 mmol, 1.0 eq) in THE (3 mL) was added and the resultant mixture was stirred at RT for 16 h. After this time TLC indicated that the reaction was complete. The reaction mixture was poured into ice/water (25 mL) and then extracted with EtOAc (50 mL). The organic extract was washed with a sat. NaHCO₃ solution (20 mL) followed with brine (20 mL), dried over Na₂SO₄, and concentrated in vacuo to give the crude product. Purification by flash column chromatography (silica gel; gradient elution: 5-40% EtOAc:hexanes) to give the title compound as a colorless solid (0.3 g, 25%). ¹H NMR (400 MHz, CDCl₃) δ 7.40 (d, J=8.7 Hz, 1H), 7.16 (d, J=8.6 Hz, 1H), 3.97 (s, 3H), 2.45 (q, J=7.5 Hz, 2H), 2.04 (s, 3H), 1.21 (t, J=7.5 Hz, 3H).

### Example 31

### Synthesis of 3,6-dichloro-2-methoxyphenyl){[(E)-(3,3-dimethylbutan-2-ylidene)amino]oxy}methanone

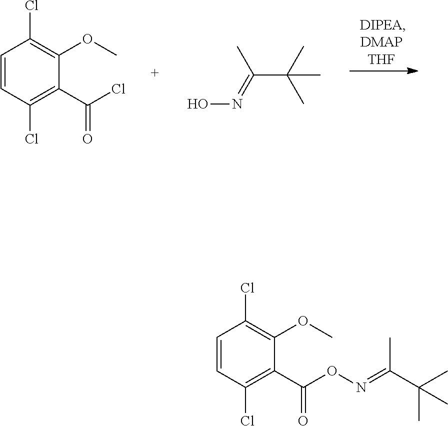

(E)-3,3-dimethylbutan-2-one oxime (0.21 g, 2.1 mmol) and anhydrous THE (15 mL) were added to a flame-dried 50 mL RBF. DMAP (0.025 g, 0.21 mmol) and DIPEA (0.27 g, 2.1 mmol) were added and the mixture was stirred at 0° C. 3,6-Dichloro-2-methoxybenzoyl chloride (0.50 g, 2.1 mmol) was added dropwise and the mixture was stirred at 0° C. for a further 30 min and then allowed to warm to RT and stirred for 8 h. HCl (1 M, 30 mL) was then added and the mixture was extracted with DCM (3×50 mL). The combined organic extracts were dried over Na₂SO₄ and concentrated in vacuo to give the crude product which was purified by flash column chromatography (eluting with 10-15% EtOAc in hexane) to give the title compound as a colorless solid (0.39 g, 1.2 mmol, 57%). ¹H NMR (400 MHz, CDCl₃) δ 7.40 (d, J=8.6 Hz, 1H), 7.16 (d, J=8.6 Hz, 1H), 3.97 (s, 3H), 2.01 (s, 3H), 1.22 (s, 10H).

### Example 32

### Synthesis of 3,6-dichloro-2-methoxyphenyl)({(E)-[(furan-2-yl)methylidene]amino}oxy) methanone

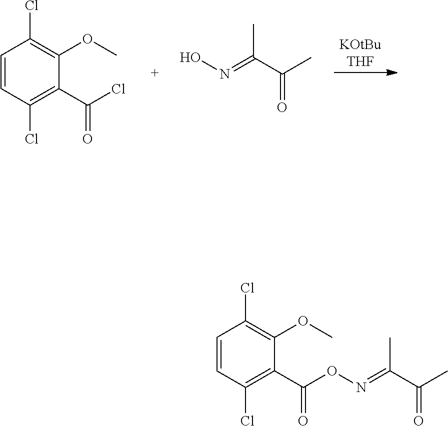

2,3-Butanedione 2-monoxime (0.21 g, 2.0 mmol) and anhydrous THE (7 mL) were added to a 50 mL RBF cooled to 5° C. KO^{t}Bu (0.68 g, 6.1 mmol) was then added and the mixture was stirred for 15 min. The reaction mixture was heated to 30° C. and then stirred at RT. 3,6-Dichloro-2-methoxybenzoyl chloride (0.63 g, 6.1 mmol) was dissolved in anhydrous THE (3 mL) and the resultant solution was added dropwise to the reaction mixture. The reaction mixture was stirred at RT for a further 2 h. The reaction mixture was filtered under vacuum and the filtrate concentrated in vacuo. The crude product was purified by flash column chromatography (silica gel; gradient elution 5-10% EtOAc:hexanes) to give the title compound as a colorless solid (0.26 g, 0.85 mmol, 43%). ¹H NMR (400 MHz, CDCl₃) δ 7.47 (d, J=8.7 Hz, 1H), 7.21 (d, J=8.7 Hz, 1H), 3.99 (s, 3H), 2.53 (s, 3H), 2.14 (s, 3H).

### Example 33

### Synthesis of methyl N-[(3,6-dichloro-2-methoxybenzoyl)oxy] benzenecarboximidate

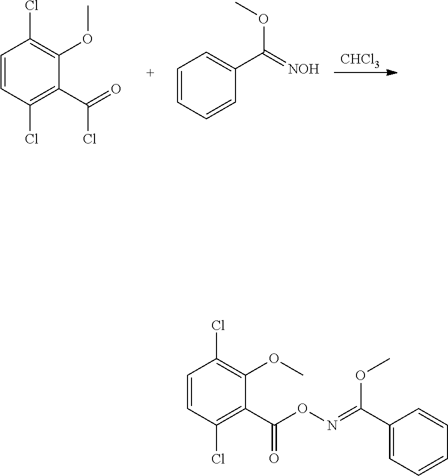

Methyl N-hydroxybenzimidate (0.25 g, 1.6 mmol) and chloroform (15 mL) were added to a flame-dried 50 mL RBF. NMM (0.26 g, 2.0 mmol) and 3,6-dichloro-2-methoxybenzoyl chloride (0.4 g, 1.6 mmol) were then added and the reaction mixture was stirred at RT for 6 h. The mixture was then concentrated in vacuo to give the crude product which was purified by flash chromatography (silica gel; gradient elution: 5-10% EtOAc:hexane) to give the title compound as a colorless solid (0.24 g, 0.67 mmol, 42%). ¹H NMR (400 MHz, DMSO) δ 7.77-7.61 (m, 4H), 7.61-7.54 (m, 2H), 7.47 (dd, J=8.7, 2.1 Hz, 1H), 3.92 (s, 3H), 3.87 (s, 3H).

### Example 34

### Synthesis of ethyl N-(3,6-dichloro-2-methoxybenzoyl)oxyacetimidate)

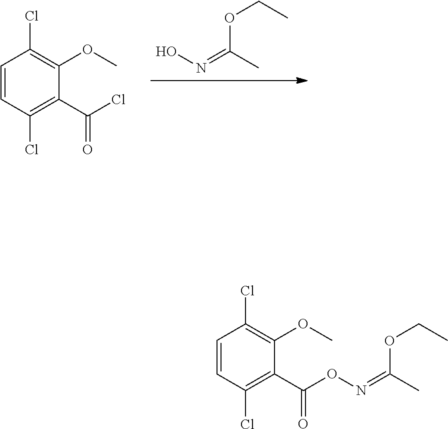

Ethyl N-hydroxyacetimidate (1 g, 10.0 mmol, 1.2 eq; CAS #10576-12-2) and THE (30 mL) were added to a flame-dried 50 mL RBF to form a homogenous solution. DIPEA (1.6 g, 12.5 mmol, 1.5 eq) was then added and the mixture was cooled to 0° C. A solution of 3,6-dichloro-2-methoxybenzoyl chloride (2.0 g, 8.3 mol, 1.0 eq) in THE (5 mL) was then added and the resultant mixture was stirred for 16 h at RT. After this time TLC indicated only a faint new spot; no change was observed after stirring for an additional 16 h. The reaction mixture was poured into ice/water (50 mL) and then extracted with EtOAc (100 mL). The organic extract was washed with a sat. NaHCO₃ solution (20 mL) followed with brine (20 mL) and then dried over Na₂SO₄ and concentrated in vacuo to give the crude product. Purification by flash column chromatography (silica gel; gradient elution: 5-20% EtOAc in hexanes) gave the title compound as a colorless solid (0.3 g, 0.98 mmol, 12%). ¹H NMR (400 MHz, CDCl₃) δ 7.41 (d, J=8.7 Hz, 1H), 7.16 (d, J=8.7 Hz, 1H), 4.27 (q, J=7.1 Hz, 2H), 3.97 (s, 3H), 2.11 (s, 3H), 1.36 (t, J=7.1 Hz, 3H).

### Example 35

### Synthesis of (Z)-methyl N-(3,6-dichloro-2-methoxybenzoyl)oxybenzimidothioate

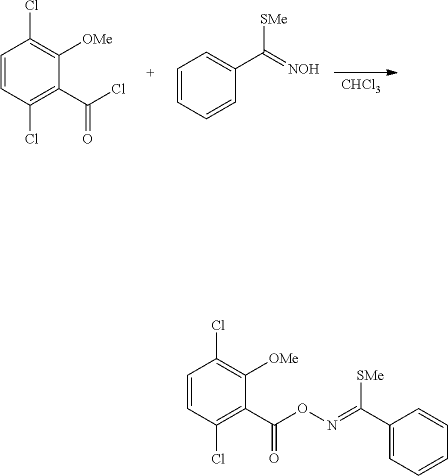

Methyl N-hydroxybenzimidothioate (0.26 g, 1.6 mmol) was dissolved in chloroform (10 mL) and then NMM (0.5 mL, 4.5 mmol) and 3,6-dichloro-2-methoxybenzoyl chloride (0.46 g, 2.0 mmol) were added. The resultant mixture was stirred at RT overnight. Water was added, followed by DCM. The organic phase was separated and then washed with brine, dried over Na₂SO₄ and concentrated in vacuo. The crude product obtained was purified by flash column chromatography (silica gel; gradient elution 0-80% DCM:hexanes) to give Ethyl N-hydroxyacetimidate as a colorless solid (250 mg, 0.68 mmol, 44%). ¹H NMR (CDCl₃): δ 7.74-7.77 (d, J=12 Hz, 1H), 7.79-7.81 (d, J=8, 1H), 7.62-7.81 (dd, J=40 Hz, 1H), 7.43-7.54 (m, 3H), 7.17-7.22 (td, J=8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. LCMS: m/z 391.99 (M+Na).

### Example 36

### Synthesis of (Z)-Methyl N-(3,6-dichloro-2-methoxybenzoyl)oxyethanimidothioate

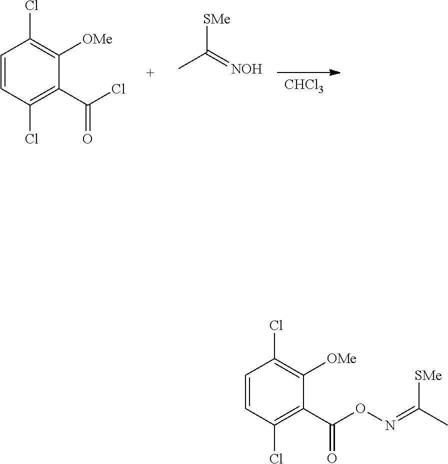

Methyl N-hydroxyethanimidothioate (10 mg, 0.1 mmol) was dissolved in chloroform (3 mL). NMM (5 drops) and 3,6-dichloro-2-methoxybenzoyl chloride (30 mg, 0.1 mmol) were added and the resultant mixture was stirred at RT for 18 h. Water was added followed by DCM and the organic layer was separated and washed with brine, dried over Na₂SO₄, and concentrated to give the crude product which was purified by flash column chromatography (silica gel; gradient elution 0-30% EtOAc:hexanes) to give Ethyl N-hydroxyacetimidate as a colorless solid (23 mg, 0.07 mmol, 76%). ¹H NMR (400 MHz, CDCl₃): δ 7.40-7.43 (d, J=10 Hz, 1H), 7.15-7.18 (d, J=10 Hz, 1H), 3.98 (s, 3H), 2.42 (s, 3H), 2.38 (s, 3H). LC-MS: m/z 308.00 (M+1).

### Example 37

### Synthesis of N-((3,6-dichloro-2-methoxybenzoyl)oxy)benzimidoyl cyanide

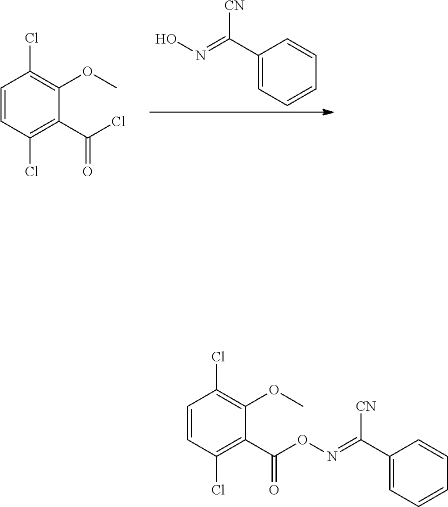 [SMILES: COc1c(Cl)ccc(Cl)c1C(=O)Cl ; N#C/C(=N\O)c1ccccc1 ; COc1c(Cl)ccc(Cl)c1C(=O)O/N=C(\C#N)c1ccccc1]

N-hydroxybenzimidoyl cyanide (0.55 g, 0.0050 mol, 1.2 eq; CAS #825-52-5) and THE (15 mL) were added to a flame-dried 50 mL RBF to form a homogeneous solution. DIPEA (0.80 g, 0.0062 mol, 1.5 eq) was then added and the mixture was cooled to 0° C. A solution of 3,6-dichloro-2-methoxybenzoyl chloride (1.0 g, 0.0041 mole, 1.0 eq) in THE (5 mL) was then added and the resultant mixture was stirred for 16 h at RT. After this time, TLC indicated that a new spot was present. The reaction mixture was then poured into ice/water (25 mL) and extracted with EtOAc (50 mL). The organic extract was washed with a NaHCO₃ solution (20 mL) followed by brine (20 mL), dried over Na₂SO₄, and concentrated in vacuo to give the crude product which was purified by flash column chromatography (silica gel; gradient elution 5-40% EtOAc:hexanes) to yield the title compound as a pale yellow solid (0.50 g, 1.4 mmol, 34%). ¹H NMR (400 MHz, CDCl₃) δ 8.04 (dt, J=7.2, 1.4 Hz, 2H), 7.69-7.53 (m, 3H), 7.50 (d, J=8.7 Hz, 1H), 7.24 (d, J=8.7 Hz, 1H), 4.04 (s, 3H).

### Example 38

### Synthesis of (E)-ethyl 2-cyano-2-(((3,6-dichloro-2-methoxybenzoyl)oxy)imino)acetate

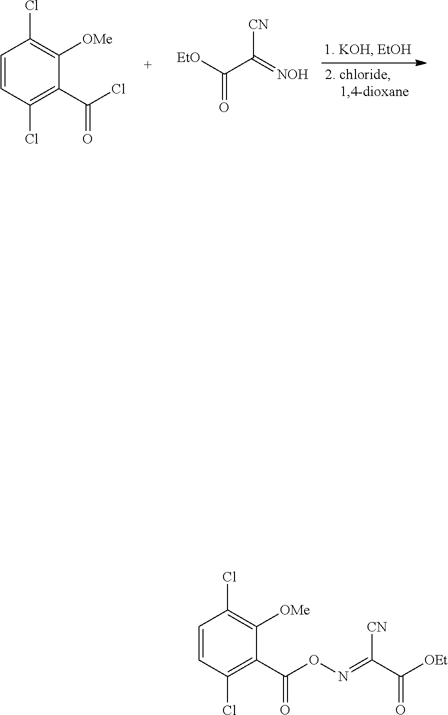

Ethyl 2-cyano-2-(hydroxyimino)acetate (1.41 g, 10 mmol) was dissolved in EtOH (15 mL) and KOH (0.6 g, 10.7 mmol) was then added. The mixture was stirred at RT for 1 h and then concentrated in vacuo to give a yellow solid which was washed with cold EtOH and air-dried to give 0.45 g of a yellow solid. This was dissolved in 1,4-dioxane (10 mL) and 3,6-dichloro-2-methoxybenzoyl chloride (0.89 g, 3.8 mmol) was added. The resulting mixture was stirred at RT overnight. Water was added (30 mL) and the mixture was extracted with EtOAc (30 mL). The organic extract was washed with brine, dried over Na₂SO₄ and concentrated in vacuo to give the crude product which was purified by flash column chromatography (silica gel; gradient elution: 0-15% EtOAc:hexanes) to give the title compound as a colorless solid (0.33 g, 0.96 mmol, 10%). ¹H-NMR (400 MHz, CDCl₃): δ 7.50-7.53 (d, J=10, 1H), 7.22-7.25 (d, J=8 Hz, 1H), 4.50-4.56 (q, 2H), 4.00 (s, 3H), 1.44-1.48 (t, 3H).

### Example 39

### Synthesis of Diethyl 2-(((3,6-dichloro-2-methoxybenzoyl)oxy)imino)malonate

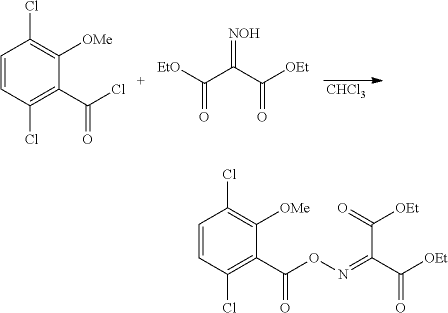

Diethyl 2-(hydroxyimino)malonate (0.57 g, 3 mmol) was dissolved in CHCl₃ (15 mL). NMM (0.9 mL, 8.2 mmol) and 3,6-dichloro-2-methoxybenzoyl chloride (0.73 g, 3.1 mmol) were then added and the reaction mixture was stirred at RT overnight. Water (15 mL) was added, followed by DCM (15 mL). The organic layer was separated, washed with brine, dried over Na₂SO₄ and concentrated in vacuo to give the crude product which was purified by flash column chromatography (silica gel; gradient elution 0-20% EtOAc:hexanes) to give the title compound as an colorless oil (0.4 g, 1.0 mmol, 34%). ¹H-NMR (CDCl₃): δ 7.44-7.47 (d, J=10 Hz, 1H), 7.16-7.19 (d, J=10 Hz, 1H), 4.43-4.49 (q, 2H), 4.37-4.42 (q, 2H), 3.95 (s, 3H), 1.40-1.45 (t, 3H), 1.29-1.33 (t, 3H). LC-MS: m/z 414.17 (M+Na).

### Example 40

### Synthesis of N-((3,6-dichloro-2-methoxybenzoyl)oxy)benzamide

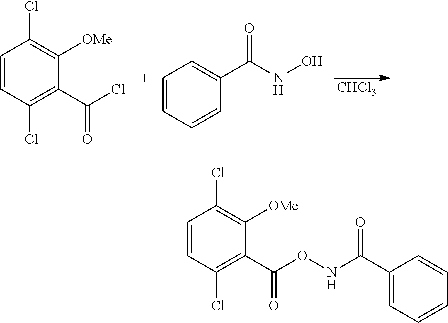

N-hydroxybenzamide (0.28 g, 2 mmol) was dissolved in chloroform (10 mL). NMM (0.24 g, 2.4 mmol) and 3,6-dichloro-2-methoxybenzoyl chloride (0.48 g, 2 mmol) were then added. The reaction mixture was stirred at RT overnight. Water (10 mL) was then added followed by DCM (10 mL). The organic layer was separated, washed with brine, dried over Na₂SO₄ and concentrated in vacuo to give the crude product which was purified by flash column chromatography (silica gel; gradient elution 0-30% EtOAc:hexanes) to give the title compound as a colorless solid (0.33 g, 0.97 mmol, 49%). ¹H-NMR (CDCl₃): δ 9.77 (s, 1H), 7.92-7.94 (d, J=8 Hz, 2H), 7.62-7.64 (t, 1H), 7.51-7.55 (t, 2H), 7.47-7.50 (d, J=6 Hz, 1 h), 7.20-7.23 (d, J=4 Hz, 1H), 4.07 (s, 3H). LC-MS: m/z 340.00 (M+1).

### Example 41

### Synthesis of [(dibenzyl amino)oxy](3,6-dichloro-2-methoxyphenyl)methanone

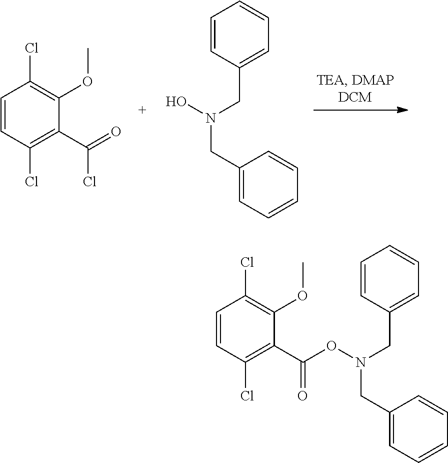 [SMILES: COc1c(Cl)ccc(Cl)c1C(=O)Cl ; ON(Cc1ccccc1)Cc1ccccc1 ; COc1c(Cl)ccc(Cl)c1C(=O)ON(Cc1ccccc1)Cc1ccccc1]

Dibenzyl hydroxylamine (0.50 g, 2.4 mmol) and anhydrous DCM (10 mL) were added to a flame-dried 50 mL RBF. DMAP (0.029 g, 0.24 mmol) and TEA (0.24 g, 2.4 mmol) were then added and the mixture was stirred at 0° C. 3,6-Dichloro-2-methoxybenzoyl chloride (0.57 g, 2.4 mmol) was added. The mixture was then allowed to warm to RT with stirring for a further 6 h, HCl (1 M, 30 mL) was added, and the mixture was extracted with DCM (3×50 mL). The combined organic extracts were dried over Na₂SO₄ and concentrated in vacuo to give the crude product which was purified by flash chromatography (eluting with 10-15% EtOAc:hexanes) to give the title compound as yellow semi-solid (0.42 g, 1.0 mmol, 42%). ¹H NMR (400 MHz) δ 7.61-7.45 (m, 4H), 7.43-7.24 (m, 7H), 7.12-6.97 (m, 1H), 4.24 (s, 4H), 3.58-3.44 (m, 3H).

### Example 42

### Synthesis of 1-[(3,6-dichloro-2-methoxybenzoyl) oxy]pyrrolidine-2,5-dione

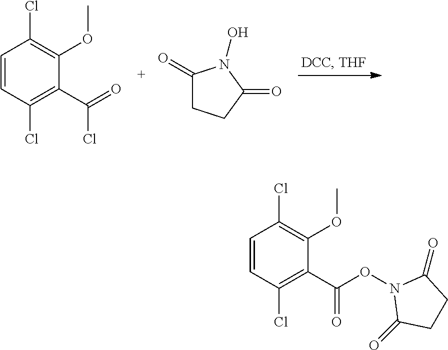 [SMILES: COc1c(Cl)ccc(Cl)c1C(=O)Cl ; O=C1CCC(=O)N1O ; COc1c(Cl)ccc(Cl)c1C(=O)ON1C(=O)CCC1=O]

3,6-Dichloro-2-methoxybenzoic acid (0.6 g, 2.7 mmol) and anhydrous THE (7 mL) were added to a flame-dried 50 mL RBF under N₂. DCC (0.6 g, 2.9 mmol) was then added and the resultant mixture was stirred for 15 min. N-Hydroxysuccinimide (0.32 g, 2.8 mmol) was added and the mixture was stirred at RT for a further 6 h. The reaction mixture was filtered under vacuum and the filtrate was concentrated. The crude product obtained was purified by flash column chromatography (silica gel; gradient elution: 20-25% EtOAc:hexane) to give the title compound as a colorless solid (0.29 g, 0.91 mmol, 34%). ¹H NMR (400 MHz, CDCl₃) δ 7.47 (d, J=8.6 Hz, 1H), 7.20 (d, J=8.9 Hz, 1H), 4.04 (d, J=2.3 Hz, 3H), 2.92 (s, 4H).

### Example 43

### Synthesis of 4-chlorophenyl 3,6-dichloro-2-methoxybenzoate

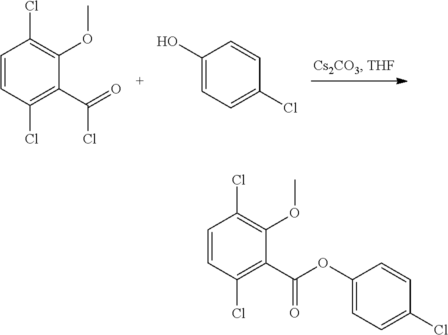 [SMILES: COc1c(Cl)ccc(Cl)c1C(=O)Cl ; Oc1ccc(Cl)cc1 ; COc1c(Cl)ccc(Cl)c1C(=O)Oc1ccc(Cl)cc1]

4-Chlorophenol (0.30 g, 2.3 mmol) and anhydrous THE (7 mL) were added to a flame-dried 50 mL RBF under N₂. Cs₂CO₃ (2.3 g, 7.0 mmol) was added and the mixture was stirred for 15 min. The solution was heated to 55° C. for 15 min and then allowed to cool to RT. A solution of 3,6-dichloro-2-methoxybenzoyl chloride (0.83 g, 3.5 mmol) in anhydrous THE (3 mL) was then added slowly to the reaction mixture with stirring for 2 h at RT. The reaction mixture was filtered under vacuum and the filtrate concentrated in vacuo to give the crude product which was purified by flash column chromatography (eluting with 18% EtOAc:hexane) to give the title compound (0.34 g, 1.0 mmol, 43%) as a colourless solid (0.34 g, 1.0 mmol, 43%). ¹H NMR (400 MHz, CDCl₃) δ 7.49-7.42 (m, 3H), 7.30-7.18 (m, 3H), 4.03 (s, 3H).

### Example 44

### Synthesis of pyrimidin-5-yl 3,6-dichloro-2-methoxybenzoate

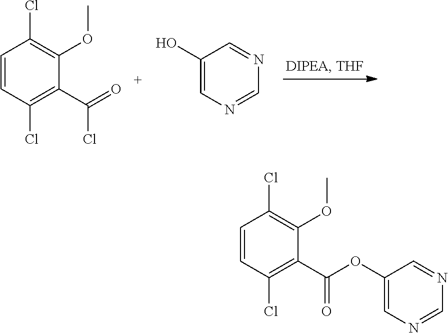 [SMILES: COc1c(Cl)ccc(Cl)c1C(=O)Cl ; Oc1cncnc1 ; COc1c(Cl)ccc(Cl)c1C(=O)Oc1cncnc1]

5-Hydroxypyrimidine (0.24 g, 2.5 mmol) and anhydrous THE (12 mL) were added to a flame-dried 50 mL RBF and the mixture was cooled to 0° C. Diisopropylethylamine (0.32 g, 2.5 mmol) was added, followed by the drop-wise addition of a solution of 3,6-dichloro-2-methoxybenzoyl chloride (0.4 g, 1.7 mmol) in THE (3 mL). The reaction mixture was stirred at 0° C. for 30 min. and then allowed to warm to RT and stirred overnight. The reaction mixture was poured into 50 mL of ice water and extracted with EtOAc (2×50 mL). The combined organic extracts were washed with a NaHCO₃ solution (10 g/50 mL H₂O), dried over Na₂SO₄ and then concentrated in vacuo. The crude product was purified by flash column chromatography (eluting with 30% EtOAc:hexane) to give the title compound (0.48 g, 1.6 mmol) as a colorless solid (0.36 g, 0.98 mmol, 58%). ¹H NMR (400 MHz, CDCl₃) δ 9.20 (d, J=5.0 Hz, 1H), 8.85-8.76 (m, 2H), 7.54-7.46 (m, 1H), 7.27-7.22 (m, 1H), 4.03 (d, J=2.9 Hz, 3H).

### Example 45

### Synthesis of 3,6-dichloro-2-methoxy-N-tosylbenzamide

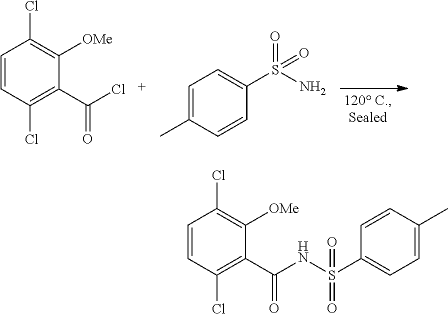

4-methylbenzenesulfonamide (0.75 g, 4.4 mmol) and 3,6-dichloro-2-methoxybenzoyl chloride (0.7 g, 3 mmol) were combined in a 10 mL sealed tube. The reaction was heated to 120° C. for 3 h. The reaction was cooled to room temperature and then water (30 mL) and DCM (50 mL) were added. The organic layer was separated, washed with brine, dried over Na₂SO₄ and concentrated in vacuo to give the crude product which was purified by flash column chromatography (silica gel; gradient elution 0-30% EtOAc:hexanes) to give the title compound as an off-white solid (0.37 g, 0.99 mmol, 33%). ¹H-NMR (CDCl₃): δ 8.91 (s, 1H), 8.03-8.05 (d, J=8 Hz, 2H), 7.40-7.42 (d, J=8 Hz, 2H), 7.29-7.32 (d, J=8 Hz, 1H), 7.07-7.10 (t, J=6 Hz, 1H), 3.68 (s, 1H), 2.49 (s, 3H). LC-MS: m/z 374.11 (M+1).

### Example 46

### Synthesis of 3,6-dichloro-2-methoxy-N-((1-methyl-1H-imidazol-2-yl)sulfonyl)benzamide

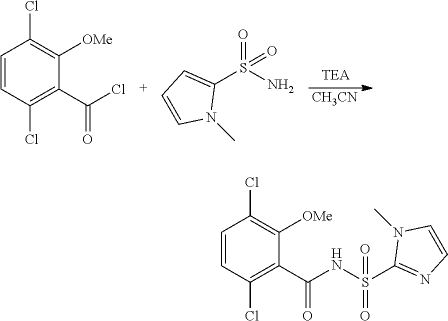

1-methyl-1H-pyrrole-2-sulfonamide (0.32 g, 2 mmol) was dissolved in MeCN (10 mL). TEA (1 mL, 7.2 mmol) and 3,6-dichloro-2-methoxybenzoyl chloride (0.6 g, 2.5 mmol) were added and the resulting mixture was stirred at RT overnight. Water (20 mL) was added, followed by DCM (40 mL). The organic layer was separated, washed with brine, dried over Na₂SO₄ and concentrated in vacuo to give the crude product which was purified by flash column chromatography (silica gel; gradient elution 0-10% MeOH:DCM) to give the title compound as an off-white solid (0.22 g, 0.60 mmol, 30%). ¹H NMR (CDCl₃): δ 7.76 (s, 1H), 7.59 (s, 1H), 7.47-7.49 (d, J=8 Hz, 1H), 7.24-7.26 (d, J=8 Hz, 1H), 4.05 (s, 1H), 3.74 (s, 3H). LC-MS: m/z 363.93 (M+1).

### Example 47

### Synthesis of 2-((3,6-dichloro-2-methoxybenzoyl)oxy)-N,N,N-trimethylethanaminium chloride

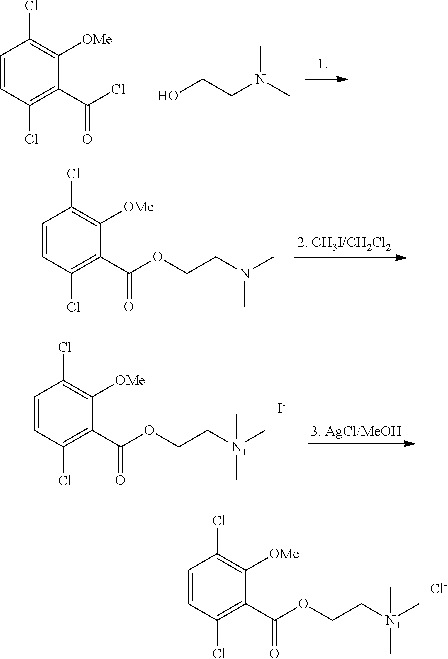

2-(dimethylamino) ethanol (2 mL, 20 mmol) was dissolved in chloroform (50 mL). NMM (3.3 mL, 30 mmol) and 3,6-dichloro-2-methoxybenzoyl chloride (5.8 g, 25 mmol) were then added and the resulting mixture was stirred at room temperature for 30 h. Water was added (30 mL), followed by DCM (30 mL). The organic layer was separated, washed with brine, dried over Na₂SO₄ and concentrated in vacuo to yield the crude product which was purified by flash column chromatography (silica gel; gradient elution 0-20% EtOAC:hexanes) to give 2-(dimethylamino) ethyl 3,6-dichloro-2-methoxybenzoate (A) as an off-white solid (2.9 g). A (0.59 g, 2 mmol) was dissolved in CH₂Cl₂ (25 mL). Iodomethane (0.15 mL, 2.4 mmol) was then added and the resulting mixture was stirred at RT for 3 h. The mixture was then concentrated in vacuo. Diethyl ether was added and the resulting solid was collected by filtration and air-dried to give 2-((3,6-dichloro-2-methoxybenzoyl) oxy)-N,N,N-trimethylethanaminium iodide (B) as a yellow solid (0.8 g, 92%). The product was mixed with MeOH (10 mL) and AgCl (0.6 g, 4.2 mmol) was added. The resulting mixture was stirred at room temperature overnight. The mixture was then passed through a Celite pad, concentrated, and diluted with diethyl ether. The resulting solid was collected by filtration and air-dried to give the title compound as an off-white solid (0.45 g, 1.3 mmol, 69%). ¹H-NMR (CD₃OD): δ 7.57-7.60 (d, J=10 Hz, 1H), 7.31-7.33 (d, J=8 Hz, 1H), 4.90-4.92 (m, 2H), 3.95 (s, 3H), 3.91 (m, 2H) 3.28 (s, 9H). LC-MS: m/z 306.15 (M+1).

### Example 48

### Volatility of Compounds Measured by Thermogravimetric Analysis (TGA).

Briefly, the rate of weight loss measured in units of □g/min can be used to determine vapor pressure as shown by the simplified equation:

$$\frac{- d m}{dt} = k * A$$

wherein, k is the intrinsic volatility and A is the surface area,

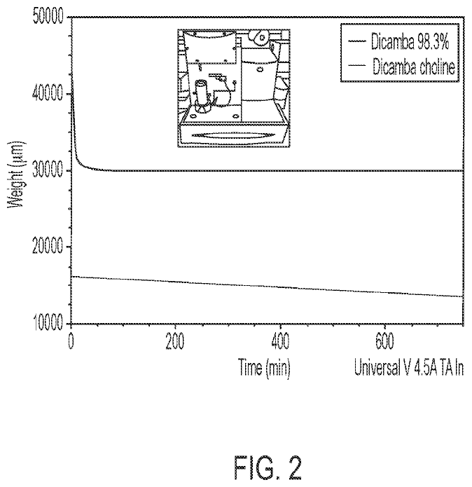

Referring now to FIG. 2. A graph of weight loss as function of time for solid samples produces a linear curve; the slope of the curve is the rate of weight loss. When this method is used to measure the volatility of aqueous salt concentrates or liquid concentrates, the water or acetone present in the sample volatilizes before the sample of interest. The first linear loss region of the curve is the loss of water or acetone and the second linear region is characteristic of the sample of interest.

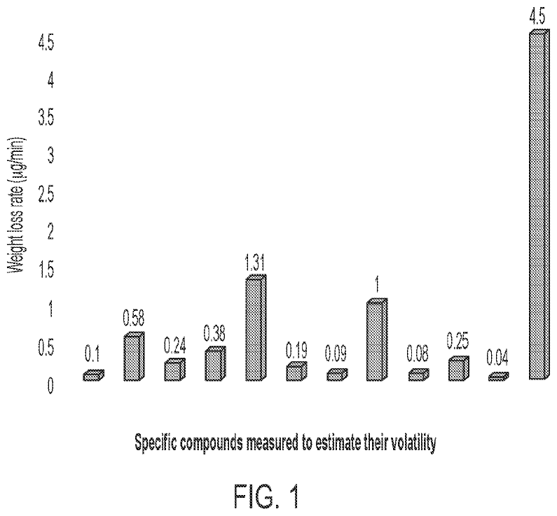

In order to illustrate the difference in volatility between some of the compounds disclosed herein and the widely used herbicide dicamba, data from both the compounds and dicamba are presented Table 3 and in FIG. 1.

### Example 49

### Postemergence Application Methods for Herbicide Evaluations

Plants were grown in a soil media composed of 90% by volume Promix BX (Premier Tech Horticulture, Quakertown, PA) and 10% Profile Greens Grade (Profile Products LLC, Buffalo Grove, IL). Promix BX contains approximately 83% Sphagnum Peat Moss, 13% Perlite, 5% vermiculite, and proprietary amounts of limestone, starter fertilizer, and wetting agent. Profile Greens Grade is a sand-sized granule formed from calcining illite and montmorillonite clay. Several seeds of each species were planted in 10 cm square pots and top watered twice daily. Plant material was propagated in a warm greenhouse with temperature ranging from 25 to 28° C. and 50 to 60% relative humidity at the Corteva Global Headquarters (Indianapolis, Indiana, USA). Natural light was supplemented with 1000-watt metal halide overhead lamps with an average illumination of 500 μE m⁻² s⁻¹ photosynthetic active radiation for 16 consecutive hours each day. Plants were top-watered prior to herbicide application and sub-watered after herbicide application.

Appropriate amounts of test materials were weighed out into glass vials in their technical form to deliver either 140 or 280 g acid equivalent (ae)/ha. The samples were dissolved in 3 ml of Solvent 1. Solvent 1 is 97% acetone and 3% dimethyl sulfoxide and serves as a general-purpose solvent (GPS) for dissolving technical materials. If samples did not readily dissolve, the sample bottles were placed in hot water and sonicated for 20 minutes. This typically resulted in the test material being thoroughly dissolved. The samples were then diluted to their final concentration using 17 ml of solvent 2 for a total of 20 ml of spray solution. Solvent 2 contains 41.58% GPS, 45.53% water, 11.88% isopropyl alcohol, 0.99% crop oil concentrate and 0.02% Trition X-155 surfactant. All percentages are listed on a volume basis. Dicamba diglycolamine was applied as a formulated herbicide, Clarity™ and diluted with solvent 2 to compare all materials in the same spray solution.

Herbicide applications were made to 3 to 4 replicates of each plant species at the 2 to 8 leaf stage, depending on the species. Treatments were applied with a research track-sprayer (Generation III Research Sprayer manufactured by DeVries Manufacturing in Hollandale, MN, USA) calibrated to deliver a spray volume of 187 L/ha. The track-sprayer was fitted with an 8003E nozzle from Spray Systems Company (North Avenue and Schmale Road, P.O. Box 7900, Wheaton, IL 60187), and used a spray pressure of 276 kPa pressure and a speed of 3.1 km/h. The nozzle height was 46 cm above the plant canopy. The experimental design used for the trials was a randomized complete block with 3 or 4 replications per treatment. After application, plants were placed on carts according to the randomization and returned to the greenhouse. Plants were sub-watered after treatment with Indianapolis city water or fertilized three times a week with a commercial fertilizer solution (Jack's Professional 15-5-15 4 Ca 2 Mg fertilizer (manufactured by JR PETERS INC., 6656 Grant Way, Allentown, PA 18106; www.jrpeters.com). Percent visual control assessments were made on a scale of 0 to 100% (where 0 was no control and 100 was complete plant death) at 7, 14, and 21 days after treatment.

### Example 50

Measuring the Effect of Representative Experimental Compounds on the Growth of Amaranthus rudis.

In conformity with the methods outlined in Example 49, the effect of representative experimental compounds on the growth of Amaranthus rudis (AMATA), common name tall water hemp, was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control. Referring now to Table 3 and FIG. 2, some of the compounds tested demonstrated a significant effect on the growth of this common species of weed.

### Example 51

Measuring the Effect of Representative Experimental Compounds on the Growth of Ambrosia artemisiifolia

In conformity with the methods outlined in Example 49, the effect of representative experimental compounds on the growth of Ambrosia artemisiifolia (AMBEL), (common ragweed), was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control. Referring now to Table 4, some of the compounds tested demonstrated a significant effect on the growth of this common species of weed.

### Example 52

Measuring the Effect of Representative Experimental Compounds on the Growth of Kochia scoparia

In conformity with the methods outlined in Example 49, the effect of representative experimental compounds on the growth of Kochia scoparia (KCHSC) was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control. Referring now to Table 4, some of the compounds tested demonstrated a significant effect on the growth of this common species of weed.

### Example 53

Measuring the Effect of Representative Experimental Compounds on the Growth of Amaranthus palmeri

In conformity with the methods outlined in Example 49, the effect of representative experimental compounds on the growth of Amaranthus palmeri (AMAPA), common name, Palmer amaranth, was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control. Referring now to Table 4, some of the compounds tested demonstrated a significant effect on the growth of this common species of weed.

### Example 54

Measuring the Effect of Representative Experimental Compounds on the Growth of Conyza canadensis (L.)

In conformity with the methods outlined in Example 49, the effect of representative experimental compounds on the growth of Conyza canadensis (L.), (ERICA), common name, Horseweed, was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control. Referring now to Table 4, some of the compounds tested demonstrated a significant effect on the growth of this common species of weed.

### Example 55

1. Measuring the Effect of Representative Experimental Compounds on the Growth of Glycine max

In conformity with the methods outlined in Example 49, the effect of representative experimental compounds on the growth of Glycine max was determined at 2 different levels (respectively, 140 and 280 g acid equivalent (ae)/ha) of the experimental actives tested. Plants were treated with one of the compounds, a control plant was not treated. Twenty-one days after treatment, the plants were measured. The data is present as a percent reduction in plant size relative to the untreated control.

### Example 56

### Synthesis of (E)-benzaldehyde O-(3,6-dichloro-2-methoxybenzoyl) oxime (Compound 3a)

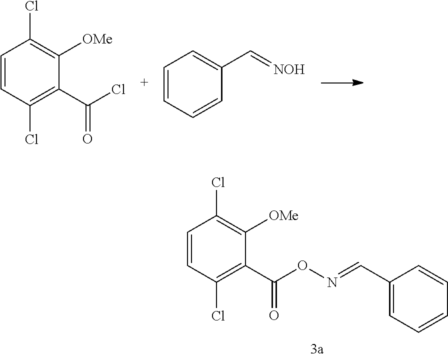

Benzaldehyde oxime (0.36 g, 3.0 mmol) was dissolved with CHCl₃ (10 mL). NMM (1 mL, 9.0 mmol) and 3,6-dichloro-2-methoxybenzoyl chloride (0.6 g, 5.0 mmol) were added and the reaction mixture was heated to 50° C. for 2 h. The reaction mixture was then cooled to RT and water (10 mL) and DCM (10 mL) were added. The organic layer was separated and washed with brine, dried over Na₂SO₄ and concentrated in vacuo to give the crude product, which was purified by flash column chromatography (silica gel; gradient elution 0-10% EtOAc:hexanes) to give Compound 3a as an colorless oil (0.31 g. 0.96 mmol, 32%). ¹H NMR (CDCl₃): δ 8.49-8.50 (d, J=4 Hz, 1H), 7.79-7.81 (d, J=8, 1H), 7.62-7.81 (dd, J=40 Hz, 1H), 7.43-7.54 (m, 3H), 7.17-7.22 (td, J=8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. LCMS: m/z 345.9 (M+Na).

### Example 57

### Synthesis of Nicotinaldehyde O-(3,6-dichloro-2-methoxybenzoyl) oxime (Compound 3b)

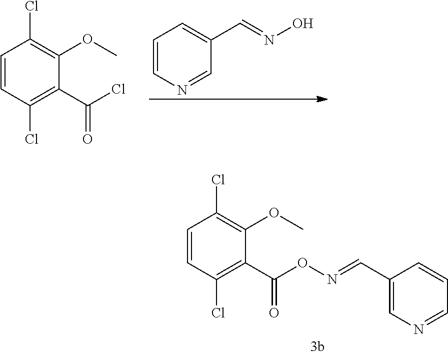

Nicotinaldehydeoxime (0.83 g, 8.3 mmol, 1.0 eq; CAS #1193-92-6) and THE (30 mL) were added to a flame-dried 50 mL RBF to yield a homogenous solution. DIPEA (1.31 g, 12.0 mmol, 1.5 eq) was added and the reaction mixture was cooled to 0° C. A solution of 3,6-dichloro-2-methoxybenzoyl chloride (2.0 g, 8.3 mmol, 1.0 eq) in THE (5 mL) was added and the resultant mixture was stirred for 16 h at RT. After this time, TLC indicated that the reaction was complete. The reaction mixture was poured into ice/water (50 mL) and extracted with EtOAc (100 mL). The organic extract was washed with a saturated NaHCO₃ solution (20 mL), followed by brine (20 mL), dried over Na₂SO₄ and concentrated in vacuo to yield the crude product. Purification by flash column chromatography (silica gel; gradient elution: 5-40% EtOAc in hexanes) yielded Compound 3b as a tan-coloured solid (0.3 g, 0.92 mmol, 11%). ¹H NMR (400 MHz, CDCl₃) δ 8.91-8.86 (m, 1H), 8.77 (d, J=5.5 Hz, 1H), 8.54 (s, 1H), 8.28-8.21 (m, 1H), 7.50-7.40 (m, 2H), 7.21 (d, J=8.7 Hz, 1H), 4.01 (s, 3H).

### Example 58

### Synthesis of 3,6-dichloro-2-methoxyphenyl)({(E)-[(furan-2-yl)methylidene]amino}oxy)methanone (Compound 3c)

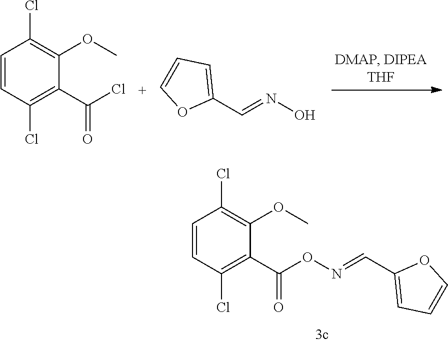

2-Furaldehyde oxime (0.40 g, 3.6 mmol) and 15 mL of anhydrous THE (15 mL) were added to a flame-dried 50 mL RBF. DMAP (0.044 g, 0.36 mmol) and DIPEA (0.46 g, 3.6 mmol) were then added and the mixture was stirred at 0° C. 3,6-Dichloro-2-methoxybenzoyl chloride (0.87 g, 3.6 mmol) was added dropwise to the mixture which was stirred at 0° C. for 30 min. and then allowed to warm to RT and stirred for a further 8 h. HCl (1 M, 30 mL) was added and the mixture was extracted with DCM (3×50 mL). The combined organic extracts were dried over Na₂SO₄ and concentrated in vacuo to give the crude product which was purified by flash column chromatography (silica gel; eluting with 10-15% EtOAc:hexane) to yield Compound 3c as a colorless solid (0.45 g, 1.4 mmol, 39%). ¹H NMR (400 MHz, CDCl₃) δ 9.12 (s, 1H), 7.61 (d, J=1.8 Hz, 1H), 7.42 (d, J=8.6 Hz, 1H), 7.33 (d, J=3.6 Hz, 1H), 7.18 (d, J=8.7 Hz, 1H), 6.63 (dd, J=3.7, 1.8 Hz, 1H), 3.94 (s, 3H).

### Example 59

### Synthesis of (E)-2-oxopropanal O-(3,6-dichloro-2-methoxybenzoyl) oxime (Compound 3d)

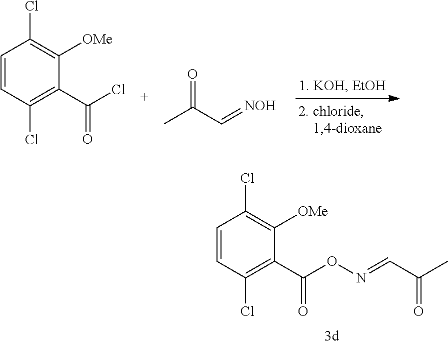

1-(Hydroxyimino)propan-2-one (1.72 g, 20.0 mmol) was dissolved in ethanol (10 mL) followed by the addition of KOH (1.34 g, 24.0 mmol). The mixture was stirred at RT for 1 h and then concentrated in vacuo to give a yellow solid (2.3 g), 0.6 g of which was dissolved in 1,4-dioxane (5 mL). 3,6-dichloro-2-methoxybenzoyl chloride (1.6 g, 6.7 mmol) was added and the resultant mixture was stirred at RT for 18 h. Water was added and the mixture was extracted with EtOAc (50 mL). The combined organic extracts were washed with brine, dried over Na₂SO₄, and concentrated to give the crude product which was purified by flash column chromatography (silica gel; gradient elution 0-15% EtOAc:hexanes) to give Compound 3d as a colorless solid (0.43 g, 1.48 mmol, 29%). ¹H-NMR (CDCl₃): δ 7.77 (s, 1H), 7.79-7.81 (d, J=8, 1H), 7.46-7.48 (dd, J=8 Hz, 1H), 7.19-7.22 (dd, J=6 Hz, 1H), 3.98 (s, 3H), 2.57 (s, 3H). ¹³C-NMR (CDCl₃): 26.2, 63.5, 126.0, 126.9, 127.7, 130.2, 133.0, 154.0, 154.5, 161.4, 195.1.

### Example 60

### Synthesis of butan-2-one O-(3,6-dichloro-2-methoxybenzoyl) oxime (Compound 3e)

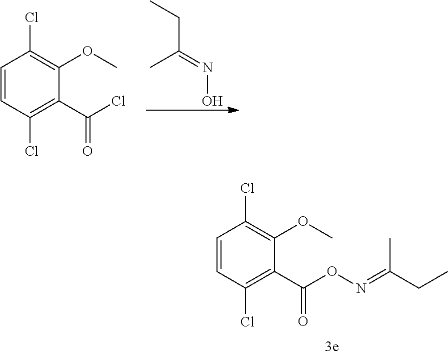

2-Butanoneoxime (0.3 g, 4.1 mmol, 1.0 eq; CAS #96-29-7) and THE (15 mL) were added to a flame-dried 50 mL RBF to form a homogenous solution. DIPEA (0.66 g, 6.2 mmol, 1.5 eq) was added and the mixture was cooled to 0° C. 3,6-Dichloro-2-methoxybenzoyl chloride (1.0 g, 4.1 mmol, 1.0 eq) in THE (3 mL) was added and the resultant mixture was stirred at RT for 16 h. After this time TLC indicated that the reaction was complete. The reaction mixture was poured into ice/water (25 mL) and then extracted with EtOAc (50 mL). The organic extract was washed with a sat. NaHCO₃ solution (20 mL) followed with brine (20 mL), dried over Na₂SO₄, and concentrated in vacuo to give the crude product. Purification by flash column chromatography (silica gel; gradient elution: 5-40% EtOAc:hexanes) to give Compound 3e as a colorless solid (0.3 g, 25%). ¹H NMR (400 MHz, CDCl₃) δ 7.40 (d, J=8.7 Hz, 1H), 7.16 (d, J=8.6 Hz, 1H), 3.97 (s, 3H), 2.45 (q, J=7.5 Hz, 2H), 2.04 (s, 3H), 1.21 (t, J=7.5 Hz, 3H).

### Example 61

### Synthesis of 3,6-dichloro-2-methoxyphenyl){[(E)-(3,3-dimethylbutan-2-ylidene)amino]oxy}methanone (Compound 3f)

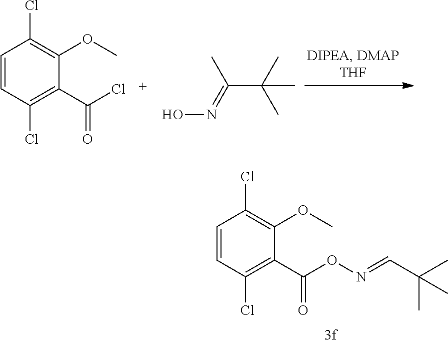

(E)-3,3-dimethylbutan-2-one oxime (0.21 g, 2.1 mmol) and anhydrous THE (15 mL) were added to a flame-dried 50 mL RBF. DMAP (0.025 g, 0.21 mmol) and DIPEA (0.27 g, 2.1 mmol) were added and the mixture was stirred at 0° C. 3,6-Dichloro-2-methoxybenzoyl chloride (0.50 g, 2.1 mmol) was added dropwise and the mixture was stirred at 0° C. for a further 30 min. and then allowed to warm to RT and stirred for 8 h. HCl (1 M, 30 mL) was then added and the mixture was extracted with DCM (3×50 mL). The combined organic extracts were dried over Na₂SO₄ and concentrated in vacuo to give the crude product which was purified by flash column chromatography (eluting with 10-15% EtOAc in hexane) to give Compound 3f as a colorless solid (0.39 g, 1.2 mmol, 57%). ¹H NMR (400 MHz, CDCl₃) δ 7.40 (d, J=8.6 Hz, 1H), 7.16 (d, J=8.6 Hz, 1H), 3.97 (s, 3H), 2.01 (s, 3H), 1.22 (s, 10H).

### Example 62

### Synthesis of 3,6-dichloro-2-methoxyphenyl)({(E)-[(furan-2-yl)methylidene]amino}oxy) methanone (Compound 3g)

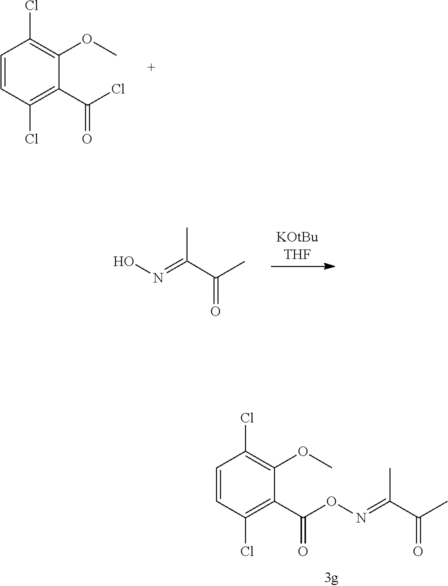

2,3-Butanedione 2-monoxime (0.21 g, 2.0 mmol) and anhydrous THE (7 mL) were added to a 50 mL RBF cooled to 5° C. KO^{t}Bu (0.68 g, 6.1 mmol) was then added and the mixture was stirred for 15 min. The reaction mixture was heated to 30° C. and then stirred at RT. 3,6-Dichloro-2-methoxybenzoyl chloride (0.63 g, 6.1 mmol) was dissolved in anhydrous THE (3 mL) and the resultant solution was added dropwise to the reaction mixture. The reaction mixture was stirred at RT for a further 2 h. The reaction mixture was filtered under vacuum and the filtrate concentrated in vacuo. The crude product was purified by flash column chromatography (silica gel; gradient elution 5-10% EtOAc:hexanes) to give Compound 3g as a colorless solid (0.26 g, 0.85 mmol, 43%). ¹H NMR (400 MHz, CDCl₃) δ 7.47 (d, J=8.7 Hz, 1H), 7.21 (d, J=8.7 Hz, 1H), 3.99 (s, 3H), 2.53 (s, 3H), 2.14 (s, 3H).

### Example 63

### Synthesis of methyl N-[(3,6-dichloro-2-methoxybenzoyl)oxy] benzenecarboximidate (Compound 3h)

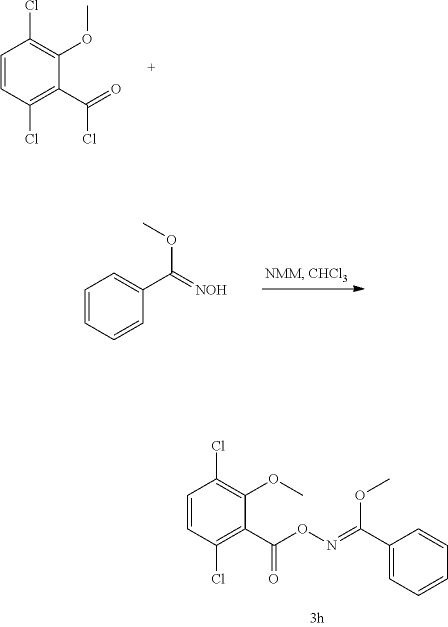

Methyl N-hydroxybenzimidate (0.25 g, 1.6 mmol) and chloroform (15 mL) were added to a flame-dried 50 mL RBF. NMM (0.26 g, 2.0 mmol) and 3,6-dichloro-2-methoxybenzoyl chloride (0.4 g, 1.6 mmol) were then added and the reaction mixture was stirred at RT for 6 h. The mixture was then concentrated in vacuo to give the crude product which was purified by flash chromatography (silica gel; gradient elution: 5-10% EtOAc:hexane) to give Compound 3h as a colorless solid (0.24 g, 0.67 mmol, 42%). ¹H NMR (400 MHz, DMSO) δ 7.77-7.61 (m, 4H), 7.61-7.54 (m, 2H), 7.47 (dd, J=8.7, 2.1 Hz, 1H), 3.92 (s, 3H), 3.87 (s, 3H).

### Example 64

### Synthesis of ethyl N-(3,6-dichloro-2-methoxybenzoyl)oxyacetimidate) (Compound 3i)

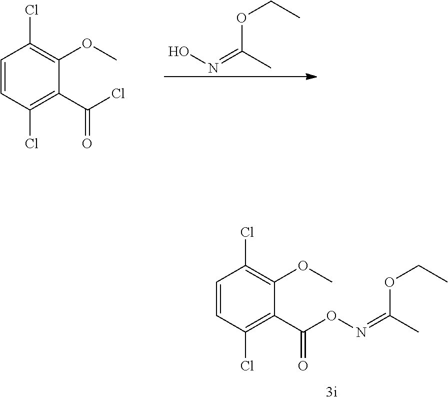

Ethyl N-hydroxyacetimidate (1 g, 10.0 mmol, 1.2 eq; CAS #10576-12-2) and THE (30 mL) were added to a flame-dried 50 mL RBF to form a homogenous solution. DIPEA (1.6 g, 12.5 mmol, 1.5 eq) was then added and the mixture was cooled to 0° C. A solution of 3,6-dichloro-2-methoxybenzoyl chloride (2.0 g, 8.3 mol, 1.0 eq) in THE (5 mL) was then added and the resultant mixture was stirred for 16 ch at RT. After this time TLC indicated only a faint new spot; no change was observed after stirring for an additional 16 h. The reaction mixture was poured into ice/water (50 mL) and then extracted with EtOAc (100 mL). The organic extract was washed with a sat. NaHCO₃ solution (20 mL) followed with brine (20 mL) and then dried over Na₂SO₄ and concentrated in vacuo to give the crude product. Purification by flash column chromatography (silica gel; gradient elution: 5-20% EtOAc in hexanes) gave Compound 3i as a colorless solid (0.3 g, 0.98 mmol, 12%). ¹H NMR (400 MHz, CDCl₃) δ 7.41 (d, J=8.7 Hz, 1H), 7.16 (d, J=8.7 Hz, 1H), 4.27 (q, J=7.1 Hz, 2H), 3.97 (s, 3H), 2.11 (s, 3H), 1.36 (t, J=7.1 Hz, 3H).

### Example 65

### Synthesis of (Z)-methyl N-(3,6-dichloro-2-methoxybenzoyl)oxybenzimidothioate (Compound 3j)

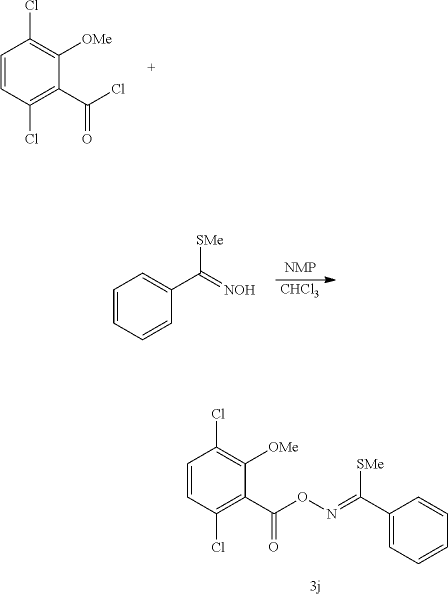

Methyl N-hydroxybenzimidothioate (0.26 g, 1.6 mmol) was dissolved in chloroform (10 mL) and then NMM (0.5 mL, 4.5 mmol) and 3,6-dichloro-2-methoxybenzoyl chloride (0.46 g, 2.0 mmol) were added. The resultant mixture was stirred at RT overnight. Water was added, followed by DCM. The organic phase was separated and then washed with brine, dried over Na₂SO₄ and concentrated in vacuo. The crude product obtained was purified by flash column chromatography (silica gel; gradient elution 0-80% DCM:hexanes) to give Compound 3j as a colorless solid (250 mg, 0.68 mmol, 44%). ¹H NMR (CDCl₃): δ 7.74-7.77 (d, J=12 Hz, 1H), 7.79-7.81 (d, J=8, 1H), 7.62-7.81 (dd, J=40 Hz, 1H), 7.43-7.54 (m, 3H), 7.17-7.22 (td, J=8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. LCMS: m/z 391.99 (M+Na).

### Example 66

### Synthesis (Z)-Methyl N-(3,6-dichloro-2-methoxybenzoyl)oxyethanimidothioate (Compound 3k)

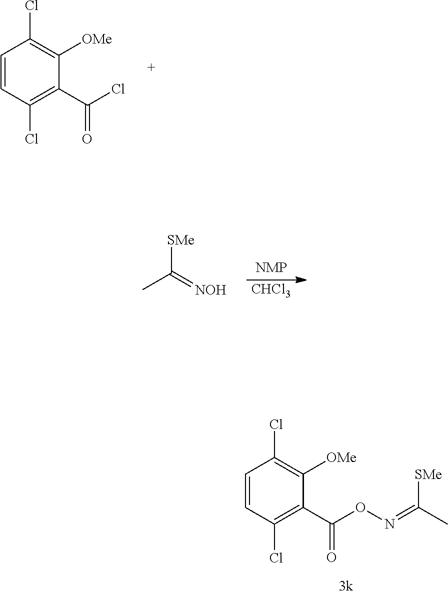

Methyl N-hydroxyethanimidothioate (10 mg, 0.1 mmol) was dissolved in chloroform (3 mL). NMM (5 drops) and 3,6-dichloro-2-methoxybenzoyl chloride (30 mg, 0.1 mmol) were added and the resultant mixture was stirred at RT for 18 h. Water was added followed by DCM and the organic layer was separated and washed with brine, dried over Na₂SO₄, and concentrated to give the crude product which was purified by flash column chromatography (silica gel; gradient elution 0-30% EtOAc:hexanes) to give Compound 3k as a colorless solid (23 mg, 0.07 mmol, 76%). ¹H NMR (400 MHz, CDCl₃): δ 7.40-7.43 (d, J=10 Hz, 1H), 7.15-7.18 (d, J=10 Hz, 1H), 3.98 (s, 3H), 2.42 (s, 3H), 2.38 (s, 3H). LC-MS: m/z 308.00 (M+1).

### Example 67

### Synthesis of N-((3,6-dichloro-2-methoxybenzoyl)oxy)benzimidoyl cyanide (Compound 31)

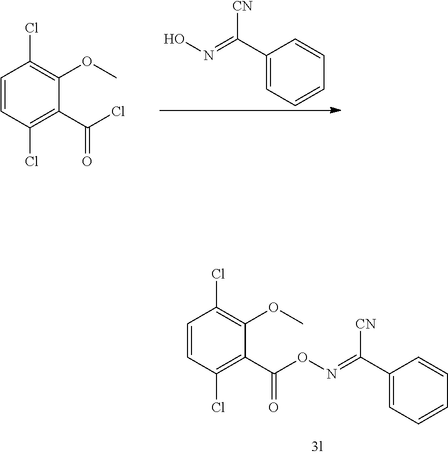 [SMILES: COc1c(Cl)ccc(Cl)c1C(=O)Cl ; N#C/C(=N\O)c1ccccc1 ; COc1c(Cl)ccc(Cl)c1C(=O)O/N=C(\C#N)c1ccccc1]

N-hydroxybenzimidoyl cyanide (0.55 g, 0.0050 mol, 1.2 eq; CAS #825-52-5) and THE (15 mL) were added to a flame-dried 50 mL RBF to form a homogeneous solution. DIPEA (0.80 g, 0.0062 mol, 1.5 eq) was then added and the mixture was cooled to 0° C. A solution of 3,6-dichloro-2-methoxybenzoyl chloride (1.0 g, 0.0041 mole, 1.0 eq) in THE (5 mL) was then added and the resultant mixture was stirred for 16 h at RT. After this time, TLC indicated that a new spot was present. The reaction mixture was then poured into ice/water (25 mL) and extracted with EtOAc (50 mL). The organic extract was washed with a NaHCO₃ solution (20 mL) followed by brine (20 mL), dried over Na₂SO₄, and concentrated in vacuo to give the crude product which was purified by flash column chromatography (silica gel; gradient elution 5-40% EtOAc:hexanes) to yield Compound 31 as a pale yellow solid (0.50 g, 1.4 mmol, 34%). ¹H NMR (400 MHz, CDCl₃) δ 8.04 (dt, J=7.2, 1.4 Hz, 2H), 7.69-7.53 (m, 3H), 7.50 (d, J=8.7 Hz, 1H), 7.24 (d, J=8.7 Hz, 1H), 4.04 (s, 3H).

### Example 68

### Synthesis of (E)-ethyl 2-cyano-2-(((3,6-dichloro-2-methoxybenzoyl)oxy)imino)acetate (Compound 3m)

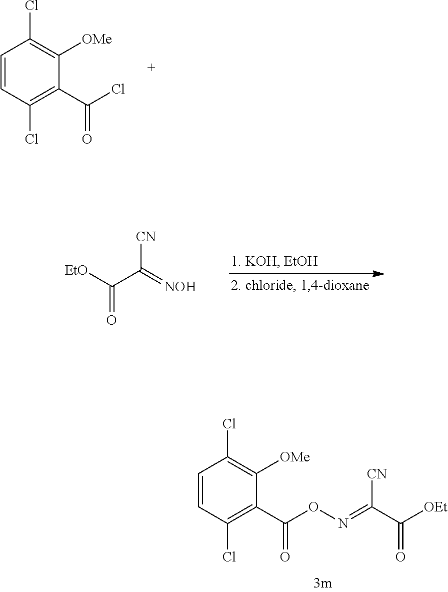

Ethyl 2-cyano-2-(hydroxyimino)acetate (1.41 g, 10 mmol) was dissolved in EtOH (15 mL) and KOH (0.6 g, 10.7 mmol) was then added. The mixture was stirred at RT for 1 h and then concentrated in vacuo to give a yellow solid which was washed with cold EtOH and air-dried to give 0.45 g of a yellow solid. This was dissolved in 1,4-dioxane (10 mL) and 3,6-dichloro-2-methoxybenzoyl chloride (0.89 g, 3.8 mmol) was added. The resulting mixture was stirred at RT overnight. Water was added (30 mL) and the mixture was extracted with EtOAc (30 mL). The organic extract was washed with brine, dried over Na₂SO₄ and concentrated in vacuo to give the crude product which was purified by flash column chromatography (silica gel; gradient elution: 0-15% EtOAc:hexanes) to give Compound 3m as a colorless solid (0.33 g, 0.96 mmol, 10%). ¹H-NMR (400 MHz, CDCl₃): δ 7.50-7.53 (d, J=10, 1H), 7.22-7.25 (d, J=8 Hz, 1H), 4.50-4.56 (q, 2H), 4.00 (s, 3H), 1.44-1.48 (t, 3H).

### Example 69

### Synthesis of diethyl 2-(((3,6-dichloro-2-methoxybenzoyl)oxy)imino)malonate (Compound 3n)

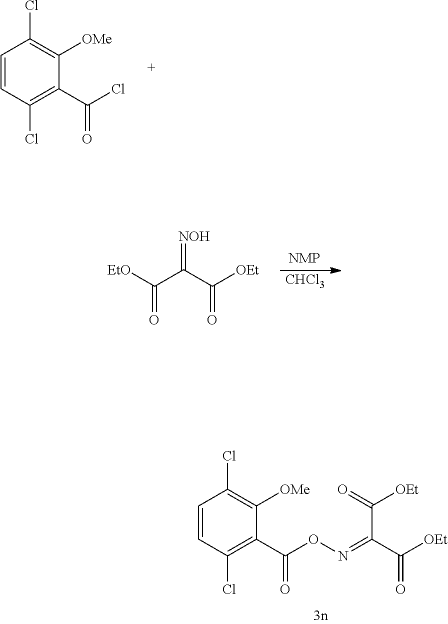

Diethyl 2-(hydroxyimino)malonate (0.57 g, 3 mmol) was dissolved in CHCl₃ (15 mL). NMM (0.9 mL, 8.2 mmol) and 3,6-dichloro-2-methoxybenzoyl chloride (0.73 g, 3.1 mmol) were then added and the reaction mixture was stirred at RT overnight. Water (15 mL) was added, followed by DCM (15 mL). The organic layer was separated, washed with brine, dried over Na₂SO₄ and concentrated in vacuo to give the crude product which was purified by flash column chromatography (silica gel; gradient elution 0-20% EtOAc:hexanes) to give Compound 3n as an colorless oil (0.4 g, 1.0 mmol, 34%). ¹H-NMR (CDCl₃): δ 7.44-7.47 (d, J=10 Hz, 1H), 7.16-7.19 (d, J=10 Hz, 1H), 4.43-4.49 (q, 2H), 4.37-4.42 (q, 2H), 3.95 (s, 3H), 1.40-1.45 (t, 3H), 1.29-1.33 (t, 3H). LC-MS: m/z 414.17 (M+Na).

### Example 70

### Synthesis of N-((3,6-dichloro-2-methoxybenzoyl)oxy)benzamide (Compound 4a)

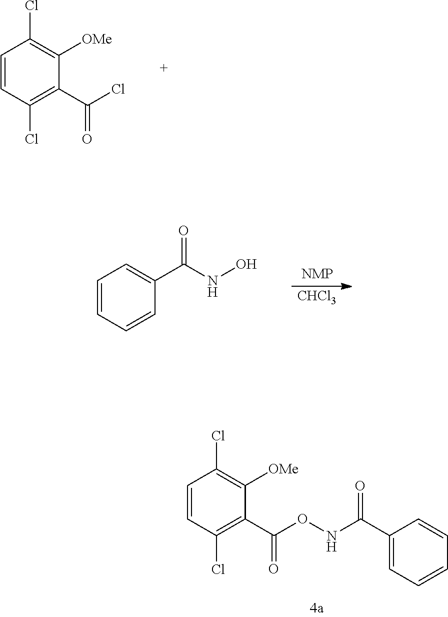

N-hydroxybenzamide (0.28 g, 2 mmol) was dissolved in chloroform (10 mL). NMM (0.24 g, 2.4 mmol) and 3,6-dichloro-2-methoxybenzoyl chloride (0.48 g, 2 mmol) were then added. The reaction mixture was stirred at RT overnight. Water (10 mL) was then added followed by DCM (10 mL). The organic layer was separated, washed with brine, dried over Na₂SO₄ and concentrated in vacuo to give the crude product which was purified by flash column chromatography (silica gel; gradient elution 0-30% EtOAc:hexanes) to give Compound 4a as a colorless solid (0.33 g, 0.97 mmol, 49%). ¹H-NMR (CDCl₃): δ 9.77 (s, 1H), 7.92-7.94 (d, J=8 Hz, 2H), 7.62-7.64 (t, 1H), 7.51-7.55 (t, 2H), 7.47-7.50 (d, J=6 Hz, 1 h), 7.20-7.23 (d, J=4 Hz, 1H), 4.07 (s, 3H). LC-MS: m/z 340.00 (M+1).

### Example 71

### Synthesis of N-((3,6-dichloro-2-methoxybenzoyl)oxy)nicotinamide (Compound 4b)

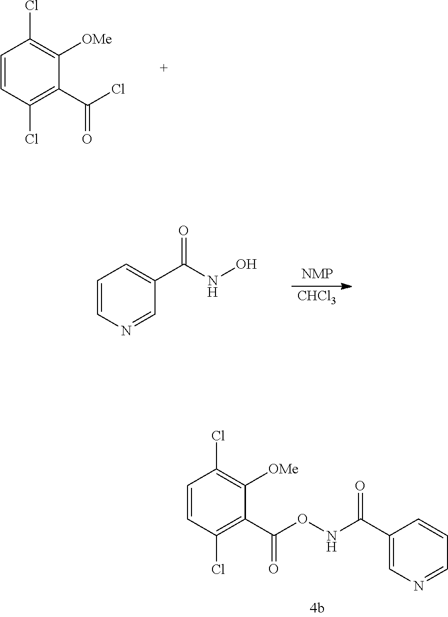

N-hydroxynicotinamide (0.41 g, 3 mmol) was dissolved in chloroform (10 mL). NMM (0.36 mL, 3.3 mmol) and 3,6-dichloro-2-methoxybenzoyl chloride (0.72 g, 3 mmol) were then added. The reaction mixture was stirred at RT overnight. Water was added (10 mL), followed by DCM (10 mL) and the organic layer was separated. The organic layer was washed with brine, dried over Na₂SO₄ and concentrated in vacuo to give the crude product which was purified by flash column chromatography (silica gel; gradient elution eluent 0-15% EtOAC:hexanes) to give Compound 4b as an off-white solid (0.30 g, 0.88 mmol, 29%). ¹H-NMR (CDCl₃): δ 9.16 (s, 1H), 9.86 (s, 1H), 8.25-8.27 (d, J=8 Hz, 1H), 7.49-7.52 (d, J=6 Hz, 2H), 7.21-7.24 (d, J=6 Hz, 1H), 4.07 (s, 3H). LC-MS: m/z 341.06 (M+1).

### Example 72

### Synthesis of N-((3,6-dichloro-2-methoxybenzoyl)oxy)acetamide (Compound 4c)

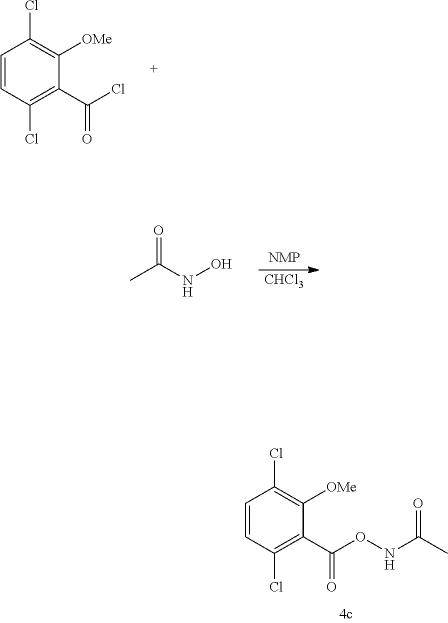

N-hydroxyacetamide (0.38 g, 5 mmol) was dissolved in chloroform (10 mL). NMM (0.7 mL, 6.4 mmol) and 3,6-dichloro-2-methoxybenzoyl chloride (1.2 g, 5 mmol) were then added. The reaction mixture was stirred at RT overnight. Water (10 mL) was added followed by DCM (10 mL) and the organic layer was separated. The organic layer was washed by brine, dried over Na₂SO₄ and concentrated in vacuo. The crude material was purified by flash column chromatography (silica gel; gradient elution 0-50% EtOAc:hexanes) to give Compound 4c as an off-white solid (0.40 g, 1.4 mmol, 29%). ¹H-NMR (CDCl₃): δ 9.16 (s, 1H), 7.45-7.47 (d, J=8 Hz, 1H), 7.17-7.20 (d, J=10 Hz, 1H), 3.99 (s, 3H), 2.17 (s, 3H). LC-MS: m/z 277.82 (M+1).

### Example 73

### Synthesis of N-((3,6-dichloro-2-methoxybenzoyl)oxy)hexanamide (Compound 4d)

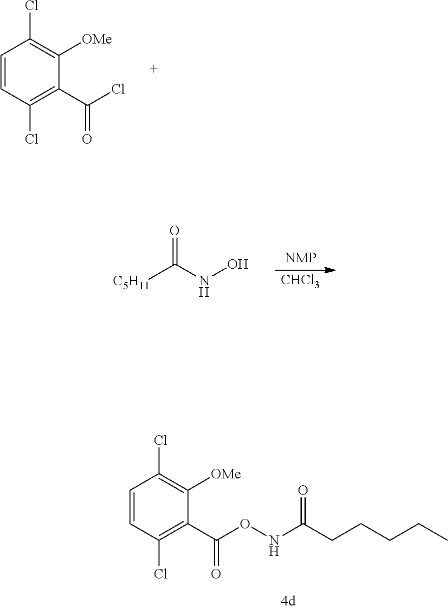

N-hydroxyhexanamide (0.26 g, 2 mmol) was dissolved in chloroform (10 mL). NMM (0.3 mL, 2.6 mmol) and 3,6-dichloro-2-methoxybenzoyl chloride (0.47 g, 2.2 mmol) were then added. The reaction mixture was stirred at RT for 3 hrs. after which time water (10 mL) was added, followed by DCM (10 mL). The organic layer was separated, washed with brine, dried over Na₂SO₄ and concentrated in vacuo to give the crude product which was purified by flash column chromatography (silica gel; gradient elution 0-15% EtOAc:hexanes) to give Compound 4d as an off-white solid (0.35 g, 1.0 mmol, 52%). ¹H-NMR (CDCl₃): δ 9.09 (s, 1H), 7.45-7.48 (d, J=12 Hz, 1H), 7.18-7.20 (d, J=8 Hz, 1H), 4.01 (s, 3H), 2.35-2.39 (m, 2H), 1.77 (s, 2H), 1.37-1.40 (m, 4H), 0.94-0.95 (s, 3H) LC-MS: m/z 333.98 (M+1).

### Example 74

### Synthesis of N-((3,6-dichloro-2-methoxybenzoyl)oxy)-N-methylbenzamide (Compound 4f)

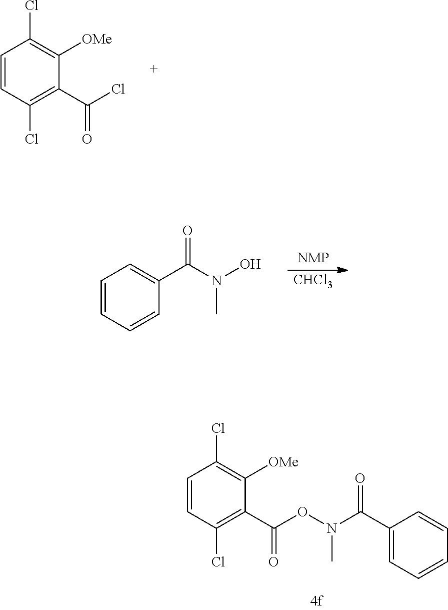

N-hydroxy-N-methylbenzamide (0.45 g, 3 mmol) was dissolved in chloroform (15 mL). NMM (0.9 mL, 3.3 mmol) and 3,6-dichloro-2-methoxybenzoyl chloride (0.72 g, 3 mmol) were then added. The reaction mixture was stirred at RT overnight. Water (15 mL) was added followed by DCM (15 mL). The organic layer was separated, washed with brine, dried over Na₂SO₄ and concentrated in vacuo to give the crude product which was purified by flash column chromatography (silica gel; gradient elution 0-30% EtOAc:hexanes) to give Compound 4f as an off-white solid (0.25 g, 0.71 mmol, 24%). ¹H-NMR (CDCl₃): δ 7.67-7.70 (d, J=10 Hz, 1H), 7.49-7.52 (t, 1H), 7.40-7.45 (m, 3H), 7.09-7.12 (d, J=10 Hz, 1H), 3.76 (s, 3H), 3.58 (s, 3H) LC-MS: m/z 353.92 (M+1).

### Example 75

### Synthesis of 1-((3,6-dichloro-2-methoxybenzoyl)oxy)urea (Compound 4g)

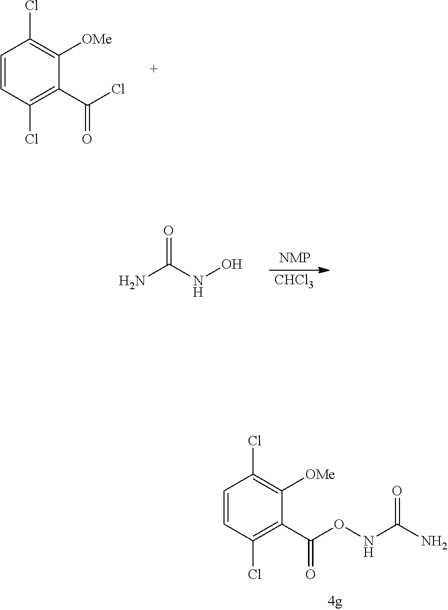

1-hydroxyurea (0.38 g, 5 mmol) was dissolved in chloroform (15 mL). NMM (1.2 mL, 6 mmol) and 3,6-dichloro-2-methoxybenzoyl chloride (1.2 g, 5 mmol) were then added. The reaction mixture was stirred at RT overnight. Water (15 mL) was added followed by DCM (15 mL). The organic layer was separated, washed with brine, dried over Na₂SO₄ and concentrated in vacuo to give the crude product which was purified by flash column chromatography (silica gel; gradient elution 0-30% EtOAc:hexanes) to give Compound 4g as an off-white solid (0.45 g, 1.6 mmol, 32%). ¹H-NMR (CDCl₃): δ 8.62 (s, 1H), 7.49-7.52 (d, J=8 Hz, 1H), 7.22-7.25 (d, J=10 Hz, 1H), 5.69 (s, 2H), 3.97 (s, 3H). LC-MS: m/z 278.93 (M+1).

### Example 76

### Synthesis of 1-((3,6-dichloro-2-methoxybenzoyl)oxy)-1-methyl-3-phenylurea (Compound 4h)

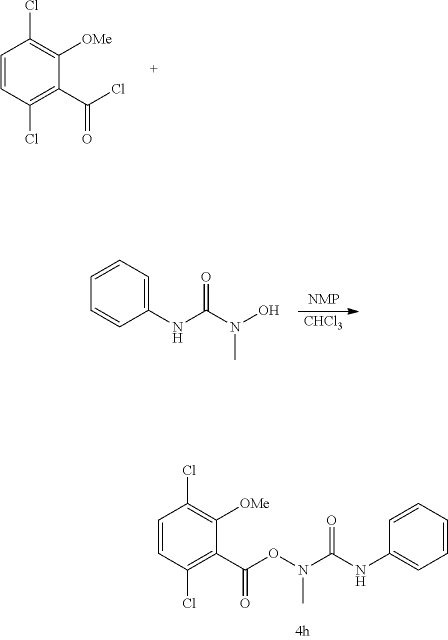

1-hydroxy-1-methyl-3-phenylurea (0.5 g, 3 mmol) was dissolved in chloroform (15 mL). NMM (1 mL, 3.3 mmol) and 3,6-dichloro-2-methoxybenzoyl chloride (0.72 g, 3 mmol) were then added. The reaction mixture was stirred at RT overnight. Water was added (15 mL), followed by DCM (15 mL). The organic layer was separated, washed with brine, dried over Na₂SO₄ and concentrated in vacuo to give the crude product which was purified by flash column chromatography (silica gel; gradient elution 0-30% EtOAc:hexanes) to give Compound 4h as an off-white solid (0.31 g, 0.84 mmol, 28%). ¹H-NMR (CDCl₃): δ 7.93 (s, 1H), 7.52-7.55 (d, J=10 Hz, 3H), 7.37-7.39 (t, 1H), 7.27-7.29 (d, J=10 Hz, 1H), 7.11-7.15 (t, J=8 Hz, 1H), 3.97 (s, 1H), 3.46 (s, 3H). LC-MS: m/z 368.94 (M+1).

### Example 77

### Synthesis of (3,6-dichloro-2-methoxyphenyl)[(diethylamino)oxy]methanone (Compound 5a)

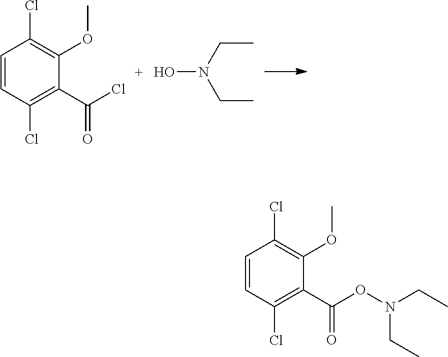

N,N-Diethyl hydroxylamine (0.37 g, 4.2 mmol) and chloroform (15 mL) were added to a flame-dried 50 mL RBF. NMM (0.64 g, 5.0 mmol) and 3,6-dichloro-2-methoxybenzoyl chloride (1 g, 4.2 mmol) were added and the reaction mixture was stirred at RT for 4 h. The mixture was then concentrated in vacuo to give the crude product which was purified by flash column chromatography (silica gel; gradient elution 12-16% EtOAc:hexanes) to give Compound 5a as a brown oil (0.51 g, 1.7 mmol, 40%). ¹H NMR (400 MHz, CDCl₃) δ 7.37 (d, J=8.6 Hz, 1H), 7.13 (d, J=8.7 Hz, 1H), 3.93 (s, 3H), 3.06 (q, J=7.1 Hz, 5H), 1.29 (t, J=7.1 Hz, 7H).

### Example 78

### Synthesis of 1-[(3,6-dichloro-2-methoxybenzoyl)oxy]piperidine (Compound 5b)

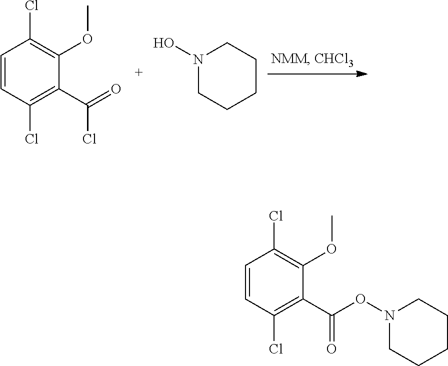

1-Hydroxypiperidine (0.25 g, 2.5 mmol) and chloroform (15 mL) were added to a flame-dried 50 mL RBF. NMM (0.38 g, 3.0 mmol) and 3,6-dichloro-2-methoxybenzoyl chloride (0.6 g, 2.5 mmol) were then added and the reaction mixture was stirred at RT for 4 h. The mixture was then concentrated in vacuo and the crude product was purified by flash column chromatography (silica gel; eluting with 10% EtOAc:hexanes) to give Compound 5b as a colorless solid (0.31 g, 1.0 mmol, 40%). ¹H NMR (400 MHz, CDCl₃) δ 7.38 (d, J=8.7 Hz, 1H), 7.14 (d, J=8.7 Hz, 1H), 3.96 (s, 3H), 3.60 (d, J=9.5 Hz, 2H), 2.79 (d, J=7.6 Hz, 1H), 1.89-1.80 (m, 4H), 1.71 (s, 1H), 1.28 (s, 2H).

### Example 79

### Synthesis of [(dibenzyl amino)oxy](3,6-dichloro-2-methoxyphenyl)methanone (Compound 5d)

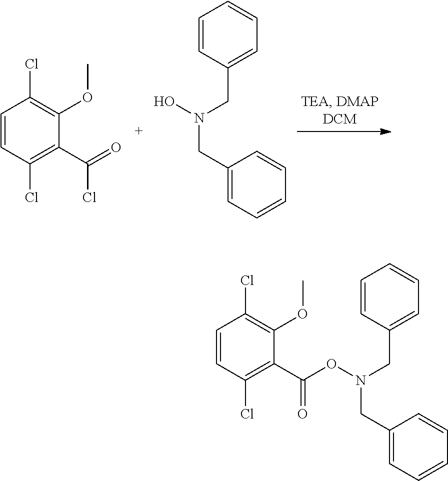

Dibenzyl hydroxylamine (0.50 g, 2.4 mmol) and anhydrous DCM (10 mL) were added to a flame-dried 50 mL RBF. DMAP (0.029 g, 0.24 mmol) and TEA (0.24 g, 2.4 mmol) were then added and the mixture was stirred at 0° C. 3,6-Dichloro-2-methoxybenzoyl chloride (0.57 g, 2.4 mmol) was added. The mixture was then allowed to warm to RT with stirring for a further 6 h. HCl (1 M, 30 mL) was added and the mixture was extracted with DCM (3×50 mL). The combined organic extracts were dried over Na₂SO₄ and concentrated in vacuo to give the crude product which was purified by flash chromatography (eluting with 10-15% EtOAc:hexanes) to give Compound 5d as a yellow semi-solid (0.42 g, 1.0 mmol, 42%). ¹H NMR (400 MHz) δ 7.61-7.45 (m, 4H), 7.43-7.24 (m, 7H), 7.12-6.97 (m, 1H), 4.24 (s, 4H), 3.58-3.44 (m, 3H).

### Example 80

### Synthesis of 1-[(3,6-dichloro-2-methoxybenzoyl)oxy]pyrrolidine-2,5-dione (Compound 5e)

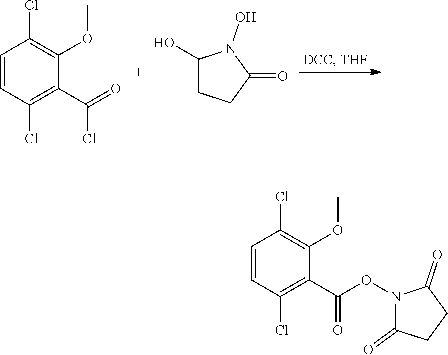

3,6-Dichloro-2-methoxybenzoic acid (0.6 g, 2.7 mmol) and anhydrous THE (7 mL) were added to a flame-dried 50 mL RBF under N₂. DCC (0.6 g, 2.9 mmol) was then added and the resultant mixture was stirred for 15 min. N-Hydroxysuccinimide (0.32 g, 2.8 mmol) was added and the mixture was stirred at RT for a further 6 h. The reaction mixture was filtered under vacuum and the filtrate was concentrated. The crude product obtained was purified by flash column chromatography (silica gel; gradient elution: 20-25% EtOAc:hexane) to give Compound 5e as a colorless solid (0.29 g, 0.91 mmol, 34%). ¹H NMR (400 MHz, CDCl₃) δ 7.47 (d, J=8.6 Hz, 1H), 7.20 (d, J=8.9 Hz, 1H), 4.04 (d, J=2.3 Hz, 3H), 2.92 (s, 4H).

### Example 81

### Synthesis of 2-[(3,6-dichloro-2-methoxybenzoyl) oxy]-1H-isoindole-1,3(2H)-dione (Compound 5f)

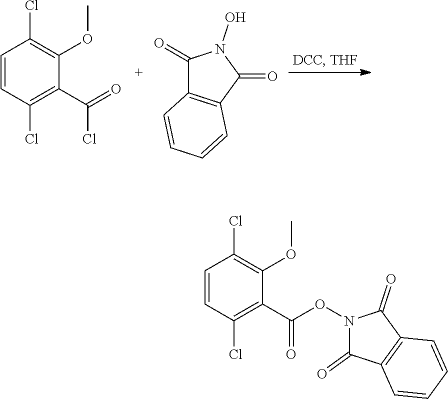

3,6-Dichloro-2-methoxybenzoic acid (0.5 g, 2.3 mmol) and anhydrous THE (7 mL) were added to a flame-dried 50 mL RBF under N₂. DCC (0.5 g, 2.4 mmol) was then added and the mixture was stirred 0° C. for 15 min. N-Hydroxyphthalimide (0.38 g, 2.4 mmol) was added and the mixture was stirred at RT for 6 h after which time it was filtered under vacuum and the filtrate concentrated in vacuo. The crude product obtained was purified by flash chromatography (silica gel; eluting: 18% EtOAc:hexane) to give Compound 5f as a colorless solid (0.36 g, 0.98 mmol, 43%).

### Example 82

### Synthesis of 4-chlorophenyl 3,6-dichloro-2-methoxybenzoate (Compound 6a)

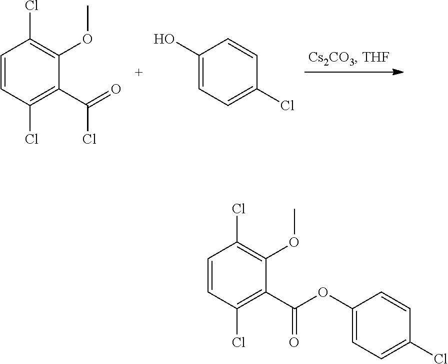

4-Chlorophenol (0.30 g, 2.3 mmol) and anhydrous THE (7 mL) were added to a flame-dried 50 mL RBF under N₂. Cs₂CO₃ (2.3 g, 7.0 mmol) was added and the mixture was stirred for 15 min. The solution was heated to 55° C. for 15 min. and then allowed to cool to RT. A solution of 3,6-dichloro-2-methoxybenzoyl chloride (0.83 g, 3.5 mmol) in anhydrous THE (3 mL) was then added slowly to the reaction mixture with stirring for 2 h at RT. The reaction mixture was filtered under vacuum and the filtrate concentrated in vacuo to give the crude product which was purified by flash column chromatography (eluting with 18% EtOAc:hexane) to give Compound 6a (0.34 g, 1.0 mmol, 43%) as a colorless solid (0.34 g, 1.0 mmol, 43%). ¹H NMR (400 MHz, CDCl₃) δ 7.49-7.42 (m, 3H), 7.30-7.18 (m, 3H), 4.03 (s, 3H).

### Example 83

### Synthesis of pyrimidin-5-yl 3,6-dichloro-2-methoxybenzoate (Compound 6b)

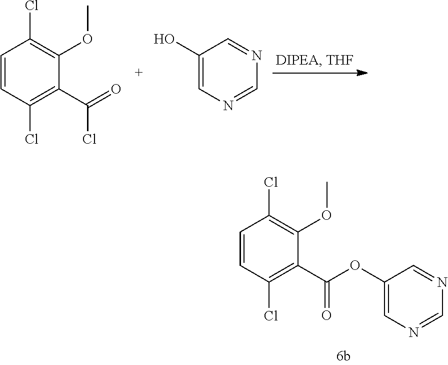

5-Hydroxypyrimidine (0.24 g, 2.5 mmol) and anhydrous THE (12 mL) were added to a flame-dried 50 mL RBF and the mixture was cooled to 0° C. Diisopropylethylamine (0.32 g, 2.5 mmol) was added, followed by the drop-wise addition of a solution of 3,6-dichloro-2-methoxybenzoyl chloride (0.4 g, 1.7 mmol) in THE (3 mL). The reaction mixture was stirred at 0° C. for 30 min. and then allowed to warm to RT and stirred overnight. The reaction mixture was poured into 50 mL of ice water and extracted with EtOAc (2×50 mL). The combined organic extracts were washed with a NaHCO₃ solution (10 g/50 mL H₂O), dried over Na₂SO₄ and then concentrated in vacuo. The crude product was purified by flash column chromatography (eluting with 30% EtOAc:hexane) to give Compound 6b (0.48 g, 1.6 mmol) as a colorless solid (0.36 g, 0.98 mmol, 58%). ¹H NMR (400 MHz, CDCl₃) δ 9.20 (d, J=5.0 Hz, 1H), 8.85-8.76 (m, 2H), 7.54-7.46 (m, 1H), 7.27-7.22 (m, 1H), 4.03 (d, J=2.9 Hz, 3H).

### Example 84

### Synthesis of 3,6-dichloro-N-(4-chlorophenyl)-2-methoxybenzamide (Compound 7a)

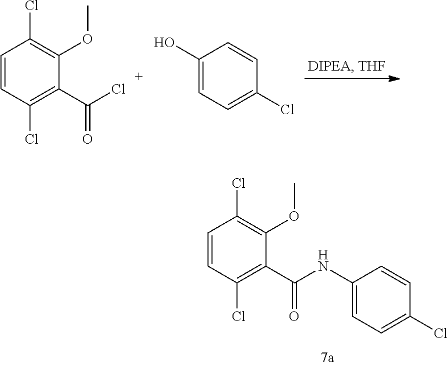

Chloroaniline (0.32 g, 2.5 mmol) and anhydrous THE (12 mL) were added to a flame-dried 50 mL RBF. The mixture was cooled to 0° C. and then DIPEA (0.32 g, 2.5 mmol) was added followed by the dropwise addition of a solution of 3,6-dichloro-2-methoxybenzoyl chloride (0.4 g, 1.7 mmol) in THE (3 mL). The reaction mixture was stirred at 0° C. for 30 min. and then allowed to warm to RT overnight with stirring. The reaction mixture was poured into water/ice (50 mL) and then extracted with EtOAc (2×50 mL). The combined organic extracts were washed with a NaHCO₃ solution (10 g NaHCO₃/50 mL H₂O), dried over Na₂SO₄ and concentrated in vacuo. The crude product was purified by flash chromatography (silica gel; elution: 25% EtOAc:hexane) to give Compound 7a as a colorless solid (0.54 g, 1.6 mmol, 94%). ¹H NMR (400 MHz, CDCl₃) δ 7.63-7.53 (m, 3H), 7.45-7.32 (m, 3H), 7.19 (d, J=8.7 Hz, 1H), 3.95 (s, 3H).

### Example 85

### Synthesis of 3,6-dichloro-2-methoxy-N-(pyridin-4-yl)benzamide (Compound 7b)

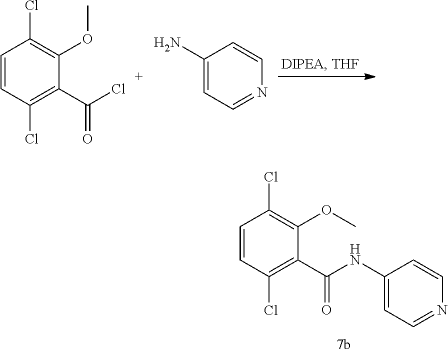

4-Aminopyridine (0.24 g, 2.5 mmol) and anhydrous THE (12 mL) were added to a flame-dried 50 mL RBF. The mixture was cooled to 0° C. and DIPEA (0.32 g, 2.5 mmol) was added followed by the dropwise addition of a solution of 3,6-dichloro-2-methoxybenzoyl chloride (0.4 g, 1.7 mmol) in THE (3 mL). The reaction mixture was stirred at 0° C. for 30 min. and then allowed to warm to RT and stirred overnight. The reaction mixture was poured into ice/water (50 mL) and extracted with EtOAc (2×50 mL). The combined organic extracts were washed with a NaHCO₃ solution (10 g in 50 mL of H₂O), dried over Na₂SO₄ and concentrated in vacuo. The crude product was purified by flash column chromatography (silica gel; elution: 20% EtOAc:hexanes) to give Compound 7b as a colorless solid (0.57 g, 1.9 mmol, 112%). ¹H NMR (400 MHz, CDCl₃) δ 8.90 (s, 1H), 8.47 (d, J=5.5 Hz, 2H), 7.61 (d, J=5.3 Hz, 2H), 7.39 (d, J=8.6 Hz, 1H), 7.16 (d, J=8.5 Hz, 1H), 3.96 (s, 3H).

### Example 86

### Synthesis of 3,6-dichloro-2-methoxy-N-(pyrimidin-2-yl)benzamide (Compound 7c)

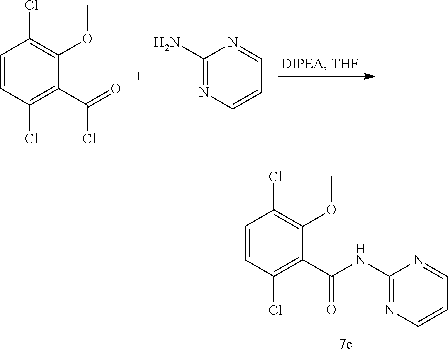

2,6-Aminopyridine (0.24 g, 2.5 mmol) and anhydrous THE (12 mL) were added to a flame-dried 50 mL RBF. The reaction mixture was cooled to 0° C. and then DIPEA (0.32 g, 2.5 mmol) was added, followed by the drop-wise addition of a solution of 3,6-dichloro-2-methoxybenzoyl chloride (0.4 g, 1.7 mmol) in THE (3 mL). The reaction mixture was stirred at 0° C. for 30 min. and then allowed to warm to RT and stirred overnight. The reaction mixture was poured into ice/water (50 mL) and extracted with EtOAc (2×50 mL). The combined organic extracts were washed with NaHCO₃ (10 g/50 mL H₂O), dried over Na₂SO₄ then concentrated in vacuo. The crude product obtained was purified by flash column chromatography (eluting with 40% EtOAc:hexane) to give Compound 7c as a yellow solid (0.41 g, 1.4 mmol, 82%). ¹H NMR (400 MHz, DMSO) δ 9.18-9.02 (m, 2H), 8.04 (d, J=8.4 Hz, 1H), 7.54 (d, J=8.4 Hz, 1H), 7.23 (dd, J=7.1, 3.8 Hz, 1H). Resonance due to CH₃ group under H₂O.

### Example 87

### Synthesis of 3,6-dichloro-2-methoxy-N-tosylbenzamide (Compound 8a)

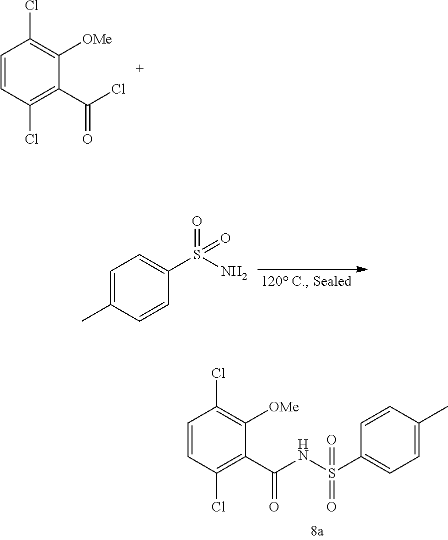

4-Methylbenzenesulfonamide (0.75 g, 4.4 mmol) and 3,6-dichloro-2-methoxybenzoyl chloride (0.7 g, 3 mmol) were combined in a 10 mL sealed tube. The reaction was heated to 120° C. for 3 h. The reaction was cooled to room temperature and then water (30 mL) and DCM (50 mL) were added. The organic layer was separated, washed with brine, dried over Na₂SO₄ and concentrated in vacuo to give the crude product which was purified by flash column chromatography (silica gel; gradient elution 0-30% EtOAc:hexanes) to give Compound 8a as an off-white solid (0.37 g, 0.99 mmol, 33%). ¹H-NMR (CDCl₃): δ 8.91 (s, 1H), 8.03-8.05 (d, J=8 Hz, 2H), 7.40-7.42 (d, J=8 Hz, 2H), 7.29-7.32 (d, J=8 Hz, 1H), 7.07-7.10 (t, J=6 Hz, 1H), 3.68 (s, 1H), 2.49 (s, 3H). LC-MS: m/z 374.11 (M+1).

### Example 88

### Synthesis of 3,6-dichloro-2-methoxy-N-((1-methyl-1H-imidazol-2-yl)sulfonyl)benzamide Compound 8c)

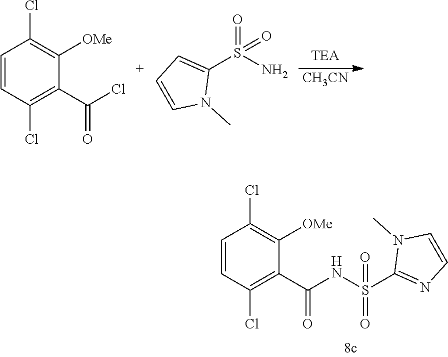

1-Methyl-1H-pyrrole-2-sulfonamide (0.32 g, 2 mmol) was dissolved in MeCN (10 mL). TEA (1 mL, 7.2 mmol) and 3,6-dichloro-2-methoxybenzoyl chloride (0.6 g, 2.5 mmol) were added and the resulting mixture was stirred at RT overnight. Water (20 mL) was added, followed by DCM (40 mL). The organic layer was separated, washed with brine, dried over Na₂SO₄ and concentrated in vacuo to give the crude product which was purified by flash column chromatography (silica gel; gradient elution 0-10% MeOH:DCM) to give Compound 8c as an off-white solid (0.22 g, 0.60 mmol, 30%). ¹H NMR (CDCl₃): δ 7.76 (s, 1H), 7.59 (s, 1H), 7.47-7.49 (d, J=8 Hz, 1H), 7.24-7.26 (d, J=8 Hz, 1H), 4.05 (s, 1H), 3.74 (s, 3H). LC-MS: m/z 363.93 (M+1).

### Example 89

### Synthesis of Compound 9: (3,6-dichloro-2-methoxyphenyl) (morpholino)methanone

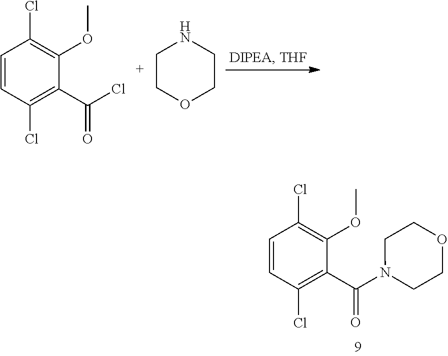

Morpholine (0.25 g, 2.8 mmol) and anhydrous THE (12 mL) were added to a flame-dried 50 mL RBF. The reaction mixture was cooled to 0° C. and DIPEA (0.36 g, 2.8 mmol) was added, followed by the drop-wise addition of a solution of 3,6-dichloro-2-methoxybenzoyl chloride (0.45 g, 1.9 mmol) in THE (3 mL). The reaction mixture was stirred at 0° C. for 30 min. and then allowed to warm to RT and stirred overnight. The reaction mixture was poured into 50 mL ice/water and extracted with EtOAc (2×50 mL). The organic layer was washed with a NaHCO₃ solution (10 g/50 mL H₂O), dried over Na₂SO₄ and then concentrated in vacuo to give the crude product which was purified by flash column chromatography (silica gel, elution: 22% EtOAc:hexane) to give Compound 9 as a colorless solid (0.61 g, 2.1 mmol, 90%). ¹H NMR (400 MHz, CDCl₃) δ 7.36 (d, J=8.6 Hz, 1H), 7.16 (d, J=8.7 Hz, 1H), 3.94 (s, 3H), 3.89-3.78 (m, 4H), 3.71-3.65 (m, 2H), 3.27-3.21 (m, 2H).

### Example 90

### Synthesis of Compound 10: 2-((3,6-dichloro-2-methoxybenzoyl)oxy)-N,N,N-trimethylethanaminium chloride

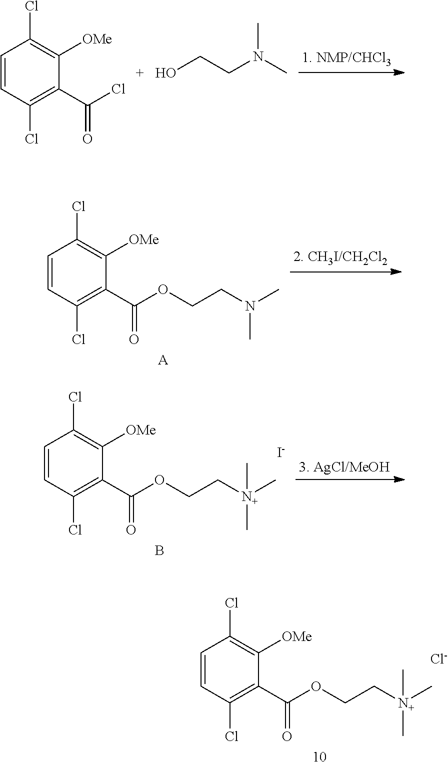

2-(dimethylamino) ethanol (2 mL, 20 mmol) was dissolved in chloroform (50 mL). NMM (3.3 mL, 30 mmol) and 3,6-dichloro-2-methoxybenzoyl chloride (5.8 g, 25 mmol) were then added and the resulting mixture was stirred at room temperature for 30 h. Water was added (30 mL), followed by DCM (30 mL). The organic layer was separated, washed with brine, dried over Na₂SO₄ and concentrated in vacuo to yield the crude product which was purified by flash column chromatography (silica gel; gradient elution 0-20% EtOAC:hexanes) to give 2-(dimethylamino) ethyl 3,6-dichloro-2-methoxybenzoate (A) as an off-white solid (2.9 g). A (0.59 g, 2 mmol) was dissolved in CH₂Cl₂ (25 mL). Iodomethane (0.15 mL, 2.4 mmol) was then added and the resulting mixture was stirred at RT for 3 h. The mixture was then concentrated in vacuo. Diethyl ether was added and the resulting solid was collected by filtration and air-dried to give 2-((3,6-dichloro-2-methoxybenzoyl) oxy)-N,N,N-trimethylethanaminium iodide (B) as a yellow solid (0.8 g, 92%). The product was mixed with MeOH (10 mL) and AgCl (0.6 g, 4.2 mmol) was added. The resulting mixture was stirred at room temperature overnight. The mixture was then passed through a Celite pad, concentrated, and diluted with diethyl ether. The resulting solid was collected by filtration and air-dried to give Compound 10 as an off-white solid (0.45 g, 1.3 mmol, 69%). ¹H-NMR (CD₃OD): δ 7.57-7.60 (d, J=10 Hz, 1H), 7.31-7.33 (d, J=8 Hz, 1H), 4.90-4.92 (m, 2H), 3.95 (s, 3H), 3.91 (m, 2H) 3.28 (s, 9H). LC-MS: m/z 306.15 (M+1).

### Example 91

### Synthesis of Compound 11: 3,6-Dichloro-2-methoxybenzoic anhydride

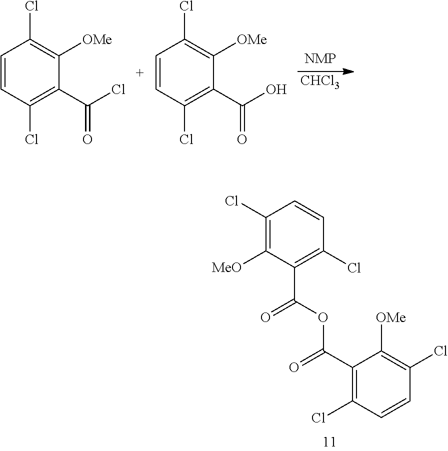

3,6-dichloro-2-methoxybenzoic acid (0.44 g, 2 mmol) was dissolved in chloroform (45 mL). NMM (0.3 mL, 2.5 mmol) and 3,6-dichloro-2-methoxybenzoyl chloride (0.46 g, 2 mmol) were then added and the resulting mixture was heated to 50° C. for 5 h. The mixture was cooled to RT and water (30 mL) and DCM (30 mL) were then added. The organic layer was separated, washed with brine, dried over Na₂SO₄ and concentrated in vacuo to give the crude product which was purified by flash column chromatography (silica gel; gradient elution 0-15% EtOAc:hexanes) to give Compound 11 as a colorless solid (0.37 g, 0.87 mmol, 44%). ¹H-NMR (CDCl₃): δ 7.43-7.46 (d, J=12 Hz, 2H), 7.17-7.19 (d, J=8 Hz, 2H), 4.01 (s, 3H). GC-MS: m/z 423.9.

TABLE 2
Exemplary compounds synthesized in confirming with the schema and representative methods disclosed herein.

| Com- | | |
|---|---|---|
| pound | | |
| No. | Compound structure | Analytical data |
| A-1 | 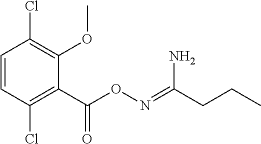 [SMILES: CCC/C(N)=N/OC(=O)c1c(Cl)ccc(Cl)c1OC] | Yield = 61%, ¹H NMR (300 MHz, Chloroform-d) δ 7.37 (d, J = 8.6 Hz, 1H), 7.13 (d, J = 8.6 Hz, 1H), 4.83 (s, 2H), 3.93 (s, 3H), 2.33-2.23 (m, 2H), 1.75-1.61 (m, 2H), 1.01 (t, J = 7.4, 7.4 Hz, 3H). ¹³C NMR (75 MHz, cdcl₃) δ 159.79, 154.09, 131.96, 129.96, 126.68, 125.79, 62.49, 32.84, 20.30, 13.48. LCMS (M + 1): 305.1. |
| A-2 | 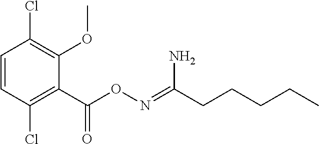 [SMILES: CCCCC/C(N)=N/OC(=O)c1c(Cl)ccc(Cl)c1OC] | Yield = 71%, Mp = 56-58° C. ¹H NMR (300 MHz, Chloroform-d) δ 7.37 (d, J = 8.8 Hz, 1H), 7.13 (d, J = 8.6 Hz, 1H), 4.83 (s, 2H), 3.93 (s, 3H), 2.36-2.24 (m, 2H), 1.67-1.60 (m, 2H), 1.38-1.32 (m, 4H), 0.93-0.87 (m, 3H). LCMS (M + 1): 333.05. |
| A-3 | 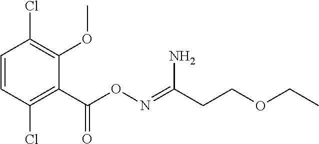 [SMILES: CCOCC/C(N)=N/OC(=O)c1c(Cl)ccc(Cl)c1OC] | Yield = 19%, Mp = 93-95° C. ¹H NMR (400 MHz, Chloroform-d) δ 7.38 (d, J = 8.6 Hz, 1H), 7.13 (d, J = 8.7 Hz, 1H), 5.45 (s, 2H), 3.94 (s, 3H), 3.70 (t, J = 5.4, 5.4 Hz, 2H), 3.53 (q, J = 7.0, Hz, 2H), 2.57 (t, J = 5.4, Hz, 2H), 1.21 (t, J = 7.0, Hz, 3H). LCMS (M + 1): 335.05. |
| A-4 | 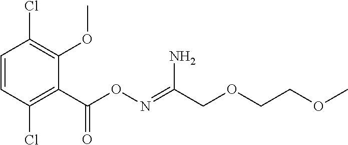 [SMILES: COCCOC/C(N)=N/OC(=O)c1c(Cl)ccc(Cl)c1OC] | Yield = 11%, ¹H NMR (300 MHz, Chloroform-d) δ 7.37 (d, J = 8.7 Hz, 1H), 7.12 (d, J = 8.7 Hz, 1H), 5.39 (s, 2H), 4.22 (s, 2H), 3.91 (s, 3H), 3.68-3.63 (m, 2H), 3.57-3.51 (m, 2H), 3.36 (s, 3H). ¹³C NMR (101 MHz, cdcl₃) δ 161.87, 157.18, 154.11, 132.03, 129.92, 126.66, 125.78, 125.72, 71.35, 70.11, 66.82, 62.44, 58.94. LCMS (M + 1): 351.05. |
| A-5 | 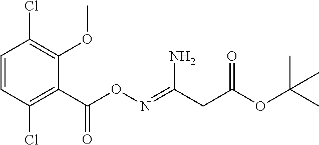 [SMILES: COc1c(Cl)ccc(Cl)c1C(=O)O/N=C(\N)CC(=O)OC(C)(C)C] | Yield = 67%. Mp = 108-110° C. ¹H NMR (400 MHz, Chloroform-d) δ 7.38 (d, J = 8.6 Hz, 1H), 7.14 (d, J = 8.7 Hz, 1H), 5.52 (s, 2H), 3.93 (s, 3H), 3.28 (s, 2H), 1.48 (s, 9H). LCMS (M + 1): 377.0 |
| A-6 | 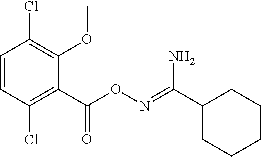 [SMILES: COc1c(Cl)ccc(Cl)c1C(=O)O/N=C(\N)C1CCCCC1] | Yield = 52%, Mp = 108-110° C. ¹H NMR (400 MHz, Chloroform-d) δ 7.37 (d, J = 8.5 Hz, 1H), 7.13 (d, J = 8.7 Hz, 1H), 4.79 (s, 2H), 3.93 (s, 3H), 2.41-2.35 (m, 1H), 1.96 (d, J = 11.0 Hz, 2H), 1.83-1.81 (m, 2H), 1.72 (d, J = 12.6 Hz, 1H), 1.44-1.26 (m, 5H). LCMS (M + 1): 345.15. |
| A-7 | 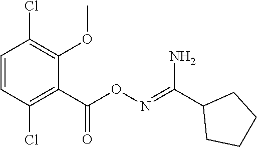 [SMILES: COc1c(Cl)ccc(Cl)c1C(=O)O/N=C(\N)C1CCCC1] | Yield = 44%, Mp = 68-70° C., ¹H NMR (300 MHz, Chloroform-d) δ 7.37 (d, J = 8.7 Hz, 1H), 7.13 (d, J = 8.6 Hz, 1H), 4.77 (s, 2H), 3.93 (s, 3H), 2.82-2.70 (m, 1H), 2.01 (dt, J = 11.9, 6.8, Hz, 2H), 1.79-1.64 (m, 6H). LCMS (M + 1): 331.10 |
| A-8 | 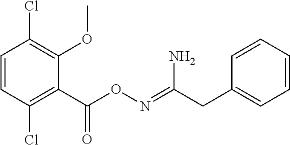 [SMILES: COc1c(Cl)ccc(Cl)c1C(=O)O/N=C(\N)Cc1ccccc1] | Yield = 77%. Mp = 105-107° C. ¹H NMR (300 MHz, Chloroform-d) δ 7.40-7.30 (m, 6H), 7.13 (d, J = 8.6 Hz, 1H), 4.76 (s, 2H), 3.94 (s, 3H), 3.65 (s, 2H). LCMS (M + 1): 353.00 |
| A-9 | 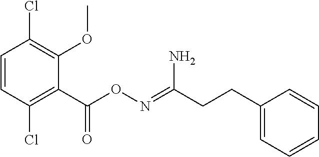 [SMILES: COc1c(Cl)ccc(Cl)c1C(=O)O/N=C(\N)CCc1ccccc1] | Yield = 58%. Mp = 103-105° C. ¹H NMR (400 MHz, Chloroform-d) δ 7.38 (d, J = 8.7 Hz, 1H), 7.34-7.28 (m, 2H), 7.24 (d, J = 7.3 Hz, 3H), 7.13 (d, J = 8.7 Hz, 1H), 4.76 (s, 2H), 3.93 (s, 3H), 2.99 (dd, J = 8.9, 6.9 Hz, 2H), 2.63 (dd, J = 8.9, 6.9 Hz, 2H). LCMS (M + 1): 367.1 |
| A-10 | 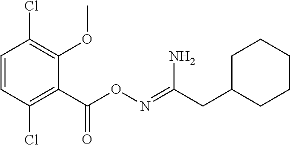 [SMILES: COc1c(Cl)ccc(Cl)c1C(=O)O/N=C(\N)CC1CCCCC1] | Yield = 50% Mp = 125-127° C. ¹H NMR (300 MHz, Chloroform-d) δ 7.37 (d, J = 8.8 Hz, 1H), 7.13 (d, J = 8.7 Hz, 1H), 4.83 (s, 2H), 3.93 (s, 3H), 2.17 (d, J = 7.4 Hz, 2H), 1.75 (t, J = 13.9, Hz, 5H), 1.29-1.14 (m, 4H), 1.02 (t, J = 11.4, 2H). LCMS (M + 1): 359.3 |
| A-11 | 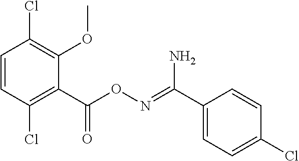 [SMILES: COc1c(Cl)ccc(Cl)c1C(=O)O/N=C(\N)c1ccc(Cl)cc1] | Yield = 83%. Mp = 58-61° C., ¹H NMR (300 MHz, Chloroform-d) δ 7.69 (d, J = 8.5 Hz, 2H), 7.41 (dd, J = 8.8, 2.8 Hz, 3H), 7.16 (d, J = 8.6 Hz, 1H), 5.17 (s, 2H), 3.96 (s, 3H). LCMS (M + 1): 373.05 |
| A-12 | 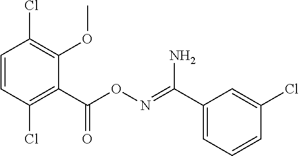 [SMILES: COc1c(Cl)ccc(Cl)c1C(=O)O/N=C(\N)c1cccc(Cl)c1] | Yield = 65%, Mp = 91-93° C. ¹H NMR (400 MHz, Chloroform-d) δ 7.77 (s, 1H), 7.63 (d, J = 7.7 Hz, 1H), 7.48 (d, J = 8.1 Hz, 1H), 7.39 (q, J = 8.5, 8.5, 7.9 Hz, 2H), 7.17 (d, J = 8.7 Hz, 1H), 5.19 (s, 2H), 3.96 (s, 3H). LCMS (M + 1): 372.9 |
| A-13 | 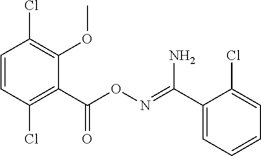 [SMILES: COc1c(Cl)ccc(Cl)c1C(=O)O/N=C(\N)c1ccccc1Cl] | Yield = 73%. Mp = 123-125° C. ¹H NMR (300 MHz, Chloroform-d) δ 7.65 (dd, J = 7.3, 1.7 Hz, 1H), 7.44-7.32 (m, 4H), 7.16 (d, J = 9.0 Hz, 1H), 5.28 (s, 2H), 3.97 (s, 3H). LCMS (M + 1): 375.0 |
| A-14 | 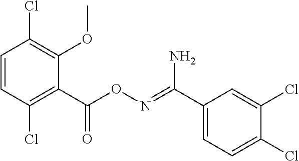 [SMILES: COc1c(Cl)ccc(Cl)c1C(=O)O/N=C(\N)c1ccc(Cl)c(Cl)c1] | Yield = 37%. Mp = 90-92° C. ¹H NMR (300 MHz, Chloroform-d) δ 7.88 (d, J = 2.2 Hz, 1H), 7.59 (dd, J = 8.2, 2.0 Hz, 1H), 7.52 (d, J = 8.4 Hz, 1H), 7.41 (d, J = 8.6 Hz, 1H), 7.17 (d, J = 8.9 Hz, 1H), 5.20 (s, 2H), 3.96 (s, 3H). LCMS (M + 1): 408.9 |
| A-15 | 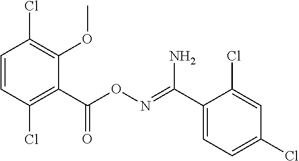 [SMILES: COc1c(Cl)ccc(Cl)c1C(=O)O/N=C(\N)c1ccc(Cl)cc1Cl] | Yield = 68%. Mp = 134-136° C. ¹H NMR (400 MHz, Chloroform-d) δ 7.60 (d, J = 8.3 Hz, 1H), 7.47 (d, J = 2.0 Hz, 1H), 7.41 (d, J = 8.7 Hz, 1H), 7.33 (dd, J = 8.3, 2.1 Hz, 1H), 7.16 (d, J = 8.7 Hz, 1H), 5.28 (s, 2H), 3.96 (s, 3H). LCMS (M + 1): 406.8. |
| A-16 | 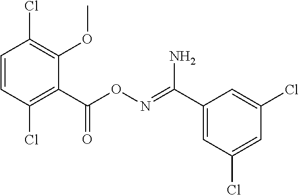 [SMILES: COc1c(Cl)ccc(Cl)c1C(=O)O/N=C(\N)c1cc(Cl)cc(Cl)c1] | Yield = 54%. Mp = 174-176° C. ¹H NMR (300 MHz, Chloroform-d) δ 7.66 (d, J = 1.9 Hz, 2H), 7.49 (d, J = 1.8 Hz, 1H), 7.42 (d, J = 8.7 Hz, 1H), 7.17 (d, J = 8.6 Hz, 1H), 5.19 (s, 2H), 3.96 (s, 3H), LCMS (M + 1): 408.9 |
| A-17 | 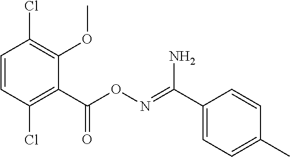 [SMILES: COc1c(Cl)ccc(Cl)c1C(=O)O/N=C(\N)c1ccc(C)cc1] | Yield = 65%. Mp = 128-130° C. ¹H NMR (300 MHz, Chloroform-d) δ 7.63 (d, J = 8.0 Hz, 2H), 7.40 (d, J = 8.7 Hz, 1H), 7.25-7.22 (m, 2H), 7.16 (d, J = 8.6 Hz, 1H), 5.15 (s, 2H), 3.96 (s, 3H), 2.39 (s, 3H). LCMS (M + 1): 353.0 |
| A-18 | 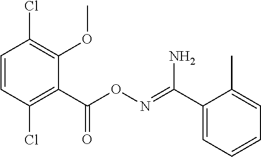 [SMILES: COc1c(Cl)ccc(Cl)c1C(=O)O/N=C(\N)c1ccccc1C] | Yield = 66%. Mp = 123-125° C. ¹H NMR (300 MHz, Chloroform-d) δ 7.48-7.30 (m, 4H), 7.21 (d, J = 7.9 Hz, 1H), 7.16 (d, J = 8.6 Hz, 1H), 5.12 (s, 2H), 3.97 (s, 3H), 2.47 (s, 3H). LCMS (M + 1): 353.0. |
| A-19 | 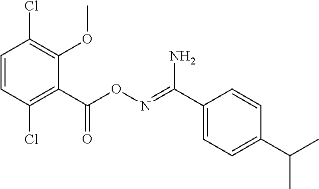 [SMILES: COc1c(Cl)ccc(Cl)c1C(=O)O/N=C(\N)c1ccc(C(C)C)cc1] | Yield = 59%, MP = 116-118° C., ¹H NMR (300 MHz, Chloroform-d) δ 7.69-7.63 (m, 2H), 7.40 (d, J = 8.6 Hz, 1H), 7.31-7.26 (m, 2H), 7.16 (d, J = 8.6 Hz, 1H), 5.16 (s, 2H), 3.96 (s, 3H), 2.94 (p, J = 7.0, 7.0, 6.9, 6.9 Hz, 1H), 1.25 (d, J = 6.7 Hz, 6H). LCMS (M + 1): 381.1 |
| A-20 | 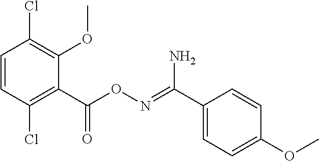 [SMILES: COc1ccc(/C(N)=N/OC(=O)c2c(Cl)ccc(Cl)c2OC)cc1] | Yield = 88%. Mp = 120-122° C. ¹H NMR (300 MHz, Chloroform-d) δ 7.69 (d, J = 8.6 Hz, 2H), 7.40 (d, J = 8.6 Hz, 1H), 7.16 (d, J = 8.7 Hz, 1H), 6.93 (d, J = 8.6 Hz, 2H), 5.13 (s, 2H), 3.96 (s, 3H), 3.84 (s, 3H). LCMS (M + 1): 369.1 |
| A-21 | 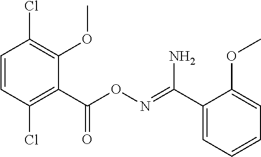 [SMILES: COc1ccccc1/C(N)=N/OC(=O)c1c(Cl)ccc(Cl)c1OC] | Yield = 46%. Mp = 124-126° C. ¹H NMR (300 MHz, Chloroform-d) δ 7.91 (dd, J = 7.8, 1.8 Hz, 1H), 7.47-7.36 (m, 2H), 7.16 (d, J = 8.6 Hz, 1H), 7.04-6.95 (m, 2H), 5.77 (s, 2H), 3.96 (s, 3H), 3.90 (s, 3H). LCMS (M + 1): 369.05. |
| A-22 | 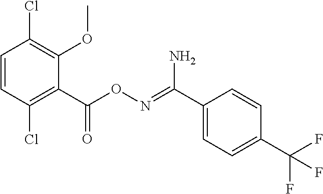 [SMILES: COc1c(Cl)ccc(Cl)c1C(=O)O/N=C(\N)c1ccc(C(F)(F)F)cc1] | Yield = 52%. Mp = 126-128° C. ¹H NMR (400 MHz, Chloroform-d) δ 7.88 (d, J = 8.1 Hz, 2H), 7.70 (d, J = 8.0 Hz, 2H), 7.45-7.39 (m, 1H), 7.18 (d, J = 8.7 Hz, 1H), 5.24 (s, 2H), 3.97 (s, 3H). LCMS (M + 1): 406.9. |
| A-23 | 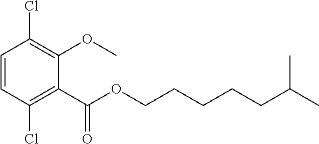 [SMILES: COc1c(Cl)ccc(Cl)c1C(=O)OCCCCCC(C)C] | Yield: 285 mg (76%); ¹H NMR (300 MHz, Chloroform-d) δ 7.35 (d, J = 8.7 Hz, 1H), 7.12 (d, J = 8.7 Hz, 1H), 4.38 (t, J = 6.7 Hz, 2H), 3.91 (s, 3H), 1.82-1.71 (m, 2H), 1.55-1.47 (m, 1H), 1.46-1.26 (m, 4H), 1.21-1.14 (m, 2H), 0.87 (d, J = 6.6 Hz, 6H). ¹³C NMR (75 MHz, cdcl₃) δ 165.23, 153.69, 131.61, 130.78, 129.42, 126.54, 125.78, 66.34, 62.20, 38.80, 28.54, 27.87, 27.45, 26.15, 22.57. LCMS (M + 1) = 332.9. |
| A-24 | 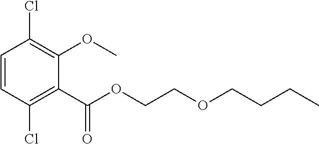 [SMILES: CCCCOCCOC(=O)c1c(Cl)ccc(Cl)c1OC] | Yield: 125 mg (17%); ¹H NMR (300 MHz, Chloroform-d) δ 7.35 (d, J = 8.6 Hz, 1H), 7.11 (d, J = 8.8 Hz, 1H), 4.55-4.49 (m, 2H), 3.92 (s, 3H), 3.77-3.71 (m, 2H), 3.49 (t, J = 6.6 Hz, 2H), 1.54-1.51 (m, 1H), 1.44-1.30 (m, 2H), 0.90 (t, J = 7.2 Hz, 3H). ¹³C NMR (75 MHz, cdcl₃) δ 164.49, 153.83, 131.75, 130.28, 129.66, 126.66, 125.75, 71.13, 68.25, 65.18, 62.21, 31.67, 19.20, 13.87. LCMS (M + 1) = 320.9. |
| A-25 | 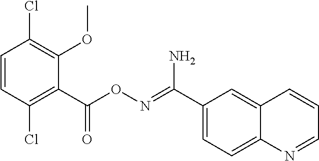 [SMILES: COc1c(Cl)ccc(Cl)c1C(=O)O/N=C(\N)c1ccc2ncccc2c1] | Mp: 143-145° C.; ¹H NMR (300 MHz, DMSO-d6) δ 8.98 (d, J = 3.7 Hz, 1H), 8.47 (d, J = 8.2 Hz, 1H), 8.42 (s, 1H), 8.11-8.00 (m, 2H), 7.69 (dd, J = 8.9, 2.3 Hz, 1H), 7.66-7.57 (m, 1H), 7.43 (d, J = 8.9 Hz, 1H), 7.16 (s, 2H), 3.90 (s, 3H). LCMS (M + 1) = 390.1. |
| A-26 | 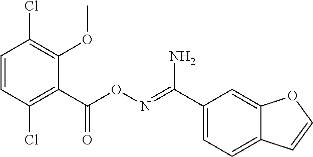 [SMILES: COc1c(Cl)ccc(Cl)c1C(=O)O/N=C(\N)c1ccc2ccoc2c1] | Mp: 134-136° C.; ¹H NMR (300 MHz, DMSO-d6) δ 8.09 (s, 1H), 7.92 (s, 1H), 7.72-7.59 (m, 3H), 7.40 (d, J = 8.7 Hz, 1H), 7.04-6.92 (m, 3H), 3.86 (s, 3H). LCMS (M + 1) = 379.1. |
| A-27 | 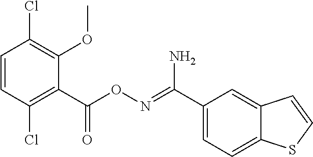 [SMILES: COc1c(Cl)ccc(Cl)c1C(=O)O/N=C(\N)c1ccc2sccc2c1] | Mp: 157-159° C.; ¹H NMR (300 MHz, DMSO-d6) δ 8.27 (s, 1H), 8.09 (d, J = 8.5 Hz, 1H), 7.86 (d, J = 5.2 Hz, 1H), 7.67 (dd, J = 8.8, 2.5 Hz, 2H), 7.55 (d, J = 5.4 Hz, 1H), 7.42 (d, J = 8.6 Hz, 1H), 7.03 (s, 2H), 3.89 (s, 3H). LCMS (M + 1) = 395.0. |
| A-28 | 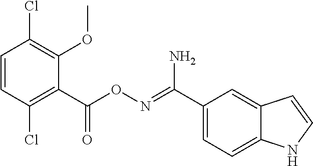 [SMILES: COc1c(Cl)ccc(Cl)c1C(=O)O/N=C(\N)c1ccc2[nH]ccc2c1] | Mp: 145-147° C.; ¹H NMR (400 MHz, Chloroform-d) δ 8.35 (s, 1H), 8.06 (s, 1H), 7.61 (dd, J = 8.7, 1.6 Hz, 1H), 7.45-7.37 (m, 2H), 7.28 (t, J = 3.0 Hz, 1H), 7.17 (d, J = 8.7 Hz, 1H), 6.61 (t, J = 2.5 Hz, 1H), 5.22 (s, 2H), 3.99 (s, 3H). LCMS (M + 1) = 378.0. |
| A-29 | 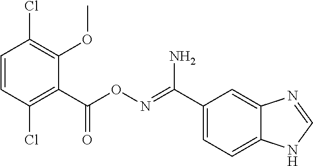 [SMILES: COc1c(Cl)ccc(Cl)c1C(=O)O/N=C(\N)c1ccc2[nH]cnc2c1] | Mp: 143-145° C.; ¹H NMR (400 MHz, DMSO-d6) δ 12.71 (s, 1H), 8.32 (s, 1H), 7.95 (s, 1H), 7.66 (d, J = 8.7 Hz, 1H), 7.62 (d, J = 8.4 Hz, 1H), 7.55 (d, J = 8.5 Hz, 1H), 7.40 (d, J = 8.7 Hz, 1H), 6.93 (s, 2H), 3.88 (s, 3H). LCMS (M + 1) = 379.1. |
| A-30 | 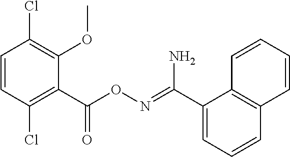 [SMILES: COc1c(Cl)ccc(Cl)c1C(=O)O/N=C(\N)c1cccc2ccccc12] | Mp: 176-178° C.; ¹H NMR (300 MHz, Chloroform-d) δ 8.33 (d, J = 8.3 Hz, 1H), 7.95 (d, J = 8.4 Hz, 1H), 7.88 (dd, J = 7.6, 1.7 Hz, 1H), 7.74 (d, J = 7.1 Hz, 1H), 7.63-7.46 (m, 3H), 7.41 (d, J = 8.6 Hz, 1H), 7.18 (d, J = 8.8 Hz, 1H), 5.35 (s, 2H), 4.00 (s, 3H). LCMS (M + 1) = 389.2. |
| A-31 | 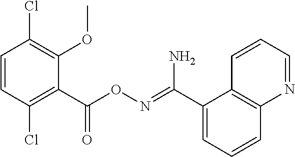 [SMILES: COc1c(Cl)ccc(Cl)c1C(=O)O/N=C(\N)c1cccc2ncccc12] | Mp: 127-129° C.; ¹H NMR (400 MHz, DMSO-d6) δ 8.96 (d, J = 5.0 Hz, 1H), 8.58 (d, J = 8.6 Hz, 1H), 8.15 (d, J = 8.3 Hz, 1H), 7.83 (t, J = 7.8 Hz, 1H), 7.76 (d, J = 7.1 Hz, 1H), 7.66 (d, J = 8.6 Hz, 1H), 7.62 (dd, J = 8.7, 4.2 Hz, 1H), 7.41 (d, J = 8.7 Hz, 1H), 7.25 (s, 2H), 3.92 (s, 3H). LCMS (M + 1) = 390.1. |
| A-32 | 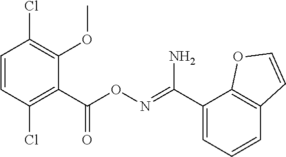 [SMILES: COc1c(Cl)ccc(Cl)c1C(=O)O/N=C(\N)c1cccc2ccoc12] | Mp: 130-132° C.; ¹H NMR (300 MHz, DMSO-d6) δ 8.05 (d, J = 2.2 Hz, 1H), 7.78 (d, J = 7.5 Hz, 1H), 7.65 (d, J = 8.7 Hz, 1H), 7.48 (d, J = 7.5 Hz, 1H), 7.39 (d, J = 8.8 Hz, 1H), 7.30 (t, J = 7.6, 7.6 Hz, 1H), 7.06 (s, 2H), 7.03 (d, 1.8 Hz, 1H), 3.88 (s, 3H). LCMS (M + 1) = 379.1. |
| A-33 | 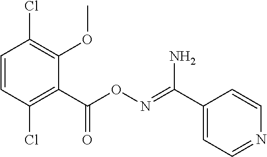 [SMILES: COc1c(Cl)ccc(Cl)c1C(=O)O/N=C(\N)c1ccncc1] | Mp: 183-185° C.; ¹H NMR (300 MHz, DMSO-d6) δ 8.72-8.65 (m, 2H), 7.69-7.66 (m, 3H), 7.42 (d, J = 8.6 Hz, 1H), 7.21 (s, 2H), 3.88 (s, 3H). LCMS (M + 1) = 340.0. |
| A-34 | 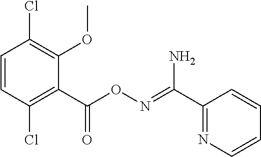 [SMILES: COc1c(Cl)ccc(Cl)c1C(=O)O/N=C(\N)c1ccccn1] | Mp: 116-118° C.; ¹H NMR (600 MHz, Chloroform-d) δ 8.59 (d, J = 4.5 Hz, 1H), 8.22 (d, J = 8.1 Hz, 1H), 7.78 (td, J = 7.8, 1.9 Hz, 1H), 7.43-7.37 (m, 2H), 7.17 (d, J = 8.6 Hz, 1H), 6.61 (s, 1H), 5.58 (s, 1H), 3.97 (s, 3H). LCMS (M + 1) = 340.0. |
| A-35 | 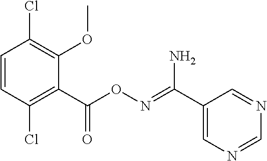 [SMILES: COc1c(Cl)ccc(Cl)c1C(=O)O/N=C(\N)c1cncnc1] | Mp: 172-174° C.; ¹H NMR (400 MHz, DMSO-d6) δ 9.33 (s, 1H), 9.08 (s, 2H), 7.70 (d, J = 8.7 Hz, 1H), 7.44 (d, J = 8.7 Hz, 1H), 7.35 (s, 2H), 3.90 (s, 3H). LCMS (M + 1) = 341.0. |
| A-36 | 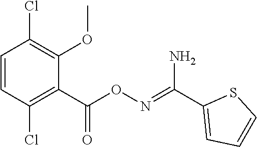 [SMILES: COc1c(Cl)ccc(Cl)c1C(=O)O/N=C(\N)c1cccs1] | Mp: 105-107° C.; ¹H NMR (600 MHz, Chloroform-d) δ 7.49 (d, J = 3.6 Hz, 1H), 7.45 (d, J = 4.7 Hz, 1H), 7.40 (d, J = 8.9 Hz, 1H), 7.16 (d, J = 8.6 Hz, 1H), 7.10 (t, J = 4.3 Hz, 1H), 5.21 (s, 2H), 3.96 (s, 3H). LCMS (M + 1) = 345.0. |
| A-37 | 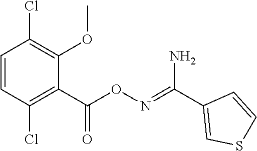 [SMILES: COc1c(Cl)ccc(Cl)c1C(=O)O/N=C(\N)c1ccsc1] | Mp: 139-141° C.; ¹H NMR (600 MHz, Chloroform-d) δ 7.78 (d, J = 2.9 Hz, 1H), 7.45 (d, J = 5.1 Hz, 1H), 7.41-7.36 (m, 2H), 7.16 (d, J = 8.6 Hz, 1H), 5.16 (s, 2H), 3.96 (s, 3H). LCMS (M + 1) = 345.0. |
| A-38 | 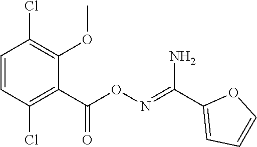 [SMILES: COc1c(Cl)ccc(Cl)c1C(=O)O/N=C(\N)c1ccco1] | Mp: 115-117° C.; ¹H NMR (300 MHz, Chloroform-d) δ 7.42 (dt, J = 8.1, 1.9 Hz, 1H), 7.36 (s, 1H), 6.80 (d, J = 8.1 Hz, 1H), 4.83 (s, 2H), 4.35 (t, J = 6.8 Hz, 2H), 1.86-1.78 (m, 2H), 1.69 (s, 6H), 1.03 (t, J = 7.5 Hz, 3H). LCMS (M + 1) = 329.05. |
| A-39 | 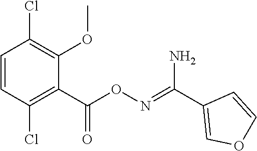 [SMILES: COc1c(Cl)ccc(Cl)c1C(=O)O/N=C(\N)c1ccoc1] | Mp: 103-105° C.; ¹H NMR (400 MHz, DMSO-d6) δ 8.22 (s, 1H), 7.77 (s, 1H), 7.68 (d, J = 8.7 Hz, 1H), 7.42 (d, J = 8.7 Hz, 1H), 6.85 (s, 2H), 6.73 (s, 1H), 3.88 (s, 3H). LCMS (M + 1) = 329.1. |
| A-40 | 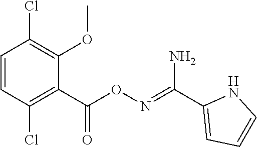 [SMILES: COc1c(Cl)ccc(Cl)c1C(=O)O/N=C(\N)c1ccc[nH]1] | Mp: 121-123° C.; ¹H NMR (300 MHz, DMSO-d6) δ 11.31 (s, 1H), 7.67 (d, J = 8.6 Hz, 1H), 7.41 (d, J = 8.6 Hz, 1H), 6.81 (d, J = 3.8 Hz, 1H), 6.72 (s, 1H), 6.62 (s, 2H), 6.10 (d, J = 2.4 Hz, 1H), 3.88 (s, 3H). LCMS (M + 1) = 328.05. |
| A-41 | 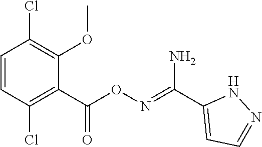 [SMILES: COc1c(Cl)ccc(Cl)c1C(=O)O/N=C(\N)c1ccn[nH]1] | Mp: 188-190° C.; ¹H NMR (400 MHz, DMSO-d6) § 13.26 (s, 1H), 7.82 (s, 1H), 7.67 (d, J = 8.8 Hz, 1H), 7.40 (d, J = 8.6 Hz, 1H), 6.68 (s, 2H), 6.54 (s, 1H), 3.87 (s, 3H). LCMS (M + 1) = 329.2. |
| A-42 | 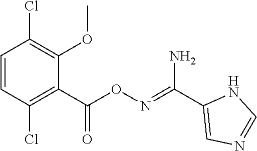 [SMILES: COc1c(Cl)ccc(Cl)c1C(=O)O/N=C(\N)c1cnc[nH]1] | Mp: 153-155° C.; ¹H NMR (400 MHz, DMSO-d6) § 12.48 (s, 1H), 7.77 (s, 1H), 7.66 (d, J = 8.5 Hz, 1H), 7.55 (s, 1H), 7.40 (d, J = 8.5 Hz, 1H), 6.54 (s, 2H), 3.87 (s, 3H). LCMS (M + 1) = 329.1. |
| A-43 | 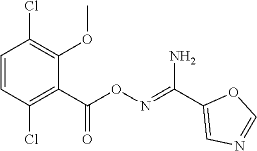 [SMILES: COc1c(Cl)ccc(Cl)c1C(=O)O/N=C(\N)c1cnco1] | Mp: 161-163° C.; ¹H NMR (300 MHz, DMSO-d6) δ 8.57 (s, 1H), 7.77 (s, 1H), 7.69 (d, J = 8.7 Hz, 1H), 7.41 (d, J = 8.7 Hz, 1H), 7.18 (s, 2H), 3.87 (s, 3H). LCMS (M + 1) = 330.0. |
| A-44 | 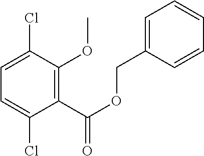 [SMILES: COc1c(Cl)ccc(Cl)c1C(=O)OCc1ccccc1] | LC-MS: 312 (M + 1). ¹H NMR (CDCl₃) δ: 7.46 (d, J = 6.5 Hz, 2H), 7.43-7.31 (m, 4H), 7.11 (d, J = 8.7 Hz, 1H), 5.41 (s, 2H), 3.82 (s, 3H). |
| A-45 | 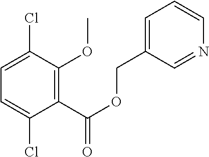 [SMILES: COc1c(Cl)ccc(Cl)c1C(=O)OCc1cccnc1] | (Yield 21%). LC-MS: 312.18 (M + 1) ¹H NMR (CDCl₃) δ: 8.72 (s, 1H), 8.61 (d, J = 3.3 Hz, 1H), 7.81 (d, J = 7.6 Hz, 1H), 7.37-7.30 (m, 2H), 7.11 (d, J = 8.7 Hz, 1H), 5.43 (s, 2H), 3.82 (s, 3H |
| A-46 | 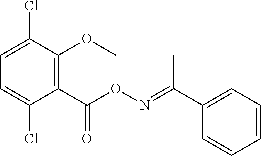 | LC-MS: 361.8 (M + Na) ¹H NMR (CDCl3) δ: 7.80-7.73 (m, 2H), 7.50-7.38 (m, 4H), 7.17 (d, J = 8.7 Hz, 1H), 3.97 (s, 3H), 2.43 (s, 3H). ¹³C NMR (CDCl3):14.8, 62.5, 125.8, 126.8, 127.2, 128.6, 129.3, 130.1, 130.9, 132.2, 134.4, 154.3, 162.4, 164.5. |
| A-47 | 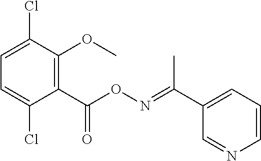 [SMILES: COc1c(Cl)ccc(Cl)c1C(=O)O/N=C(\C)c1cccnc1] | LC-MS: 340 (M + 1). ¹H NMR (CDCl₃) δ: 8.94 (d, J = 1.7 Hz, 1H), 8.69 (dd, J = 4.8, 1.6 Hz, 1H), 8.12 (dt, J = 8.0, 1.9 Hz, 1H), 7.42 (d, J = 8.7 Hz, 1H), 7.36 (dd, J = 8.0, 4.8 Hz, 1H), 7.17 (d, J = 8.7 Hz, 1H), 3.96 (s, 3H), 2.45 (s, 3H). ¹³C NMR (CDCl₃): 14.5, 62.5, 123.4, 125.9, 126.8, 129.0, 130.0, 130.4, 132.4, 134.5, 148.3, 151.8, 154.3, 162.2. |
| | 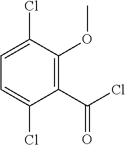 | ¹H NMR (CDCl₃) δ: 7.42 (d, J = 8.7 Hz, 1H), 7.16 (d, J = 8.7 Hz, 1H), 3.98 (s, 3H). |
| A-48 | 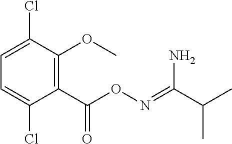 | LC-MS: 328.9 (M + Na). ¹H NMR (CDCl₃) δ: 7.35 (d, J = 8.7 Hz, 1H), 7.11 (d, J = 8.7 Hz, 1H), 4.82 (s, 2H), 3.92 (s, 3H), 2.66 (p, J = 7.0 Hz, 1H), 1.23 (d, J = 7.0 Hz, 6H). ¹³C NMR (CDCl₃): 20.2, 30.8, 62.5, 125.8, 126.7, 129.6, 130.0, 131.9, 154.2, 162.2, 164.0. |
| A-49 | 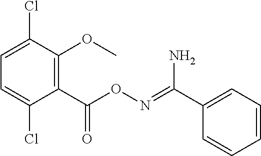 [SMILES: COc1c(Cl)ccc(Cl)c1C(=O)O/N=C(\N)c1ccccc1] | LC-MS: 338.9 (M + 1). ¹H NMR (CDCl₃) δ: 7.73 (d, J = 7.3 Hz, 2H), 7.51-7.36 (m, 4H), 7.15 (d, J = 8.7 Hz, 1H), 5.23 (s, 2H), 3.96 (s, 3H). ¹³C NMR (CDCl₃): 62.5, 125.9, 126.8, 126.9, 128.8, 129.4, 130.1, 130.7, 131.3, 132.1, 154.3, 157.9, 162.1. |
| A-50 | 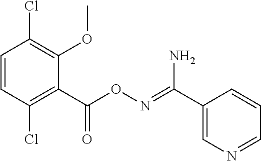 [SMILES: COc1c(Cl)ccc(Cl)c1C(=O)O/N=C(\N)c1cccnc1] | LC-MS: 340 (M), 341 (M + 1). ¹H NMR (CDCl₃) δ: 8.94 (d, J = 2.1 Hz, 1H), 8.71 (dd, J = 4.8, 1.6 Hz, 1H), 8.08 (dt, J = 8.0, 1.9 Hz, 1H), 7.41 (d, J = 8.7 Hz, 1H), 7.36 (dd, J = 8.0, 4.9 Hz, 1H), 7.16 (d, J = 8.7 Hz, 1H), 5.36 (s, 2H), 3.96 (s, 3H). ¹³C NMR (CDCl₃): 62.6, 123.5, 125.9, 126.8, 127.0, 129.1, 130.1, 132.3, 134.8, 147.7, 152.2, 154.3, 155.7 |
| A-51 | 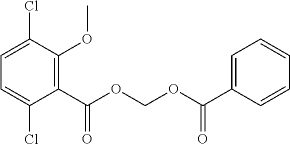 [SMILES: COc1c(Cl)ccc(Cl)c1C(=O)OCOC(=O)c1ccccc1] | LC-MS: 355.15 (M + 1). ¹H NMR (CDCl₃) δ: 8.14-8.07 (m, 2H), 7.62 (t, J = 7.5 Hz, 1H), 7.48 (t, J = 7.8 Hz, 2H), 7.36 (d, J = 8.7 Hz, 1H), 7.11 (d, J = 8.7 Hz, 1H), 6.25 (s, 2H), 3.86 (s, 3H). |
| A-52 | 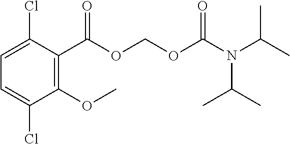 | LC-MS: 401 (M + Na). ¹H NMR (CDCl₃) δ: 7.35 (d, J = 8.4 Hz, 1H), 7.10 (d, J = 8.8 Hz, 1H), 6.02 (s, 2H), 4.12-3.96 (m, 1H), 3.89 (s, 3H), 3.88-3.82 (m, 1H), 1.23 (d, J = 6.8 Hz, 12H). ¹³C NMR (CDCl₃) :20.4, 21.3, 46.0, 46.8, 62.2, 80.3, 125.8, 126.8, 129.6, 129.8, 132.1, 153.3, 154.1, 163.6. |
| A-53 | 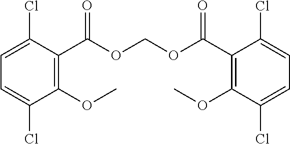 | LC-MS: 476.9 (M + Na). ¹H NMR (CDCl₃) δ: 7.39 (d, J = 8.7 Hz, 2H), 7.14 (d, J = 8.7 Hz, 2H), 6.22 (s, 2H), 3.93 (s, 6H). ¹³C NMR (CDCl₃): 62.4, 80.8, 125.9, 126.9, 129.0, 130.0, 132.6, 154.3, 163.1. |
| A-54 | 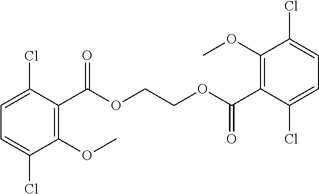 | LC-MS: 512.8 (M + 1). ¹H NMR (CDCl₃) δ: 7.34 (d, J = 8.7 Hz, 2H), 7.09 (d, J = 8.7 Hz, 2H), 4.56-4.47 (m, 4H), 3.88 (s, 6H), 3.86-3.80 (m, 4H). ¹³C NMR (CDCl₃): 62.2, 65.0, 68.8, 125.8, 126.7, 129.7, 130.2, 131.9, 153.9, 164.4. |
| A-55 | 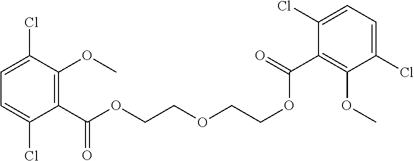 [SMILES: COc1c(Cl)ccc(Cl)c1C(=O)OCCOCCOC(=O)c1c(Cl)ccc(Cl)c1OC] | LC-MS: 512.8 (M + 1). ¹H NMR (CDCl₃) δ: 7.34 (d, J = 8.7 Hz, 2H), 7.09 (d, J = 8.7 Hz, 2H), 4.56-4.47 (m, 4H), 3.88 (s, 6H), 3.86-3.80 (m, 4H). ¹³C NMR (CDCl₃): 62.2, 65.0, 68.8, 125.8, 126.7, 129.7, 130.2, 131.9, 153.9, 164.4. |
| A-56 | 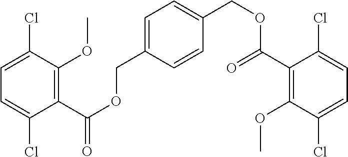 | LC-MS: 566.9 (M + Na). ¹H NMR (CDCl₃) δ: 7.48 (s, 4H), 7.35 (d, J = 8.7 Hz, 2H), 7.11 (d, J = 8.7 Hz, 2H), 5.41 (s, 4H), 3.82 (s, 6H). ¹³C NMR (CDCl₃): 62.2, 67.4, 125.8, 126.8, 128.8, 129.7, 130.3, 131.9, 135.5, 154.0, 164.4. |
| A-57 | 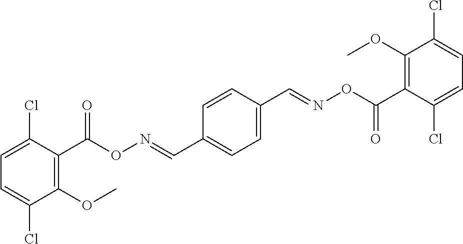 [SMILES: COc1c(Cl)ccc(Cl)c1C(=O)O/N=C/c1ccc(/C=N/OC(=O)c2c(Cl)ccc(Cl)c2OC)cc1] | LC-MS: 570.55 (M + 1). ¹H NMR (CDCl₃) δ: 8.48 (s, 2H), 7.85 (s, 4H), 7.43 (d, J = 8.7 Hz, 2H), 7.17 (d, J = 8.7 Hz, 2H), 3.97 (s, 6H). ¹³C NMR (CDCl₃): 62.5, 125.9, 126.9, 128.5, 129.1, 130.2, 132.6, 133.0, 154.4, 156.3, 162.0. |
| A-58 | 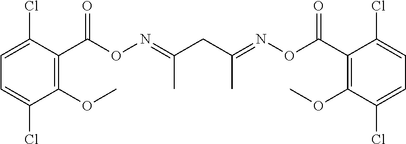 [SMILES: COc1c(Cl)ccc(Cl)c1C(=O)O/N=C(\C)C/C(C)=N/OC(=O)c1c(Cl)ccc(Cl)c1OC] | ¹H NMR (CDCl₃): 7.40 (d, J = 8.7 Hz, 1H), 7.23 (s, 1H), 7.15 (d, J = 8.7 Hz, 1H), 3.95 (s, 3H), 3.26 (s, 2H), 2.02 (s, 3H), 1.90 (s, 3H) |
| A-59 | 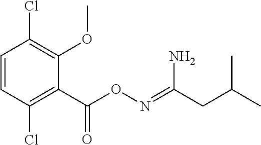 [SMILES: COc1c(Cl)ccc(Cl)c1C(=O)O/N=C(\N)CC(C)C] | Yield = 59%, ¹H NMR (300 MHz, Chloroform-d) δ 7.37 (d, J = 8.6 Hz, 1H), 7.13 (d, J = 8.7 Hz, 1H), 4.85 (s, 2H), 3.93 (s, 3H), 2.17 (d, J = 7.5 Hz, 2H), 1.95 (dt, J = 13.6, 6.9, Hz, 1H), 1.01 (d, J = 6.6 Hz, 6H). 13C NMR (75 MHz, cdcl3) δ 159.11, 131.92, 129.96, 125.78, 62.47, 39.81, 26.83, 22.15, 14.18. LCMS (M + 1): 319.1. |
| A-60 | 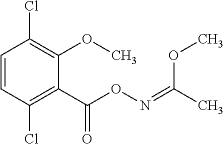 | ¹H NMR (400 MHz, CDCl₃): δ 7.40-7.43 (d, J = 10 Hz, 1H), 7.15-7.18 (d, J = 10 Hz, 1H), 3.98 (s, 3H), 2.42 (s, 3H), 2.38 (s, 3H). LC-MS: m/z 308.00 (M + 1). |
| A-61 | 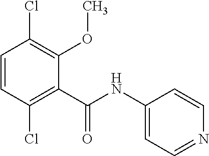 [SMILES: COc1c(Cl)ccc(Cl)c1C(=O)Nc1ccncc1] | ¹H NMR (400 MHz, CDCl₃) δ 8.90 (s, 1H), 8.47 (d, J = 5.5 Hz, 2H), 7.61 (d, J = 5.3 Hz, 2H), 7.39 (d, J = 8.6 Hz, 1H), 7.16 (d, J = 8.5 Hz, 1H), 3.96 (s, 3H). |
| A-62 | 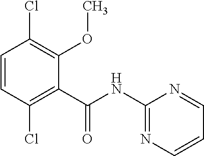 [SMILES: COc1c(Cl)ccc(Cl)c1C(=O)Nc1ncccn1] | ¹H NMR (400 MHz, DMSO) δ 9.18-9.02 (m, 2H), 8.04 (d, J = 8.4 Hz, 1H), 7.54 (d, J = 8.4 Hz, 1H), 7.23 (dd, J = 7.1, 3.8 Hz, 1H). Resonance due to CH₃ group under H₂O. |
| A-63 | 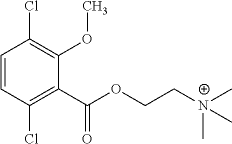 [SMILES: COc1c(Cl)ccc(Cl)c1C(=O)OCC[N+](C)(C)C] | ¹H NMR (CD₃OD): δ 7.57-7.60 (d, J = 10 Hz, 1H), 7.31-7.33 (d, J = 8 Hz, 1H), 4.90-4.92 (m, 2H), 3.95 (s, 3H), 3.91 (m, 2H) 3.28 (s, 9H). LC-MS: m/z 306.15 (M + 1). |
| A-64 | 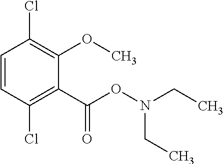 [SMILES: CCN(CC)OC(=O)c1c(Cl)ccc(Cl)c1OC] | ¹H NMR (400 MHz, CDCl₃) δ 7.37 (d, J = 8.6 Hz, 1H), 7.13 (d, J = 8.7 Hz, 1H), 3.93 (s, 3H), 3.06 (q, J = 7.1 Hz, 5H), 1.29 (t, J = 7.1 Hz, 7H). |
| A-65 | 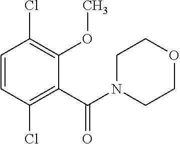 [SMILES: COc1c(Cl)ccc(Cl)c1C(=O)N1CCOCC1] | ¹H NMR (400 MHz, CDCl₃) δ 7.36 (d, J = 8.6 Hz, 1H), 7.16 (d, J = 8.7 Hz, 1H), 3.94 (s, 3H), 3.89-3.78 (m, 4H), 3.71-3.65 (m, 2H), 3.27-3.21 (m, 2H). |
| A-66 | 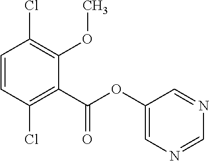 [SMILES: COc1c(Cl)ccc(Cl)c1C(=O)Oc1cncnc1] | ¹H NMR (400 MHz, CDCl₃) δ 9.20 (d, J = 5.0 Hz, 1H), 8.85-8.76 (m, 2H), 7.54-7.46 (m, 1H), 7.27-7.22 (m, 1H), 4.03 (d, J = 2.9 Hz, 3H). |
| A-67 | 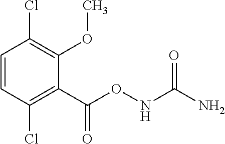 [SMILES: COc1c(Cl)ccc(Cl)c1C(=O)ONC(N)=O] | ¹H NMR (CDCl₃): δ 8.62 (s, 1H), 7.49-7.52 (d, J = 8 Hz, 1H), 7.22-7.25 (d, J = 10 Hz, 1H), 5.69 (s, 2H), 3.97 (s, 3H). LC-MS: m/z 278.93 (M + 1). |
| A-68 | 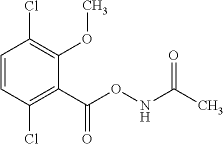 [SMILES: COc1c(Cl)ccc(Cl)c1C(=O)ONC(C)=O] | ¹H NMR (CDCl₃): δ 9.16 (s, 1H), 7.45-7.47 (d, J = 8 Hz, 1H), 7.17-7.20 (d, J = 10 Hz, 1H), 3.99 (s, 3H), 2.17 (s, 3H). LC-MS: m/z 277.82 (M + 1). |
| A-69 | 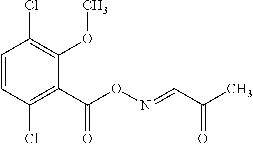 [SMILES: COc1c(Cl)ccc(Cl)c1C(=O)O/N=C/C(C)=O] | ¹H NMR (CDCl₃): δ 7.77 (s, 1H), 7.79-7.81 (d, J = 8, 1H), 7.46-7.48 (dd, J = 8 Hz, 1H), 7.19-7.22 (dd, J = 6 Hz, 1H), 3.98 (s, 3H), 2.57 (s, 3H). ¹³C-NMR (CDCl₃): 26.2, 63.5, 126.0, 126.9, 127.7, 130.2, 133.0, 154.0, 154.5, 161.4, 195.1. |
| A-70 | 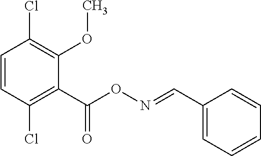 [SMILES: COc1c(Cl)ccc(Cl)c1C(=O)O/N=C/c1ccccc1] | ¹H NMR (CDCl₃): δ 8.49-8.50 (d, J = 4 Hz, 1H), 7.79-7.81 (d, J = 8, 1H), 7.62-7.81 (dd, J = 40 Hz, 1H), 7.43-7.54 (m, 3H), 7.17-7.22 (td, J = 8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. LCMS: m/z 345.9 (M + Na). |
| A-71 | 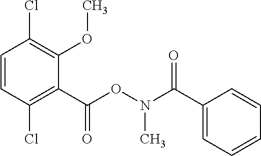 [SMILES: COc1c(Cl)ccc(Cl)c1C(=O)ON(C)C(=O)c1ccccc1] | ¹H NMR (CDCl₃): δ 7.67-7.70 (d, J = 10 Hz, 1H), 7.49-7.52 (t, 1H), 7.40-7.45 (m, 3H), 7.09-7.12 (d, J = 10 Hz, 1H), 3.76 (s, 3H), 3.58 (s, 3H.) LC- MS: m/z 353.92 (M + 1). |
| A-72 | 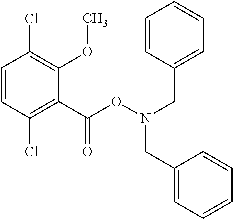 [SMILES: COc1c(Cl)ccc(Cl)c1C(=O)ON(Cc1ccccc1)Cc1ccccc1] | ¹H NMR (400 MHz,) δ 7.61-7.45 (m, 4H), 7.43-7.24 (m, 7H), 7.12-6.97 (m, 1H), 4.24 (s, 4H), 3.58-3.44 (m, 3H). |
| A-73 | 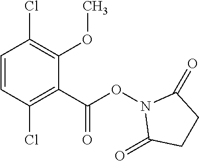 [SMILES: COc1c(Cl)ccc(Cl)c1C(=O)ON1C(=O)CCC1=O] | ¹H NMR (400 MHz, CDCl₃) δ 7.47 (d, J = 8.6 Hz, 1H), 7.20 (d, J = 8.9 Hz, 1H), 4.04 (d, J = 2.3 Hz, 3H), 2.92 (s, 4H). |
| A-74 | 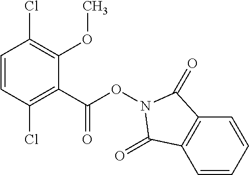 [SMILES: COc1c(Cl)ccc(Cl)c1C(=O)ON1C(=O)c2ccccc2C1=O] | N/A |
| A-75 | 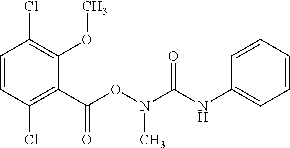 [SMILES: COc1c(Cl)ccc(Cl)c1C(=O)ON(C)C(=O)Nc1ccccc1] | ¹H NMR (CDCl₃): δ 7.93 (s, 1H), 7.52-7.55 (d, J = 10 Hz, 3H), 7.37-7.39 (t, 1H), 7.27-7.29 (d, J = 10 Hz, 1H), 7.11-7.15 (t, J = 8 Hz, 1H), 3.97 (s, 1H), 3.46 (s, 3H). LC-MS: m/z 368.94 (M + 1). |
| A-76 | 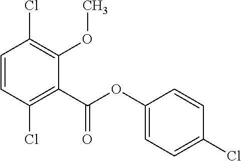 [SMILES: COc1c(Cl)ccc(Cl)c1C(=O)Oc1ccc(Cl)cc1] | ¹H NMR (400 MHz, CDCl₃) δ 7.49-7.42 (m, 3H), 7.30-7.18 (m, 3H), 4.03 (s, 3H). |
| A-77 | 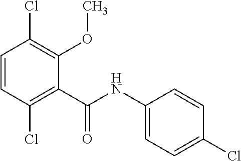 [SMILES: COc1c(Cl)ccc(Cl)c1C(=O)Nc1ccc(Cl)cc1] | ¹H NMR (400 MHz, CDCl₃) δ 7.63-7.53 (m, 3H), 7.45-7.32 (m, 3H), 7.19 (d, J = 8.7 Hz, 1H), 3.95 (s, 3H). |
| A-78 | 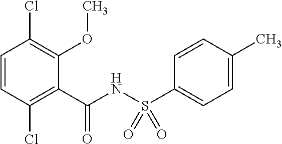 [SMILES: COc1c(Cl)ccc(Cl)c1C(=O)NS(=O)(=O)c1ccc(C)cc1] | ¹H-NMR (CDCl₃): δ 8.91 (s, 1H), 8.03-8.05 (d, J = 8 Hz,2H), 7.40-7.42 (d, J = 8 Hz, 2H), 7.29-7.32 (d, J = 8 Hz, 1H), 7.07-7.10 (t, J = 6 Hz, 1H), 3.68 (s, 1H), 2.49 (s, 3H). LC-MS: m/z 374.11 (M + 1). |
| A-79 | 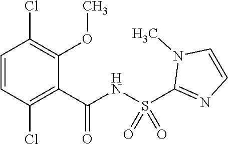 [SMILES: COc1c(Cl)ccc(Cl)c1C(=O)NS(=O)(=O)c1nccn1C] | ¹H NMR (CDCl₃): δ 7.76 (s, 1H), 7.59 (s, 1H), 7.47-7.49 (d, J = 8 Hz, 1H), 7.24-7.26 (d, J = 8 Hz, 1H), 4.05 (s, 1H), 3.74 (s, 3H). LC-MS: m/z 363.93 (M + 1). |
| A-80 | 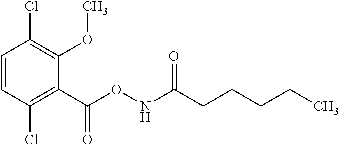 [SMILES: CCCCCC(=O)NOC(=O)c1c(Cl)ccc(Cl)c1OC] | ¹H-NMR (CDCl₃): δ 9.09 (s, 1H), 7.45-7.48 (d, J = 12 Hz, 1H), 7.18-7.20 (d, J = 8 Hz, 1H), 4.01 (s, 3H), 2.35-2.39 (m, 2H), 1.77 (s, 2H), 1.37-1.40 (m, 4H), 0.94-0.95 (s, 3H.) LC-MS: m/z 333.98 (M + 1). |
| A-81 | 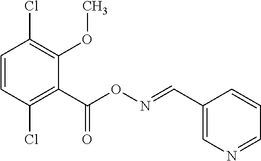 [SMILES: COc1c(Cl)ccc(Cl)c1C(=O)O/N=C/c1cccnc1] | ¹H NMR (400 MHz, CDCl₃) δ 8.91-8.86 (m, 1H), 8.77 (d, J = 5.5 Hz, 1H), 8.54 (s, 1H), 8.28-8.21 (m, 1H), 7.50-7.40 (m, 2H), 7.21 (d, J = 8.7 Hz, 1H), 4.01 (s, 3H). |
| A-82 | 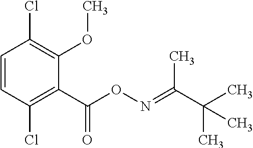 [SMILES: COc1c(Cl)ccc(Cl)c1C(=O)O/N=C(\C)C(C)(C)C] | ¹H NMR (400 MHz, CDCl₃) δ 7.40 (d, J = 8.6 Hz, 1H), 7.16 (d, J = 8.6 Hz, 1H), 3.97 (s, 3H), 2.01 (s, 3H), 1.22 (s, 10H). |
| A-83 | 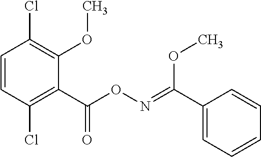 [SMILES: CO/C(=N\OC(=O)c1c(Cl)ccc(Cl)c1OC)c1ccccc1] | ¹H NMR (400 MHz, DMSO) δ 7.77-7.61 (m, 4H), 7.61-7.54 (m, 2H), 7.47 (dd, J = 8.7, 2.1 Hz, 1H), 3.92 (s, 3H), 3.87 (s, 3H). |
| A-84 | 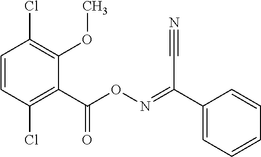 [SMILES: COc1c(Cl)ccc(Cl)c1C(=O)O/N=C(\C#N)c1ccccc1] | ¹H NMR (400 MHz, CDCl₃) δ 8.04 (dt, J = 7.2, 1.4 Hz, 2H), 7.69-7.53 (m, 3H), 7.50 (d, J = 8.7 Hz, 1H), 7.24 (d, J = 8.7 Hz, 1H), 4.04 (s, 3H). |
| A-85 | 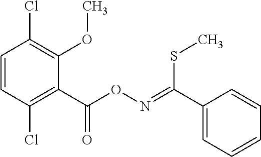 [SMILES: COc1c(Cl)ccc(Cl)c1C(=O)O/N=C(\SC)c1ccccc1] | ¹H NMR (CDCl₃): δ 7.74-7.77 (d, J = 12 Hz, 1H), 7.79-7.81 (d, J = 8, 1H), 7.62-7.81 (dd, J = 40 Hz, 1H), 7.43-7.54 (m, 3H), 7.17-7.22 (td, J = 8 Hz, 1H), 4.00 (s, 3H). ¹³C-NMR (CDCl₃): 62.5, 125.9, 126.1, 126.8, 128.7, 129.0, 129.5, 130.2, 132.2, 132.8, 154.3, 157.5. LCMS: m/z 391.99 (M + Na). |
| A-86 | 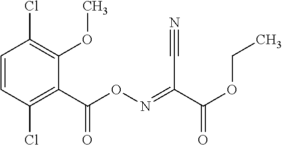 [SMILES: CCOC(=O)/C(C#N)=N/OC(=O)c1c(Cl)ccc(Cl)c1OC] | ¹H-NMR (400 MHz, CDCl₃): δ 7.50-7.53 (d, J = 10, 1H), 7.22-7.25 (d, J = 8 Hz, 1H), 4.50-4.56 (q, 2H), 4.00 (s, 3H), 1.44-1.48 (t, 3H). |
| A-87 | 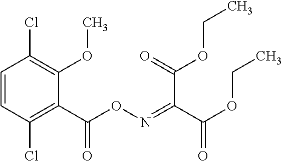 [SMILES: CCOC(=O)C(=NOC(=O)c1c(Cl)ccc(Cl)c1OC)C(=O)OCC] | ¹H-NMR (CDCl₃): δ 7.44-7.47 (d, J = 10 Hz, 1H), 7.16-7.19 (d, J = 10 Hz, 1H), 4.43-4.49 (q, 2H), 4.37-4.42 (q, 2H), 3.95 (s, 3H), 1.40-1.45 (t, 3H), 1.29-1.33 (t, 3H). LC-MS: m/z 414.17 (M + Na). |
| A-88 | 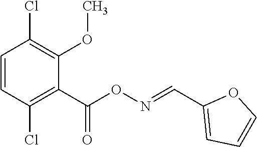 [SMILES: COc1c(Cl)ccc(Cl)c1C(=O)O/N=C/c1ccco1] | ¹H NMR (400 MHz, CDCl₃) δ 9.12 (s, 1H), 7.61 (d, J = 1.8 Hz, 1H), 7.42 (d, J = 8.6 Hz, 1H), 7.33 (d, J = 3.6 Hz, 1H), 7.18 (d, J = 8.7 Hz, 1H), 6.63 (dd, J = 3.7, 1.8 Hz, 1H), 3.94 (s, 3H). |
| A-89 | 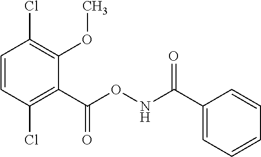 [SMILES: COc1c(Cl)ccc(Cl)c1C(=O)ONC(=O)c1ccccc1] | ¹H-NMR (CDCl₃): δ 9.77 (s, 1H), 7.92-7.94 (d, J = 8 Hz, 2H), 7.62-7.64 (t, 1H), 7.51-7.55 (t, 2H), 7.47-7.50 (d, J = 6 Hz, 1h), 7.20-7.23 (d, J = 4 Hz, 1H), 4.07 (s, 3H). LC-MS: m/z 340.00 (M + 1). |
| A-90 | 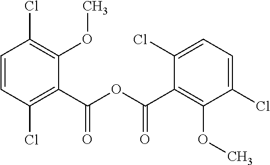 [SMILES: COc1c(Cl)ccc(Cl)c1C(=O)OC(=O)c1c(Cl)ccc(Cl)c1OC] | ¹H-NMR (CDCl₃): δ 7.43-7.46 (d, J = 12 Hz, 2H), 7.17-7.19 (d, J = 8 Hz, 2H), 4.01 (s, 3H). GC-MS: m/z 423.9. |
| A-91 | 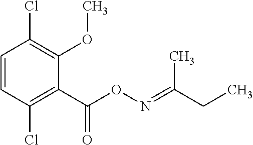 [SMILES: CC/C(C)=N/OC(=O)c1c(Cl)ccc(Cl)c1OC] | ¹H NMR (400 MHz, CDCl₃) δ 7.40 (d, J = 8.7 Hz, 1H), 7.16 (d, J = 8.6 Hz, 1H), 3.97 (s, 3H), 2.45 (q, J = 7.5 Hz, 2H), 2.04 (s, 3H), 1.21 (t, J = 7.5 Hz, 3H). |
| A-92 | 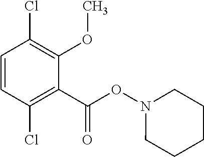 [SMILES: COc1c(Cl)ccc(Cl)c1C(=O)ON1CCCCC1] | ¹H NMR (400 MHz, CDCl₃) δ 7.38 (d, J = 8.7 Hz, 1H), 7.14 (d, J = 8.7 Hz, 1H), 3.96 (s, 3H), 3.60 (d, J = 9.5 Hz, 2H), 2.79 (d, J = 7.6 Hz, 1H), 1.89-1.80 (m, 4H), 1.71 (s, 1H), 1.28 (s, 2H). |
| A-93 | 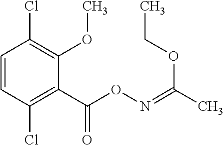 [SMILES: CCO/C(C)=N\OC(=O)c1c(Cl)ccc(Cl)c1OC] | ¹H NMR (400 MHz, CDCl₃) δ 7.41 (d, J = 8.7 Hz, 1H), 7.16 (d, J = 8.7 Hz, 1H), 4.27 (q, J = 7.1 Hz, 2H), 3.97 (s, 3H), 2.11 (s, 3H), 1.36 (t, J = 7.1 Hz, 3H). |
| A-94 | 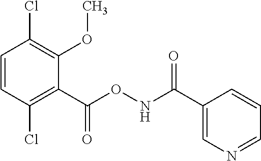 [SMILES: COc1c(Cl)ccc(Cl)c1C(=O)ONC(=O)c1cccnc1] | ¹H-NMR (CDCl₃): δ 9.16 (s, 1H), 9.86 (s, 1H), 8.25-8.27 (d, J = 8 Hz, 1H), 7.49-7.52 (d, J = 6 Hz, 2H), 7.21-7.24 (d, J = 6 Hz, 1H), 4.07 (s, 3H). LC-MS: m/z 341.06 (M + 1). |
| A-95 | 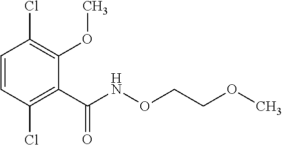 [SMILES: COCCONC(=O)c1c(Cl)ccc(Cl)c1OC] | ¹H NMR (400 MHz, DMSO-d6): δ 11.73 (s, 1H), 7.49 (m, 1H), 7.09 (m, 1H), 4.00 (m, 2H), 3.84 (s, 3H), 3.55 (m, 2H), 3.30 (s, 3H). LCMS: m/z 293.83. |
| A-96 | 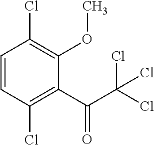 [SMILES: COc1c(Cl)ccc(Cl)c1C(=O)C(Cl)(Cl)Cl] | ¹H NMR (400 MHz, CDCl₃): δ 7.44 (d, J = 8.7 Hz, 1H), 7.18 (d, J = 8.7 Hz, 1H), 3.91 (s, 3H). GC-MS: m/z = 322. |
| A-97 | 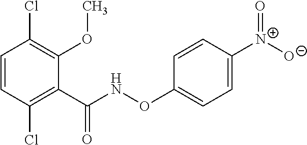 [SMILES: COc1c(Cl)ccc(Cl)c1C(=O)NOc1ccc([N+](=O)[O-])cc1] | ¹H NMR (400 MHz, DMSO-d6): δ 8.53-8.28 (m, 2H), 7.80 (d, J = 8.7 Hz, 1H), 7.64-7.59 (m, 2H), 7.53 (d, J = 8.7 Hz, 1H), 3.98 (s, 3H). LCMS: m/z = 356.89. |
| A-98 | 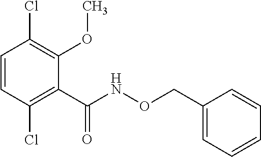 [SMILES: COc1c(Cl)ccc(Cl)c1C(=O)NOCc1ccccc1] | ¹H NMR (400 MHz, DMSO-d6): δ 11.77 (s, 1H), 7.61 (d, J = 8.7 Hz, 1H), 7.45 (m, 2H), 7.36 (m, 3H), 7.34 (d, J = 8.7 Hz, 1H), 4.96 (s, 2H), 3.80 (s, 3H). LCMS: m/z = 325.61. |
| A-99 | 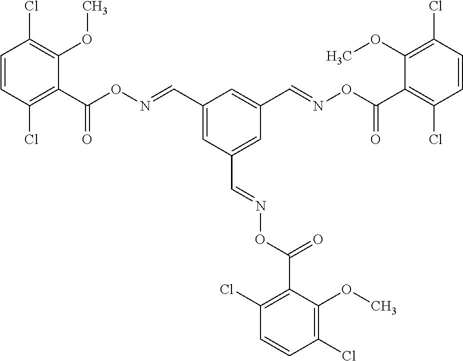 [SMILES: COc1c(Cl)ccc(Cl)c1C(=O)O/N=C/c1cc(/C=N/OC(=O)c2c(Cl)ccc(Cl)c2OC)cc(/C=N/OC(=O)c2c(Cl)ccc(Cl)c2OC)c1] | ¹H NMR (400 MHz, DMSO-d6) 9.11 (s, 3H), 8.43 (s, 3H), 7.77 (d, J = 8.7 Hz, 3H), 7.49 (d, J = 8.7 Hz, 3H), 3.93 (s, 9H). |
| A-100 | 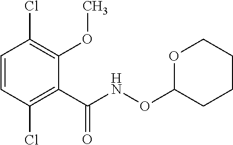 [SMILES: COc1c(Cl)ccc(Cl)c1C(=O)NOC1CCCCO1] | ¹H NMR (400 MHz, DMSO-d6): δ 11.71 (s, 1H), 7.61 (d, J = 8.7 Hz, 1H), 7.34 (d, J = 8.7 Hz, 1H), 5.04 (s, 1H), 3.88 (m, 1H), 3.83 (s, 3H), 3.49 (m, 1H), 1.64 (m, 3H), 1.48 (m, 3H). LCMS: m/z 341.78. |
| A-101 | 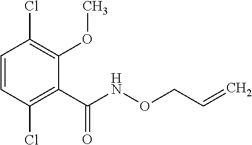 [SMILES: C=CCONC(=O)c1c(Cl)ccc(Cl)c1OC] | %). ¹H NMR (400 MHz, DMSO-d6): δ 11.67 (s, 1H), 7.61 (d, J = 8.7 Hz, 1H), 7.35 (d, J = 8.7 Hz, 1H), 5.85 (m, 1H), 5.19 (m, 2H), 4.44 (d, J = 6.0 Hz, 2H), 3.83 (s, 3H). LCMS: m/z = 275.76. |
| A-102 | 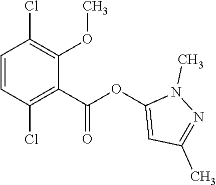 | ¹H NMR (400 MHz, DMSO-d6): δ 7.67 (m, 1H), 7.37 (m, 1H), 6.33 (s, 1H), 3.72 (s, 3H), 2.61 (s, 3H), 2.08 (s, 3H). LCMS: m/z 298.68. |
| A-103 | 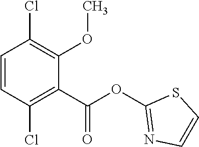 [SMILES: COc1c(Cl)ccc(Cl)c1C(=O)Oc1nccs1] | ¹H NMR (400 MHz, CDCl₃): δ 13.49 (s, 1H), 7.50 (d, J = 8.6 Hz, 1H), 7.23 (d, J = 8.7 Hz, 1H), 6.88 (d, J = 3.5 Hz, 1H), 6.22 (d, J = 3.5 Hz, 1H), 3.89 (s, 3H). LCMS: 302.99. |
| A-104 | 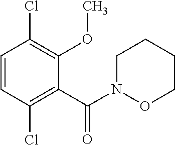 [SMILES: COc1c(Cl)ccc(Cl)c1C(=O)N1CCCCO1] | ¹H NMR (400 MHz, DMSO-d6): δ 7.57 (d, J = 8.7 Hz, 1H), 7.34 (d, J = 8.7 Hz, 1H), 3.86 (d, J = 21.0 Hz, 4H), 3.81 (s, 3H), 1.70 (m, 4H). LCMS m/z = 290.13. |
| A-105 | 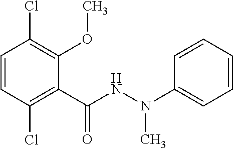 | %). ¹H NMR (400 MHz, CDCl₃): δ 10.28 (s, 1H), 8.00 (m, 1H), 7.62 (d, J = 8.7 Hz, 1H), 7.38 (d, J = 8.7 Hz, 1H), 7.11 (m, 2H), 6.91 (d, J = 7.7 Hz, 2H), 6.73 (t, J = 7.3 Hz, 1H), 3.85 (s, 3H). LCMS: m/z = 310.72. |
| A-106 | 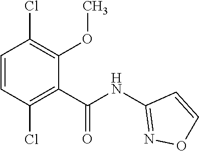 [SMILES: COc1c(Cl)ccc(Cl)c1C(=O)Nc1ccon1] | ¹H NMR (400 MHz, CDCl₃): δ 9.91 (s, 1H), 8.25 (s, 1H), 7.39 (d, J = 8.7 Hz, 1H), 7.20 (s, 1H), 7.16 (d, J = 8.7 Hz, 1H), 3.90 (s, 3H). LCMS m/z 286.93. |
| A-107 | 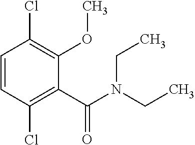 [SMILES: CCN(CC)C(=O)c1c(Cl)ccc(Cl)c1OC] | ¹H NMR (400 MHz, CDCl₃): δ 7.31 (dd, J = 8.7, 1.1 Hz, 1H), 7.11 (dd, J = 8.6, 1.1 Hz, 1H), 3.90 (d, J = 1.2 Hz, 3H), 3.65-3.53 (m, 2H), 3.21-3.04 (m, 2H), 1.27 (td, J = 7.1, 1.2 Hz, 3H), 1.09 (td, J = 7.2, 1.1 Hz, 3H). LCMS m/z 276.14 [M + 1]. |
| A-108 | 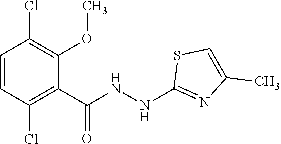 [SMILES: COc1c(Cl)ccc(Cl)c1C(=O)NNc1nc(C)cs1] | ¹H NMR (400 MHz, DMSO-d6): δ 7.51 (d, J = 8.7 Hz, 1H), 7.28 (d, J = 8.7 Hz, 1H), 6.79 (s, 1H), 6.12 (s, 2H), 3.81 (s, 3H), 2.30 (s, 3H). LCMS: m/z = 331.85. |
| A-109 | 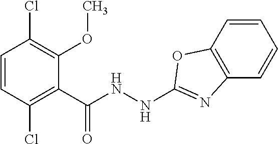 [SMILES: COc1c(Cl)ccc(Cl)c1C(=O)NNc1nc2ccccc2o1] | ¹H NMR (400 MHz, DMSO-d6): δ 10.86 (s, 1H), 10.24 (s, 1H), 7.65 (d, J = 8.7 Hz, 1H), 7.48 (d, J = 7.9 Hz, 1H), 7.32 (m, 2H), 7.16 (m, 1H), 7.06 (m, 1H), 3.96 (s, 3H). LCMS: m/z = 351.86. |
| A-110 | 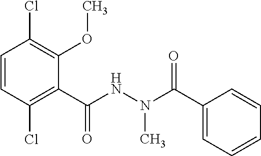 | ¹H NMR (400 MHz, DMSO-d6): δ 10.61 (s, 1H), 7.64 (d, J = 8.7 Hz, 1H), 7.40 (d, J = 8.7 Hz, 1H), 7.23 (m, 2H), 6.98 (d, J = 8.0 Hz, 2H), 6.81 (t, J = 7.3 Hz, 1H), 3.89 (s, 3H), 3.21 (s, 3H). LCMS: m/z = 324.86. |
| A-111 | 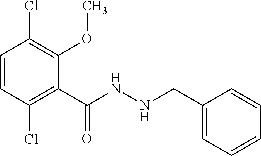 [SMILES: COc1c(Cl)ccc(Cl)c1C(=O)NNCc1ccccc1] | ¹H NMR (400 MHz, DMSO-d6): δ 9.95 (d, J = 6.1 Hz, 1H), 7.55 (d, J = 8.7 Hz, 1H), 7.35 (m, 2H), 7.16 (m, 4H) 5.62 (q, J = 5.2 Hz, 1H), 4.03 (d, J = 4.9 Hz, 2H), 3.73 (s, 3H). LCMS: m/z 324.88. |
| A-112 | 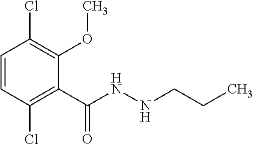 [SMILES: CCCNNC(=O)c1c(Cl)ccc(Cl)c1OC] | ¹H NMR (400 MHz, DMSO-d6): δ 9.87 (s, 1H), 7.57 (d, J = 8.6 Hz, 1H), 7.20 (m, 1H), 5.18 (s, 1H), 3.82 (s, 3H), 2.78 (t, J = 7.1 Hz, 2H), 1.49 (h, J = 7.3, 6.6 Hz, 2H), 0.90 (q, J = 7.4, 5.2 Hz, 3H). LCMS: m/z 276.95. |
| A-113 | 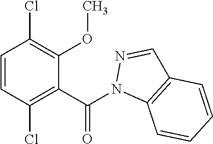 [SMILES: COc1c(Cl)ccc(Cl)c1C(=O)n1ncc2ccccc21] | ¹H NMR (400 MHz, DMSO-d6): δ 9.26 (s, 1H), 7.73 (m, 2H), 7.63 (dq, J = 9.1, 1.0 Hz, 1H), 7.51 (d, J = 8.7 Hz, 1H), 7.39 (ddd, J = 9.0, 6.5, 1.1 Hz, 1H), 7.13 (m, 1H), 3.72 (s, 3H). LCMS: m/z 320.30. |
| A-114 | 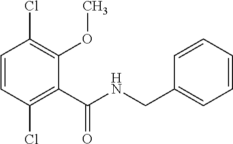 [SMILES: COc1c(Cl)ccc(Cl)c1C(=O)NCc1ccccc1] | ¹H NMR (400 MHz, CDCl₃): δ 7.37-7.30 (m, 3H), 7.29 (d, J = 1.5 Hz, 1H), 7.27 (s, 1H), 7.26-7.21 (m, 1H), 7.07 (d, J = 8.7 Hz, 1H), 6.09-5.99 (m, 1H), 4.62 (d, J = 5.9 Hz, 2H), 3.83 (s, 3H). LCMS m/z 310.18 [M + 1]. |
| A-115 | 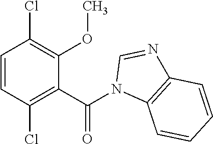 [SMILES: COc1c(Cl)ccc(Cl)c1C(=O)n1cnc2ccccc21] | ¹H NMR (400 MHz, DMSO-d6): δ 8.53 (s, 1H), 8.32 (s, 1H), 7.84 (s, 2H), 7.58 (m, 7.51 (m, 3H), 3.81 (s, 3H) LCMS: m/z = 320.86 [M]⁺. |
| A-116 | 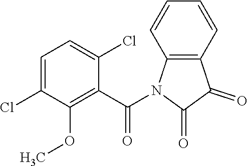 | ¹H NMR (400 MHz, CDCl₃): δ 8.59 (d, J = 8.2 Hz, 1H), 7.88-7.80 (m, 2H), 7.49-7.39 (m, 2H), 7.17 (d, J = 8.7 Hz, 1H), 3.89 (s, 3H). LCMS: m/z 381.87. |
| A-117 | 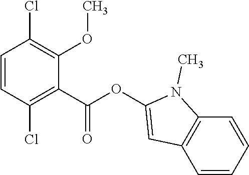 [SMILES: COc1c(Cl)ccc(Cl)c1C(=O)Oc1cc2ccccc2n1C] | ¹H NMR (400 MHz, CDCl₃): δ 7.60 (d, J = 7.8 Hz, 1H), 7.46 (d, J = 8.7 Hz, 1H), 7.25 (dt, J = 18.4, 8.8 Hz, 3H), 7.15 (d, J = 7.5 Hz, 1H), 6.46 (s, 1H), 4.01 (s, 3H), 3.69 (s, 3H). LCMS: m/z 349.27. |
| A-118 | 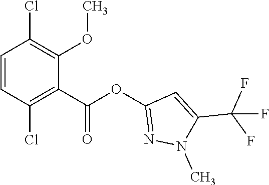 [SMILES: COc1c(Cl)ccc(Cl)c1C(=O)Oc1cc(C(F)(F)F)n(C)n1] | ¹H NMR (400 MHz, CDCl₃): δ 7.43 (d, J = 8.6 Hz, 1H), 7.18 (d, J = 8.6 Hz, 1H), 6.71 (s, 1H), 3.99 (s, 3H), 3.96 (s, 3H). LCMS: m/z = 368.86. |
| A-119 | 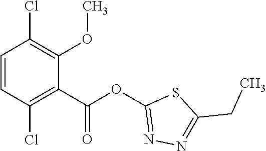 [SMILES: CCc1nnc(OC(=O)c2c(Cl)ccc(Cl)c2OC)s1] | ¹H NMR (400 MHz, CDCl₃): δ 13.02 (s, 1H), 7.44 (d, J = 8.7 Hz, 1H), 7.17 (d, J = 8.7 Hz, 1H), 3.87 (s, 3H), 2.99-2.89 (m, 2H), 1.38-1.29 (m, 3H). LCMS: m/z 332. |
| A-120 | 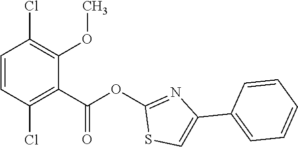 [SMILES: COc1c(Cl)ccc(Cl)c1C(=O)Oc1nc(-c2ccccc2)cs1] | ¹H NMR (400 MHz, CDCl₃): δ 7.88 (d, J = 8.0 Hz, 2H), 7.48 (d, J = 8.7 Hz, 1H), 7.42 (t, J = 7.5 Hz, 2H), 7.35 (d, J = 7.3 Hz, 1H), 7.32 (s, 1H), 7.21 (d, J = 8.7 Hz, 1H), 4.02 (s, 3H). LCMS: m/z = 381.76. |
| A-121 | 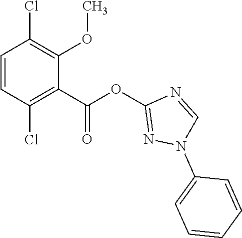 [SMILES: COc1c(Cl)ccc(Cl)c1C(=O)Oc1ncn(-c2ccccc2)n1] | ¹H NMR (400 MHz, CDCl₃): δ 8.48 (s, 1H), 7.69 (d, J = 7.9 Hz, 2H), 7.57-7.49 (m, 2H), 7.48-7.39 (m, 2H), 7.20 (d, J = 8.6 Hz, 1H), 4.07 (s, 3H). LCMS: m/z 365.19 [M⁺]. |
| A-122 | 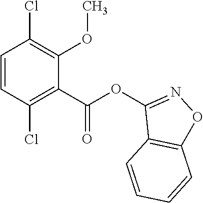 [SMILES: COc1c(Cl)ccc(Cl)c1C(=O)Oc1noc2ccccc12] | ¹H NMR (400 MHz, CDCl₃): δ 7.74 (d, J = 8.0 Hz, 1H), 7.66-7.60 (m, 2H), 7.50 (d, J = 8.7 Hz, 1H), 7.43-7.37 (m, 1H), 7.26-7.23 (m, 1H), 4.07 (s, 3H). |
| A-123 | 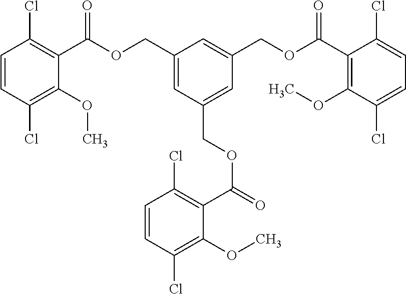 | ¹H NMR (400 MHz, DMSO-d6): δ 7.69-7.62 (m, 3H), 7.57 (s, 3H), 7.37 (d, J = 8.7 Hz, 3H), 5.46 (s, 6H), 3.74 (s, 9H). LCMS m/z 793.97. |
| A-124 | 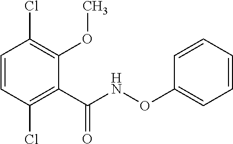 [SMILES: COc1c(Cl)ccc(Cl)c1C(=O)NOc1ccccc1] | ¹H NMR (400 MHz, DMSO-d6): δ 12.56 (s, 1H), 7.70 (d, J = 8.7 Hz, 1H), 7.37 (m, 3H), 7.21 (d, J = 8.3 Hz, 2H), 7.05 (m, 1H), 3.89 (s, 3H). LCMS: m/z = 313.83. |
| A-125 | 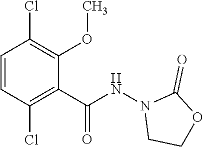 [SMILES: COc1c(Cl)ccc(Cl)c1C(=O)NN1CCOC1=O] | ¹H NMR (400 MHz, DMSO-d6): δ 10.86 (s, 1H), 10.24 (s, 1H), 7.65 (d, J = 8.7 Hz, 1H), 7.48 (d, J = 7.9 Hz, 1H), 7.32 (m, 2H), 7.16 (m, 1H), 7.06 (m, 1H), 3.96 (s, 3H). LCMS: m/z = 321.44. |
| A-126 | 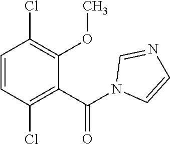 [SMILES: COc1c(Cl)ccc(Cl)c1C(=O)n1ccnc1] | ¹H NMR (400 MHz, CDCl₃): δ 7.86 (s, 1H), 7.52 (d, J = 8.7 Hz, 1H), 7.39 (s, 1H), 7.25 (m, 1H), 7.14 (s, 1H), 5.30 (s, 1H), 3.88 (s, 3H). LCMS: m/z = 270.69 [M]⁺. |
| A-127 | 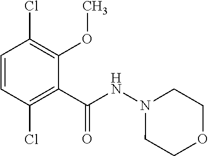 [SMILES: COc1c(Cl)ccc(Cl)c1C(=O)NN1CCOCC1] | ¹H NMR (400 MHz, DMSO-d6): δ 9.62 (s, 1H), 9.56 (s, OH), 7.57 (d, J = 8.7 Hz, 1H), 7.30 (d, J = 8.7 Hz, 1H), 3.82 (S, 3H), 3.64 (m, 4H), 2.84 (m, 4H). LCMS: m/z 326.80. |
| A-128 | 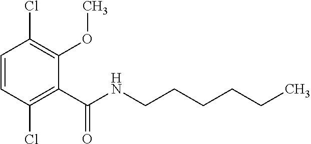 [SMILES: CCCCCCNC(=O)c1c(Cl)ccc(Cl)c1OC] | ¹H NMR (400 MHz, CDCl₃): δ 7.35 (d, J = 8.6 Hz, 1H), 7.14 (d, 8.6 Hz, 1H), 5.77 (s, 1H), 3.94 (s, 3H), 3.50 (m, 8 Hz, 2H), 1.71 (m, 2H), 1.64 (m, 2H), 1.55 (m, 2H), 1.21 (m, 2H), 0.84 (m, 3H). LCMS: m/z = 303.93 [M]+. |
| A-129 | 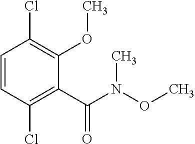 [SMILES: COc1c(Cl)ccc(Cl)c1C(=O)N(C)OC] | ¹H NMR (400 MHz, CDCl₃): δ 7.33 (d, J = 8.6 Hz, 1H), 7.13 (dd, J = 8.6, 4.5 Hz, 1H), 3.94 (s, 1H), 3.91 (d, J = 2.0 Hz, 3H), 3.54 (s, 3H), 3.40 (s, 3H), 3.11 (s, 1H). LCMS m/z 263.72 [M + 1]. |
| A-130 | 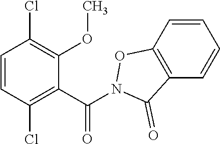 [SMILES: COc1c(Cl)ccc(Cl)c1C(=O)n1oc2ccccc2c1=O] | ¹H NMR (400 MHz, DMSO-d6): δ 7.94 (m, 1H), 7.86 (m, 1H), 7.68 (m, 2H), 7.43 (m, 2H), 3.83 (s, 3H). LCMS: m/z = 359.83. |
| A-131 | 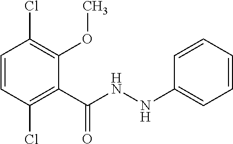 [SMILES: COc1c(Cl)ccc(Cl)c1C(=O)NNc1ccccc1] | ¹H NMR (400 MHz, CDCl₃): δ 10.28 (s, 1H), 8.00 (m, 1H), 7.62 (d, J = 8.7 Hz, 1H), 7.38 (d, J = 8.7 Hz, 1H), 7.11 (m, 2H), 6.91 (d, J = 7.7 Hz, 2H), 6.73 (t, J = 7.3 Hz, 1H), 3.85 (s, 3H). LCMS: m/z = 310.72. |
| A-132 | 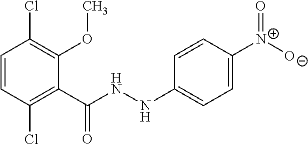 [SMILES: COc1c(Cl)ccc(Cl)c1C(=O)NNc1ccc([N+](=O)[O-])cc1] | ¹H NMR (400 MHz, CDCl₃): δ 10.69 (s, 1H), 9.42 (s, 1H), 7.98 (m, 2H), 7.66 (d, J = 8.7 Hz, 1H), 7.20 (m, 1H), 6.74 (m, 2H), 3.88 (s, 3H). LCMS: m/z = 355.79. |
| A-133 | 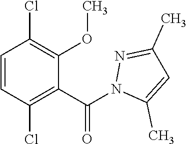 [SMILES: COc1c(Cl)ccc(Cl)c1C(=O)n1nc(C)cc1C] | ¹H NMR (400 MHz, DMSO-d6): δ 7.67 (m, 1H), 7.37 (m, 1H), 6.33 (s, 1H), 3.72 (s, 3H), 2.61 (s, 3H), 2.08 (s, 3H). LCMS: m/z 298.68. |
| A-134 | 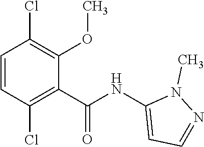 [SMILES: COc1c(Cl)ccc(Cl)c1C(=O)Nc1ccnn1C] | ¹H NMR (400 MHz, DMSO-d6): δ 10.76 (s, 1H), 7.66 (d, J = 8.7 Hz, 1H), 7.44-7.36 (m, 2H), 6.30 (d, J = 1.7 Hz, 1H), 3.87 (s, 3H), 3.74 (s, 3H). LCMS: m/z 300.09 [M⁺]. |
| A-135 | 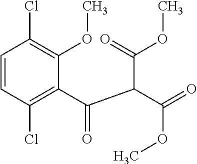 [SMILES: COC(=O)C(C(=O)OC)C(=O)c1c(Cl)ccc(Cl)c1OC] | ¹H NMR (400 MHz, CDCl₃): δ 13.97 (s, 1H), 7.36 (d, J = 8.6 Hz, 1H), 7.13 (d, J = 8.7 Hz, 1H), 3.93 (s, 3H), 3.90 (s, 3H), 3.50 (s, 3H). LCMS: m/z 334.75. |
| A-136 | 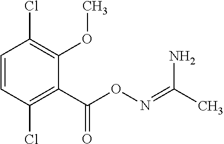 [SMILES: COc1c(Cl)ccc(Cl)c1C(=O)O/N=C(/C)N] | |
| A-137 | 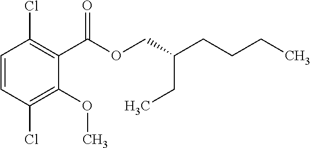 [SMILES: CCCC[C@H](CC)COC(=O)c1c(Cl)ccc(Cl)c1OC] | N/A |
| A-138 | 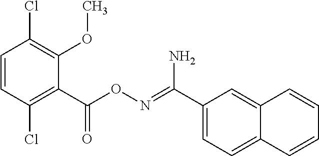 [SMILES: COc1c(Cl)ccc(Cl)c1C(=O)O/N=C(\N)c1ccc2ccccc2c1] | N/A |
| A-139 | 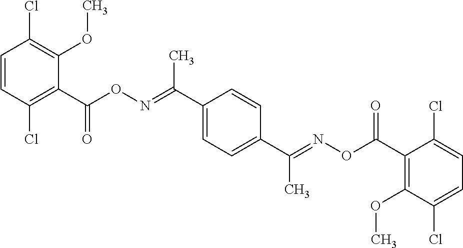 [SMILES: COc1c(Cl)ccc(Cl)c1C(=O)O/N=C(\C)c1ccc(/C(C)=N/OC(=O)c2c(Cl)ccc(Cl)c2OC)cc1] | N/A |
| A-140 | 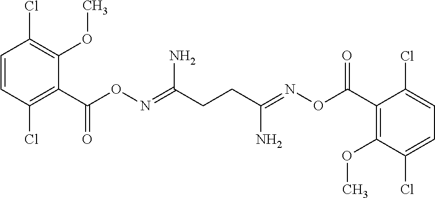 [SMILES: COc1c(Cl)ccc(Cl)c1C(=O)O/N=C(\N)CC/C(N)=N/OC(=O)c1c(Cl)ccc(Cl)c1OC] | N/A |
| A-141 | 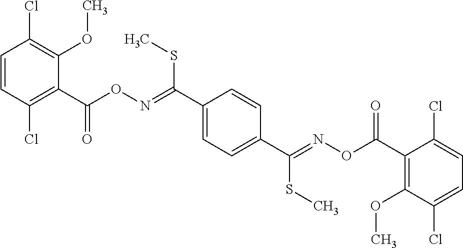 [SMILES: COc1c(Cl)ccc(Cl)c1C(=O)O/N=C(\SC)c1ccc(/C(=N/OC(=O)c2c(Cl)ccc(Cl)c2OC)SC)cc1] | N/A |
| A-142 | 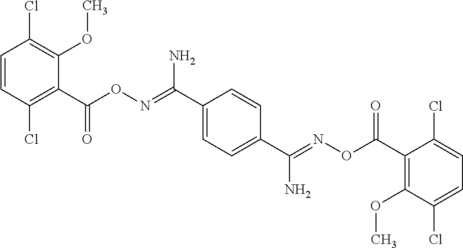 [SMILES: COc1c(Cl)ccc(Cl)c1C(=O)O/N=C(\N)c1ccc(/C(N)=N/OC(=O)c2c(Cl)ccc(Cl)c2OC)cc1] | N/A |
| A-143 | 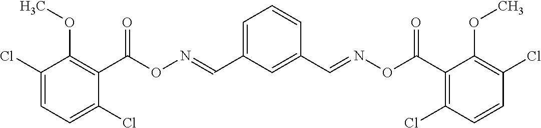 [SMILES: COc1c(Cl)ccc(Cl)c1C(=O)O/N=C/c1cccc(/C=N/OC(=O)c2c(Cl)ccc(Cl)c2OC)c1] | N/A |
| A-144 | 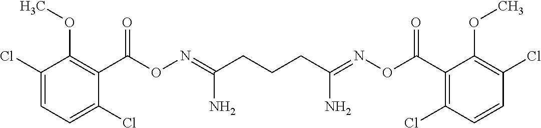 [SMILES: COc1c(Cl)ccc(Cl)c1C(=O)O/N=C(\N)CCC/C(N)=N/OC(=O)c1c(Cl)ccc(Cl)c1OC] | N/A |
| A-145 | 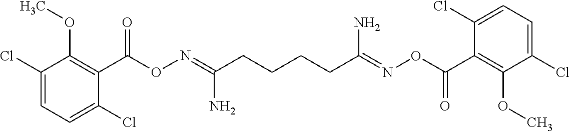 [SMILES: COc1c(Cl)ccc(Cl)c1C(=O)O/N=C(\N)CCCC/C(N)=N/OC(=O)c1c(Cl)ccc(Cl)c1OC] | N/A |
| A-146 | 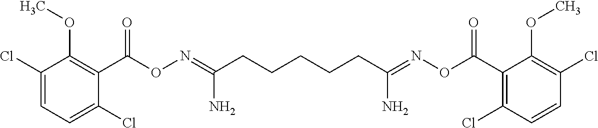 [SMILES: COc1c(Cl)ccc(Cl)c1C(=O)O/N=C(\N)CCCCC/C(N)=N/OC(=O)c1c(Cl)ccc(Cl)c1OC] | N/A |
| A-147 | 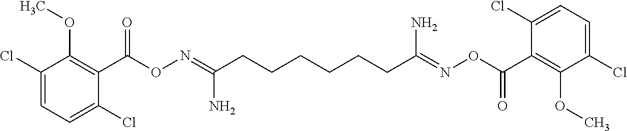 [SMILES: COc1c(Cl)ccc(Cl)c1C(=O)O/N=C(\N)CCCCCC/C(N)=N/OC(=O)c1c(Cl)ccc(Cl)c1OC] | N/A |
| A-148 | 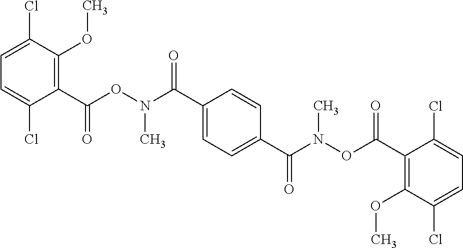 [SMILES: COc1c(Cl)ccc(Cl)c1C(=O)ON(C)C(=O)c1ccc(C(=O)N(C)OC(=O)c2c(Cl)ccc(Cl)c2OC)cc1] | N/A |
| A-149 | 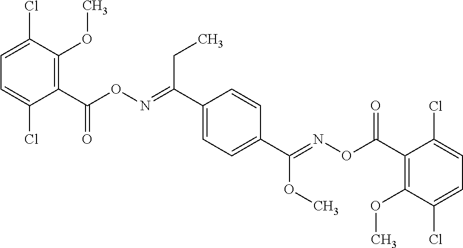 [SMILES: CC/C(=N\OC(=O)c1c(Cl)ccc(Cl)c1OC)c1ccc(/C(=N/OC(=O)c2c(Cl)ccc(Cl)c2OC)OC)cc1] | N/A |
| A-150 | 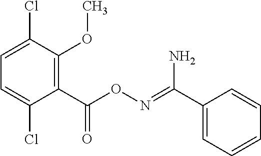 [SMILES: COc1c(Cl)ccc(Cl)c1C(=O)O/N=C(\N)c1ccccc1] | N/A |
| A-151 | 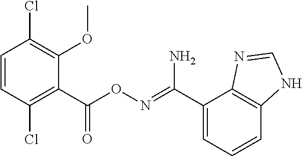 [SMILES: COc1c(Cl)ccc(Cl)c1C(=O)O/N=C(\N)c1cccc2[nH]cnc12] | Mp: 108-110° C.; ¹H NMR (400 MHz, DMSO-d6) δ 8.45 (s, 1H), 7.75 (t, J = 6.7 Hz, 2H), 7.68 (d, J = 8.7 Hz, 1H), 7.42 (d, J = 8.7 Hz, 1H), 7.31 (t, J = 7.9 Hz, 1H), 3.89 (s, 3H). LCMS (M + 1) = 379.0. |

TABLE 3
Estimates of Volatility for Specific Representative Compounds.

| Compound No. | Volatility (ng/min) |
|---|---|
| A-14 | 0.056 |
| A-26 | 0.0034 |
| A-34 | 0.039 |
| A-59 | 0.086 |
| A-15 | 0.0098 |
| A-35 | 0.022 |
| A-6 | 0.064 |
| A-33 | 0.015 |
| A-25 | 0.021 |
| A-21 | 0.074 |
| A-38 | 0.46 |
| A-8 | 0.189 |
| A-36 | 0.417 |
| A-17 | 0.026 |
| A-13 | 0.012 |
| A-37 | 0.145 |
| A-20 | 0.04 |
| A-45 | 0.73 |
| A-44 | 1.31 |
| A-46 | 0.1 |
| A-47 | 0.58 |
| A-48 | 0.38 |
| A-49 | 0.08 |
| A-50 | 0.09 |
| A-51 | 0.25 |
| A-60 | 1.9 |
| A-52 | 1.19 |
| A-53 | 0.19 |
| A-54 | 0.04 |
| A-55 | 0.24 |
| A-56 | 0.08 |
| A-57 | 1 |
| A-58 | 0.11 |
| A-105 | 0.01 |
| A-125 | 0.01 |
| A-134 | 0.01 |
| A-117 | 0.04 |
| A-98 | 0.08 |
| A-85 | 0.28 |
| A-88 | 0.35 |
| A-102 | 0.68 |
| A-129 | 13.4 |
| A-150 | 0.08 |
| A-136 | 0.086 |
| A-137 | 3.42 |
| A-138 | 0.008 |
| A-150 | 0.08 |

TABLE 4a
Effect of Specific Representative Compounds on the Growth of Some Crop
Weeds and One Commercially Available Variety of Soybeans.

| Compound No. | Rate (g ae/ha) | Species | Control/Injury |
|---|---|---|---|
| A-46 | 140 | AMATA | 50 |
| A-46 | 280 | AMATA | 75 |
| A-47 | 140 | AMATA | 50 |
| A-47 | 280 | AMATA | 90 |
| A-55 | 140 | AMATA | 20 |
| A-55 | 280 | AMATA | 0 |
| A-48 | 140 | AMATA | 60 |
| A-48 | 280 | AMATA | 90 |
| A-44 | 140 | AMATA | 50 |
| A-44 | 280 | AMATA | 60 |
| A-53 | 140 | AMATA | 40 |
| A-53 | 280 | AMATA | 50 |
| A-50 | 140 | AMATA | 95 |
| A-50 | 280 | AMATA | 97 |
| A-57 | 140 | AMATA | 95 |
| A-57 | 280 | AMATA | 90 |
| A-49 | 140 | AMATA | 98 |
| A-49 | 280 | AMATA | 100 |
| A-51 | 140 | AMATA | 50 |
| A-51 | 280 | AMATA | 85 |
| A-54 | 140 | AMATA | 0 |
| A-54 | 280 | AMATA | 0 |
| A-61 | 140 | AMATA | 85 |
| A-61 | 280 | AMATA | 90 |
| UNTREATED | | AMATA | 0 |
| A-44 | 280 | AMATA | 70 |
| UNTREATED | | AMATA | 0 |
| A-57 | 280 | AMATA | 99 |
| A-51 | 140 | AMATA | 75 |
| A-54 | 140 | AMATA | 15 |
| A-53 | 280 | AMATA | 85 |
| A-51 | 280 | AMATA | 75 |
| A-47 | 140 | AMATA | 100 |
| A-44 | 140 | AMATA | 40 |
| A-50 | 140 | AMATA | 78 |
| A-50 | 280 | AMATA | 100 |
| A-46 | 280 | AMATA | 60 |
| A-53 | 140 | AMATA | 85 |
| A-57 | 140 | AMATA | 80 |
| A-49 | 140 | AMATA | 50 |
| A-55 | 280 | AMATA | 15 |
| A-61 | 140 | AMATA | 75 |
| A-48 | 140 | AMATA | 60 |
| A-55 | 140 | AMATA | 5 |
| A-61 | 280 | AMATA | 90 |
| A-48 | 280 | AMATA | 95 |
| A-49 | 280 | AMATA | 99 |
| A-46 | 140 | AMATA | 25 |
| A-47 | 280 | AMATA | 75 |
| A-54 | 280 | AMATA | 5 |
| UNTREATED | | AMATA | 0 |
| A-54 | 140 | AMATA | 5 |
| A-50 | 140 | AMATA | 80 |
| A-44 | 140 | AMATA | 25 |
| A-48 | 140 | AMATA | 75 |
| A-57 | 140 | AMATA | 75 |
| A-44 | 280 | AMATA | 65 |
| A-53 | 140 | AMATA | 60 |
| A-54 | 280 | AMATA | 5 |
| A-46 | 280 | AMATA | 25 |
| A-49 | 280 | AMATA | 90 |
| A-48 | 280 | AMATA | 99 |
| A-50 | 280 | AMATA | 85 |
| A-61 | 140 | AMATA | 95 |
| A-53 | 280 | AMATA | 75 |
| A-47 | 140 | AMATA | 90 |
| A-46 | 140 | AMATA | 50 |
| A-55 | 140 | AMATA | 5 |
| A-47 | 280 | AMATA | 75 |
| A-51 | 140 | AMATA | 98 |
| A-55 | 280 | AMATA | 15 |
| A-61 | 280 | AMATA | 100 |
| A-51 | 280 | AMATA | 100 |
| A-57 | 280 | AMATA | 78 |
| A-49 | 140 | AMATA | 100 |
| A-62 | 140 | AMATA | 65 |
| A-62 | 280 | AMATA | 76 |
| A-63 | 140 | AMATA | 58 |
| A-63 | 280 | AMATA | 77 |
| A-64 | 140 | AMATA | 3 |
| A-64 | 280 | AMATA | 2 |
| A-65 | 140 | AMATA | 15 |
| A-65 | 280 | AMATA | 23 |
| A-66 | 140 | AMATA | 0 |
| A-66 | 280 | AMATA | 2 |
| A-67 | 140 | AMATA | 0 |
| A-67 | 280 | AMATA | 2 |
| A-68 | 140 | AMATA | 23 |
| A-68 | 280 | AMATA | 40 |
| A-69 | 140 | AMATA | 67 |
| A-69 | 280 | AMATA | 80 |
| A-70 | 140 | AMATA | 52 |
| A-70 | 280 | AMATA | 77 |
| A-71 | 140 | AMATA | 83 |
| A-71 | 280 | AMATA | 80 |
| A-72 | 140 | AMATA | 63 |
| A-72 | 280 | AMATA | 74 |
| A-73 | 140 | AMATA | 50 |
| A-73 | 280 | AMATA | 88 |
| A-74 | 140 | AMATA | 70 |
| A-74 | 280 | AMATA | 90 |
| A-75 | 140 | AMATA | 58 |
| A-75 | 280 | AMATA | 85 |
| A-76 | 140 | AMATA | 68 |
| A-76 | 280 | AMATA | 67 |
| A-77 | 140 | AMATA | 83 |
| A-77 | 280 | AMATA | 85 |
| A-78 | 140 | AMATA | 12 |
| A-78 | 280 | AMATA | 20 |
| A-79 | 140 | AMATA | 7 |
| A-79 | 280 | AMATA | 13 |
| A-80 | 140 | AMATA | 33 |
| A-80 | 280 | AMATA | 38 |
| A-81 | 140 | AMATA | 3 |
| A-81 | 280 | AMATA | 8 |
| A-82 | 140 | AMATA | 78 |
| A-82 | 280 | AMATA | 72 |
| A-83 | 140 | AMATA | 65 |
| A-83 | 280 | AMATA | 65 |
| A-84 | 140 | AMATA | 17 |
| A-84 | 280 | AMATA | 27 |
| A-85 | 140 | AMATA | 57 |
| A-85 | 280 | AMATA | 73 |
| A-86 | 140 | AMATA | 63 |
| A-86 | 280 | AMATA | 67 |
| A-87 | 140 | AMATA | 37 |
| A-87 | 280 | AMATA | 20 |
| A-88 | 140 | AMATA | 72 |
| A-88 | 280 | AMATA | 80 |
| A-89 | 140 | AMATA | 63 |
| A-89 | 280 | AMATA | 78 |
| A-90 | 140 | AMATA | 22 |
| A-90 | 280 | AMATA | 18 |
| A-91 | 140 | AMATA | 72 |
| A-91 | 280 | AMATA | 78 |
| A-92 | 140 | AMATA | 63 |
| A-92 | 280 | AMATA | 92 |
| A-93 | 140 | AMATA | 60 |
| A-93 | 280 | AMATA | 75 |
| A-94 | 140 | AMATA | 68 |
| A-94 | 280 | AMATA | 70 |
| A-95 | 140 | AMATA | 12 |
| A-95 | 280 | AMATA | 35 |
| A-46 | 140 | AMBEL | 85 |
| A-46 | 280 | AMBEL | 82 |
| A-47 | 140 | AMBEL | 85 |
| A-47 | 280 | AMBEL | 100 |
| A-55 | 140 | AMBEL | 25 |
| A-55 | 280 | AMBEL | 5 |
| A-48 | 140 | AMBEL | 85 |
| A-48 | 280 | AMBEL | 100 |
| A-44 | 140 | AMBEL | 50 |
| A-44 | 280 | AMBEL | 80 |
| A-53 | 140 | AMBEL | 60 |
| A-53 | 280 | AMBEL | 70 |
| A-50 | 140 | AMBEL | 90 |
| A-50 | 280 | AMBEL | 100 |
| A-57 | 140 | AMBEL | 95 |
| A-57 | 280 | AMBEL | 98 |
| A-49 | 140 | AMBEL | 98 |
| A-49 | 280 | AMBEL | 99 |
| A-51 | 140 | AMBEL | 90 |
| A-51 | 280 | AMBEL | 95 |
| A-54 | 140 | AMBEL | 15 |
| A-54 | 280 | AMBEL | 25 |
| A-61 | 140 | AMBEL | 99 |
| A-61 | 280 | AMBEL | 98 |
| UNTREATED | | AMBEL | 0 |
| A-44 | 280 | AMBEL | 75 |
| UNTREATED | | AMBEL | 0 |
| A-57 | 280 | AMBEL | 99 |
| A-51 | 140 | AMBEL | 85 |
| A-54 | 140 | AMBEL | 0 |
| A-53 | 280 | AMBEL | 50 |
| A-51 | 280 | AMBEL | 95 |
| A-47 | 140 | AMBEL | 98 |
| A-44 | 140 | AMBEL | 75 |
| A-50 | 140 | AMBEL | 85 |
| A-50 | 280 | AMBEL | 95 |
| A-46 | 280 | AMBEL | 90 |
| A-53 | 140 | AMBEL | 75 |
| A-57 | 140 | AMBEL | 85 |
| A-49 | 140 | AMBEL | 95 |
| A-55 | 280 | AMBEL | 25 |
| A-61 | 140 | AMBEL | 90 |
| A-48 | 140 | AMBEL | 78 |
| A-55 | 140 | AMBEL | 25 |
| A-61 | 280 | AMBEL | 100 |
| A-48 | 280 | AMBEL | 98 |
| A-49 | 280 | AMBEL | 100 |
| A-46 | 140 | AMBEL | 95 |
| A-47 | 280 | AMBEL | 98 |
| A-54 | 280 | AMBEL | 10 |
| UNTREATED | | AMBEL | 0 |
| A-54 | 140 | AMBEL | 15 |
| A-50 | 140 | AMBEL | 100 |
| A-44 | 140 | AMBEL | 60 |
| A-48 | 140 | AMBEL | 90 |
| A-57 | 140 | AMBEL | 90 |
| A-44 | 280 | AMBEL | 78 |
| A-53 | 140 | AMBEL | 55 |
| A-54 | 280 | AMBEL | 25 |
| A-46 | 280 | AMBEL | 95 |
| A-49 | 280 | AMBEL | 100 |
| A-48 | 280 | AMBEL | 100 |
| A-50 | 280 | AMBEL | 100 |
| A-61 | 140 | AMBEL | 99 |
| A-53 | 280 | AMBEL | 70 |
| A-47 | 140 | AMBEL | 100 |
| A-46 | 140 | AMBEL | 95 |
| A-55 | 140 | AMBEL | 20 |
| A-47 | 280 | AMBEL | 100 |
| A-51 | 140 | AMBEL | 90 |
| A-55 | 280 | AMBEL | 50 |
| A-61 | 280 | AMBEL | 100 |
| A-51 | 280 | AMBEL | 98 |
| A-57 | 280 | AMBEL | 99 |
| A-49 | 140 | AMBEL | 100 |
| A-62 | 140 | AMBEL | 83 |
| A-62 | 280 | AMBEL | 87 |
| A-63 | 140 | AMBEL | 82 |
| A-63 | 280 | AMBEL | 97 |
| A-64 | 140 | AMBEL | 5 |
| A-64 | 280 | AMBEL | 12 |
| A-65 | 140 | AMBEL | 40 |
| A-65 | 280 | AMBEL | 55 |
| A-66 | 140 | AMBEL | 15 |
| A-66 | 280 | AMBEL | 15 |
| A-67 | 140 | AMBEL | 3 |
| A-67 | 280 | AMBEL | 3 |
| A-68 | 140 | AMBEL | 55 |
| A-68 | 280 | AMBEL | 58 |
| A-69 | 140 | AMBEL | 80 |
| A-69 | 280 | AMBEL | 96 |
| A-70 | 140 | AMBEL | 78 |
| A-70 | 280 | AMBEL | 97 |
| A-71 | 140 | AMBEL | 83 |
| A-71 | 280 | AMBEL | 93 |
| A-72 | 140 | AMBEL | 82 |
| A-72 | 280 | AMBEL | 98 |
| A-73 | 140 | AMBEL | 77 |
| A-73 | 280 | AMBEL | 82 |
| A-74 | 140 | AMBEL | 77 |
| A-74 | 280 | AMBEL | 88 |
| A-75 | 140 | AMBEL | 82 |
| A-75 | 280 | AMBEL | 88 |
| A-76 | 140 | AMBEL | 80 |
| A-76 | 280 | AMBEL | 83 |
| A-77 | 140 | AMBEL | 67 |
| A-77 | 280 | AMBEL | 77 |
| A-78 | 140 | AMBEL | 45 |
| A-78 | 280 | AMBEL | 57 |
| A-79 | 140 | AMBEL | 15 |
| A-79 | 280 | AMBEL | 22 |
| A-80 | 140 | AMBEL | 63 |
| A-80 | 280 | AMBEL | 62 |
| A-81 | 140 | AMBEL | 15 |
| A-81 | 280 | AMBEL | 27 |
| A-82 | 140 | AMBEL | 90 |
| A-82 | 280 | AMBEL | 88 |
| A-83 | 140 | AMBEL | 93 |
| A-83 | 280 | AMBEL | 87 |
| A-84 | 140 | AMBEL | 70 |
| A-84 | 280 | AMBEL | 78 |
| A-85 | 140 | AMBEL | 67 |
| A-85 | 280 | AMBEL | 78 |
| A-86 | 140 | AMBEL | 88 |
| A-86 | 280 | AMBEL | 91 |
| A-87 | 140 | AMBEL | 70 |
| A-87 | 280 | AMBEL | 65 |
| A-88 | 140 | AMBEL | 70 |
| A-88 | 280 | AMBEL | 82 |
| A-89 | 140 | AMBEL | 80 |
| A-89 | 280 | AMBEL | 90 |
| A-90 | 140 | AMBEL | 57 |
| A-90 | 280 | AMBEL | 67 |
| A-91 | 140 | AMBEL | 82 |
| A-91 | 280 | AMBEL | 96 |
| A-92 | 140 | AMBEL | 92 |
| A-92 | 280 | AMBEL | 96 |
| A-93 | 140 | AMBEL | 68 |
| A-93 | 280 | AMBEL | 90 |
| A-94 | 140 | AMBEL | 75 |
| A-94 | 280 | AMBEL | 83 |
| A-95 | 140 | AMBEL | 47 |
| A-95 | 280 | AMBEL | 63 |
| A-46 | 140 | KCHSC | 99 |
| A-46 | 280 | KCHSC | 100 |
| A-47 | 140 | KCHSC | 98 |
| A-47 | 280 | KCHSC | 100 |
| A-55 | 140 | KCHSC | 0 |
| A-55 | 280 | KCHSC | 15 |
| A-48 | 140 | KCHSC | 90 |
| A-48 | 280 | KCHSC | 100 |
| A-44 | 140 | KCHSC | 60 |
| A-44 | 280 | KCHSC | 90 |
| A-53 | 140 | KCHSC | 85 |
| A-53 | 280 | KCHSC | 90 |
| A-50 | 140 | KCHSC | 99 |
| A-50 | 280 | KCHSC | 99 |
| A-57 | 140 | KCHSC | 92 |
| A-57 | 280 | KCHSC | 100 |
| A-49 | 140 | KCHSC | 82 |
| A-49 | 280 | KCHSC | 100 |
| A-51 | 140 | KCHSC | 92 |
| A-51 | 280 | KCHSC | 99 |
| A-54 | 140 | KCHSC | 15 |
| A-54 | 280 | KCHSC | 15 |
| A-61 | 140 | KCHSC | 98 |
| A-61 | 280 | KCHSC | 99 |
| UNTREATED | | KCHSC | 0 |
| A-44 | 280 | KCHSC | 78 |
| UNTREATED | | KCHSC | 0 |
| A-57 | 280 | KCHSC | 99 |
| A-51 | 140 | KCHSC | 90 |
| A-54 | 140 | KCHSC | 25 |
| A-53 | 280 | KCHSC | 92 |
| A-51 | 280 | KCHSC | 99 |
| A-47 | 140 | KCHSC | 99 |
| A-44 | 140 | KCHSC | 60 |
| A-50 | 140 | KCHSC | 100 |
| A-50 | 280 | KCHSC | 100 |
| A-46 | 280 | KCHSC | 100 |
| A-53 | 140 | KCHSC | 85 |
| A-57 | 140 | KCHSC | 95 |
| A-49 | 140 | KCHSC | 92 |
| A-55 | 280 | KCHSC | 15 |
| A-61 | 140 | KCHSC | 99 |
| A-48 | 140 | KCHSC | 98 |
| A-55 | 140 | KCHSC | 0 |
| A-61 | 280 | KCHSC | 99 |
| A-48 | 280 | KCHSC | 100 |
| A-49 | 280 | KCHSC | 95 |
| A-46 | 140 | KCHSC | 100 |
| A-47 | 280 | KCHSC | 100 |
| A-54 | 280 | KCHSC | 15 |
| UNTREATED | | KCHSC | 0 |
| A-54 | 140 | KCHSC | 5 |
| A-50 | 140 | KCHSC | 99 |
| A-44 | 140 | KCHSC | 60 |
| A-48 | 140 | KCHSC | 92 |
| A-57 | 140 | KCHSC | 98 |
| A-44 | 280 | KCHSC | 90 |
| A-53 | 140 | KCHSC | 85 |
| A-54 | 280 | KCHSC | 15 |
| A-46 | 280 | KCHSC | 99 |
| A-49 | 280 | KCHSC | 92 |
| A-48 | 280 | KCHSC | 100 |
| A-50 | 280 | KCHSC | 100 |
| A-61 | 140 | KCHSC | 92 |
| A-53 | 280 | KCHSC | 92 |
| A-47 | 140 | KCHSC | 100 |
| A-46 | 140 | KCHSC | 90 |
| A-55 | 140 | KCHSC | 15 |
| A-47 | 280 | KCHSC | 100 |
| A-51 | 140 | KCHSC | 95 |
| A-55 | 280 | KCHSC | 20 |
| A-61 | 280 | KCHSC | 99 |
| A-51 | 280 | KCHSC | 95 |
| A-57 | 280 | KCHSC | 100 |
| A-49 | 140 | KCHSC | 80 |
| A-62 | 140 | KCHSC | 77 |
| A-62 | 280 | KCHSC | 90 |
| A-63 | 140 | KCHSC | 92 |
| A-63 | 280 | KCHSC | 97 |
| A-64 | 140 | KCHSC | 0 |
| A-64 | 280 | KCHSC | 3 |
| A-65 | 140 | KCHSC | 28 |
| A-65 | 280 | KCHSC | 37 |
| A-66 | 140 | KCHSC | 0 |
| A-66 | 280 | KCHSC | 0 |
| A-67 | 140 | KCHSC | 3 |
| A-67 | 280 | KCHSC | 2 |
| A-68 | 140 | KCHSC | 58 |
| A-68 | 280 | KCHSC | 82 |
| A-69 | 140 | KCHSC | 91 |
| A-69 | 280 | KCHSC | 96 |
| A-70 | 140 | KCHSC | 73 |
| A-70 | 280 | KCHSC | 88 |
| A-71 | 140 | KCHSC | 85 |
| A-71 | 280 | KCHSC | 87 |
| A-72 | 140 | KCHSC | 82 |
| A-72 | 280 | KCHSC | 94 |
| A-73 | 140 | KCHSC | 82 |
| A-73 | 280 | KCHSC | 88 |
| A-74 | 140 | KCHSC | 94 |
| A-74 | 280 | KCHSC | 97 |
| A-75 | 140 | KCHSC | 88 |
| A-75 | 280 | KCHSC | 97 |
| A-76 | 140 | KCHSC | 83 |
| A-76 | 280 | KCHSC | 87 |
| A-77 | 140 | KCHSC | 96 |
| A-77 | 280 | KCHSC | 93 |
| A-78 | 140 | KCHSC | 50 |
| A-78 | 280 | KCHSC | 85 |
| A-79 | 140 | KCHSC | 0 |
| A-79 | 280 | KCHSC | 3 |
| A-80 | 140 | KCHSC | 13 |
| A-80 | 280 | KCHSC | 22 |
| A-81 | 140 | KCHSC | 2 |
| A-81 | 280 | KCHSC | 7 |
| A-82 | 140 | KCHSC | 98 |
| A-82 | 280 | KCHSC | 88 |
| A-83 | 140 | KCHSC | 85 |
| A-83 | 280 | KCHSC | 94 |
| A-84 | 140 | KCHSC | 68 |
| A-84 | 280 | KCHSC | 85 |
| A-85 | 140 | KCHSC | 95 |
| A-85 | 280 | KCHSC | 97 |
| A-86 | 140 | KCHSC | 90 |
| A-86 | 280 | KCHSC | 97 |
| A-87 | 140 | KCHSC | 90 |
| A-87 | 280 | KCHSC | 70 |
| A-88 | 140 | KCHSC | 87 |
| A-88 | 280 | KCHSC | 94 |
| A-89 | 140 | KCHSC | 84 |
| A-89 | 280 | KCHSC | 95 |
| A-90 | 140 | KCHSC | 17 |
| A-90 | 280 | KCHSC | 32 |
| A-91 | 140 | KCHSC | 78 |
| A-91 | 280 | KCHSC | 98 |
| A-92 | 140 | KCHSC | 83 |
| A-92 | 280 | KCHSC | 98 |
| A-93 | 140 | KCHSC | 77 |
| A-93 | 280 | KCHSC | 93 |
| A-94 | 140 | KCHSC | 85 |
| A-94 | 280 | KCHSC | 93 |
| A-95 | 140 | KCHSC | 57 |
| A-95 | 280 | KCHSC | 77 |
| A-46 | 140 | R-AMAPA | 85 |
| A-46 | 280 | R-AMAPA | 80 |
| A-47 | 140 | R-AMAPA | 90 |
| A-47 | 280 | R-AMAPA | 95 |
| A-55 | 140 | R-AMAPA | 25 |
| A-55 | 280 | R-AMAPA | 30 |
| A-48 | 140 | R-AMAPA | 90 |
| A-48 | 280 | R-AMAPA | 99 |
| A-44 | 140 | R-AMAPA | 80 |
| A-44 | 280 | R-AMAPA | 85 |
| A-53 | 140 | R-AMAPA | 70 |
| A-53 | 280 | R-AMAPA | 98 |
| A-50 | 140 | R-AMAPA | 95 |
| A-50 | 280 | R-AMAPA | 99 |
| A-57 | 140 | R-AMAPA | 87 |
| A-57 | 280 | R-AMAPA | 100 |
| A-49 | 140 | R-AMAPA | 95 |
| A-49 | 280 | R-AMAPA | 100 |
| A-51 | 140 | R-AMAPA | 95 |
| A-51 | 280 | R-AMAPA | 95 |
| A-54 | 140 | R-AMAPA | 25 |
| A-54 | 280 | R-AMAPA | 35 |
| A-61 | 140 | R-AMAPA | 85 |
| A-61 | 280 | R-AMAPA | 100 |
| UNTREATED | | R-AMAPA | 0 |
| A-44 | 280 | R-AMAPA | 90 |
| UNTREATED | | R-AMAPA | 0 |
| A-57 | 280 | R-AMAPA | 80 |
| A-51 | 140 | R-AMAPA | 100 |
| A-54 | 140 | R-AMAPA | 25 |
| A-53 | 280 | R-AMAPA | 100 |
| A-51 | 280 | R-AMAPA | 92 |
| A-47 | 140 | R-AMAPA | 100 |
| A-44 | 140 | R-AMAPA | 75 |
| A-50 | 140 | R-AMAPA | 90 |
| A-50 | 280 | R-AMAPA | 90 |
| A-46 | 280 | R-AMAPA | 80 |
| A-53 | 140 | R-AMAPA | 85 |
| A-57 | 140 | R-AMAPA | 80 |
| A-49 | 140 | R-AMAPA | 100 |
| A-55 | 280 | R-AMAPA | 35 |
| A-61 | 140 | R-AMAPA | 95 |
| A-48 | 140 | R-AMAPA | 90 |
| A-55 | 140 | R-AMAPA | 50 |
| A-61 | 280 | R-AMAPA | 100 |
| A-48 | 280 | R-AMAPA | 99 |
| A-49 | 280 | R-AMAPA | 99 |
| A-46 | 140 | R-AMAPA | 70 |
| A-47 | 280 | R-AMAPA | 90 |
| A-54 | 280 | R-AMAPA | 25 |
| UNTREATED | | R-AMAPA | 0 |
| A-54 | 140 | R-AMAPA | 15 |
| A-50 | 140 | R-AMAPA | 85 |
| A-44 | 140 | R-AMAPA | 85 |
| A-48 | 140 | R-AMAPA | 75 |
| A-57 | 140 | R-AMAPA | 50 |
| A-44 | 280 | R-AMAPA | 100 |
| A-53 | 140 | R-AMAPA | 85 |
| A-54 | 280 | R-AMAPA | 0 |
| A-46 | 280 | R-AMAPA | 80 |
| A-49 | 280 | R-AMAPA | 92 |
| A-48 | 280 | R-AMAPA | 95 |
| A-50 | 280 | R-AMAPA | 100 |
| A-61 | 140 | R-AMAPA | 98 |
| A-53 | 280 | R-AMAPA | 90 |
| A-47 | 140 | R-AMAPA | 95 |
| A-46 | 140 | R-AMAPA | 75 |
| A-55 | 140 | R-AMAPA | 0 |
| A-47 | 280 | R-AMAPA | 100 |
| A-51 | 140 | R-AMAPA | 100 |
| A-55 | 280 | R-AMAPA | 0 |
| A-61 | 280 | R-AMAPA | 100 |
| A-51 | 280 | R-AMAPA | 85 |
| A-57 | 280 | R-AMAPA | 100 |
| A-49 | 140 | R-AMAPA | 80 |
| A-62 | 140 | R-AMAPA | 73 |
| A-62 | 280 | R-AMAPA | 92 |
| A-63 | 140 | R-AMAPA | 73 |
| A-63 | 280 | R-AMAPA | 87 |
| A-64 | 140 | R-AMAPA | 3 |
| A-64 | 280 | R-AMAPA | 20 |
| A-65 | 140 | R-AMAPA | 33 |
| A-65 | 280 | R-AMAPA | 33 |
| A-66 | 140 | R-AMAPA | 13 |
| A-66 | 280 | R-AMAPA | 5 |
| A-67 | 140 | R-AMAPA | 13 |
| A-67 | 280 | R-AMAPA | 10 |
| A-68 | 140 | R-AMAPA | 42 |
| A-68 | 280 | R-AMAPA | 52 |
| A-69 | 140 | R-AMAPA | 70 |
| A-69 | 280 | R-AMAPA | 80 |
| A-70 | 140 | R-AMAPA | 72 |
| A-70 | 280 | R-AMAPA | 78 |
| A-71 | 140 | R-AMAPA | 70 |
| A-71 | 280 | R-AMAPA | 82 |
| A-72 | 140 | R-AMAPA | 72 |
| A-72 | 280 | R-AMAPA | 83 |
| A-73 | 140 | R-AMAPA | 70 |
| A-73 | 280 | R-AMAPA | 83 |
| A-74 | 140 | R-AMAPA | 68 |
| A-74 | 280 | R-AMAPA | 85 |
| A-75 | 140 | R-AMAPA | 73 |
| A-75 | 280 | R-AMAPA | 91 |
| A-76 | 140 | R-AMAPA | 55 |
| A-76 | 280 | R-AMAPA | 65 |
| A-77 | 140 | R-AMAPA | 82 |
| A-77 | 280 | R-AMAPA | 78 |
| A-78 | 140 | R-AMAPA | 23 |
| A-78 | 280 | R-AMAPA | 32 |
| A-79 | 140 | R-AMAPA | 13 |
| A-79 | 280 | R-AMAPA | 10 |
| A-80 | 140 | R-AMAPA | 20 |
| A-80 | 280 | R-AMAPA | 35 |
| A-81 | 140 | R-AMAPA | 17 |
| A-81 | 280 | R-AMAPA | 15 |
| A-82 | 140 | R-AMAPA | 85 |
| A-82 | 280 | R-AMAPA | 83 |
| A-83 | 140 | R-AMAPA | 70 |
| A-83 | 280 | R-AMAPA | 83 |
| A-84 | 140 | R-AMAPA | 33 |
| A-84 | 280 | R-AMAPA | 28 |
| A-85 | 140 | R-AMAPA | 68 |
| A-85 | 280 | R-AMAPA | 72 |
| A-86 | 140 | R-AMAPA | 72 |
| A-86 | 280 | R-AMAPA | 73 |
| A-87 | 140 | R-AMAPA | 62 |
| A-87 | 280 | R-AMAPA | 53 |
| A-88 | 140 | R-AMAPA | 67 |
| A-88 | 280 | R-AMAPA | 68 |
| A-89 | 140 | R-AMAPA | 70 |
| A-89 | 280 | R-AMAPA | 88 |
| A-90 | 140 | R-AMAPA | 32 |
| A-90 | 280 | R-AMAPA | 40 |
| A-91 | 140 | R-AMAPA | 72 |
| A-91 | 280 | R-AMAPA | 88 |
| A-92 | 140 | R-AMAPA | 78 |
| A-92 | 280 | R-AMAPA | 80 |
| A-93 | 140 | R-AMAPA | 68 |
| A-93 | 280 | R-AMAPA | 80 |
| A-94 | 140 | R-AMAPA | 73 |
| A-94 | 280 | R-AMAPA | 80 |
| A-95 | 140 | R-AMAPA | 42 |
| A-95 | 280 | R-AMAPA | 55 |
| A-140 | 140 | R-AMAPA | 54 |
| A-140 | 280 | R-AMAPA | 59 |
| A-143 | 140 | R-AMAPA | 70 |
| A-143 | 280 | R-AMAPA | 64 |
| A-144 | 140 | R-AMAPA | 59 |
| A-144 | 280 | R-AMAPA | 71 |
| A-145 | 140 | R-AMAPA | 55 |
| A-145 | 280 | R-AMAPA | 65 |
| A-146 | 140 | R-AMAPA | 43 |
| A-146 | 280 | R-AMAPA | 60 |
| A-147 | 140 | R-AMAPA | 43 |
| A-147 | 280 | R-AMAPA | 38 |
| A-49 | 140 | ERICA | 95 |
| A-49 | 280 | ERICA | 98 |
| A-59 | 140 | ERICA | 94 |
| A-59 | 280 | ERICA | 99 |
| A-96 | 140 | ERICA | 0 |
| A-96 | 280 | ERICA | 0 |
| A-25 | 140 | ERICA | 95 |
| A-25 | 280 | ERICA | 90 |
| A-26 | 140 | ERICA | 93 |
| A-26 | 280 | ERICA | 93 |
| A-28 | 140 | ERICA | 70 |
| A-28 | 280 | ERICA | 83 |
| A-29 | 140 | ERICA | 40 |
| A-29 | 280 | ERICA | 40 |
| A-37 | 140 | ERICA | 87 |
| A-37 | 280 | ERICA | 96 |
| A-36 | 140 | ERICA | 83 |
| A-36 | 280 | ERICA | 98 |
| A-35 | 140 | ERICA | 96 |
| A-35 | 280 | ERICA | 99 |
| A-34 | 140 | ERICA | 87 |
| A-34 | 280 | ERICA | 97 |
| A-33 | 140 | ERICA | 87 |
| A-33 | 280 | ERICA | 93 |
| A-30 | 140 | ERICA | 50 |
| A-30 | 280 | ERICA | 22 |
| A-17 | 140 | ERICA | 94 |
| A-17 | 280 | ERICA | 95 |
| A-15 | 140 | ERICA | 98 |
| A-15 | 280 | ERICA | 96 |
| A-12 | 140 | ERICA | 72 |
| A-12 | 280 | ERICA | 87 |
| A-97 | 140 | ERICA | 75 |
| A-97 | 280 | ERICA | 70 |
| A-8 | 140 | ERICA | 98 |
| A-8 | 280 | ERICA | 99 |
| A-38 | 140 | ERICA | 89 |
| A-38 | 280 | ERICA | 97 |
| A-6 | 140 | ERICA | 98 |
| A-6 | 280 | ERICA | 98 |
| A-21 | 140 | ERICA | 95 |
| A-21 | 280 | ERICA | 98 |
| A-16 | 140 | ERICA | 68 |
| A-16 | 280 | ERICA | 78 |
| A-62 | 140 | ERICA | 82 |
| A-62 | 280 | ERICA | 93 |
| A-63 | 140 | ERICA | 85 |
| A-63 | 280 | ERICA | 92 |
| A-64 | 140 | ERICA | 3 |
| A-64 | 280 | ERICA | 10 |
| A-65 | 140 | ERICA | 8 |
| A-65 | 280 | ERICA | 28 |
| A-66 | 140 | ERICA | 0 |
| A-66 | 280 | ERICA | 2 |
| A-67 | 140 | ERICA | 2 |
| A-67 | 280 | ERICA | 3 |
| A-68 | 140 | ERICA | 8 |
| A-68 | 280 | ERICA | 23 |
| A-69 | 140 | ERICA | 88 |
| A-69 | 280 | ERICA | 91 |
| A-70 | 140 | ERICA | 87 |
| A-70 | 280 | ERICA | 93 |
| A-71 | 140 | ERICA | 85 |
| A-71 | 280 | ERICA | 92 |
| A-72 | 140 | ERICA | 83 |
| A-72 | 280 | ERICA | 92 |
| A-73 | 140 | ERICA | 85 |
| A-73 | 280 | ERICA | 80 |
| A-74 | 140 | ERICA | 70 |
| A-74 | 280 | ERICA | 83 |
| A-75 | 140 | ERICA | 72 |
| A-75 | 280 | ERICA | 73 |
| A-76 | 140 | ERICA | 68 |
| A-76 | 280 | ERICA | 55 |
| A-77 | 140 | ERICA | 40 |
| A-77 | 280 | ERICA | 68 |
| A-78 | 140 | ERICA | 5 |
| A-78 | 280 | ERICA | 15 |
| A-79 | 140 | ERICA | 0 |
| A-79 | 280 | ERICA | 2 |
| A-80 | 140 | ERICA | 20 |
| A-80 | 280 | ERICA | 23 |
| A-81 | 140 | ERICA | 0 |
| A-81 | 280 | ERICA | 7 |
| A-82 | 140 | ERICA | 91 |
| A-82 | 280 | ERICA | 96 |
| A-83 | 140 | ERICA | 90 |
| A-83 | 280 | ERICA | 97 |
| A-84 | 140 | ERICA | 37 |
| A-84 | 280 | ERICA | 78 |
| A-85 | 140 | ERICA | 37 |
| A-85 | 280 | ERICA | 68 |
| A-86 | 140 | ERICA | 87 |
| A-86 | 280 | ERICA | 95 |
| A-87 | 140 | ERICA | 30 |
| A-87 | 280 | ERICA | 33 |
| A-88 | 140 | ERICA | 75 |
| A-88 | 280 | ERICA | 94 |
| A-89 | 140 | ERICA | 77 |
| A-89 | 280 | ERICA | 95 |
| A-90 | 140 | ERICA | 30 |
| A-90 | 280 | ERICA | 25 |
| A-91 | 140 | ERICA | 85 |
| A-91 | 280 | ERICA | 88 |
| A-92 | 140 | ERICA | 85 |
| A-92 | 280 | ERICA | 92 |
| A-93 | 140 | ERICA | 63 |
| A-93 | 280 | ERICA | 80 |
| A-94 | 140 | ERICA | 62 |
| A-94 | 280 | ERICA | 77 |
| A-95 | 140 | ERICA | 8 |
| A-95 | 280 | ERICA | 17 |
| A-46 | 140 | GLXMA | 10 |
| A-46 | 280 | GLXMA | 10 |
| A-47 | 140 | GLXMA | 10 |
| A-47 | 280 | GLXMA | 0 |
| A-55 | 140 | GLXMA | 0 |
| A-55 | 280 | GLXMA | 5 |
| A-48 | 140 | GLXMA | 10 |
| A-48 | 280 | GLXMA | 12 |
| A-44 | 140 | GLXMA | 5 |
| A-44 | 280 | GLXMA | 10 |
| A-53 | 140 | GLXMA | 8 |
| A-53 | 280 | GLXMA | 10 |
| A-50 | 140 | GLXMA | 5 |
| A-50 | 280 | GLXMA | 3 |
| A-57 | 140 | GLXMA | 3 |
| A-57 | 280 | GLXMA | 3 |
| A-49 | 140 | GLXMA | 12 |
| A-49 | 280 | GLXMA | 8 |
| A-51 | 140 | GLXMA | 10 |
| A-51 | 280 | GLXMA | 10 |
| A-54 | 140 | GLXMA | 3 |
| A-54 | 280 | GLXMA | 10 |
| A-61 | 140 | GLXMA | 5 |
| A-61 | 280 | GLXMA | 5 |
| UNTREATED | | GLXMA | 0 |
| A-44 | 280 | GLXMA | 0 |
| UNTREATED | | GLXMA | 0 |
| A-57 | 280 | GLXMA | 3 |
| A-51 | 140 | GLXMA | 0 |
| A-54 | 140 | GLXMA | 5 |
| A-53 | 280 | GLXMA | 18 |
| A-51 | 280 | GLXMA | 5 |
| A-47 | 140 | GLXMA | 5 |
| A-44 | 140 | GLXMA | 3 |
| A-50 | 140 | GLXMA | 0 |
| A-50 | 280 | GLXMA | 0 |
| A-46 | 280 | GLXMA | 5 |
| A-53 | 140 | GLXMA | 3 |
| A-57 | 140 | GLXMA | 5 |
| A-49 | 140 | GLXMA | 10 |
| A-55 | 280 | GLXMA | 3 |
| A-61 | 140 | GLXMA | 0 |
| A-48 | 140 | GLXMA | NT |
| A-55 | 140 | GLXMA | 10 |
| A-61 | 280 | GLXMA | 5 |
| A-48 | 280 | GLXMA | 0 |
| A-49 | 280 | GLXMA | 0 |
| A-46 | 140 | GLXMA | NT |
| A-47 | 280 | GLXMA | 5 |
| A-54 | 280 | GLXMA | 5 |
| UNTREATED | | GLXMA | 0 |
| A-54 | 140 | GLXMA | 5 |
| A-50 | 140 | GLXMA | 8 |
| A-44 | 140 | GLXMA | 8 |
| A-48 | 140 | GLXMA | 0 |
| A-57 | 140 | GLXMA | NT |
| A-44 | 280 | GLXMA | 3 |
| A-53 | 140 | GLXMA | 5 |
| A-54 | 280 | GLXMA | 5 |
| A-46 | 280 | GLXMA | 5 |
| A-49 | 280 | GLXMA | 0 |
| A-48 | 280 | GLXMA | 0 |
| A-50 | 280 | GLXMA | 3 |
| A-61 | 140 | GLXMA | 5 |
| A-53 | 280 | GLXMA | 3 |
| A-47 | 140 | GLXMA | 0 |
| A-46 | 140 | GLXMA | 12 |
| A-55 | 140 | GLXMA | 0 |
| A-47 | 280 | GLXMA | 5 |
| A-51 | 140 | GLXMA | 8 |
| A-55 | 280 | GLXMA | 0 |
| A-61 | 280 | GLXMA | 12 |
| A-51 | 280 | GLXMA | 0 |
| A-57 | 280 | GLXMA | 18 |
| A-49 | 140 | GLXMA | 0 |
| A-62 | 140 | GLXMA | 3 |
| A-62 | 280 | GLXMA | 3 |
| A-63 | 140 | GLXMA | 2 |
| A-63 | 280 | GLXMA | 5 |
| A-64 | 140 | GLXMA | 2 |
| A-64 | 280 | GLXMA | 1 |
| A-65 | 140 | GLXMA | 17 |
| A-65 | 280 | GLXMA | 38 |
| A-66 | 140 | GLXMA | 3 |
| A-66 | 280 | GLXMA | 3 |
| A-67 | 140 | GLXMA | 1 |
| A-67 | 280 | GLXMA | 4 |
| A-68 | 140 | GLXMA | 2 |
| A-68 | 280 | GLXMA | 3 |
| A-69 | 140 | GLXMA | 4 |
| A-69 | 280 | GLXMA | 5 |
| A-70 | 140 | GLXMA | 2 |
| A-70 | 280 | GLXMA | 3 |
| A-71 | 140 | GLXMA | 1 |
| A-71 | 280 | GLXMA | 3 |
| A-72 | 140 | GLXMA | 1 |
| A-72 | 280 | GLXMA | 5 |
| A-73 | 140 | GLXMA | 1 |
| A-73 | 280 | GLXMA | 4 |
| A-74 | 140 | GLXMA | 2 |
| A-74 | 280 | GLXMA | 3 |
| A-75 | 140 | GLXMA | 3 |
| A-75 | 280 | GLXMA | 3 |
| A-76 | 140 | GLXMA | 4 |
| A-76 | 280 | GLXMA | 4 |
| A-77 | 140 | GLXMA | 8 |
| A-77 | 280 | GLXMA | 8 |
| A-78 | 140 | GLXMA | 25 |
| A-78 | 280 | GLXMA | 67 |
| A-79 | 140 | GLXMA | 6 |
| A-79 | 280 | GLXMA | 3 |
| A-80 | 140 | GLXMA | 2 |
| A-80 | 280 | GLXMA | 4 |
| A-81 | 140 | GLXMA | 19 |
| A-81 | 280 | GLXMA | 20 |
| A-82 | 140 | GLXMA | 27 |
| A-82 | 280 | GLXMA | 7 |
| A-83 | 140 | GLXMA | 22 |
| A-83 | 280 | GLXMA | 15 |
| A-84 | 140 | GLXMA | 8 |
| A-84 | 280 | GLXMA | 38 |
| A-85 | 140 | GLXMA | 5 |
| A-85 | 280 | GLXMA | 7 |
| A-86 | 140 | GLXMA | 32 |
| A-86 | 280 | GLXMA | 25 |
| A-87 | 140 | GLXMA | 5 |
| A-87 | 280 | GLXMA | 28 |
| A-88 | 140 | GLXMA | 10 |
| A-88 | 280 | GLXMA | 3 |
| A-89 | 140 | GLXMA | 13 |
| A-89 | 280 | GLXMA | 5 |
| A-90 | 140 | GLXMA | 8 |
| A-90 | 280 | GLXMA | 3 |
| A-91 | 140 | GLXMA | 3 |
| A-91 | 280 | GLXMA | 3 |
| A-92 | 140 | GLXMA | 2 |
| A-92 | 280 | GLXMA | 4 |
| A-93 | 140 | GLXMA | 10 |
| A-93 | 280 | GLXMA | 5 |
| A-94 | 140 | GLXMA | 12 |
| A-94 | 280 | GLXMA | 3 |
| A-95 | 140 | GLXMA | 4 |
| A-95 | 280 | GLXMA | 6 |

TABLE 4b
Effect of Specific Representative Compounds on the Growth of Some
Crop Weeds and One Commercially Available Variety of Soybeans.

| Compound No. | Rate (g ae/ha) | Species | Control/Injury |
|---|---|---|---|
| Dicamba | 140 | AMAPA | 78 |
| Dicamba | 280 | AMAPA | 94 |
| A-122 | 140 | AMAPA | 28 |
| A-122 | 280 | AMAPA | 45 |
| A-131 | 140 | AMAPA | 23 |
| A-131 | 280 | AMAPA | 38 |
| A-104 | 140 | AMAPA | 45 |
| A-104 | 280 | AMAPA | 65 |
| A-119 | 140 | AMAPA | 8 |
| A-119 | 280 | AMAPA | 20 |
| A-135 | 140 | AMAPA | 6 |
| A-135 | 280 | AMAPA | 10 |
| A-107 | 140 | AMAPA | 9 |
| A-107 | 280 | AMAPA | 18 |
| A-114 | 140 | AMAPA | 5 |
| A-114 | 280 | AMAPA | 5 |
| A-123 | 140 | AMAPA | 2 |
| A-123 | 280 | AMAPA | 3 |
| A-109 | 140 | AMAPA | 8 |
| A-109 | 280 | AMAPA | 5 |
| A-110 | 140 | AMAPA | 7 |
| A-110 | 280 | AMAPA | 10 |
| A-116 | 140 | AMAPA | 8 |
| A-116 | 280 | AMAPA | 30 |
| A-101 | 140 | AMAPA | 18 |
| A-101 | 280 | AMAPA | 13 |
| A-120 | 140 | AMAPA | 28 |
| A-120 | 280 | AMAPA | 45 |
| A-115 | 140 | AMAPA | 20 |
| A-115 | 280 | AMAPA | 38 |
| A-97 | 140 | AMAPA | 50 |
| A-97 | 280 | AMAPA | 65 |
| A-126 | 140 | AMAPA | 33 |
| A-126 | 280 | AMAPA | 35 |
| A-105 | 140 | AMAPA | 18 |
| A-105 | 280 | AMAPA | 25 |
| A-150 | 140 | AMAPA | 75 |
| A-150 | 280 | AMAPA | 97 |
| A-106 | 140 | AMAPA | 25 |
| A-106 | 280 | AMAPA | 20 |
| A-124 | 140 | AMAPA | 4 |
| A-124 | 280 | AMAPA | 3 |
| A-108 | 140 | AMAPA | 8 |
| A-108 | 280 | AMAPA | 28 |
| A-94 | 140 | AMAPA | 83 |
| A-94 | 280 | AMAPA | 99 |
| A-130 | 140 | AMAPA | 18 |
| A-130 | 280 | AMAPA | 20 |
| A-103 | 140 | AMAPA | 35 |
| A-103 | 280 | AMAPA | 30 |
| A-113 | 140 | AMAPA | 40 |
| A-113 | 280 | AMAPA | 70 |
| A-95 | 140 | AMAPA | 5 |
| A-95 | 280 | AMAPA | 13 |
| A-150 | 140 | AMAPA | 93 |
| A-150 | 280 | AMAPA | 95 |
| A-111 | 140 | AMAPA | 20 |
| A-111 | 280 | AMAPA | 33 |
| A-127 | 140 | AMAPA | 20 |
| A-127 | 280 | AMAPA | 23 |
| A-118 | 140 | AMAPA | 63 |
| A-118 | 280 | AMAPA | 73 |
| A-121 | 140 | AMAPA | 75 |
| A-121 | 280 | AMAPA | 85 |
| A-129 | 140 | AMAPA | 8 |
| A-129 | 280 | AMAPA | 20 |
| A-98 | 140 | AMAPA | 23 |
| A-98 | 280 | AMAPA | 20 |
| A-112 | 140 | AMAPA | 18 |
| A-112 | 280 | AMAPA | 33 |
| A-125 | 140 | AMAPA | 15 |
| A-125 | 280 | AMAPA | 12 |
| A-132 | 140 | AMAPA | 20 |
| A-132 | 280 | AMAPA | 30 |
| A-100 | 140 | AMAPA | 0 |
| A-100 | 280 | AMAPA | 15 |
| A-99 | 140 | AMAPA | 90 |
| A-99 | 280 | AMAPA | 80 |
| A-134 | 140 | AMAPA | 15 |
| A-134 | 280 | AMAPA | 15 |
| A-117 | 140 | AMAPA | 83 |
| A-117 | 280 | AMAPA | 89 |
| A-102 | 140 | AMAPA | 25 |
| A-102 | 280 | AMAPA | 35 |
| A-133 | 140 | AMAPA | 10 |
| A-133 | 280 | AMAPA | 15 |
| A-128 | 140 | AMAPA | 3 |
| A-128 | 280 | AMAPA | 5 |
| A-136 | 140 | AMAPA | 85 |
| A-136 | 280 | AMAPA | 90 |
| A-137 | 140 | AMAPA | 15 |
| A-137 | 280 | AMAPA | 15 |
| A-138 | 140 | AMAPA | 73 |
| A-138 | 280 | AMAPA | 59 |
| A-150 | 140 | AMAPA | 80 |
| A-150 | 280 | AMAPA | 78 |
| Untreated | | AMAPA | 0 |
| Dicamba | 140 | AMATA | 99 |
| Dicamba | 280 | AMATA | 90 |
| A-122 | 140 | AMATA | 38 |
| A-122 | 280 | AMATA | 50 |
| A 131 | 140 | AMATA | 40 |
| A-131 | 280 | AMATA | 30 |
| A-104 | 140 | AMATA | 73 |
| A-104 | 280 | AMATA | 92 |
| A-119 | 140 | AMATA | 20 |
| A-119 | 280 | AMATA | 13 |
| A-135 | 140 | AMATA | 0 |
| A-135 | 280 | AMATA | 5 |
| A-107 | 140 | AMATA | 2 |
| A-107 | 280 | AMATA | 18 |
| A-114 | 140 | AMATA | 0 |
| A-114 | 280 | AMATA | 5 |
| A-123 | 140 | AMATA | 0 |
| A-123 | 280 | AMATA | 8 |
| A-109 | 140 | AMATA | 2 |
| A-109 | 280 | AMATA | 3 |
| A-110 | 140 | AMATA | 2 |
| A-110 | 280 | AMATA | 8 |
| A-116 | 140 | AMATA | 5 |
| A-116 | 280 | AMATA | 33 |
| A-101 | 140 | AMATA | 18 |
| A-101 | 280 | AMATA | 33 |
| A-120 | 140 | AMATA | 40 |
| A-120 | 280 | AMATA | 58 |
| A-115 | 140 | AMATA | 15 |
| A-115 | 280 | AMATA | 38 |
| A-97 | 140 | AMATA | 55 |
| A-97 | 280 | AMATA | 68 |
| A-126 | 140 | AMATA | 45 |
| A-126 | 280 | AMATA | 55 |
| A-105 | 140 | AMATA | 25 |
| A-105 | 280 | AMATA | 38 |
| A-150 | 140 | AMATA | 85 |
| A-150 | 280 | AMATA | 100 |
| A-106 | 140 | AMATA | 25 |
| A-106 | 280 | AMATA | 28 |
| A-124 | 140 | AMATA | 3 |
| A-124 | 280 | AMATA | 10 |
| A-108 | 140 | AMATA | 18 |
| A-108 | 280 | AMATA | 28 |
| A-94 | 140 | AMATA | 81 |
| A-94 | 280 | AMATA | 99 |
| A-130 | 140 | AMATA | 20 |
| A-130 | 280 | AMATA | 28 |
| A-103 | 140 | AMATA | 8 |
| A-103 | 280 | AMATA | 18 |
| A-113 | 140 | AMATA | 50 |
| A-113 | 280 | AMATA | 63 |
| A-95 | 140 | AMATA | 4 |
| A-95 | 280 | AMATA | 10 |
| A-150 | 140 | AMATA | 90 |
| A-150 | 280 | AMATA | 100 |
| A-111 | 140 | AMATA | 18 |
| A-111 | 280 | AMATA | 28 |
| A-127 | 140 | AMATA | 30 |
| A-127 | 280 | AMATA | 35 |
| A-118 | 140 | AMATA | 68 |
| A-118 | 280 | AMATA | 80 |
| A-121 | 140 | AMATA | 75 |
| A-121 | 280 | AMATA | 94 |
| A-129 | 140 | AMATA | 20 |
| A-129 | 280 | AMATA | 23 |
| A-98 | 140 | AMATA | 18 |
| A-98 | 280 | AMATA | 13 |
| A-112 | 140 | AMATA | 13 |
| A-112 | 280 | AMATA | 20 |
| A-125 | 140 | AMATA | 8 |
| A-125 | 280 | AMATA | 13 |
| A-132 | 140 | AMATA | 18 |
| A-132 | 280 | AMATA | 18 |
| A-100 | 140 | AMATA | 0 |
| A-100 | 280 | AMATA | 19 |
| A-99 | 140 | AMATA | 84 |
| A-99 | 280 | AMATA | 78 |
| A-134 | 140 | AMATA | 15 |
| A-134 | 280 | AMATA | 8 |
| A-117 | 140 | AMATA | 85 |
| A-117 | 280 | AMATA | 85 |
| A-102 | 140 | AMATA | 35 |
| A-102 | 280 | AMATA | 58 |
| A-133 | 140 | AMATA | 8 |
| A-133 | 280 | AMATA | 5 |
| A-128 | 140 | AMATA | 3 |
| A-128 | 280 | AMATA | 8 |
| A-136 | 140 | AMATA | 68 |
| A-136 | 280 | AMATA | 74 |
| A-137 | 140 | AMATA | 1 |
| A-137 | 280 | AMATA | 8 |
| A-138 | 140 | AMATA | 65 |
| A-138 | 280 | AMATA | 64 |
| A-150 | 140 | AMATA | 64 |
| A-150 | 280 | AMATA | 75 |
| A-140 | 140 | AMATA | 70 |
| A-140 | 280 | AMATA | 68 |
| A-143 | 140 | AMATA | 73 |
| A-143 | 280 | AMATA | 48 |
| A-144 | 140 | AMATA | 71 |
| A-144 | 280 | AMATA | 77 |
| A-145 | 140 | AMATA | 60 |
| A-145 | 280 | AMATA | 64 |
| A-146 | 140 | AMATA | 70 |
| A-146 | 280 | AMATA | 63 |
| A-147 | 140 | AMATA | 59 |
| A-147 | 280 | AMATA | 49 |
| Untreated | | AMATA | 0 |
| Dicamba | 140 | AMBEL | 97 |
| Dicamba | 280 | AMBEL A-1 | 100 |
| A-122 | 140 | AMBEL | 73 |
| A-122 | 280 | AMBEL | 97 |
| A131 | 140 | AMBEL | 48 |
| A131 | 280 | AMBEL | 58 |
| A-104 | 140 | AMBEL | 5 |
| A-104 | 280 | AMBEL | 15 |
| A-119 | 140 | AMBEL | 5 |
| A-119 | 280 | AMBEL | 10 |
| A-135 | 140 | AMBEL | 23 |
| A-135 | 280 | AMBEL | 35 |
| A-107 | 140 | AMBEL | 10 |
| A-107 | 280 | AMBEL | 18 |
| A-114 | 140 | AMBEL | 5 |
| A-114 | 280 | AMBEL | 0 |
| A-123 | 140 | AMBEL | 5 |
| A-123 | 280 | AMBEL | 5 |
| A-109 | 140 | AMBEL | 23 |
| A-109 | 280 | AMBEL | 20 |
| A-110 | 140 | AMBEL | 13 |
| A-110 | 280 | AMBEL | 18 |
| A-116 | 140 | AMBEL | 3 |
| A-116 | 280 | AMBEL | 10 |
| A-101 | 140 | AMBEL | 25 |
| A-101 | 280 | AMBEL | 15 |
| A-120 | 140 | AMBEL | 68 |
| A-120 | 280 | AMBEL | 85 |
| A-115 | 140 | AMBEL | 5 |
| A-115 | 280 | AMBEL | 28 |
| A-97 | 140 | AMBEL | 73 |
| A-97 | 280 | AMBEL | 90 |
| A-126 | 140 | AMBEL | 33 |
| A-126 | 280 | AMBEL | 50 |
| A-105 | 140 | AMBEL | 40 |
| A-105 | 280 | AMBEL | 43 |
| A-150 | 140 | AMBEL | 90 |
| A-150 | 280 | AMBEL | 99 |
| A-106 | 140 | AMBEL | 25 |
| A-106 | 280 | AMBEL | 28 |
| A-124 | 140 | AMBEL | 20 |
| A-124 | 280 | AMBEL | 28 |
| A-108 | 140 | AMBEL | 5 |
| A-108 | 280 | AMBEL | 15 |
| A-94 | 140 | AMBEL | 93 |
| A-94 | 280 | AMBEL | 98 |
| A-130 | 140 | AMBEL | 40 |
| A-130 | 280 | AMBEL | 48 |
| A-103 | 140 | AMBEL | 28 |
| A-103 | 280 | AMBEL | 12 |
| A-113 | 140 | AMBEL | 70 |
| A-113 | 280 | AMBEL | 90 |
| A-95 | 140 | AMBEL | 13 |
| A-95 | 280 | AMBEL | 23 |
| A-150 | 140 | AMBEL | 91 |
| A-150 | 280 | AMBEL | 99 |
| A-111 | 140 | AMBEL | 25 |
| A-111 | 280 | AMBEL | 35 |
| A-127 | 140 | AMBEL | 30 |
| A-127 | 280 | AMBEL | 63 |
| A-118 | 140 | AMBEL | 80 |
| A-118 | 280 | AMBEL | 97 |
| A-121 | 140 | AMBEL | 88 |
| A-121 | 280 | AMBEL | 98 |
| A-129 | 140 | AMBEL | 10 |
| A-129 | 280 | AMBEL | 15 |
| A-98 | 140 | AMBEL | 20 |
| A-98 | 280 | AMBEL | 15 |
| A-112 | 140 | AMBEL | 18 |
| A-112 | 280 | AMBEL | 38 |
| A-125 | 140 | AMBEL | 10 |
| A-125 | 280 | AMBEL | 8 |
| A-132 | 140 | AMBEL | 38 |
| A-132 | 280 | AMBEL | 33 |
| A-100 | 140 | AMBEL | 5 |
| A-100 | 280 | AMBEL | 20 |
| A-99 | 140 | AMBEL | 96 |
| A-99 | 280 | AMBEL | 95 |
| A-134 | 140 | AMBEL | 33 |
| A-134 | 280 | AMBEL | 30 |
| A-117 | 140 | AMBEL | 90 |
| A-117 | 280 | AMBEL | 97 |
| A-102 | 140 | AMBEL | 50 |
| A-102 | 280 | AMBEL | 70 |
| A-133 | 140 | AMBEL | 3 |
| A-133 | 280 | AMBEL | 8 |
| A-128 | 140 | AMBEL | 3 |
| A-128 | 280 | AMBEL | 5 |
| A-136 | 140 | AMBEL | 87 |
| A-136 | 280 | AMBEL | 96 |
| A-137 | 140 | AMBEL | 33 |
| A-137 | 280 | AMBEL | 36 |
| A-138 | 140 | AMBEL | 79 |
| A-138 | 280 | AMBEL | 76 |
| A-150 | 140 | AMBEL | 87 |
| A-150 | 280 | AMBEL | 93 |
| A-140 | 140 | AMBEL | 94 |
| A-140 | 280 | AMBEL | 94 |
| A-143 | 140 | AMBEL | 86 |
| A-143 | 280 | AMBEL | 86 |
| A-144 | 140 | AMBEL | 88 |
| A-144 | 280 | AMBEL | 88 |
| A-145 | 140 | AMBEL | 88 |
| A-145 | 280 | AMBEL | 96 |
| A-146 | 140 | AMBEL | 83 |
| A-146 | 280 | AMBEL | 86 |
| A-147 | 140 | AMBEL | 80 |
| A-147 | 280 | AMBEL | 81 |
| Untreated | | AMBEL | 0 |
| Dicamba | 140 | ERICA | 94 |
| Dicamba | 280 | ERICA | 100 |
| A-122 | 140 | ERICA | 95 |
| A-122 | 280 | ERICA | 100 |
| A-131 | 140 | ERICA | 28 |
| A-131 | 280 | ERICA | 30 |
| A-104 | 140 | ERICA | 0 |
| A-104 | 280 | ERICA | 10 |
| A-119 | 140 | ERICA | 0 |
| A-119 | 280 | ERICA | 10 |
| A-135 | 140 | ERICA | 10 |
| A-135 | 280 | ERICA | 25 |
| A-107 | 140 | ERICA | 3 |
| A-107 | 280 | ERICA | 5 |
| A-114 | 140 | ERICA | 2 |
| A-114 | 280 | ERICA | 7 |
| A-123 | 140 | ERICA | 0 |
| A-123 | 280 | ERICA | 0 |
| A-109 | 140 | ERICA | 3 |
| A-109 | 280 | ERICA | 5 |
| A-110 | 140 | ERICA | 0 |
| A-110 | 280 | ERICA | 5 |
| A-116 | 140 | ERICA | 3 |
| A-116 | 280 | ERICA | 5 |
| A-101 | 140 | ERICA | 0 |
| A-101 | 280 | ERICA | 8 |
| A-120 | 140 | ERICA | 85 |
| A-120 | 280 | ERICA | 99 |
| A-115 | 140 | ERICA | 3 |
| A-115 | 280 | ERICA | 13 |
| A-97 | 140 | ERICA | 18 |
| A-97 | 280 | ERICA | 40 |
| A-126 | 140 | ERICA | 15 |
| A-126 | 280 | ERICA | 33 |
| A-105 | 140 | ERICA | 38 |
| A-105 | 280 | ERICA | 45 |
| A-150 | 140 | ERICA | 98 |
| A-150 | 280 | ERICA | 97 |
| A-106 | 140 | ERICA | 5 |
| A-106 | 280 | ERICA | 10 |
| A-124 | 140 | ERICA | 0 |
| A-124 | 280 | ERICA | 3 |
| A-108 | 140 | ERICA | 5 |
| A-108 | 280 | ERICA | 8 |
| A-94 | 140 | ERICA | 95 |
| A-94 | 280 | ERICA | 99 |
| A-130 | 140 | ERICA | 13 |
| A-130 | 280 | ERICA | 28 |
| A-103 | 140 | ERICA | 0 |
| A-103 | 280 | ERICA | 3 |
| A-113 | 140 | ERICA | 50 |
| A-113 | 280 | ERICA | 99 |
| A-95 | 140 | ERICA | 3 |
| A-95 | 280 | ERICA | 5 |
| A-150 | 140 | ERICA | 98 |
| A-150 | 280 | ERICA | 98 |
| A-111 | 140 | ERICA | 8 |
| A-111 | 280 | ERICA | 10 |
| A-127 | 140 | ERICA | 18 |
| A-127 | 280 | ERICA | 13 |
| A-118 | 140 | ERICA | 93 |
| A-118 | 280 | ERICA | 96 |
| A-121 | 140 | ERICA | 97 |
| A-121 | 280 | ERICA | 99 |
| A-129 | 140 | ERICA | 38 |
| A-129 | 280 | ERICA | 0 |
| A-98 | 140 | ERICA | 2 |
| A-98 | 280 | ERICA | 3 |
| A-112 | 140 | ERICA | 10 |
| A-112 | 280 | ERICA | 10 |
| A-125 | 140 | ERICA | 5 |
| A-125 | 280 | ERICA | 10 |
| A-132 | 140 | ERICA | 23 |
| A-132 | 280 | ERICA | 8 |
| A-100 | 140 | ERICA | 8 |
| A-100 | 280 | ERICA | 13 |
| A-99 | 140 | ERICA | 97 |
| A-99 | 280 | ERICA | 99 |
| A-134 | 140 | ERICA | 5 |
| A-134 | 280 | ERICA | 10 |
| A-117 | 140 | ERICA | 98 |
| A-117 | 280 | ERICA | 95 |
| A-102 | 140 | ERICA | 18 |
| A-102 | 280 | ERICA | 30 |
| A-133 | 140 | ERICA | 3 |
| A-133 | 280 | ERICA | 3 |
| A-128 | 140 | ERICA | 3 |
| A-128 | 280 | ERICA | 5 |
| A-136 | 140 | ERICA | 94 |
| A-136 | 280 | ERICA | 99 |
| A-137 | 140 | ERICA | 0 |
| A-137 | 280 | ERICA | 0 |
| A-138 | 140 | ERICA | 75 |
| A-138 | 280 | ERICA | 70 |
| A-150 | 140 | ERICA | 95 |
| A-150 | 280 | ERICA | 98 |
| A-140 | 140 | ERICA | 83 |
| A-140 | 280 | ERICA | 83 |
| A-143 | 140 | ERICA | 80 |
| A-143 | 280 | ERICA | 93 |
| A-144 | 140 | ERICA | 83 |
| A-144 | 280 | ERICA | 75 |
| A-145 | 140 | ERICA | 83 |
| A-145 | 280 | ERICA | 78 |
| A-146 | 140 | ERICA | 73 |
| A-146 | 280 | ERICA | 63 |
| A-147 | 140 | ERICA | 50 |
| A-147 | 280 | ERICA | 60 |
| Untreated | | ERICA | 0 |
| Dicamba | 140 | GLXMA | 2 |
| Dicamba | 280 | GLXMA | 4 |
| A-122 | 140 | GLXMA | 2 |
| A-122 | 280 | GLXMA | 8 |
| A-131 | 140 | GLXMA | 3 |
| A-131 | 280 | GLXMA | 8 |
| A-104 | 140 | GLXMA | 63 |
| A-104 | 280 | GLXMA | 78 |
| A-119 | 140 | GLXMA | 1 |
| A-119 | 280 | GLXMA | 3 |
| A-135 | 140 | GLXMA | 1 |
| A-135 | 280 | GLXMA | 5 |
| A-107 | 140 | GLXMA | 3 |
| A-107 | 280 | GLXMA | 4 |
| A-114 | 140 | GLXMA | 3 |
| A-114 | 280 | GLXMA | 3 |
| A-123 | 140 | GLXMA | 2 |
| A-123 | 280 | GLXMA | 1 |
| A-109 | 140 | GLXMA | 2 |
| A-109 | 280 | GLXMA | 3 |
| A-110 | 140 | GLXMA | 9 |
| A-110 | 280 | GLXMA | 5 |
| A-116 | 140 | GLXMA | 2 |
| A-116 | 280 | GLXMA | 2 |
| A-101 | 140 | GLXMA | 13 |
| A-101 | 280 | GLXMA | 7 |
| A-120 | 140 | GLXMA | 5 |
| A-120 | 280 | GLXMA | 5 |
| A-115 | 140 | GLXMA | 3 |
| A-115 | 280 | GLXMA | 5 |
| A-97 | 140 | GLXMA | 4 |
| A-97 | 280 | GLXMA | 7 |
| A-126 | 140 | GLXMA | 5 |
| A-126 | 280 | GLXMA | 3 |
| A-105 | 140 | GLXMA | 8 |
| A-105 | 280 | GLXMA | 23 |
| A-150 | 140 | GLXMA | 13 |
| A-150 | 280 | GLXMA | 8 |
| A-106 | 140 | GLXMA | 8 |
| A-106 | 280 | GLXMA | 9 |
| A-124 | 140 | GLXMA | 5 |
| A-124 | 280 | GLXMA | 10 |
| A-108 | 140 | GLXMA | 8 |
| A-108 | 280 | GLXMA | 4 |
| A-94 | 140 | GLXMA | 15 |
| A-94 | 280 | GLXMA | 15 |
| A-130 | 140 | GLXMA | 28 |
| A-130 | 280 | GLXMA | 8 |
| A-103 | 140 | GLXMA | 7 |
| A-103 | 280 | GLXMA | 48 |
| A-113 | 140 | GLXMA | 20 |
| A-113 | 280 | GLXMA | 18 |
| A-95 | 140 | GLXMA | 15 |
| A-95 | 280 | GLXMA | 15 |
| A-150 | 140 | GLXMA | 18 |
| A-150 | 280 | GLXMA | 8 |
| A-111 | 140 | GLXMA | 13 |
| A-111 | 280 | GLXMA | 8 |
| A-127 | 140 | GLXMA | 33 |
| A-127 | 280 | GLXMA | 35 |
| A-118 | 140 | GLXMA | 8 |
| A-118 | 280 | GLXMA | 8 |
| A-121 | 140 | GLXMA | 10 |
| A-121 | 280 | GLXMA | 8 |
| A-129 | 140 | GLXMA | 8 |
| A-129 | 280 | GLXMA | 18 |
| A-98 | 140 | GLXMA | 3 |
| A-98 | 280 | GLXMA | 5 |
| A-112 | 140 | GLXMA | 4 |
| A-112 | 280 | GLXMA | 3 |
| A-125 | 140 | GLXMA | 6 |
| A-125 | 280 | GLXMA | 7 |
| A-132 | 140 | GLXMA | 5 |
| A-132 | 280 | GLXMA | 8 |
| A-100 | 140 | GLXMA | 3 |
| A-100 | 280 | GLXMA | 4 |
| A-99 | 140 | GLXMA | 5 |
| A-99 | 280 | GLXMA | 29 |
| A-134 | 140 | GLXMA | 28 |
| A-134 | 280 | GLXMA | 30 |
| A-117 | 140 | GLXMA | 35 |
| A-117 | 280 | GLXMA | 28 |
| A-102 | 140 | GLXMA | 13 |
| A-102 | 280 | GLXMA | 30 |
| A-133 | 140 | GLXMA | 8 |
| A-133 | 280 | GLXMA | 5 |
| A-128 | 140 | GLXMA | 10 |
| A-128 | 280 | GLXMA | 15 |
| A-140 | 140 | GLXMA | 0 |
| A-140 | 280 | GLXMA | 1 |
| A-143 | 140 | GLXMA | 0 |
| A-143 | 280 | GLXMA | 0 |
| A-144 | 140 | GLXMA | 0 |
| A-144 | 280 | GLXMA | 0 |
| A-145 | 140 | GLXMA | 0 |
| A-145 | 280 | GLXMA | 1 |
| A-146 | 140 | GLXMA | 0 |
| A-146 | 280 | GLXMA | 0 |
| A-147 | 140 | GLXMA | 0 |
| A-147 | 280 | GLXMA | 1 |
| Untreated | | GLXMA | 8 |
| Dicamba | 140 | KCHSC | 94 |
| Dicamba | 280 | KCHSC | 97 |
| A-122 | 140 | KCHSC | 80 |
| A-122 | 280 | KCHSC | 93 |
| A131 | 140 | KCHSC | 30 |
| A131 | 280 | KCHSC | 38 |
| A-104 | 140 | KCHSC | 3 |
| A-104 | 280 | KCHSC | 13 |
| A-119 | 140 | KCHSC | 10 |
| A-119 | 280 | KCHSC | 3 |
| A-135 | 140 | KCHSC | 3 |
| A-135 | 280 | KCHSC | 3 |
| A-107 | 140 | KCHSC | 0 |
| A-107 | 280 | KCHSC | 0 |
| A-114 | 140 | KCHSC | 0 |
| A-114 | 280 | KCHSC | 0 |
| A-123 | 140 | KCHSC | 0 |
| A-123 | 280 | KCHSC | 0 |
| A-109 | 140 | KCHSC | 0 |
| A-109 | 280 | KCHSC | 3 |
| A-110 | 140 | KCHSC | 0 |
| A-110 | 280 | KCHSC | 0 |
| A-116 | 140 | KCHSC | 0 |
| A-116 | 280 | KCHSC | 5 |
| A-101 | 140 | KCHSC | 0 |
| A-101 | 280 | KCHSC | 0 |
| A-120 | 140 | KCHSC | 63 |
| A-120 | 280 | KCHSC | 85 |
| A-115 | 140 | KCHSC | 8 |
| A-115 | 280 | KCHSC | 13 |
| A-97 | 140 | KCHSC | 73 |
| A-97 | 280 | KCHSC | 88 |
| A-126 | 140 | KCHSC | 28 |
| A-126 | 280 | KCHSC | 50 |
| A-105 | 140 | KCHSC | 28 |
| A-105 | 280 | KCHSC | 30 |
| A-150 | 140 | KCHSC | 88 |
| A-150 | 280 | KCHSC | 99 |
| A-106 | 140 | KCHSC | 3 |
| A-106 | 280 | KCHSC | 3 |
| A-124 | 140 | KCHSC | 0 |
| A-124 | 280 | KCHSC | 0 |
| A-108 | 140 | KCHSC | 0 |
| A-108 | 280 | KCHSC | 3 |
| A-94 | 140 | KCHSC | 93 |
| A-94 | 280 | KCHSC | 98 |
| A-130 | 140 | KCHSC | 45 |
| A-130 | 280 | KCHSC | 45 |
| A-103 | 140 | KCHSC | 0 |
| A-103 | 280 | KCHSC | 3 |
| A-113 | 140 | KCHSC | 85 |
| A-113 | 280 | KCHSC | 93 |
| A-95 | 140 | KCHSC | 3 |
| A-95 | 280 | KCHSC | 3 |
| A-150 | 140 | KCHSC | 93 |
| A-150 | 280 | KCHSC | 100 |
| A-111 | 140 | KCHSC | 5 |
| A-111 | 280 | KCHSC | 5 |
| A-127 | 140 | KCHSC | 3 |
| A-127 | 280 | KCHSC | 5 |
| A-118 | 140 | KCHSC | 83 |
| A-118 | 280 | KCHSC | 99 |
| A-121 | 140 | KCHSC | 83 |
| A-121 | 280 | KCHSC | 96 |
| A-129 | 140 | KCHSC | 0 |
| A-129 | 280 | KCHSC | 5 |
| A-98 | 140 | KCHSC | 8 |
| A-98 | 280 | KCHSC | 0 |
| A-112 | 140 | KCHSC | 0 |
| A-112 | 280 | KCHSC | 18 |
| A-125 | 140 | KCHSC | 0 |
| A-125 | 280 | KCHSC | 10 |
| A-132 | 140 | KCHSC | 8 |
| A-132 | 280 | KCHSC | 15 |
| A-100 | 140 | KCHSC | 0 |
| A-100 | 280 | KCHSC | 0 |
| A-99 | 140 | KCHSC | 93 |
| A-99 | 280 | KCHSC | 95 |
| A-134 | 140 | KCHSC | 0 |
| A-134 | 280 | KCHSC | 0 |
| A-117 | 140 | KCHSC | 80 |
| A-117 | 280 | KCHSC | 98 |
| A-102 | 140 | KCHSC | 78 |
| A-102 | 280 | KCHSC | 90 |
| A-133 | 140 | KCHSC | 0 |
| A-133 | 280 | KCHSC | 20 |
| A-128 | 140 | KCHSC | 0 |
| A-128 | 280 | KCHSC | 0 |
| A-136 | 140 | KCHSC | 76 |
| A-136 | 280 | KCHSC | 94 |
| A-137 | 140 | KCHSC | 6 |
| A-137 | 280 | KCHSC | 3 |
| A-138 | 140 | KCHSC | 91 |
| A-138 | 280 | KCHSC | 91 |
| A-140 | 140 | KCHSC | 95 |
| A-140 | 280 | KCHSC | 98 |
| A-143 | 140 | KCHSC | 88 |
| A-143 | 280 | KCHSC | 88 |
| A-144 | 140 | KCHSC | 89 |
| A-144 | 280 | KCHSC | 99 |
| A-145 | 140 | KCHSC | 94 |
| A-145 | 280 | KCHSC | 91 |
| A-146 | 140 | KCHSC | 89 |
| A-146 | 280 | KCHSC | 96 |
| A-147 | 140 | KCHSC | 93 |
| A-147 | 280 | KCHSC | 88 |
| Untreated | | KCHSC | 0 |

While the novel technology has been illustrated and described in detail in the figures and foregoing description, the same is to be considered as illustrative and not restrictive in character, it being understood that only the preferred aspects have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety to the extent they are not inconsistent with the explicit teachings of this specification.

1. A compound, comprising at a compound according to Formula I: 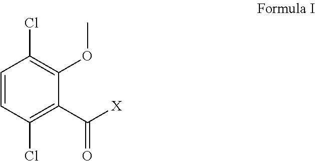
wherein X is: 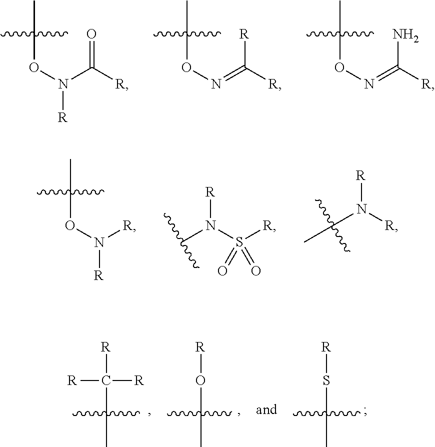
wherein R is independently selected from the group consisting of:
alkyl, aryl, or heteroaryl, wherein the compound exhibits herbicidal activity.

2. A compound according to claim 1, wherein X is: 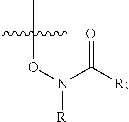
and
R is selected from the group consisting of; alkyl, aryl, or heteroaryl;
wherein; the compound exhibits herbicidal activity.

3. The compound according to claim 1, wherein, X is: 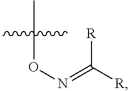
and
R is selected from the group consisting of; alkyl, aryl, or heteroaryl;
wherein the compound exhibits herbicidal activity.

4. The compound according to claim 1, wherein, Xa is one or more tautomers of: 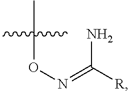
and
R is selected from the group consisting of; alkyl, aryl, or heteroaryl;
wherein the compound exhibits herbicidal activity.

5. The compound according to claim 1, wherein, X is: 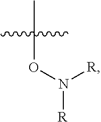
and
R is selected from the group consisting of; alkyl, aryl, or heteroaryl;
wherein the compound exhibits herbicidal activity.

6. A compound according to claim 1, comprising at least one compound with herbicidal activity selected from the group consisting of

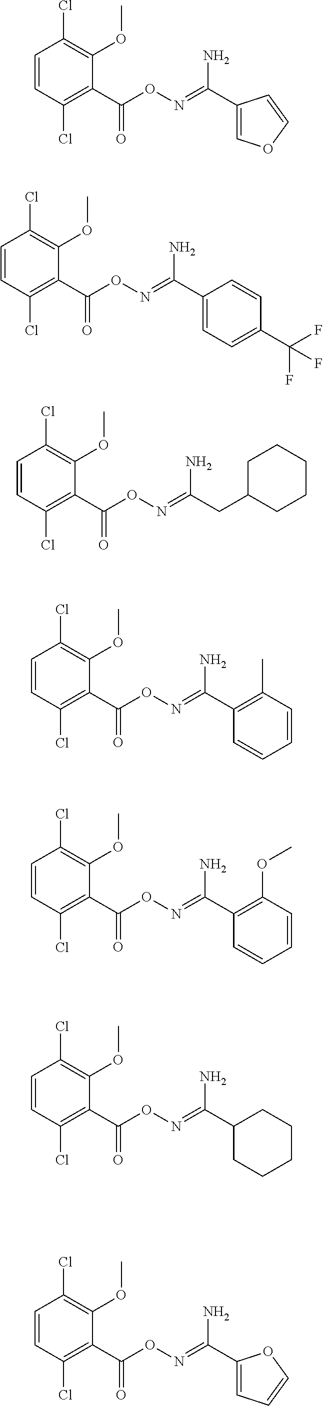

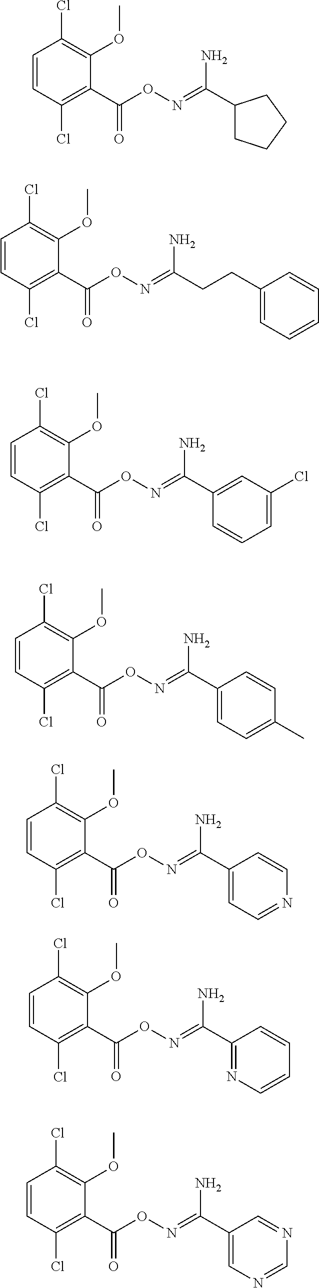

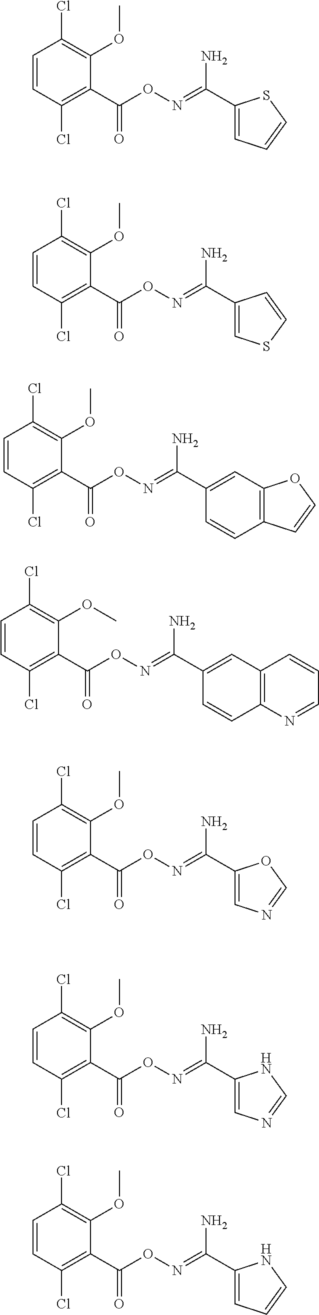

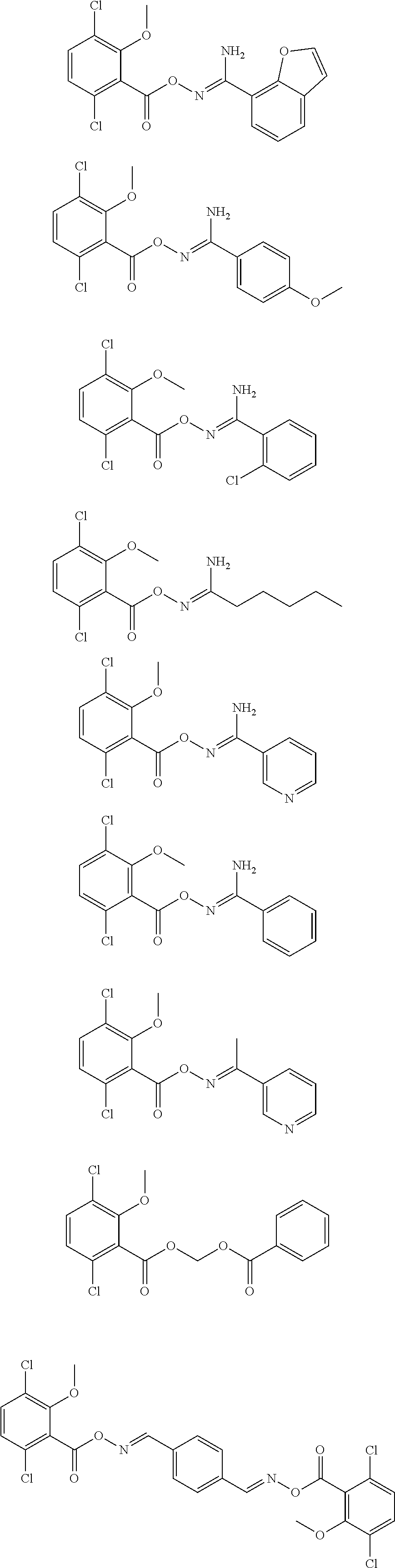

7. The compound according to claim 1, wherein the compound exhibits lower volatility than 3,6-dichloro-2-methoxybenzoic acid.

8-9. (canceled)

10. A formulation, comprising:
a compound of claim 1, and
at least one addition herbicide.

11. The formation of claim 10, comprising
at least one safener.

12-18. (canceled)

19. The formulation according to claim 10, wherein the at least one additional herbicide is selected from the group consisting of acetolactate synthase (ALS) inhibitor herbicides, synthetic auxin herbicides, phytoene desaturase (PDS) inhibitor herbicides, glyphosate, glufosinate, photosystem II (PS II) inhibitor herbicides, acetyl CoA carboxylase (ACCase) inhibitor herbicides, 4-hydroxyphenylpyruvate dioxygenase (HPPD) inhibitor herbicides, protoporphyrinogen oxidase (PROTOX) inhibitor herbicides, plant growth regulator herbicides, cellulose biosynthesis (CBI) inhibitor herbicides, very long chain fatty acid (VLCFA) herbicides, microtubule assembly inhibitor herbicides, fatty acid and lipid synthesis (FA/LSI) inhibitor herbicides, and combinations thereof.

20. (canceled)

21. The formulation according to claim 19, wherein the herbicide is an acetolactate synthase (ALS) inhibitor herbicide selected from the group consisting of: clodinafop, cyhalofop, diclofop, fenoxaprop, fenthiaprop, fluazifop, haloxyfop, metamifop, propaquizafop, quizalofop, alloxydim, butroxydim, clethodim, cloproxydim, cycloxydim, pinoxaden, profoxydim, sethoxydim, tepraloxydim, tralkoxydim, agriculturally acceptable salts or esters thereof, or combinations thereof

22. (canceled)

23. The formulation according to claim 19, wherein the herbicide is a synthetic auxin herbicide selected from the group consisting of: 2,4-D; 2,4-DB; 2,3,6-TBA, aminocyclopyrachlor, aminopyralid, benazolin-ethyl, chloramben, clomeprop, clopyralid, dichlorprop, dichlorprop-P, florpyrauxifen (such as florpyrauxifen-benzyl), fluroxypyr, fluroxypyr-MHE, halauxifen, halauxifen-methyl, mecoprop, mecoprop-P, MCPA, MCPA-thioethyl, MCPB, picloram, quinclorac, quinmerac, triclopyr, agriculturally acceptable salts and esters thereof, and combinations thereof.

24. The formulation according to claim 19, wherein the herbicide is a phytoene desaturase (PDS) inhibitor herbicides herbicide selected from the group consisting of: beflubutamid, diflufenican, fluridone, flurochloridone, flurtamone, norflurazon, picolinafen, agriculturally acceptable salts and esters thereof, and combinations thereof.

25. The formulation according to claim 19, wherein the herbicide is selected from the group consisting of: glyphosate, glufosinate, agriculturally acceptable salts and esters thereof, and combinations thereof.

26. The formulation according to claim 19, wherein the herbicide is a photosystem II (PS II) inhibitor herbicide selected from the group consisting of: ametryne, amicarbazone, atrazine, bentazone, bromacil, bromofenoxim, bromoxynil, chlorbromuron, chloridazon, chlorotoluron, chloroxuron, cyanazine, desmedipham, desmetryn, dimefuron, dimethametryn, diuron, ethidimuron, ethiozin, fenuron, fluometuron, hexazinone, iodobonil, ioxynil, isocil, isomethiozin, isoproturon, isouron, karbutilate, lenacil, linuron, metamitron, methabenzthiazuron, metobromuron, metoxuron, metribuzin, monolinuron, neburon, pentanochlor, phenmedipham, prometon, prometryn, propanil, propazine, pyridafol, pyridate, siduron, simazine, simetryne, tebuthiuron, terbacil, terbumeton, terbuthylazine, terbutryn, trietazine, and combinations thereof.

27. (canceled)

28. The formulation according to claim 19, wherein the herbicide is an acetyl CoA carboxylase (ACCase) inhibitor herbicide selected from the group consisting of: clodinafop, cyhalofop, diclofop, fenoxaprop, fenthiaprop, fluazifop, haloxyfop, metamifop, propaquizafop, quizalofop, alloxydim, butroxydim, clethodim, cloproxydim, cycloxydim, profoxydim, sethoxydim, tepraloxydim, tralkoxydim, agriculturally acceptable salts or esters thereof, and combinations thereof.

29. The formulation according to claim 19, wherein the herbicide is a 4-hydroxyphenylpyruvate dioxygenase (HPPD) inhibitor herbicide selected from the group consisting of: benzobicyclon, benzofenap, bicyclopyrone, fenquinotrione, isoxachlortole, isoxaflutole, lancotrione, mesotrione, pyrasulfotole, pyrazolynate, pyrazoxyfen, sulcotrione, tefuryltrione, tembotrione, tolpyralate, topramezone, agriculturally acceptable salts or esters thereof, and combinations thereof.

30. The formulation according to claim 19, wherein the herbicide is a protoporphyrinogen oxidase (PROTOX) inhibitor herbicide selected from the group consisting of: acifluorfen, azafenidin, benzfendizone, bifenox, butafenacil, carfentrazone, chlomethoxyfen, cinidon, fluazolate, flufenpyr, flumiclorac, flumioxazin, fluoroglycofen, fluthiacet, fomesafen, halosafen, lactofen, oxadiargyl, oxadiazon, oxyfluorfen, pentoxazone, profluazol, pyraclonil, pyraflufen, saflufenacil, sulfentrazone, thidiazimin, tiafenacil, agriculturally acceptable salts or esters thereof, and combinations thereof.

31. The formulation according to claim 19, wherein the herbicide is a plant growth regulator herbicide selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and combinations thereof.

32. The formulation according to claim 19, wherein the herbicide is a cellulose biosynthesis (CBI) inhibitor herbicide selected from the group consisting of chlorthiamid, dichlobenil, flupoxam, indaziflam, isoxaben, triaziflam, agriculturally acceptable salts or esters thereof, and combinations thereof.

33. The formulation according to claim 19, wherein the herbicide is a very long chain fatty acid (VLCFA) herbicide selected from the group consisting of acetochlor, alachlor, anilofos, butachlor, cafenstrole, dimethachlor, dimethenamid, diphenamid, fentrazamide, flufenacet, ipfencarbazone, mefenacet, metazachlor, metolachlor, naproanilide, napropamide, pethoxamid, piperophos, pretilachlor, propachlor, propisochlor, pyroxasulfone, thenylchlor, agriculturally acceptable salts or esters thereof, and combinations thereof.

34. The formulation according to claim 19, wherein the herbicide is a fatty acid and lipid synthesis (FA/LSI) inhibitor herbicide selected from the group consisting of benfuresate, bensulide, butylate, cycloate, dalapon, EPTC, esprocarb, ethofumesate, flupropanate, molinate, orbencarb, prosulfocarb, thiobencarb, tiocarbazil, tri-allate, vemolate, agriculturally acceptable salts or esters thereof, and combinations thereof.

35-36. (canceled)

37. The formulation according to claim 11, wherein the at least one safener is selected from the group consisting of quinolinoxyacetate safeners, azole safeners, or mixtures thereof.

38. The formulation according to claim 37, wherein the safener is selected from the group consisting of isoxadifen (e.g., isoxadifen-ethyl), cloquintocet (e.g., cloquintocet-mexyl), cyprosulfamide, mefenpyr (e.g., mefenpyr-diethyl), naphthalic anhydride, oxabetrinil, benzenesulfonamide, N-(aminocarbonyl)-2-chlorobenzenesulfonamide (2-CBSU), daimuron, dichloroacetamide, dicyclonon, fenchlorazole (e.g., fenchlorazole-ethyl), fenclorim, fluxofenim, dichloroacetamide safeners (e.g., AD-67, benoxacor, dichlormid, and furilazole), metcamifen, naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetyl hexahydro-3,3,8a-trimethylpyrrolo[1,2-a]pyrimidin-6-(2H-one) (BAS-145138), dichloromethyl-1,3-dioxolane (MG-191), and agriculturally acceptable salts, esters, or mixtures thereof.

39. (canceled)

40. A method of treating a field, comprising the steps of:
obtaining at least one compound according to claim 1; and
applying an agriculturally effective amount of the at least one of the compounds to a field.

41-43. (canceled)
